(19) United States
(12) Patent Application Publication
(10) Pub. No.: US 2011/0066414 A1
(43) Pub. Date: Mar. 17, 2011

(54) System and Method of Computing and Rendering the Nature of Molecules,Molecular Ions, Compounds and Materials

(76) Inventor: Randell L. Mills, Princeton, NJ (US)

(21) Appl. No.: 12/522,116

(22) PCT Filed: Jan. 2, 2008
(86) PCT No.: PCT/US08/00002

§ 371 Date: Dec. 1, 2010

Related U.S. Application Data
(60) Provisional application No. 60/986,750, filed on Nov. 9, 2007.
(60) Provisional application No. 60/986,675, filed on Nov. 9, 2007.
(60) Provisional application No. 60/988,537, filed on Nov. 16, 2007.
(60) Provisional application No. 60/904,164, filed on Mar. 1, 2007.
(60) Provisional application No. 60/898,415, filed on Jan. 31, 2007.
(60) Provisional application No. 60/907,433, filed on Apr. 2, 2007.
(60) Provisional application No. 60/880,061, filed on Jan. 12, 2007.
(60) Provisional application No. 60/913,556, filed on Apr. 24, 2007.
(60) Provisional application No. 60/878,055, filed on Jan. 3, 2007.
(60) Provisional application No. 60/907,722, filed on Apr. 13, 2007.

(51) Int. Cl. G06G 7/58

(52) U.S. Cl. 703/11

(57) ABSTRACT

A method and system of physically solving the charge, mass, and current density functions of pharmaceuticals, allotropes of carbon, metals, silicon molecules, semiconductors, boron molecules, aluminum molecules, coordinate compounds, and organometallic molecules, and tin molecules, or any portion of these species using Maxwell's equations and computing and rendering the physical nature of the chemical bond using the solutions. The results can be displayed on visual or graphical media. The display can be static or dynamic such that electron motion and specie's vibrational, rotational, and translational motion can be displayed in an embodiment. The displayed information is useful to anticipate reactivity and physical properties. The insight into the nature of the chemical bond of at least one species can permit the solution and display of those of other species to provide utility to anticipate their reactivity and physical properties.

This application claims priority to U.S. Application Nos. 60/878,055, filed 3 Jan. 2007; 60/880,061, filed 12 Jan. 2007; 60/898,415, filed 31 Jan. 2007; 60/904,164, filed 1 Mar. 2007; 60/907,433, filed 2 Apr. 2007; 60/907,722, filed 13 Apr. 2007; 60/913,556, filed 24 Apr. 2007; 60/986,675, filed 9 Nov. 2007; 60/986,750, filed 9 Nov. 2007; and 60/988,537, filed 16 Nov. 2007, the complete disclosures of which are incorporated herein by reference.

### FIELD OF THE INVENTION

This invention relates to a system and method of physically solving the charge, mass, and current density functions of molecules, molecular ions, compounds and materials, and at least one part thereof, comprising at least one from the group of pharmaceuticals, allotropes of carbon, metals, silicon molecules, semiconductors, boron molecules, aluminum molecules, coordinate compounds, and organometallic molecules, and tin molecules, or any portion of these species, and computing and rendering the nature of these species using the solutions. The results can be displayed on visual or graphical media. The displayed information provides insight into the nature of these species and is useful to anticipate their reactivity, physical properties, and spectral absorption and emission, and permits the solution and display of other species.

Rather than using postulated unverifiable theories that treat atomic particles as if they were not real, physical laws are now applied to atoms and ions. In an attempt to provide some physical insight into atomic problems and starting with the same essential physics as Bohr of the e⁻ moving in the Coulombic field of the proton with a true wave equation, as opposed to the diffusion equation of Schrödinger, a classical approach is explored which yields a model that is remarkably accurate and provides insight into physics on the atomic level. The proverbial view deeply seated in the wave-particle duality notion that there is no large-scale physical counterpart to the nature of the electron is shown not to be correct. Physical laws and intuition may be restored when dealing with the wave equation and quantum atomic problems.

Specifically, a theory of classical quantum mechanics (CQM) was derived from first principles as reported previously [reference Nos. 1-8] that successfully applies physical laws to the solution of atomic problems that has its basis in a breakthrough in the understanding of the stability of the bound electron to radiation. Rather than using the postulated Schrödinger boundary condition: “Ψ→0 as r→∞”, which leads to a purely mathematical model of the electron, the constraint is based on experimental observation. Using Maxwell's equations, the classical wave equation is solved with the constraint that the bound n=1-state electron cannot radiate energy. Although it is well known that an accelerated point particle radiates, an extended distribution modeled as a superposition of accelerating charges does not have to radiate. A simple invariant physical model arises naturally wherein the predicted results are extremely straightforward and internally consistent requiring minimal math, as in the case of the most famous equations of Newton, Maxwell, Poincare, de Broglie, and Planck on which the model is based. No new physics is needed; only the known physical laws based on direct observation are used.

Applicant's previously filed WO2005/067678 discloses a method and system of physically solving the charge, mass, and current density functions of atoms and atomic ions and computing and rendering the nature of these species using the solutions. The complete disclosure of this published PCT application is incorporated herein by reference.

Applicant's previously filed WO2005/116630 discloses a method and system of physically solving the charge, mass, and current density functions of excited states of atoms and atomic ions and computing and rendering the nature of these species using the solutions. The complete disclosure of this published PCT application is incorporated herein by reference.

Applicant's previously filed U.S. Published Patent Application No. 20050209788A1, relates to a method and system of physically solving the charge, mass, and current density functions of hydrogen-type molecules and molecular ions and computing and rendering the nature of the chemical bond using the solutions. The complete disclosure of this published application is incorporated herein by reference.

Applicant's previously filed WO2007/051078 discloses a method and system of physically solving the charge, mass, and current density functions of polyatomic molecules and polyatomic molecular ions and computing and rendering the nature of these species using the solutions. The complete disclosure of this published PCT application is incorporated herein by reference. This incorporated application discloses complete flow charts and written description of a computer program that can be modified using the novel equations and description below to physically solve the charge, mass, and current density functions of the specific groups of molecules, molecular ions, compounds and materials disclosed herein and computing and rendering the nature of these specific groups.

### BACKGROUND OF THE INVENTION

The old view that the electron is a zero or one-dimensional point in an all-space probability wave function Ψ(x) is not taken for granted. The theory of classical quantum mechanics (CQM), derived from first principles, must successfully and consistently apply physical laws on all scales [1-8]. Stability to radiation was ignored by all past atomic models. Historically, the point at which QM broke with classical laws can be traced to the issue of nonradiation of the one electron atom. Bohr just postulated orbits stable to radiation with the further postulate that the bound electron of the hydrogen atom does not obey Maxwell's equations—rather it obeys different physics [1-12]. Later physics was replaced by “pure mathematics” based on the notion of the inexplicable wave-particle duality nature of electrons which lead to the Schrödinger equation wherein the consequences of radiation predicted by Maxwell's equations were ignored. Ironically, Bohr, Schrödinger, and Dirac used the Coulomb potential, and Dirac used the vector potential of Maxwell's equations. But, all ignored electrodynamics and the corresponding radiative consequences. Dirac originally attempted to solve the bound electron physically with stability with respect to radiation according to Maxwell's equations with the further constraints that it was relativistically invariant and gave rise to electron spin [13]. He and many founders of QM such as Sommerfeld, Bohm, and Weinstein wrongly pursued a planetary model, were unsuccessful, and resorted to the current mathematical-probability-wave model that has many problems [9-16]. Consequently, Feynman for example, attempted to use first principles including Maxwell's equations to discover new physics to replace quantum mechanics [17].

Physical laws may indeed be the root of the observations thought to be “purely quantum mechanical”, and it was a mistake to make the assumption that Maxwell's electrodynamic equations must be rejected at the atomic level. Thus, in the present approach, the classical wave equation is solved with the constraint that a bound n=1-state electron cannot radiate energy.

Herein, derivations consider the electrodynamic effects of moving charges as well as the Coulomb potential, and the search is for a solution representative of the electron wherein there is acceleration of charge motion without radiation. The mathematical formulation for zero radiation based on Maxwell's equations follows from a derivation by Haus [18]. The function that describes the motion of the electron must not possess spacetime Fourier components that are synchronous with waves traveling at the speed of light. Similarly, nonradiation is demonstrated based on the electron's electromagnetic fields and the Poynting power vector.

It was shown previously [1-8] that CQM gives closed form solutions for the atom, including the stability of the n=1 state and the instability of the excited states, the equation of the photon and electron in excited states, and the equation of the free electron and photon, which predict the wave-particle duality behavior of particles and light. The current and charge density functions of the electron may be directly physically interpreted. For example, spin angular momentum results from the motion of negatively charged mass moving systematically, and the equation for angular momentum, r×p, can be applied directly to the wave function (a current density function) that describes the electron. The magnetic moment of a Bohr magneton, Stern Gerlach experiment, g factor, Lamb shift, resonant line width and shape, selection rules, correspondence principle, wave-particle duality, excited states, reduced mass, rotational energies, and momenta, orbital and spin splitting, spin-orbital coupling, Knight shift, and spin-nuclear coupling, and elastic electron scattering from helium atoms, are derived in closed-form equations based on Maxwell's equations. The calculations agree with experimental observations.

The Schrödinger equation gives a vague and fluid model of the electron. Schrödinger interpreted eΨ*(x)Ψ(x) as the charge-density or the amount of charge between x and x+dx (Ψ* is the complex conjugate of Ψ). Presumably, then, he pictured the electron to be spread over large regions of space. After Schrödinger's interpretation, Max Born, who was working with scattering theory, found that this interpretation led to inconsistencies, and he replaced the Schrödinger interpretation with the probability of finding the electron between x and x+dx as

∫Ψ(x)Ψ*(x)dx (1)

Born's interpretation is generally accepted. Nonetheless, interpretation of the wave function is a never-ending source of confusion and conflict. Many scientists have solved this problem by conveniently adopting the Schrödinger interpretation for some problems and the Born interpretation for others. This duality allows the electron to be everywhere at one time—yet have no volume. Alternatively, the electron can be viewed as a discrete particle that moves here and there (from r=0 to r=∞), and ΨΨ* gives the time average of this motion.

In contrast to the failure of the Bohr theory and the nonphysical, adjustable-parameter approach of quantum mechanics, multielectron atoms [1, 4] and the nature of the chemical bond [1, 5] are given by exact closed-form solutions containing fundamental constants only. Using the nonradiative wave equation solutions that describe the bound electron having conserved momentum and energy, the radii are determined from the force balance of the electric, magnetic, and centrifugal forces that corresponds to the minimum of energy of the system. The ionization energies are then given by the electric and magnetic energies at these radii. The spreadsheets to calculate the energies from exact solutions of one through twenty-electron atoms are given in '06 Mills GUT [1] and are available from the interne [19]. For 400 atoms and ions, as well as hundreds of molecules, the agreement between the predicted and experimental results is remarkable.

The background theory of classical quantum mechanics (CQM) for the physical solutions of atoms and atomic ions is disclosed in R. L. Mills, The Grand Unified Theory of Classical Quantum Mechanics, January 2000 Edition, BlackLight Power, Inc., Cranbury, N.J., ISBN 0963517147, Library of Congress Control Number 200091384, (“'00 GUT”), provided by BlackLight Power, Inc. 493 Old Trenton Road, Cranbury, N.J. 08512; R. L. Mills, The Grand Unified Theory of Classical Quantum Mechanics, September 2001 Edition, BlackLight Power, Inc., Cranbury, N.J., ISBN 0963517155, Library of Congress Control Number 2001097371, (“'01 GUT”), provided by BlackLight Power, Inc. 493 Old Trenton Road, Cranbury, N.J. 08512; R. L. Mills, The Grand Unified Theory of Classical Quantum Mechanics, May 2005 Edition, BlackLight Power, Inc., Cranbury, N.J., ISBN 0963517163, Library of Congress Control Number 2004101976, (“'05 GUT”), provided by BlackLight Power, Inc. 493 Old Trenton Road, Cranbury, N.J. 08512; R. L. Mills, The Grand Unified Theory of Classical Quantum Mechanics, June 2006 Edition, Cadmus Professional Communications—Science Press Division, Ephrata, Pa., ISBN 0963517171, Library of Congress Control Number 2005936834, (“'06 GUT”), provided by BlackLight Power, Inc. 493 Old Trenton Road, Cranbury, N.J. 08512; R. L. Mills, The Grand Unified Theory of Classical Quantum Mechanics, October 2007 Edition, Cadmus Professional Communications—A Conveo Company, Richmond, Va., ISBN 096351718X, Library of Congress Control Number 2007938695, (“'07 GUT”), provided by BlackLight Power, Inc. 493 Old Trenton Road, Cranbury, N.J. 08512 posted at http://www.blacklightpower.com/theory/bookdownload.shtml., and in prior published PCT applications WO90/13126; WO92/10838; WO94/29873; WO96/42085; WO99/05735; WO99/26078; WO99/34322; WO99/35698; WO00/07931; WO00/07932; WO01/095944; WO01/18948; WO01/21300; WO01/22472; WO01/70627; WO02/087291; WO02/088020; WO02/16956; WO03/093173; WO03/066516; WO04/092058; WO05/041368; WO05/067678; WO2005/116630; WO2007/051078; and WO2007/053486, and U.S. Pat. Nos. 6,024,935 and 7,188,033; the entire disclosures of which are all incorporated herein by reference (hereinafter “Mills Prior Publications”).

The following list of references, which are also incorporated herein by reference in their entirety, are referred to in the above sections using [brackets]:
1. R. L. Mills, “The Grand Unified Theory of Classical Quantum Mechanics”, October 2007 Edition, Cadmus Professional Communications—A Conveo Company, Richmond, Va., ISBN 096351718X, Library of Congress Control Number 2007938695, at www.blacklightpower.com.
2. R. L. Mills, “Classical Quantum Mechanics”, Physics Essays, Vol. 16, No. 4, December, (2003), pp. 433-498; posted with spreadsheets at www.blacklightpower.com/techpapers.shtml.
3. R. Mills, “Physical Solutions of the Nature of the Atom, Photon, and Their Interactions to Form Excited and Predicted Hydrino States”, in press, http://www.blacklightpower.comAechpapers.shtml.
4. R. L. Mills, “Exact Classical Quantum Mechanical Solutions for One-Through Twenty-Electron Atoms”, Phys. Essays, Vol. 18, (2005), 321-361, posted with spreadsheets at http://www.blacklightpower.com/techpapers.shtml.
5. R. L. Mills, “The Nature of the Chemical Bond Revisited and an Alternative Maxwellian Approach”, Physics Essays, Vol. 17, (2004), pp. 342-389, posted with spreadsheets at http://www.blacklightpower.com/techpapers.shtml.
6. R. L. Mills, “Maxwell's Equations and QED: Which is Fact and Which is Fiction”, in press, posted with spreadsheets at http://www.blacklightpower.com/techpapers.shtml.
7. R. L. Mills, “Exact Classical Quantum Mechanical Solution for Atomic Helium Which Predicts Conjugate Parameters from a Unique Solution for the First Time”, submitted, posted with spreadsheets at http://www.blacklightpower.com/theory/theory.shtml.
8. R. Mills, “The Grand Unified Theory of Classical Quantum Mechanics”, Int. J. Hydrogen Energy, Vol. 27, No. 5, (2002), pp. 565-590.
9. R. L. Mills, “The Fallacy of Feynman's Argument on the Stability of the Hydrogen Atom According to Quantum Mechanics”, Annales de la Fondation Louis de Broglie, Vol. 30, No. 2, (2005), pp. 129-151, posted at http://www.blacklightpower.com/techpapers.shtml.
10. R. Mills, The Nature of Free Electrons in Superfluid Helium—a Test of Quantum Mechanics and a Basis to Review its Foundations and Make a Comparison to Classical Theory, Int. J. Hydrogen Energy, Vol. 26, No. 10, (2001), pp. 1059-1096.
11. R. Mills, “The Hydrogen Atom Revisited”, Int. J. of Hydrogen Energy, Vol. 25, Issue 12, December, (2000), pp. 1171-1183.
12. F. Laloë, Do we really understand quantum mechanics? Strange correlations, paradoxes, and theorems, Am. J. Phys. 69 (6), June 2001, 655-701.
13. P. Pearle, Foundations of Physics, “Absence of radiationless motions of relativistically rigid classical electron”, Vol. 7, Nos. 11/12, (1977), pp. 931-945.
14. V. F. Weisskopf, Reviews of Modern Physics, Vol. 21, No. 2, (1949), pp. 305-315.
15. H. Wergeland, “The Klein Paradox Revisited”, Old and New Questions in Physics, Cosmology, Philosophy, and Theoretical Biology, A. van der Merwe, Editor, Plenum Press, New York, (1983), pp. 503-515.
16. A. Einstein, B. Podolsky, N. Rosen, Phys. Rev., Vol. 47, (1935), p. 777.
17. F. Dyson, “Feynman's proof of Maxwell equations”, Am. J. Phys., Vol. 58, (1990), pp. 209-211.
18. Haus, H. A., “On the radiation from point charges”, American Journal of Physics, 54, (1986), pp. 1126-1129.
19. http://www.blacklightpower.com/new.shtml.

### SUMMARY OF THE INVENTION

The present invention, an exemplary embodiment of which is also referred to as Millsian software, stems from a new fundamental insight into the nature of the atom. Applicant's new theory of Classical Quantum Mechanics (CQM) reveals the nature of atoms, molecules, molecular ions, compounds and materials using classical physical laws for the first time. As discussed above, traditional quantum mechanics can solve neither multi-electron atoms nor molecules exactly. By contrast, CQM produces exact, closed-form solutions containing physical constants only for even the most complex atoms, molecules, molecular ions, compounds and materials.

The present invention is the first and only molecular modeling program ever built on the CQM framework. For example, all the major functional groups that make up most organic molecules have been solved exactly in closed-form solutions with CQM. By using these functional groups as building blocks, or independent units, a potentially infinite number of organic molecules can be solved. As a result, the present invention can be used to visualize the exact 3D structure and calculate the heat of formation of any organic molecule.

For the first time, the significant building-block molecules of chemistry have been successfully solved using classical physical laws in exact closed-form equations having fundamental constants only. The major functional groups have been solved from which molecules of infinite length can be solved almost instantly with a computer program. The predictions are accurate within experimental error for over 375 exemplary molecules.

Applicant's CQM is the theory that physical laws (Maxwell's Equations, Newton's Laws, Special and General Relativity) must hold on all scales. The theory is based on an often overlooked result of Maxwell's Equations, that an extended distribution of charge may, under certain conditions, accelerate without radiating. This “condition of no radiation” is invoked to solve the physical structure of subatomic particles, atoms, and molecules.

In exact closed-form equations with physical constants only, solutions to thousands of known experimental values arise that were beyond the reach of previous outdated theories. These include the electron spin, g-factor, multi-electron atoms, excited states, polyatomic molecules, wave-particle duality and the nature of the photon, the masses and families of fundamental particles, and the relationships between fundamental laws of the universe that reveal why the universe is accelerating as it expands. CQM is successful to over 85 orders of magnitude, from the level of quarks to the cosmos. Applicant now has over 65 peer-reviewed journal articles and also books discussing the CQM and supporting experimental evidence.

The molecular modeling market was estimated to be a two-billion-dollar per year industry in 2002, with hundreds of millions of government and industry dollars invested in computer algorithms and supercomputer centers. This makes it the largest effort of computational chemistry and physics.

The present invention's advantages over other models includes: Rendering true molecular structures; Providing precisely all characteristics, spatial and temporal charge distributions and energies of every electron in every bond, and of every bonding atom; Facilitating the identification of biologically active sites in drugs; and Facilitating drug design.

An objective of the present invention is to solve the charge (mass) and current-density functions of specific groups of molecules, molecular ions, compounds and materials disclosed herein or any portion of these species from first principles. In an embodiment, the solution for the molecules, molecular ions, compounds and materials, or any portion of these species is derived from Maxwell's equations invoking the constraint that the bound electron before excitation does not radiate even though it undergoes acceleration.

Another objective of the present invention is to generate a readout, display, or image of the solutions so that the nature of the molecules, molecular ions, compounds and materials, or any portion of these species be better understood and potentially applied to predict reactivity and physical and optical properties.

Another objective of the present invention is to apply the methods and systems of solving the nature of the molecules, molecular ions, compounds and materials, or any portion of these species and their rendering to numerical or graphical.

These objectives and other objectives are obtained by a system of computing and rendering the nature of at least one specie selected from the groups of molecules, molecular ions, compounds and materials disclosed herein, comprising physical, Maxwellian solutions of charge, mass, and current density functions of said specie, said system comprising a processor for processing physical, Maxwellian equations representing charge, mass, and current density functions of said specie; and an output device in communication with the processor for displaying said physical, Maxwellian solutions of charge, mass, and current density functions of said specie.

Also provided is a composition of matter comprising a plurality of atoms, the improvement comprising a novel property or use discovered by calculation of at least one of a bond distance between two of the atoms, a bond angle between three of the atoms, and a bond energy between two of the atoms, orbital intercept distances and angles, charge-density functions of atomic, hybridized, and molecular orbitals, the bond distance, bond angle, and bond energy being calculated from physical solutions of the charge, mass, and current density functions of atoms and atomic ions, which solutions are derived from Maxwell's equations using a constraint that a bound electron(s) does not radiate under acceleration.

The presented exact physical solutions for known species of the groups of molecules, molecular ions, compounds and materials disclosed herein can be applied to other unknown species. These solutions can be used to predict the properties of presently unknown species and engineer compositions of matter in a manner which is not possible using past quantum mechanical techniques. The molecular solutions can be used to design synthetic pathways and predict product yields based on equilibrium constants calculated from the heats of formation. Not only can new stable compositions of matter be predicted, but now the structures of combinatorial chemistry reactions can be predicted.

Pharmaceutical applications include the ability to graphically or computationally render the structures of drugs that permit the identification of the biologically active parts of the specie to be identified from the common spatial charge-density functions of a series of active species. Novel drugs can now be designed according to geometrical parameters and bonding interactions with the data of the structure of the active site of the drug.

The molecular solutions can be used to design synthetic pathways and predict product yields based on equilibrium constants calculated from the heats of formation. New stable compositions of matter can be predicted as well as the structures of combinatorial chemistry reactions. Further important pharmaceutical applications include the ability to graphically or computationally render the structures of drugs that permit the identification of the biologically active parts of the molecules to be identified from the common spatial charge-density functions of a series of active molecules. Drugs can be designed according to geometrical parameters and bonding interactions with the data of the structure of the active site of the drug.

To calculate conformations, folding, and physical properties, the exact solutions of the charge distributions in any given molecule are used to calculate the fields, and from the fields, the interactions between groups of the same molecule or between groups on different molecules are calculated wherein the interactions are distance and relative orientation dependent. The fields and interactions can be determined using a finite-element-analysis approach of Maxwell's equations.

The system can be used to calculate conformations, folding, and physical properties, and the exact solutions of the charge distributions in any given specie are used to calculate the fields. From the fields, the interactions between groups of the same specie or between groups on different species are calculated wherein the interactions are distance and relative orientation dependent. The fields and interactions can be determined using a finite-element-analysis approach of Maxwell's equations.

In another embodiment of the system, metabolites or inhibitors that bind to a target enzyme are rendered and based on the topography of the electron density revealed by these renderings, nonmetabolizable analogues with the same or similar electron topography that bind to this enzyme to provide inhibition are rendered by the system. Thus, the system provides candidate drug agents based on charge density and geometry without direct knowledge of the structure of the enzyme. For example, metabolites or inhibitors that bind to 3-hydroxy-3-methylglutaryl-CoA reductase which catalyzes the rate-limiting and irreversible step of cholesterol synthesis are modeled. Then, based on the topography of the electron density revealed by these renderings, nonmetabolizable analogues with the same or similar electron topography that bind to this enzyme to provide inhibition at this step are rendered by the system. Thus, the system provides candidate anticholesterol agents based on charge density and geometry without direct knowledge of the structure of the enzyme. In an embodiment, the metabolites or inhibitors are at least one from the list of 3-hydroxy-3-methylglutarate, 3-hydroxybutyrate, 3-hydroxy-3-methylpentanoate, 4-bromocrotonyl-CoA, but-3-ynoyl-CoA, pent-3-ynoyl-CoA, dec-3-ynoyl-CoA, ML-236A, ML-236B (compactin), ML-236C, mevinolin, mevinolinic acid, or a mevalonic acid analogue. Further metabolites and inhibitors of corresponding enzymes that are rendered by system which then outputs renderings of analogues as candidate new drugs based on similarities of geometry and charge density are disclosed in my previous U.S. Pat. No. 5,773,592, Randell L. Mills, Jun. 30, 1998, entitled, “Prodrugs for Selective Drug Delivery” and U.S. Pat. No. 5,428,163, Randell L. Mills, Jun. 27, 1995 entitled “Prodrugs for Selective Drug Delivery” which are herein incorporated in their entirety by reference.

Embodiments of the system for performing computing and rendering of the nature of the groups of molecules and molecular ions, or any portion of these species using the physical solutions may comprise a general purpose computer. Such a general purpose computer may have any number of basic configurations. For example, such a general purpose computer may comprise a central processing unit (CPU), one or more specialized processors, system memory, a mass storage device such as a magnetic disk, an optical disk, or other storage device, an input means, such as a keyboard or mouse, a display device, and a printer or other output device. A system implementing the present invention can also comprise a special purpose computer or other hardware system and all should be included within its scope. A complete description and drawing of a flow chart of how a computer can be used is disclosed in Applicant's prior incorporated WO2007/051078 application.

Although not preferred, any of the calculated and measured values and constants recited in the equations herein can be adjusted, for example, up to +10%, if desired.

### BRIEF DESCRIPTION OF THE DRAWINGS

FIG. 1 illustrates Aspirin (acetylsalicylic acid).

FIG. 2 illustrates grey scale, translucent view of the charge-density of aspirin showing the orbitals of the atoms at their radii, the ellipsoidal surface of each H or H₂-type ellipsoidal MO that transitions to the corresponding outer shell of the atom(s) participating in each bond, and the hydrogen nuclei.

FIG. 3 illustrates the structure of diamond. (A) Twenty six C—C-bond MOs. (B). Fifty one C—C-bond MOs.

FIG. 4 illustrates C₆₀ MO comprising a hollow cage of sixty carbon atoms bound with the linear combination of sixty sets of C—C-bond MOs bridged by 30 sets of C═C-bond MOs. A C═C group is bound to two C—C groups at each vertex carbon atom of C₆₀. Color scale, translucent pentagonal view of the charge-density of the C₆₀-bond MO with each C2sp³ HO shown transparently. For each C—C and C═C bond, the ellipsoidal surface of the H₂-type ellipsoidal MO that transitions to the C2sp³ HO, the C2sp³ HO shell, inner most C1s shell, and the nuclei, are shown.

FIG. 5 illustrates an opaque pentagonal view of the charge-density of the C₆₀ MO high-lighting the twenty hexagonal and twelve pentagonal units joined together such that no two pentagons share an edge. The six-six ring edges are C═C bonds and the five-five ring edges are C—C-bonds such that each hexagon is comprised of alternating C═C-bond MOs and C—C-bond MOs and each pentagon is comprised of only C—C-bond MOs.

FIG. 6 illustrates a hexagonal translucent view.

FIG. 7 illustrates a hexagonal opaque view.

FIG. 8 illustrates the structure of graphite. (A). Single plane of macromolecule of indefinite size. (B). Layers of graphitic planes.

FIG. 9 illustrates a point charge above an infinite planar conductor.

FIG. 10 illustrates a point charge above an infinite planar conductor and the image charge to meet the boundary condition Φ=0 at z=0.

FIG. 11 illustrates electric field lines from a positive point charge near an infinite planar conductor.

FIG. 12 illustrates the surface charge density distribution on the surface of the conduction planar conductor induced by the point charge at the position +. (A) The surface charge density −σ(ρ) (shown in color-scale relief). (B) The cross-sectional view of the surface charge density.

FIG. 13 illustrates a point charge located between two infinite planar conductors.

FIG. 14 illustrates the surface charge density −σ(ρ) of a planar electron shown in color scale.

FIG. 15 illustrates the body-centered cubic lithium metal lattice showing the electrons of as planar two-dimensional membranes of zero thickness that are each an equipotential energy surface comprised of the superposition of multiple electrons. (A) and (B) The unit-cell component of the surface charge density of a planar electron having an electric field equivalent to that of image point charge for each corresponding positive ion of the lattice. (C) Opaque view of the ions and electrons of a unit cell. (D) Transparent view of the ions and electrons of a unit cell.

FIG. 16 illustrates the body-centered cubic metal lattice of lithium showing the unit cell of electrons and ions. (A) Diagonal view. (B) Top view.

FIG. 17 illustrates a portion of the crystalline lattice of Li metal comprising 3³ body-centered cubic unit cells of electrons and ions. (A) Rotated diagonal opaque view. (B) Rotated diagonal transparent view. (C) Side transparent view.

FIG. 18 illustrates the crystalline unit cells of the alkali metals showing each lattice of ions and electrons to the same scale. (A) The crystal structure of Li. (B) The crystal structure of Na. (C) The crystal structure of K. (D) The crystal structure of Rb. (E) The crystal structure of Cs.

FIG. 19A-D illustrates grey scale, translucent view of the charge-densities of the series SiH_{n=1,2,3,4}, showing the orbitals of each member Si atom at their radii, the ellipsoidal surface of each H₂-type ellipsoidal MO of H that transitions to the outer shell of the Si atom participating in each Si—H bond, and the hydrogen nuclei.

FIG. 20 illustrates Disilane. Color scale, translucent view of the charge-density of H₃SiSiH₃ comprising the linear combination of two sets of three Si—H-bond MOs and a Si—Si-bond MO with the Siₛᵢₗₐₙₑ3sp³ HOs of the Si—Si-bond MO shown transparently. The Si—Si-bond MO comprises a H₂-type ellipsoidal MO bridging two Siₛᵢₗₐₙₑ3sp3 HOs. For each Si—H and the Si—Si bond, the ellipsoidal surface of the H₂-type ellipsoidal MO that transitions to the Siₛᵢₗₐₙₑ3sp3 HO, the Siₛᵢₗₐₙₑ3SP3 HO shell with radius 0.97295a₀ (Eq. (20.21)), inner Si1s, Si2s, and Si2p shells with radii of Si1s=0.07216a₀ (Eq. (10.51)), Si2s=0.31274a₀ (Eq. (10.62)), and Si2p=0.40978a₀ (Eq. (10.212)), respectively, and the nuclei, are shown.

FIG. 21 illustrates Dimethylsilane. Grey scale, translucent view of the charge-density of (H₃C)₂ SiH₂ showing the orbitals of the Si and C atoms at their radii, the ellipsoidal surface of each H or H₂-type ellipsoidal MO that transitions to the corresponding outer shell of the atoms participating in each bond, and the hydrogen nuclei.

FIG. 22 illustrates Hexamethyldisilane. Grey scale, opaque view of the charge-density of (CH₃)₃ SiSi (CH₃)₃ showing the orbitals of the Si and C atoms at their radii, the ellipsoidal surface of each H or H₂-type ellipsoidal MO that transitions to the corresponding outer shell of the atoms participating in each bond, and the hydrogen nuclei.

FIG. 23 illustrates grey scale, translucent view of the charge-density of ((CH₃)₂SiO)₃ showing the orbitals of the Si, O, and C atoms at their radii, the ellipsoidal surface of each H or H₂-type ellipsoidal MO that transitions to the corresponding outer shell of the atoms participating in each bond, and the nuclei.

FIG. 24 illustrates grey scale, translucent view of the charge-density of (CH₃)₃ SiOSi (CH₃)₃ showing the orbitals of the Si, O, and C atoms at their radii, the ellipsoidal surface of each H or H₂-type ellipsoidal MO that transitions to the corresponding outer shell of the atoms participating in each bond, and the nuclei.

FIG. 25A-B illustrates the diamond structure of silicon in the insulator state. Axes indicate positions of additional bonds of the repeating structure. (A) Twenty six C—C-bond MOs. (B) Fifty one C—C-bond MOs.

FIG. 26A-B illustrates STM topographs of the clean Si(111)-(7×7) surface. Reprinted with permission from Ref [1]. Copyright 1995 American Chemical Society.

FIG. 27 (A), (B), and (C) illustrate the conducting state of crystalline silicon showing the covalent diamond-structure network of the unit cell with two electrons ionized from σ MO shown as a planar two-dimensional membrane of zero thickness that is the perpendicular bisector of the former Si—Si bond axis. The corresponding two Si⁺ ions (smaller radii) are centered at the positions of the atoms that contributed the ionized Si3sp³-HO electrons. The electron equipotential energy surface may superimpose with multiple planar electron membranes. The surface charge density of each electron gives rise to an electric field equivalent to that of image point charge for each corresponding positive ion of the lattice.

FIG. 28 illustrates Diborane. Grey scale, opague view of the charge-density of B₂H₆ comprising the linear combination of two sets of two B—H-bond MOs and two B—H—B-bond MOs. For each B—H and B—H—B bond, the ellipsoidal surface of the H₂-type ellipsoidal MO transitions to the B2sp³ HO shell with radius 0.89047a₀ (Eq. (22.17)). The inner B1s radius is 0.20670a₀ (Eq. (10.51)).

FIG. 29 illustrates Trimethylborane. Grey scale, translucent view of the charge-density of (H₃C)₃ B showing the orbitals of the B and C atoms at their radii, the ellipsoidal surface of each H or H₂-type ellipsoidal MO that transitions to the corresponding outer shell of the atoms participating in each bond, and the hydrogen nuclei.

FIG. 30 illustrates Tetramethyldiborane. Grey scale, translucent view of the charge-density of (CH₃)₂ BH₂B(CH₃)₂ showing the orbitals of the B and C atoms at their radii, the ellipsoidal surface of each H or H₂-type ellipsoidal MO that transitions to the corresponding outer shell of the atoms participating in each bond, and the hydrogen nuclei.

FIG. 31 illustrates Trimethoxyborane. Grey scale, translucent view of the charge-density of (H₃CO)₃ B showing the orbitals of the B, O, and C atoms at their radii, the ellipsoidal surface of each H or H₂-type ellipsoidal MO that transitions to the corresponding outer shell of the atoms participating in each bond, and the hydrogen nuclei.

FIG. 32 illustrates Boric Acid. Grey scale, translucent view of the charge-density of (HO)₃ B showing the orbitals of the B and O atoms at their radii, the ellipsoidal surface of each H or H₂-type ellipsoidal MO that transitions to the corresponding outer shell of the atoms participating in each bond, and the hydrogen nuclei.

FIG. 33 illustrates Phenylborinic Anhydride. Grey scale, translucent view of the charge-density of phenylborinic anhydride showing the orbitals of the B and O atoms at their radii, the ellipsoidal surface of each H or H₂-type ellipsoidal MO that transitions to the corresponding outer shell of the atoms participating in each bond, and the hydrogen nuclei.

FIG. 34 illustrates Trisdimethylaminoborane. Grey scale, translucent view of the charge-density of ((H₃C)₂ N)₃ B showing the orbitals of the B, N, and C atoms at their radii, the ellipsoidal surface of each H or H₂-type ellipsoidal MO that transitions to the corresponding outer shell of the atoms participating in each bond, and the hydrogen nuclei.

FIG. 35 illustrates Trimethylaminotrimethylborane. Grey scale, translucent view of the charge-density of (CH₃)₃ BN(CH₃)₃ showing the orbitals of the B, N, and C atoms at their radii, the ellipsoidal surface of each H or H₂-type ellipsoidal MO that transitions to the corresponding outer shell of the atoms participating in each bond, and the hydrogen nuclei.

FIG. 36 illustrates Boron Trifluoride. Grey scale, translucent view of the charge-density of BF₃ showing the orbitals of the B and F atoms at their radii, and the ellipsoidal surface of each H₂-type ellipsoidal MO that transitions to the corresponding outer shell of the atoms participating in each bond.

FIG. 37 illustrates Boron Trichloride. Grey scale, translucent view of the charge-density of BCl₃ showing the orbitals of the B and Cl atoms at their radii, and the ellipsoidal surface of each H₂-type ellipsoidal MO that transitions to the corresponding outer shell of the atoms participating in each bond.

FIG. 38 illustrates Trimethylaluminum. Grey scale, translucent view of the charge-density of (H₃C)₃ Al comprising the linear combination of three sets of three C—H-bond MOs and three C—Al-bond MOs with the Al_{ogranoAl}3sp³ HOs and C2sp³ HOs shown transparently. Each C—Al-bond MO comprises a H₂-type ellipsoidal MO bridging C2sp³ and Al3sp³ HOs. For each C—H and C—Al bond, the ellipsoidal surface of the H₂-type ellipsoidal MO that transitions to the C2sp³ HO shell with radius 0.89582; (Eq. (15.32)) or Al3sp³ HO, the Al3sp³ HO shell with radius 0.85503; (Eq. (15.32)), inner Al1s, Al2s, and Al2p shells with radii of Al1s=0.07778; (Eq. (10.51)), Al2s=0.33923; (Eq. (10.62)), and Al2p=0.45620; (Eq. (10.212)), respectively, and the nuclei (red, not to scale), are shown.

FIG. 39 illustrates Scandium Trifluoride. Grey scale, translucent view of the charge-density of ScF₃ showing the orbitals of the Sc and F atoms at their radii, the ellipsoidal surface of each H₂-type ellipsoidal MO that transitions to the corresponding outer shell of the atoms participating in each bond, and the nuclei.

FIG. 40 illustrates Titanium Tetrafluoride. Grey scale, translucent view of the charge-density of TiF₄ showing the orbitals of the Ti and F atoms at their radii, the ellipsoidal surface of each H₂-type ellipsoidal MO that transitions to the corresponding outer shell of the atoms participating in each bond, and the nuclei.

FIG. 41 illustrates Vanadium Hexacarbonyl. Grey scale, translucent view of the charge-density of V (CO)₆ showing the orbitals of the V, C, and O atoms at their radii, the ellipsoidal surface of each H₂-type ellipsoidal MO that transitions to the corresponding outer shell of the atoms participating in each bond, and the nuclei.

FIG. 42 illustrates Dibenzene Vanadium. Grey scale, translucent view of the charge-density of V(C₆H₆)₂ showing the orbitals of the V and C atoms at their radii, the ellipsoidal surface of each H or H₂-type ellipsoidal MO that transitions to the corresponding outer shell of the atoms participating in each bond, and the hydrogen nuclei.

FIG. 43 illustrates Toluene.

FIG. 44 illustrates Chromium Hexacarbonyl. Grey scale, translucent view of the charge-density of Cr (CO)₆ showing the orbitals of the Cr, C, and O atoms at their radii, the ellipsoidal surface of each H₂-type ellipsoidal MO that transitions to the corresponding outer shell of the atoms participating in each bond, and the nuclei.

FIG. 45 illustrates Di-(1,2,4-trimethylbenzene) Chromium. Grey scale, opaque view of the charge-density of Cr((CH₃)₃C₆H₃)₂ showing the orbitals of the Cr and C atoms at their radii and the ellipsoidal surface of each H or H₂-type ellipsoidal MO that transitions to the corresponding outer shell of the atoms participating in each bond.

FIG. 46 illustrates Diamanganese decacarbonyl. Grey scale, opaque view of the charge-density of Mn₂ (CO)₁₀ showing the orbitals of the Mn, C, and O atoms at their radii and the ellipsoidal surface of each H₂-type ellipsoidal MO that transitions to the corresponding outer shell of the atoms participating in each bond.

FIG. 47 illustrates Iron Pentacarbonyl. Grey scale, translucent view of the charge-density of Fe (CO)₅ showing the orbitals of the Fe, C, and O atoms at their radii, the ellipsoidal surface of each H₂-type ellipsoidal MO that transitions to the corresponding outer shell of the atoms participating in each bond, and the nuclei.

FIG. 48 illustrates Bis-cylopentadienyl Iron. Grey scale, opaque view of the charge-density of Fe (C₅H₅)₂ showing the orbitals of the Fe and C atoms at their radii and the ellipsoidal surface of each H or H₂-type ellipsoidal MO that transitions to the corresponding outer shell of the atoms participating in each bond.

FIG. 49 illustrates Cobalt Tetracarbonyl Hydride. Color scale, translucent view of the charge-density of CoH(CO)₄ showing the orbitals of the Co, C, and O atoms at their radii, the ellipsoidal surface of each H or H₂-type ellipsoidal MO that transitions to the corresponding outer shell of the atoms participating in each bond, and the nuclei.

FIG. 50 illustrates Nickel Tetracarbonyl. Grey scale, translucent view of the charge-density of Ni (CO)₄ showing the orbitals of the Ni, C, and O atoms at their radii, the ellipsoidal surface of each H₂-type ellipsoidal MO that transitions to the corresponding outer shell of the atoms participating in each bond, and the nuclei.

FIG. 51 illustrates Nickelocene. Grey scale, opaque view of the charge-density of Ni(C₅H₅)₂ showing the orbitals of the Ni and C atoms at their radii and the ellipsoidal surface of each H or H₂-type ellipsoidal MO that transitions to the corresponding outer shell of the atoms participating in each bond.

FIG. 52 illustrates Copper Chloride. Grey scale, translucent view of the charge-density of CuCl showing the orbitals of the Cu and Cl atoms at their radii, the ellipsoidal surface of each H₂-type ellipsoidal MO that transitions to the corresponding outer shell of the atoms participating in each bond, and the nuclei.

FIG. 53 illustrates Copper Dichloride. Grey scale, translucent view of the charge-density of CuCl₂ showing the orbitals of the Cu and Cl atoms at their radii, the ellipsoidal surface of each H₂-type ellipsoidal MO that transitions to the corresponding outer shell of the atoms participating in each bond, and the nuclei.

FIG. 54 illustrates Zinc Chloride. Grey scale, translucent view of the charge-density of ZnCl showing the orbitals of the Zn and Cl atoms at their radii, the ellipsoidal surface of each H₂-type ellipsoidal MO that transitions to the corresponding outer shell of the atoms participating in each bond, and the nuclei.

FIG. 55 illustrates Di-n-butylzinc. Grey scale, translucent view of the charge-density of Zn(C₄H₉)₂ showing the orbitals of the Zn and C atoms at their radii, the ellipsoidal surface of each H or H₂-type ellipsoidal MO that transitions to the corresponding outer shell of the atoms participating in each bond, and the nuclei.

FIG. 56 illustrates Tin Tetrachloride. Grey scale, translucent view of the charge-density of SnCl₄ showing the orbitals of the Sn and Cl atoms at their radii, the ellipsoidal surface of each H₂-type ellipsoidal MO that transitions to the corresponding outer shell of the atoms participating in each bond, and the nuclei.

FIG. 57 illustrates Hexaphenyldistannane. Grey scale, opaque view of the charge-density of (C₆H₅)₃SnSn(C₆H₅)₃ showing the orbitals of the Sn and C atoms at their radii and the ellipsoidal surface of each H or H₂-type ellipsoidal MO that transitions to the corresponding outer shell of the atoms participating in each bond.

### DETAILED DESCRIPTION

The inventions disclosed herein will now be described with reference to the attached non-limiting Figures.

### Organic Molecular Functional Groups and Molecules

### Derivation of the General Geometrical and Energy Equations of Organic Chemistry

Organic molecules comprising an arbitrary number of atoms can be solved using similar principles and procedures as those used to solve alkanes of arbitrary length. Alkanes can be considered to be comprised of the functional groups of CH₃, CH₂, and C—C. These groups with the corresponding geometrical parameters and energies can be added as a linear sum to give the solution of any straight chain alkane as shown in the Continuous-Chain Alkanes section. Similarly, the geometrical parameters and energies of all functional groups such as alkanes, branched alkanes, alkenes, branched alkenes, alkynes, alkyl fluorides, alkyl chlorides, alkyl bromides, alkyl iodides, alkene halides, primary alcohols, secondary alcohols, tertiary alcohols, ethers, primary amines, secondary amines, tertiary amines, aldehydes, ketones, carboxylic acids, carboxylic esters, amides, N-alkyl amides, N,N-dialkyl amides, urea, acid halides, acid anhydrides, nitriles, thiols, sulfides, disulfides, sulfoxides, sulfones, sulfites, sulfates, nitro alkanes, nitrites, nitrates, conjugated polyenes, aromatics, heterocyclic aromatics, substituted aromatics, and others can be solved. The functional-group solutions can be made into a linear superposition and sum, respectively, to give the solution of any organic molecule. The solutions of the functional groups can be conveniently obtained by using generalized forms of the geometrical and energy equations. The total bond energies of exemplary organic molecules calculated using the functional group composition and the corresponding energies derived in the following sections compared to the experimental values are given in Tables 15.333.1-15.333.36.

Consider the case wherein at least two atomic orbital hybridize as a linear combination of electrons at the same energy in order to achieve a bond at an energy minimum, and the sharing of electrons between two or more such orbitals to form σ MO permits the participating hybridized orbitals to decrease in energy through a decrease in the radius of one or more of the participating orbitals. The force generalized constant k′ of a H₂-type ellipsoidal MO due to the equivalent of two point charges of at the foci is given by:

$${k}^{′} = \frac{{C}_{1} {C}_{2} 2 {e}^{2}}{4 {πɛ}_{0}} \qquad ( 15.1 )$$

where C₁ is the fraction of the H₂-type ellipsoidal MO basis function of a chemical bond of the molecule or molecular ion which is 0.75 (Eq. (13.59)) in the case of H bonding to a central atom and 0.5 (Eq. (14.152)) otherwise, and C₂ is the factor that results in an equipotential energy match of the participating at least two molecular or atomic orbitals of the chemical bond. From Eqs. (13.58-13.63), the distance from the origin of the MO to each focus c′ is given by:

$${c}^{′} = a \sqrt{\frac{{ℏ}^{2} 4 {πɛ}_{0}}{{m}_{e} {e}^{2} 2 {C}_{1} {C}_{2} a}} = \sqrt{\frac{{aa}_{0}}{2 {C}_{1} {C}_{2}}} \qquad ( 15.2 )$$

The internuclear distance is

$$2 {c}^{′} = 2 \sqrt{\frac{{aa}_{0}}{2 {C}_{1} {C}_{2}}} \qquad ( 15.3 )$$

The length of the semiminor axis of the prolate spheroidal MO b=c is given by

b=\sqrt{a²−c′²} (15.4)

And, the eccentricity, e, is

$$e = \frac{{c}^{′}}{a} \qquad ( 15.5 )$$

From Eqs. (11.207-11.212), the potential energy of the two electrons in the central field of the nuclei at the foci is

$${V}_{e} = {n}_{1} {c}_{1} {c}_{2} \frac{- 2 {e}^{2}}{8 {πɛ}_{0} \sqrt{{a}^{2} - {b}^{2}}} ln \frac{a + \sqrt{{a}^{2} - {b}^{2}}}{a - \sqrt{{a}^{2} - {b}^{2}}} \qquad ( 15.6 )$$

The potential energy of the two nuclei is

$${V}_{p} = {n}_{1} \frac{{e}^{2}}{8 {πɛ}_{0} \sqrt{{a}^{2} - {b}^{2}}} \qquad ( 15.7 )$$

The kinetic energy of the electrons is

$$T = {n}_{1} {c}_{1} {c}_{2} \frac{{ℏ}^{2}}{2 {m}_{e} a \sqrt{{a}^{2} - {b}^{2}}} ln \frac{a + \sqrt{{a}^{2} - {b}^{2}}}{a - \sqrt{{a}^{2} - {b}^{2}}} \qquad ( 15.8 )$$

And, the energy, Vₘ, of the magnetic force between the electrons is

$${V}_{m} = {n}_{1} {c}_{1} {c}_{2} \frac{- {ℏ}^{2}}{4 {m}_{e} a \sqrt{{a}^{2} - {b}^{2}}} ln \frac{a + \sqrt{{a}^{2} - {b}^{2}}}{a - \sqrt{{a}^{2} - {b}^{2}}} \qquad ( 15.9 )$$

The total energy of the H₂-type prolate spheroidal MO, E_{T}(H₂MO), is given by the sum of the energy terms:

$$\begin{matrix}{E}_{T} ( {H}_{2} MO ) = {V}_{e} + T + {V}_{m} + {V}_{p} & ( 15.10 ) \\ \begin{matrix}{E}_{T} ( {H}_{2} MO ) = - \frac{{n}_{1} {e}^{2}}{8 {πɛ}_{0} \sqrt{{a}^{2} - {b}^{2}}} \\ [ {c}_{1} {c}_{2} ( 2 - \frac{{a}_{0}}{a} ) ln \frac{a + \sqrt{{a}^{2} - {b}^{2}}}{a - \sqrt{{a}^{2} - {b}^{2}}} - 1 ] \\ = - \frac{{n}_{1} {e}^{2}}{8 {πɛ}_{0} {c}^{′}} \\ [ {c}_{1} {c}_{2} ( 2 - \frac{{a}_{0}}{a} ) ln \frac{a + {c}^{′}}{a - {c}^{′}} - 1 ]\end{matrix} & ( 15.11 )\end{matrix}$$

where n₁ is the number of equivalent bonds of the MO and applies in the case of functional groups. In the case of independent MOs not in contact with the bonding atoms, the terms based on charge are multiplied by c_{BO}, the bond-order factor. It is 1 for a single bond, 4 for an independent double bond as in the case of the CO₂ and NO₂ molecules, and 9 for an independent triplet bond. Then, the kinetic energy term is multiplied by c′_{BO} which is 1 for a single bond, 2 for a double bond, and 9/2 for a triple bond. c₁ is the fraction of the H₂-type ellipsoidal MO basis function of an MO which is 0.75 (Eqs. (13.67-13.73)) in the case of H bonding to an unhybridized central atom and 1 otherwise, and c₂ is the factor that results in an equipotential energy match of the participating the MO and the at least two atomic orbitals of the chemical bond. Specifically, to meet the equipotential condition and energy matching conditions for the union of the H₂-type-ellipsoidal-MO and the HOs or AOs of the bonding atoms, the factor c₂ of a H₂-type ellipsoidal MO may given by (i) one, (ii) the ratio of the Coulombic or valence energy of the AO or HO of at least one atom of the bond and 13.605804 eV, the Coulombic energy between the electron and proton of H, (iii) the ratio of the valence energy of the AO or HO of one atom and the Coulombic energy of another, (iv) the ratio of the valence energies of the AOs or HOs of two atoms, (v) the ratio of two c₂ factors corresponding to any of cases (ii)-(iv), and (vi) the product of two different c₂ factors corresponding to any of the cases (i)-(v). Specific examples of the factor c₂ of a H₂-type ellipsoidal MO given in previous sections are 0.936127, the ratio of the ionization energy of N 14.53414 eV and 13.605804 eV, the Coulombic energy between the electron and proton of H,
0.91771, the ratio of 14.82575 eV, −E_{Coulomb}(C,2sp³), and 13.605804 eV;
0.87495, the ratio of 15.55033 eV, −E_{Coulomb}(Cₑₜₕₐₙₑ,2sp³), and 13.605804 eV;
0.85252, the ratio of 15.95955 eV, −E_{Coulomb}(C_{ethylene},2sp³), and 13.605804 eV;
0.85252, the ratio of 15.95955 eV, −E_{Coulomb}(C_{benzene},2sp³), and 13.605804 eV, and
0.86359, the ratio of 15.55033 eV, −E_{Coulomb}(Cₐₗₖₐₙₑ,2sp³), and 13.605804 eV.

In the generalization of the hybridization of at least two atomic-orbital shells to form a shell of hybrid orbitals, the hybridized shell comprises a linear combination of the electrons of the atomic-orbital shells. The radius of the hybridized shell is calculated from the total Coulombic energy equation by considering that the central field decreases by an integer for each successive electron of the shell and that the total energy of the shell is equal to the total Coulombic energy of the initial AO electrons. The total energy E_{T}(atom,msp³) (m is the integer of the valence shell) of the AO electrons and the hybridized shell is given by the sum of energies of successive ions of the atom over the n electrons comprising total electrons of the at least one AO shell.

$${E}_{T} ( atom , {msp}^{3} ) = - {\sum }_{m = 1}^{n} {IP}_{m} \qquad ( 15.12 )$$

where IPₘ is the m th ionization energy (positive) of the atom. The radius rₘₛₚ_{³}, of the hybridized shell is given by:

$${r}_{{msp}^{3}} = {\sum }_{q = Z - n}^{Z - 1} \frac{- ( Z - q ) {e}^{2}}{8 {πɛ}_{0} {E}_{T} ( atom , {msp}^{3} )} \qquad ( 15.13 )$$

Then, the Coulombic energy E_{Coulomb}(atom,msp³) of the outer electron of the atom msp³ shell is given by

$${E}_{Coulomb} ( atom , {msp}^{3} ) = \frac{- {e}^{2}}{8 {πɛ}_{0} {r}_{{msp}^{3}}} \qquad ( 15.14 )$$

In the case that during hybridization at least one of the spin-paired AO electrons is unpaired in the hybridized orbital (HO), the energy change for the promotion to the unpaired state is the magnetic energy E(magnetic) at the initial radius r of the AO electron:

$$E ( magnetic ) = \frac{2 {πμ}_{0} {e}^{2} {ℏ}^{2}}{{m}_{e}^{2} {r}^{3}} = \frac{8 {πμ}_{0} {μ}_{B}^{2}}{{r}^{3}} \qquad ( 15.15 )$$

Then, the energy E(atom,msp³) of the outer electron of the atom msp³ shell is given by the sum of E_{Coulomb}(atom,msp³) and E(magnetic):

$$E ( atom , {msp}^{3} ) = \frac{- {e}^{2}}{8 π {ɛ}_{0} {r}_{{msp}^{3}}} + \frac{2 π {μ}_{0} {e}^{2} {ℏ}^{2}}{{m}_{e}^{2} {r}^{3}} \qquad ( 15.16 )$$

Consider next that the at least two atomic orbitals hybridize as a linear combination of electrons at the same energy in order to achieve a bond at an energy minimum with another atomic orbital or hybridized orbital. As a further generalization of the basis of the stability of the MO, the sharing of electrons between two or more such hybridized orbitals to form σ MO permits the participating hybridized orbitals to decrease in energy through a decrease in the radius of one or more of the participating orbitals. In this case, the total energy of the hybridized orbitals is given by the sum of E(atom,msp³) and the next energies of successive ions of the atom over the n electrons comprising the total electrons of the at least two initial AO shells. Here, E(atom,msp³) is the sum of the first ionization energy of the atom and the hybridization energy. An example of E(atom,msp³) for E(C, 2sp³) is given in Eq. (14.503) where the sum of the negative of the first ionization energy of C, −11.27671 eV, plus the hybridization energy to form the C2sp³ shell given by Eq. (14.146) is E(C,2sp³)=−14.63489 eV.

Thus, the sharing of electrons between two atom msp³ HOs to form an atom-atom-bond MO permits each participating hybridized orbital to decrease in radius and energy. In order to further satisfy the potential, kinetic, and orbital energy relationships, each atom msp³ HO donates an excess of 25% per bond of its electron density to the atom-atom-bond MO to form an energy minimum wherein the atom-atom bond comprises one of a single, double, or triple bond. In each case, the radius of the hybridized shell is calculated from the Coulombic energy equation by considering that the central field decreases by an integer for each successive electron of the shell and the total energy of the shell is equal to the total Coulombic energy of the initial AO electrons plus the hybridization energy. The total energy E_{T}(mol.atom,msp³) (m is the integer of the valence shell) of the HO electrons is given by the sum of energies of successive ions of the atom over the n electrons comprising total electrons of the at least one initial AO shell and the hybridization energy:

$${E}_{T} ( mol \cdot atom , {msp}^{3} ) = E ( atom , {msp}^{3} ) - {\sum }_{m = 2}^{n} {IP}_{m} \qquad ( 15.17 )$$

where IPₘ is the m th ionization energy (positive) of the atom and the sum of plus the hybridization energy is E(atom,msp³). Thus, the radius rₘₛₚ_{³} of the hybridized shell due to its donation of a total charge −Qe to the corresponding MO is given by:

$$\begin{matrix}{r}_{{msp}^{3}} = ( {\sum }_{q = Z - n}^{Z - 1} ( Z - q ) - Q ) \frac{- {e}^{2}}{8 π {ɛ}_{0} {E}_{T} ( mol \cdot atom , {msp}^{3} )} \\ = ( {\sum }_{q = Z - n}^{Z - 1} ( Z - q ) - s ( 0.25 ) ) \frac{- {e}^{2}}{8 π {ɛ}_{0} {E}_{T} ( mol \cdot atom , {msp}^{3} )}\end{matrix} \qquad ( 15.18 )$$

where −e is the fundamental electron charge and s=1,2,3 for a single, double, and triple bond, respectively. The Coulombic energy E_{Coulomb}(mol.atom,msp³) of the outer electron of the atom msp³ shell is given by:

$${E}_{Coulomb} ( mol \cdot atom , {msp}^{3} ) = \frac{- {e}^{2}}{8 π {ɛ}_{0} {r}_{{msp}^{3}}} \qquad ( 15.19 )$$

In the case that during hybridization at least one of the spin-paired AO electrons is unpaired in the hybridized orbital (HO), the energy change for the promotion to the unpaired state is the magnetic energy E(magnetic) at the initial radius r of the AO electron given by Eq. (15.15). Then, the energy E(mol.atom,msp³) of the outer electron of the atom msp³ shell is given by the sum of E_{Coulomb}(mol.atom,msp³) and E(magnetic):

$$E ( mol \cdot atom , {msp}^{3} ) = \frac{- {e}^{2}}{8 π {ɛ}_{0} {r}_{{msp}^{3}}} + \frac{2 π {μ}_{0} {e}^{2} {ℏ}^{2}}{{m}_{e}^{2} {r}^{3}} \qquad ( 15.20 )$$

E_{T}(atom−atom,msp³), the energy change of each atom msp³ shell with the formation of the atom-atom-bond MO is given by the difference between E(mol.atom,msp³) and E(atom,msp³):

E_{T}(atom−atom,msp³)=E(mol.atom,msp³)−E(atom,msp³) (15.21)

As examples from prior sections, E_{Coulomb}(mol.atom,msp³) is one of:

E_{Coulomb}(C_{ethylene},2sp³) E_{Coulomb}(Cₑₜₕₐₙₑ,2sp³), E_{Coulomb}(C_{acetylene},2sp³ and E_{Coulomb}(Cₐₗₖₐₙₑ,2sp³);

E_{Coulomb} and E_{Coulomb}(atom,msp³) is one of E_{Coulomb}(C,2sp³) and E_{Coulomb}(Cl,3sp³);

E(mol.atom,msp³) is one of E(C_{ethylene},2sp³), E(Cₑₜₕₐₙₑ,2sp³),

E(C_{acetylene},2sp³)E(Cₐₗₖₐₙₑ,2sp³);

E(atom,msp³) is one of and E(C,2sp³) and E(Cl,3sp³);

E_{T}(atom−atom,msp³) is one of E(C—C,2sp³), E(C═C,2sp³), and. E(C≡C,2sp³);

atom msp³ is one of C2sp³, Cl3sp³

E_{T}(atom−atom(s₁),msp³) is E_{T}(C—C,2sp³) and E_{T}(atom−atom(s₂),msp³) is E_{T}(C═C,2sp³), and

rₘₛₚ_{³} is one of r_{C3sp}_{³}, rₑₜₕₐₙₑ₂ₛₚ_{³}r_{acetylene2sp}_{³}, rₐₗₖₐₙₑ₂ₛₚ_{³}, and r_{Cl3sp}_{³}.

In the case of the C2sp³ HO, the initial parameters (Eqs. (14.142-14.146)) are

$$\begin{matrix}\begin{matrix}{r}_{2 {sp}^{3}} = {\sum }_{n = 2}^{5} \frac{( Z - n ) {e}^{2}}{8 π {ɛ}_{0} ( e 148.25751 eV )} \\ = \frac{10 {e}^{2}}{8 π {ɛ}_{0} ( e 148.25751 eV )} \\ = 0.91771 {a}_{0}\end{matrix} & ( 15.22 ) \\ \begin{matrix}{E}_{Coulomb} ( C , 2 {sp}^{3} ) = \frac{- {e}^{2}}{8 π {ɛ}_{0} {r}_{2 {sp}^{3}}} \\ = \frac{- {e}^{2}}{8 π {ɛ}_{0} 0.91771 {a}_{0}} \\ = - 14.82575 eV\end{matrix} & ( 15.23 ) \\ \begin{matrix}E ( magnetic ) = \frac{2 π {μ}_{0} {e}^{2} {ℏ}^{2}}{{{m}_{e}^{2} ( {r}_{3} )}^{3}} \\ = \frac{8 π {μ}_{0} {μ}_{B}^{2}}{{( 0.84317 {a}_{0} )}^{3}} \\ = 0.19086 eV\end{matrix} & ( 15.24 ) \\ \begin{matrix}E ( C , 2 {sp}^{3} ) = \frac{- {e}^{2}}{8 π {ɛ}_{0} {r}_{2 {sp}^{3}}} + \frac{2 π {μ}_{0} {e}^{2} {ℏ}^{2}}{{{m}_{e}^{2} ( {r}_{3} )}^{3}} \\ = - 14.82575 eV + 0.19086 eV \\ = - 14.63489 eV\end{matrix} & ( 15.25 )\end{matrix}$$

### In Eq. (15.18),

$${\sum }_{q = Z - n}^{Z - 1} ( Z - q ) = 10 \qquad ( 15.26 )$$

Eqs. (14.147) and (15.17) give

E_{T}(mol.atom,msp³)=E_{T}(Cₑₜₕₐₙₑ,2sp³)=−151.61569 eV (15.27)

Using Eqs. (15.18-15.28), the final values of r_{c2sp}_{³}, E_{Coulomb}(C2sp³), and E(C2sp³), and the resulting

$${E}_{T} ( C {-}^{BO} C , C 2 {sp}^{3} )$$

of the MO due to charge donation from the HO to the MO where

$$C {-}^{BO} C$$

refers to the bond order of the carbon-carbon bond for different values of the parameter s are given in Table 15.1.

TABLE 15.1
The final values of r_{C2sp}_{³}, E_{Coulomb}(C2sp³), and E(C2sp³) $\begin{matrix}and the resulting {E}_{T} ( C {—}^{BO} C , C 2 {sp}^{3} ) of the MO due to \\ charge donation from the HO to the MO where C {—}^{BO} C\end{matrix}$ refers to the bond order of the carbon-carbon bond.

| MO Bond Order (BO) | s 1 | s 2 | r_{C2sp}_{³} (a₀) Final | E_{Coulomb} (C2sp³) (eV) Final | E(C2sp³) (eV) Final | ${E}_{T} ( C {—}^{BO} C , C 2 {sp}^{3} )$ (eV) |
|---|---|---|---|---|---|---|
| I | 1 | 0 | 0.87495 | −15.55033 | −15.35946 | −0.72457 |
| II | 2 | 0 | 0.85252 | −15.95955 | −15.76868 | −1.13379 |
| III | 3 | 0 | 0.83008 | −16.39089 | −16.20002 | −1.56513 |
| IV | 4 | 0 | 0.80765 | −16.84619 | −16.65532 | −2.02043 |

In another generalized case of the basis of forming a minimum-energy bond with the constraint that it must meet the energy matching condition for all MOs at all HOs or AOs, the energy E(mol.atom,msp³) of the outer electron of the atom msp³ shell of each bonding atom must be the average of E(mol.atom,msp³) for two different values of s:

$$E ( mol \cdot atom , {msp}^{3} ) = \frac{\begin{matrix}E ( mol \cdot atom ( {s}_{1} ) , {msp}^{3} ) + \\ E ( mol \cdot atom ( {s}_{2} ) , {msp}^{3} )\end{matrix}}{2} \qquad ( 15.28 )$$

In this case, E_{T}(atom−atom,msp³), the energy change of each atom msp³ shell with the formation of each atom-atom-bond MO, is average for two different values of s:

$${E}_{T} ( atom - atom , {msp}^{3} ) = \frac{\begin{matrix}{E}_{T} ( atom - atom ( {s}_{1} ) , {msp}^{3} ) + \\ {E}_{T} ( atom - atom ( {s}_{2} ) , {msp}^{3} )\end{matrix}}{2} \qquad ( 15.29 )$$

Consider an aromatic molecule such as benzene given in the Benzene Molecule section. Each C═C double bond comprises a linear combination of a factor of 0.75 of four paired electrons (three electrons) from two sets of two C2sp³ HOs of the participating carbon atoms. Each C—H bond of CH having two spin-paired electrons, one from an initially unpaired electron of the carbon atom and the other from the hydrogen atom, comprises the linear combination of 75% H₂-type ellipsoidal MO and 25% C2sp³ HO as given by Eq. (13.439). However, E_{T}(atom−atom,msp³) of the C—H-bond MO is given by 0.5E_{T}(C═C,2sp³) (Eq. (14.247)) corresponding to one half of a double bond that matches the condition for a single-bond order for C—H that is lowered in energy due to the aromatic character of the bond.

A further general possibility is that a minimum-energy bond is achieved with satisfaction of the potential, kinetic, and orbital energy relationships by the formation of an MO comprising an allowed multiple of a linear combination of H₂-type ellipsoidal MOs and corresponding HOs or AOs that contribute a corresponding allowed multiple (e.g. 0.5, 0.75, 1) of the bond order given in Table 15.1. For example, the alkane MO given in the Continuous-Chain Alkanes section comprises a linear combination of factors of 0.5 of a single bond and 0.5 of a double bond.

Consider a first MO and its HOs comprising a linear combination of bond orders and a second MO that shares a HO with the first. In addition to the mutual HO, the second MO comprises another AO or HO having a single bond order or a mixed bond order. Then, in order for the two MOs to be energy matched, the bond order of the second MO and its HOs or its HO and AO is a linear combination of the terms corresponding to the bond order of the mutual HO and the bond order of the independent HO or AO. Then, in general, E_{T}(atom−atom,msp³), the energy change of each atom msp³ shell with the formation of each atom-atom-bond MO, is a weighted linear sum for different values of s that matches the energy of the bonded MOs, HOs, and AOs:

$${E}_{T} ( \begin{matrix}atom - \\ atom , {msp}^{3}\end{matrix} ) = {\sum }_{n = 1}^{N} {c}_{{s}_{n}} {E}_{T} ( \begin{matrix}atom - \\ atom ( {s}_{n} ) , {msp}^{3}\end{matrix} ) \qquad ( 15.30 )$$

where cₛ_{ₙ} is the multiple of the BO of sₙ. The radius rₘₛₚ_{³} of the atom msp³ shell of each bonding atom is given by the Coulombic energy using the initial energy E_{Coulomb}(atom,msp³) and E_{T}(atom−atom,msp³), the energy change of each atom msp³ shell with the formation of each atom-atom-bond MO:

$${r}_{{msp}^{3}} = \frac{- {e}^{2}}{8 π {ɛ}_{0} {a}_{0} ( \begin{matrix}{E}_{Coulomb} ( atom , {msp}^{3} ) + \\ {E}_{T} ( atom - atom , {msp}^{3} )\end{matrix} )} \qquad ( 15.31 )$$

where E_{Coulomb}(C2sp³)=−14.825751 eV. The Coulombic energy E_{Coulomb}(mol.atom,msp³) of the outer electron of the atom msp³ shell is given by Eq. (15.19). In the case that during hybridization, at least one of the spin-paired AO electrons is unpaired in the hybridized orbital (HO), the energy change for the promotion to the unpaired state is the magnetic energy E(magnetic) (Eq. (15.15)) at the initial radius r of the AO electron. Then, the energy E(mol.atom,msp³) of the outer electron of the atom msp³ shell is given by the sum of E_{Coulomb}(mol.atom,msp³) and E(magnetic) (Eq. (15.20)). E_{T}(atom−atom,msp³), the energy change of each atom msp³ shell with the formation of the atom-atom-bond MO is given by the difference between E(mol.atom,msp³) and E(atom,msp³) given by Eq. (15.21). Using Eq. (15.23) for E_{Coulomb}(C,2sp³) in Eq. (15.31), the single bond order energies given by Eqs. (15.18-15.27) and shown in Table 15.1, and the linear combination energies (Eqs. (15.28-15.30)), the parameters of linear combinations of bond orders and linear combinations of mixed bond orders are given in Table 15.2.

TABLE 15.2
The final values of r_{C2sp}_{³}, E_{Colomb}(C2sp³) and E(C2sp³) and the $resulting {E}_{T} ( C {—}^{BO} C , C 2 {sp}^{3} ) of the MO comprising a linear combination$ of H₂-type ellipsoidal MOs and corresponding HOs of single or mixed bond order where cₛ_{ₙ} is the multiple of the bond order parameter E_{T}(atom—atom (sₙ), msp³) given in Table 15.1.

| MO Bond Order (BO) | s 1 | cₛ_{₁} | s 2 | cₛ_{₂} | s 3 | cₛ_{₃} | r_{C2sp}_{³}(a₀) Final | E_{Coulomb}(C2sp³) (eV) Final | E(C2sp³) (ev) Final | $\begin{matrix}{E}_{T} ( \begin{matrix}C {—}^{BO} C , \\ C 2 {sp}^{3}\end{matrix} ) \\ ( eV )\end{matrix}$ |
|---|---|---|---|---|---|---|---|---|---|---|
| 1/2I | 1 | 0.5 | 0 | 0 | 0 | 0 | 0.89582 | −15.18804 | −14.99717 | −0.36228 |
| 1/2II | 2 | 0.5 | 0 | 0 | 0 | 0 | 0.88392 | −15.39265 | −15.20178 | −0.56689 |
| I + 1/2II | 1 | 0.5 | 2 | 0.25 | 0 | 0 | 0.87941 | −15.47149 | −15.28062 | −0.64573 |
| 1/2II + (I + II) | 2 | 0.25 | 1 | 0.25 | 2 | 0.25 | 0.87363 | −15.57379 | −15.38293 | −0.74804 |
| 3/4II | 2 | 0.75 | 0 | 0 | 0 | 0 | 0.86793 | −15.67610 | −15.48523 | −0.85034 |
| I + II | 1 | 0.5 | 2 | 0.5 | 0 | 0 | 0.86359 | −15.75493 | −15.56407 | −0.92918 |
| I + III | 1 | 0.5 | 3 | 0.5 | 0 | 0 | 0.85193 | −15.97060 | −15.77974 | −1.14485 |
| I + IV | 1 | 0.5 | 4 | 0.5 | 0 | 0 | 0.83995 | −16.19826 | −16.00739 | −1.37250 |
| II + III | 2 | 0.5 | 3 | 0.5 | 0 | 0 | 0.84115 | −16.17521 | −15.98435 | −1.34946 |
| II + IV | 2 | 0.5 | 4 | 0.5 | 0 | 0 | 0.82948 | −16.40286 | −16.21200 | −1.57711 |
| III + IV | 3 | 0.5 | 4 | 0.5 | 0 | 0 | 0.81871 | −16.61853 | −16.42767 | −1.79278 |
| IV + IV | 4 | 0.5 | 4 | 0.5 | 0 | 0 | 0.80765 | −16.84619 | −16.65532 | −2.02043 |

Consider next the radius of the AO or HO due to the contribution of charge to more than one bond. The energy contribution due to the charge donation at each atom such as carbon superimposes linearly. In general, the radius rₘₒₗ₂ₛₚ_{³} of the C2sp³ HO of a carbon atom of a given molecule is calculated using Eq. (14.514) by considering ΣE_{T}_{ₘₒₗ}(MO,2sp³), the total energy donation to all bonds with which it participates in bonding. The general equation for the radius is given by

$$\begin{matrix}{r}_{mol 2 {sp}^{3}} = \frac{- {e}^{2}}{8 π {ɛ}_{0} ( {E}_{Coulomb} ( C , 2 {sp}^{3} ) + \sum {E}_{{T}_{mol}} ( MO , 2 {sp}^{3} ) )} \\ = \frac{{e}^{2}}{8 π {ɛ}_{0} ( e 14.825751 eV + \sum \vert {E}_{{T}_{mol}} ( MO , 2 {sp}^{3} ) \vert )}\end{matrix} \qquad ( 15.32 )$$

The Coulombic energy E_{Coulomb}(mol.atom,msp³) of the outer electron of the atom msp³ shell is given by Eq. (15.19). In the case that during hybridization, at least one of the spin-paired AO electrons is unpaired in the hybridized orbital (HO), the energy change for the promotion to the unpaired state is the magnetic energy E(magnetic) (Eq. (15.15)) at the initial radius r of the AO electron. Then, the energy E(mol.atom,msp³) of the outer electron of the atom msp³ shell is given by the sum of E_{Coulomb}(mol.atom,msp³) and E(magnetic) (Eq. (15.20)).

For example, the C2sp³ HO of each methyl group of an alkane contributes −0.92918 eV (Eq. (14.513)) to the corresponding single C—C bond; thus, the corresponding C2sp³ HO radius is given by Eq. (14.514). The C2sp³ HO of each methylene group of CₙH₂₊₂ contributes −0.92918 eV to each of the two corresponding C—C bond MOs. Thus, the radius (Eq. (15.32)), the Coulombic energy (Eq. (15.19)), and the energy (Eq. (15.20)) of each alkane methylene group are

$$\begin{matrix}\begin{matrix}{r}_{{alkaneC}_{methylene} 2 {sp}^{3}} = \frac{- {e}^{2}}{8 {πɛ}_{0} ( \begin{matrix}{E}_{Coulomb} ( C , 2 {sp}^{3} ) + \\ \sum {E}_{{T}_{alkane}} ( methylene C - C , 2 {sp}^{3} )\end{matrix} )} \\ = \frac{{e}^{2}}{8 {πɛ}_{0} ( \begin{matrix}e 14.825751 eV + \\ e 0.92918 eV + e0 .92918 eV\end{matrix} )} \\ = 0.81549 {a}_{0}\end{matrix} & ( 15.33 ) \\ \begin{matrix}{E}_{Coulomb} ( {C}_{methylene} 2 {sp}^{3} ) = \frac{- {e}^{2}}{8 {πɛ}_{0} ( 0.81549 {a}_{0} )} \\ = - 16.68412 eV\end{matrix} & ( 15.34 ) \\ \begin{matrix}E ( {C}_{methylene} 2 {sp}^{3} ) = \frac{- {e}^{2}}{8 {πɛ}_{0} ( 0.81549 {a}_{0} )} + \frac{2 {πμ}_{0} {e}^{2} {ℏ}^{2}}{{{m}_{e}^{2} ( 0.84317 {a}_{0} )}^{3}} \\ = - 16.49325 eV\end{matrix} & ( 15.35 )\end{matrix}$$

In the determination of the parameters of functional groups, heteroatoms bonding to C2sp³ HOs to form MOs are energy matched to the C2sp³ HOs. Thus, the radius and the energy parameters of a bonding heteroatom are given by the same equations as those for C2sp³ HOs. Using Eqs. (15.15), (15.19-15.20), (15.24), and (15.32) in a generalized fashion, the final values of the radius of the HO or AO, r_{Atom.HO.AO}, E_{Coulomb}(mol.atom,msp3), and E(Cₘₒₗ2sp³) are calculated using ΣE_{T}_{_{group}}(MO,2sp³), the total energy donation to each group bond with which an atom participates in bonding corresponding to the values of E_{T}(C^{BO}—C,C2sp³) of the MO due to charge donation from the AO or HO to the MO given in Tables 15.1 and 15.2.

TABLE 15.3.A
The final values of r_{Atom.HO.AO}, E_{Coulomb}(mol.atom.msp³), and E(CₘₒₗC2sp³) calculated $using the values of {E}_{T} ( C {—}^{BO} C , C 2 {sp}^{3} ) given in Tables 15.1 and 15.2 .$

| Atom Hybrid- ization Desig- nation | ${E}_{T} ( \begin{matrix}C {—}^{BO} C , \\ C 2 {sp}^{3}\end{matrix} )$ | ${E}_{T} ( \begin{matrix}C {—}^{BO} C , \\ C 2 {sp}^{3}\end{matrix} )$ | ${E}_{T} ( \begin{matrix}C {—}^{BO} C , \\ C 2 {sp}^{3}\end{matrix} )$ | ${E}_{T} ( \begin{matrix}C {—}^{BO} C , \\ C 2 {sp}^{3}\end{matrix} )$ | ${E}_{T} ( \begin{matrix}C {—}^{BO} C , \\ C 2 {sp}^{3}\end{matrix} )$ | r_{Atom.HO.AO} Final | E_{Coulomb} (mol.atom,msp³) (eV) Final | E(Cₘₒₗ2sp³) (eV) Final |
|---|---|---|---|---|---|---|---|---|
| 1 | 0 | 0 | 0 | 0 | 0 | 0.91771 | −14.83575 | −14.63489 |
| 2 | −0.36229 | 0 | 0 | 0 | 0 | 0.89582 | −15.18804 | −14.99717 |
| 3 | −0.46459 | 0 | 0 | 0 | 0 | 0.88983 | −15.29034 | −15.09948 |
| 4 | −0.56689 | 0 | 0 | 0 | 0 | 0.88392 | −15.39265 | −15.20178 |
| 5 | −0.72457 | 0 | 0 | 0 | 0 | 0.87495 | −15.55033 | −15.35946 |
| 6 | −0.85034 | 0 | 0 | 0 | 0 | 0.86793 | −15.6761 | −15.48523 |
| 7 | −0.92918 | 0 | 0 | 0 | 0 | 0.86359 | −15.75493 | −15.56407 |
| 8 | −0.54343 | −0.54343 | 0 | 0 | 0 | 0.85503 | −15.91261 | −15.72175 |
| 9 | −1.13379 | 0 | 0 | 0 | 0 | 0.85252 | −15.95955 | −15.76868 |
| 10 | −1.14485 | 0 | 0 | 0 | 0 | 0.85193 | −15.9706 | −15.77974 |
| 11 | −0.46459 | −0.82688 | 0 | 0 | 0 | 0.84418 | −16.11722 | −15.92636 |
| 12 | −1.34946 | 0 | 0 | 0 | 0 | 0.84115 | −16.17521 | −15.98435 |
| 13 | −1.3725 | 0 | 0 | 0 | 0 | 0.83995 | −16.19826 | −16.00739 |
| 14 | −0.46459 | −0.92918 | 0 | 0 | 0 | 0.83885 | −16.21952 | −16.02866 |
| 15 | −0.72457 | −0.72457 | 0 | 0 | 0 | 0.836 | −16.2749 | −16.08404 |
| 16 | −0.5669 | −0.92918 | 0 | 0 | 0 | 0.8336 | −16.32183 | −16.13097 |
| 17 | −0.82688 | −0.72457 | 0 | 0 | 0 | 0.83078 | −16.37721 | −16.18634 |
| 18 | −1.56513 | 0 | 0 | 0 | 0 | 0.83008 | −16.39089 | −16.20002 |
| 19 | −0.64574 | −0.92918 | 0 | 0 | 0 | 0.82959 | −16.40067 | −16.20981 |
| 20 | −1.57711 | 0 | 0 | 0 | 0 | 0.82948 | −16.40286 | −16.212 |
| 21 | −0.72457 | −0.92918 | 0 | 0 | 0 | 0.82562 | −16.47951 | −16.28865 |
| 22 | −0.85035 | −0.85035 | 0 | 0 | 0 | 0.82327 | −16.52645 | −16.33559 |
| 23 | −1.79278 | 0 | 0 | 0 | 0 | 0.81871 | −16.61853 | −16.42767 |
| 24 | −1.13379 | −0.72457 | 0 | 0 | 0 | 0.81549 | −16.68411 | −16.49325 |
| 25 | −0.92918 | −0.92918 | 0 | 0 | 0 | 0.81549 | −16.68412 | −16.49325 |
| 26 | −2.02043 | 0 | 0 | 0 | 0 | 0.80765 | −16.84619 | −16.65532 |
| 27 | −1.13379 | −0.92918 | 0 | 0 | 0 | 0.80561 | −16.88872 | −16.69786 |
| 28 | −0.56690 | −0.56690 | −0.92918 | 0 | 0 | 0.80561 | −16.88873 | −16.69786 |
| 29 | −0.85035 | −0.85035 | −0.46459 | 0 | 0 | 0.80076 | −16.99104 | −16.80018 |
| 30 | −0.85035 | −0.42517 | −0.92918 | 0 | 0 | 0.79891 | −17.03045 | −16.83959 |
| 31 | −0.5669 | −0.72457 | −0.92918 | 0 | 0 | 0.78916 | −17.04641 | −16.85554 |
| 32 | −1.13379 | −1.13379 | 0 | 0 | 0 | 0.79597 | −17.09334 | −16.90248 |
| 33 | −1.34946 | −0.92918 | 0 | 0 | 0 | 0.79546 | −17.1044 | −18.91353 |
| 34 | −0.46459 | −0.92918 | −0.92918 | 0 | 0 | 0.79340 | −17.14871 | −16.95784 |
| 35 | −0.64574 | −0.85034 | −0.85034 | 0 | 0 | 0.79232 | −17.17217 | −16.98131 |
| 36 | −0.85035 | −0.5669 | −0.92918 | 0 | 0 | 0.79232 | −17.17218 | −16.98132 |
| 37 | −0.72457 | −0.72457 | −0.92918 | 0 | 0 | 0.79085 | −17.20408 | −17.01322 |
| 38 | −0.75586 | −0.75586 | −0.92918 | 0 | 0 | 0.78798 | 17.26666 | 17.07580 |
| 39 | −0.74804 | −0.85034 | −0.85034 | 0 | 0 | 0.78762 | 17.27448 | 17.08362 |
| 40 | −0.82688 | −0.72457 | −0.92918 | 0 | 0 | 0.78617 | −17.30638 | −17.11552 |
| 41 | −0.72457 | −0.92918 | −0.92918 | 0 | 0 | 0.78155 | −17.40868 | −17.21782 |
| 42 | −0.92918 | −0.72457 | −0.92918 | 0 | 0 | 0.78155 | −17.40869 | −17.21783 |
| 43 | −0.54343 | −0.54343 | −0.5669 | −0.92918 | 0 | 0.78155 | −17.40869 | −17.21783 |
| 44 | −0.92918 | −0.85034 | −0.85034 | 0 | 0 | 0.77945 | −17.45561 | −17.26475 |
| 45 | −0.42517 | −0.42517 | −0.85035 | −0.92918 | 0 | 0.77945 | −17.45563 | −17.24676 |
| 46 | −0.82688 | −0.92918 | −0.92918 | 0 | 0 | 0.77699 | −17.51099 | −17.32013 |
| 47 | −0.92918 | −0.92918 | −0.92918 | 0 | 0 | 0.77247 | −17.6133 | −17.42244 |
| 48 | −0.85035 | −0.54343 | −0.5669 | −0.92918 | 0 | 0.76801 | −17.71561 | −17.52475 |
| 49 | −1.34946 | −0.64574 | −0.92918 | 0 | 0 | 0.76652 | −17.75013 | −17.55927 |
| 50 | −0.85034 | −0.54343 | −0.60631 | −0.92918 | 0 | 0.76631 | −17.75502 | −17.56415 |
| 51 | −1.1338 | −0.92918 | −0.92918 | 0 | 0 | 0.7636 | −17.81791 | −17.62705 |
| 52 | −0.46459 | −0.85035 | −0.85035 | −0.92918 | 0 | 0.75924 | −17.92022 | −17.72936 |
| 53 | −0.82688 | −1.34946 | −0.92918 | 0 | 0 | 0.75877 | −17.93128 | −17.74041 |
| 54 | −0.92918 | −1.34946 | −0.92918 | 0 | 0 | 0.75447 | −18.03358 | −17.84272 |
| 55 | −1.13379 | −1.13379 | −1.13379 | 0 | 0 | 0.74646 | −18.22712 | −18.03626 |
| 56 | −1.79278 | −0.92918 | −0.92918 | 0 | 0 | 0.73637 | −18.47690 | −18.28604 |

TABLE 15.3.B
The final values of r_{Atom.HO.AO}, E_{Coulomb}(mol.atom.msp³), and E(CₘₒₗC2sp³) calculated for $heterocyclic groups using the values of {E}_{T} ( C {—}^{BO} C , C 2 {sp}^{3} ) given in Tables 15.1 and 15.2 .$

| Atom Hybrid- ization Desig- nation | ${E}_{T} ( \begin{matrix}C {—}^{BO} C , \\ C 2 {sp}^{3}\end{matrix} )$ | ${E}_{T} ( \begin{matrix}C {—}^{BO} C , \\ C 2 {sp}^{3}\end{matrix} )$ | ${E}_{T} ( \begin{matrix}C {—}^{BO} C , \\ C 2 {sp}^{3}\end{matrix} )$ | ${E}_{T} ( \begin{matrix}C {—}^{BO} C , \\ C 2 {sp}^{3}\end{matrix} )$ | ${E}_{T} ( \begin{matrix}C {—}^{BO} C , \\ C 2 {sp}^{3}\end{matrix} )$ | r_{Atom.HO.AO} Final | E_{Coulomb} (mol.atom,msp³) (eV) Final | E(Cₘₒₗ2sp³) (eV) Final |
|---|---|---|---|---|---|---|---|---|
| 1 | 0 | 0 | 0 | 0 | 0 | 0.91771 | −14.82575 | −14.63489 |
| 2 | −0.56690 | 0 | 0 | 0 | 0 | 0.88392 | −15.39265 | −15.20178 |
| 3 | −0.72457 | 0 | 0 | 0 | 0 | 0.87495 | −15.55033 | −15.35946 |
| 4 | −0.92918 | 0 | 0 | 0 | 0 | 0.86359 | −15.75493 | −15.56407 |
| 5 | −0.54343 | −0.54343 | 0 | 0 | 0 | 0.85503 | −15.91261 | −15.72175 |
| 6 | −1.13379 | 0 | 0 | 0 | 0 | 0.85252 | −15.95954 | −15.76868 |
| 7 | −0.60631 | −0.60631 | 0 | 0 | 0 | 0.84833 | −16.03838 | −15.84752 |
| 8 | −0.46459 | −0.92918 | 0 | 0 | 0 | 0.83885 | −16.21953 | −16.02866 |
| 9 | −0.72457 | −0.72457 | 0 | 0 | 0 | 0.83600 | −16.27490 | −16.08404 |
| 10 | −0.92918 | −0.60631 | 0 | 0 | 0 | 0.83159 | −16.36125 | −16.17038 |
| 11 | −0.92918 | −0.72457 | 0 | 0 | 0 | 0.82562 | −16.47951 | −16.28864 |
| 12 | −0.85035 | −0.85035 | 0 | 0 | 0 | 0.82327 | −16.52644 | −16.33558 |
| 13 | −0.92918 | −0.92918 | 0 | 0 | 0 | 0.81549 | −16.68411 | −16.49325 |
| 14 | −1.13379 | −0.72457 | 0 | 0 | 0 | 0.81549 | −16.68412 | −16.49325 |
| 15 | −1.13379 | −0.92918 | 0 | 0 | 0 | 0.80561 | −16.88873 | −16.69786 |
| 16 | −0.85035 | −0.85035 | −0.46459 | 0 | 0 | 0.80076 | −16.99103 | −16.80017 |
| 17 | −0.85034 | −0.85034 | −0.56690 | 0 | 0 | 0.79595 | −17.09334 | −16.90247 |
| 18 | −1.13379 | −1.13380 | 0 | 0 | 0 | 0.79597 | −17.09334 | −16.90248 |
| 19 | −0.85035 | −0.54343 | 0.00000 | −0.92918 | 0 | 0.79340 | −17.14871 | −16.95785 |
| 20 | −0.85035 | −0.56690 | −0.92918 | 0 | 0 | 0.79232 | −17.17218 | −16.98132 |
| 21 | −0.54343 | −0.54343 | −0.56690 | −0.92918 | 0 | 0.78155 | −17.40869 | −17.21783 |
| 22 | −0.85034 | −0.28345 | −0.54343 | −0.92918 | 0 | 0.78050 | −17.43216 | −17.24130 |
| 23 | −0.92918 | −0.92918 | −0.92918 | 0 | 0 | 0.77247 | −17.61330 | −17.42243 |
| 24 | −0.85034 | −0.54343 | −0.56690 | −0.92918 | 0 | 0.76801 | −17.71560 | −17.52474 |
| 25 | −0.85034 | −0.54343 | −0.60631 | −0.92918 | 0 | 0.76631 | −17.75502 | −17.56416 |
| 26 | −1.13379 | −0.92918 | −0.92918 | 0 | 0 | 0.76360 | −17.81791 | −17.62704 |
| 27 | −1.13379 | −1.13380 | −0.72457 | 0 | 0 | 0.76360 | −17.81791 | −17.62705 |
| 28 | −0.46459 | −0.85035 | −0.85035 | −0.92918 | 0 | 0.75924 | −17.92022 | −17.72935 |
| 29 | −1.13380 | −1.13379 | −0.92918 | 0 | 0 | 0.75493 | −18.02252 | −17.83166 |
| 30 | −1.13379 | −1.13379 | −1.13379 | 0 | 0 | 0.74646 | −18.22713 | −18.03627 |

From Eq. (15.18), the general equation for the radius due to a total charge −Qe of an AO or a HO that participates in bonding to form σ MO is given by

$${r}_{{msp}^{3}} = ( {\sum }_{q = Z - n}^{Z - 1} ( Z - q ) - Q ) \frac{- {e}^{2}}{8 {πɛ}_{0} {E}_{T} ( mol \cdot atom , {msp}^{3} )} \qquad ( 15.36 )$$

By equating the radii of Eqs. (15.36) and (15.32), the total charge parameter Q of the AO or HO can be calculated wherein the excess charge is on the MO:

$$Q = ( {\sum }_{q = Z - n}^{Z - 1} ( Z - q ) ) - \frac{\vert {E}_{T} ( mol \cdot atom , {msp}^{3} ) \vert}{( \begin{matrix}e 14.825751 eV + \\ Σ \vert {E}_{{T}_{mol}} ( MO , 2 {sp}^{3} ) \vert\end{matrix} )} \qquad ( 15.37 )$$

The modulation of the constant function by the time and spherically harmonic functions as given in Eq. (1.65) time-averages to zero such that the charge density of any HO or AO is determined by the constant function. The charge density a is then given by the fundamental charge −e times the number of electrons n divided by the area of the spherical shell of radius rₘₒₗ₂ₛₚ_{³} given by Eq. (15.32):

$$σ = \frac{( n - Q ) ( - e )}{\frac{4}{3} π {r}_{mol 2 {sp}^{3}}^{2}} \qquad ( 15.38 )$$

The charge density of an ellipsoidal MO in rectangular coordinates (Eqs. 11.42-11.45)) is

$$σ = \frac{q}{4 π abc} \frac{1}{\sqrt{\frac{{x}^{2}}{{a}^{4}} + \frac{{y}^{2}}{{b}^{4}} + \frac{{z}^{2}}{{c}^{4}}}} = \frac{q}{4 π abc} D \qquad ( 15.39 )$$

where D is the distance from the origin to the tangent plane. The charge q is given by the fundamental electron charge −e times the sum of parameter n₁ of Eqs. (15.51) and (15.61) and the charge donation parameter Q (Eq. (15.37)) of each AO or HO to the MO. Thus, the charge density of the MO is given by

$$σ = \frac{- e ( {n}_{1} + Q )}{4 π abc} D \qquad ( 15.40 )$$

The charge density of the MO that is continuous with the surface of the AO or HO and any radial bisector current resulting from the intersection of two or more MOs as given in the Methane Molecule (CH₄) section is determined by the current continuity condition. Consider the continuity of the current due to the intersection of an MO with a corresponding AO or HO. The parameters of each point of intersection of each H₂-type ellipsoidal MO and the corresponding atom AO or HO determined from the polar equation of the ellipse are given by Eqs. (15.80-15.87). The overlap charge Δq is given by the total charge of the prolate-spheroidal MO minus the integral of the charge density of the MO over the area between curves of intersection with the AOs or HOs that forms the MO:

$$Δ q = - e ( {n}_{1} + Q ) - \int σ d A = - e ( {n}_{1} + Q ) ( 1 - \int \frac{D}{4 π abc} d A ) \qquad ( 15.41 )$$

The overlap charge of the prolate-spheroidal MO Δq is uniformly distributed on the external spherical surface of the AO or HO of radius rₘₒₗ₂ₛₚ_{³}³ such that the charge density σ from Eq. (15.41) is

$$σ = \frac{Δ q}{A} \qquad ( 15.42 )$$

where A is the external surface area of the AO or HO between the curves of intersection with the MO surface.

At the curves of intersection of two or more MOs where they occur, the current between the AO or HO shell and curves of mutual contact is projected onto and flows in the direction of the radial vector to the surface of the AO or HO shell. This current designated the bisector current (BC) meets the AO or HO surface and does not travel to distances shorter than its radius. Due to symmetry, a radial axis through the AO or HO exists such that current travels from the MOs to the AO or HO along the radial vector in one direction and returns to the MO along the radial vector in the opposite direction from the AO or HO surface to conserve current flow. Since the continuation of the MO charge density on the bisector current and the external surface of the AO or HO is an equipotential, the charge density on these surfaces must be uniform. Thus, σ on these surfaces is given by Eq. (15.42) where Δq is given by Eq. (15.41) with the integral over the MO area between curves of intersection of the MOs, and A is the sum of the surface areas of the bisector current and the external surface of the AO or HO between the curves of intersection of the bisector current with the AO or HO surface.

The angles at which any two prolate spheroidal A-C and B—C-bond MOs intersect can be determined using Eq. (13.85) by equating the radii of the elliptic cross sections of the MOs:

$$( {a}_{1} - {c}_{1}^{′} ) \frac{1 + \frac{{c}_{1}^{′}}{{a}_{1}}}{1 + \frac{{c}_{1}^{′}}{{a}_{1}} cos {θ}_{1}^{′}} = ( {a}_{2} - {c}_{2}^{′} ) \frac{1 + \frac{{c}_{2}^{′}}{{a}_{2}}}{1 + \frac{{c}_{2}^{′}}{{a}_{2}} cos {θ}_{2}^{′}} \qquad ( 15.43 )$$

and by using the following relationship between the polar angles θ₁′ and θ₂′:

θ_{∠ACB}=θ₁′+θ₂′−360° (15.44)

where θ_{∠ACB} is the bond angle of atoms A and B with central atom C. From either angle, the polar radius of intersection can be determined using Eq. (13.85). An example for methane is shown in Eqs. (13.597-13.600). Using these coordinates and the radius of the AO or HO, the limits of the integrals for the determination of the charge densities as well as the regions of each charge density are determined.

The energy of the MO is matched to each of the participating outermost atomic or hybridized orbitals of the bonding atoms wherein the energy match includes the energy contribution due to the AO or HO's donation of charge to the MO. The force constant k′ (Eq. (15.1)) is used to determine the ellipsoidal parameter c′ (Eq. (15.2)) of the each H₂-type-ellipsoidal-MO in terms of the central force of the foci. Then, c′ is substituted into the energy equation (from Eq. (15.11))) which is set equal to n₁ times the total energy of H₂ where n₁ is the number of equivalent bonds of the MO and the energy of H₂, −31.63536831 eV, Eq. (11.212) is the minimum energy possible for a prolate spheroidal MO. From the energy equation and the relationship between the axes, the dimensions of the MO are solved. The energy equation has the semimajor axis a as it only parameter. The solution of the semimajor axis a then allows for the solution of the other axes of each prolate spheroid and eccentricity of each MO (Eqs. (15.3-15.5)). The parameter solutions then allow for the component and total energies of the MO to be determined.

The total energy, E_{T}(H₂MO), is given by the sum of the energy terms (Eqs. (15.6-15.11)) plus E_{T}(AO/HO):

$$\begin{matrix} {E}_{T} ( {}_{{H}_{2} MO} ) = {V}_{e} + T + {V}_{m} + {V}_{p} + {E}_{T} ( AO / HO ) & ( 15.45 ) \\ \begin{matrix}{E}_{T} ( {}_{{H}_{2} MO} ) = - \frac{{n}_{1} {e}^{2}}{8 π {ɛ}_{0} \sqrt{{a}^{2} - {b}^{2}}} [ {c}_{1} {c}_{2} ( 2 - \frac{{a}_{0}}{a} ) ln \frac{a + \sqrt{{a}^{2} - {b}^{2}}}{a - \sqrt{{a}^{2} - {b}^{2}}} - 1 ] + \\ {E}_{T} ( AO / HO ) \\ = - \frac{{n}_{1} {e}^{2}}{8 π {ɛ}_{0} {c}^{′}} [ {c}_{1} {c}_{2} ( 2 - \frac{{a}_{0}}{a} ) ln \frac{a + {c}^{′}}{a - {c}^{′}} - 1 ] + {E}_{T} ( AO / HO )\end{matrix} & ( 15.46 )\end{matrix}$$

where n₁ is the number of equivalent bonds of the MO, c₁ is the fraction of the H₂-type ellipsoidal MO basis function of a chemical bond of the group, c₂ is the factor that results in an equipotential energy match of the participating at least two atomic orbitals of each chemical bond, and E_{T}(AO/HO) is the total energy comprising the difference of the energy E(AO/HO) of at least one atomic or hybrid orbital to which the MO is energy matched and any energy component ΔE_{H}_{₂}_{MO}(AO/HO) due to the AO or HO's charge donation to the MO.

E_{T}(AO/HO)=E(AO/HO)−ΔE_{H}_{₂}_{MO}(AO/HO) (15.47)

As specific examples given in previous sections, E_{T}(AO/HO) is one from the group of

E_{T}(AO/HO)=E(O2p shell)=−E(ionization; O)=−13.6181 eV;

E_{T}(AO/HO)=E(N2p shell)=−E(ionization; N)=−14.53414 eV;

E_{T}(AO/HO)=E(C,2sp³)=−14.63489 eV;

E_{T}(AO/HO)=E_{Coulomb}(C1,3sp³)=−14.60295 eV;

E_{T}(AO/HO)=E(ionization; C)+E(ionization; C⁺);

E_{T}(AO/HO)=E(Cₑₜₕₐₙₑ,2sp³)=−15.35946 eV;

E_{T}(AO/HO=+E(C_{ethylene},2sp³)−E(C_{ethylene},2sp³);

E_{T}(AO/HO)=E(C,2sp³)−2E_{T}(C═C,2sp³)=−14.63489 eV+2.26758 eV);

E_{T}(AO/HO)=E(C_{acetylene},2sp³)−E(C_{acetylene},2sp³)−E(C_{acetylene},2sp³)=16.20002 eV;

E_{T}(AO/HO)=E(C,2sp³)−2E_{T}(C≡C,2sp³)=−14.63489 eV −(−3.13026 eV);

E_{T}(AO/HO)=E(C_{benzene},2sp³)−E(C_{benzene},2sp³);

E_{T}(AO/HO=E(C,2sp³)−E_{T}(C═C,2sp³)=−14.63489 eV−(−1.13379 eV), and

E_{T}(AO/HO)=E(C_{benzene},2sp³)=−15.56407 eV.

To solve the bond parameters and energies,

$${c}^{′} = a \sqrt{\frac{{ℏ}^{2} 4 π {ɛ}_{0}}{{m}_{e} {e}^{2} 2 {C}_{1} {C}_{2} a}} = \sqrt{\frac{{aa}_{0}}{2 {C}_{1} {C}_{2}}}$$

(Eq. (15.2)) is substituted into E_{T}(H₂MO) to give

$$\begin{matrix}{E}_{T} ( {}_{{H}_{2} MO} ) = - \frac{{n}_{1} {e}^{2}}{8 π {ɛ}_{0} \sqrt{{a}^{2} - {b}^{2}}} [ {c}_{1} {c}_{2} ( 2 - \frac{{a}_{0}}{a} ) ln \frac{a + \sqrt{{a}^{2} - {b}^{2}}}{a - \sqrt{{a}^{2} - {b}^{2}}} - 1 ] + \\ {E}_{T} ( AO / HO ) \\ = - \frac{{n}_{1} {e}^{2}}{8 π {ɛ}_{0} {c}^{′}} [ {c}_{1} {c}_{2} ( 2 - \frac{{a}_{0}}{a} ) ln \frac{a + {c}^{′}}{a - {c}^{′}} - 1 ] + {E}_{T} ( AO / HO ) \\ = - \frac{{n}_{1} {e}^{2}}{8 π {ɛ}_{0} \sqrt{\frac{{aa}_{0}}{2 {C}_{1} {C}_{2}}}} [ {c}_{1} {c}_{2} ( 2 - \frac{{a}_{0}}{a} ) ln \frac{\begin{matrix}a + \\ \sqrt{\frac{{aa}_{0}}{2 {C}_{1} {C}_{2}}}\end{matrix}}{\begin{matrix}a - \\ \sqrt{\frac{{aa}_{0}}{2 {C}_{1} {C}_{2}}}\end{matrix}} - 1 ] + \\ {E}_{T} ( AO / HO )\end{matrix} \qquad ( 15.48 )$$

The total energy is set equal to E(basis energies) which in the most general case is given by the sum of a first integer n₁ times the total energy of H₂ minus a second integer n₂ times the total energy of H, minus a third integer n₃ times the valence energy of E(A0) (e.g. E(N)=−14.53414 eV) where the first integer can be 1,2,3 . . . , and each of the second and third integers can be 0, 1, 2, 3 . . . .

E(basis energies)=n₁(−31.63536831 eV)−n₂(−13.605804 eV)−n₃E(AO) (15.49)

In the case that the MO bonds two atoms other than hydrogen, E(basis energies) is n₁ times the total energy of H₂ where n₁ is the number of equivalent bonds of the MO and the energy of H₂, −31.63536831 eV, Eq. (11.212) is the minimum energy possible for a prolate spheroidal MO:

E(basis energies)=n₁(−31.63536831 eV) (15.50)

E_{T}(H₂MO), is set equal to E(basis energies), and the semimajor axis a is solved. Thus, the semimajor axis a is solved from the equation of the form:

$$- \frac{{n}_{1} {e}^{2}}{8 π {ɛ}_{0} \sqrt{\frac{{aa}_{0}}{2 {C}_{1} {C}_{2}}}} [ {c}_{1} {c}_{2} ( 2 - \frac{{a}_{0}}{a} ) ln \frac{a + \sqrt{\frac{{aa}_{0}}{2 {C}_{1} {C}_{2}}}}{a - \sqrt{\frac{{aa}_{0}}{2 {C}_{1} {C}_{2}}}} - 1 ] + {E}_{T} ( AO / HO ) = E ( basis energies ) \qquad ( 15.51 )$$

The distance from the origin of the H₂-type-ellipsoidal-MO to each focus c′, the internuclear distance 2c′, and the length of the semiminor axis of the prolate spheroidal H₂-type MO b=c are solved from the semimajor axis a using Eqs. (15.2-15.4). Then, the component energies are given by Eqs. (15.6-15.9) and (15.48).

The total energy of the MO of the functional group, E_{T}(MO), is the sum of the total energy of the components comprising the energy contribution of the MO formed between the participating atoms and E_{T}(atom−atom,msp³.AO), the change in the energy of the AOs or HOs upon forming the bond. From Eqs. (15.48-15.49), E_{T}(Mo) is

E_{T}(MO)=E(basis energies)+E_{T}(atom−atom,msp³.AO) (15.52)

During bond formation, the electrons undergo a reentrant oscillatory orbit with vibration of the nuclei, and the corresponding energy Ē_{osc} is the sum of the Doppler, Ē_{D}, and average vibrational kinetic energies, Ē_{Kvib}:

$${\overline{E}}_{osc} = {n}_{1} ( {\overline{E}}_{D} + {\overline{E}}_{Kvib} ) = {n}_{1} ( {E}_{hv} \sqrt{\frac{2 {\overline{E}}_{K}}{{m}_{e} {c}^{2}}} + \frac{1}{2} ℏ \sqrt{\frac{k}{μ}} ) \qquad ( 15.53 )$$

where n₁ is the number of equivalent bonds of the MO, k is the spring constant of the equivalent harmonic oscillator, and μ is the reduced mass. The angular frequency of the reentrant oscillation in the transition state corresponding to Ē_{D} is determined by the force between the central field and the electrons in the transition state. The force and its derivative are given by

$$\begin{matrix}f ( R ) = - {c}_{BO} \frac{{C}_{1 o} {C}_{2 o} {e}^{2}}{4 π {ɛ}_{0} {R}^{3}} and & ( 15.54 ) \\ {f}^{′} ( a ) = 2 {c}_{BO} \frac{{C}_{1 o} {C}_{2 o} {e}^{2}}{4 π {ɛ}_{0} {R}^{3}} & ( 15.55 )\end{matrix}$$

such that the angular frequency of the oscillation in the transition state is given by

$$\begin{matrix}ω = \sqrt{\frac{[ \frac{- 3}{a} f ( a ) - {f}^{′} ( a ) ]}{{m}_{e}}} \\ = \sqrt{\frac{k}{{m}_{e}}} \\ = \sqrt{\frac{{c}_{BO} \frac{{C}_{1 o} {C}_{2 o} {e}^{2}}{4 π {ɛ}_{0} {R}^{3}}}{{m}_{e}}}\end{matrix} \qquad ( 15.56 )$$

where R is the semimajor axis a or the semiminor axis b depending on the eccentricity of the bond that is most representative of the oscillation in the transition state, c_{BO}, is the bond-order factor which is 1 for a single bond and when the MO comprises n₁ equivalent single bonds as in the case of functional groups. c_{BO} is 4 for an independent double bond as in the case of the CO₂ and NO₂ molecules and 9 for an independent triplet bond. C₁ₒ is the fraction of the H₂-type ellipsoidal MO basis function of the oscillatory transition state of a chemical bond of the group, and C₂ₒ is the factor that results in an equipotential energy match of the participating at least two atomic orbitals of the transition state of the chemical bond. Typically, C₁ₒ═C₁ and C₂ₒ═C₂. The kinetic energy, E_{K}, corresponding to Ē_{D} is given by Planck's equation for functional groups:

$${\overline{E}}_{K} = ℏ ω = ℏ \sqrt{\frac{\frac{{C}_{1 o} {C}_{2 o} {e}^{2}}{4 π {ɛ}_{0} {R}^{3}}}{{m}_{e}}} \qquad ( 15.57 )$$

The Doppler energy of the electrons of the reentrant orbit is

$${\overline{E}}_{D} ≅ {E}_{hv} \sqrt{\frac{2 {\overline{E}}_{K}}{{m}_{e} {c}^{2}}} = {E}_{hv} \sqrt{\frac{2 ℏ \sqrt{\frac{\frac{{C}_{1 o} {C}_{2 o} {e}^{2}}{4 π {ɛ}_{0} {R}^{3}}}{{m}_{e}}}}{{m}_{e} {c}^{2}}} \qquad ( 15.58 )$$

Ē_{osc} given by the sum of Ē_{D} and Ē_{Kvib} is

$$\begin{matrix}{\overline{E}}_{osc} ( group ) = {n}_{1} ( {\overline{E}}_{D} + {\overline{E}}_{Kvib} ) \\ = {n}_{1} ( {E}_{hv} \sqrt{\frac{2 ℏ \sqrt{\frac{\frac{{C}_{1 o} {C}_{2 o} {e}^{2}}{4 π {ɛ}_{0} {R}^{3}}}{{m}_{e}}}}{{m}_{e} {c}^{2}}} + {E}_{vib} )\end{matrix} \qquad ( 15.59 )$$

Eₕᵥ of a group having n₁ bonds is given by E_{T}(Mo)/n₁ such that

$$\begin{matrix}{\overline{E}}_{osc} = {n}_{1} ( {\overline{E}}_{D} + {\overline{E}}_{Kvib} ) \\ = {n}_{1} ( {E}_{T} ( MO ) / {n}_{1} \sqrt{\frac{2 {\overline{E}}_{K}}{M {c}^{2}}} + \frac{1}{2} ℏ \sqrt{\frac{k}{μ}} )\end{matrix} \qquad ( 15.60 )$$

E_{T+osc} (Group) is given by the sum of E_{T}(Mo) (Eq. (15.51)) and Ē_{osc} (Eq. (15.60)):

$$\begin{matrix} ( 15.61 ) & \\ {E}_{T + OSC} ( {}_{Group} ) = {E}_{T} ( {}_{MO} ) + {\overline{E}}_{osc} = ( \begin{matrix}( \begin{matrix}- \frac{{n}_{1} {e}^{2}}{8 π {ɛ}_{0} \sqrt{\frac{{aa}_{0}}{2 {C}_{1} {C}_{2}}}} [ {c}_{1} {c}_{2} ( 2 - \frac{{a}_{0}}{a} ) ln \frac{a + \sqrt{\frac{{aa}_{0}}{2 {C}_{1} {C}_{2}}}}{a - \sqrt{\frac{{aa}_{0}}{2 {C}_{1} {C}_{2}}}} - 1 ] + \\ {E}_{T} ( AO / HO ) + {E}_{T} ( atom—atom , {msp}^{3} . AO )\end{matrix} ) \\ [ 1 + \sqrt{\frac{2 ℏ \sqrt{\frac{\frac{{C}_{1 o} {C}_{2 o} {e}^{2}}{4 π {ɛ}_{0} {R}^{3}}}{{m}_{e}}}}{{m}_{e} {c}^{2}}} ] + {n}_{1} \frac{1}{2} ℏ \sqrt{\frac{k}{μ}}\end{matrix} ) = ( E ( basis energies ) + {E}_{T} ( atom—atom , {msp}^{3} . AO ) ) [ 1 + \sqrt{\frac{2 ℏ \sqrt{\frac{\frac{{C}_{1 o} {C}_{2 o} {e}^{2}}{4 π {ɛ}_{0} {R}^{3}}}{{m}_{e}}}}{{m}_{e} {c}^{2}}} ] + {n}_{1} \frac{1}{2} ℏ \sqrt{\frac{k}{μ}} & \end{matrix}$$

The total energy of the functional group E_{T}(group) is the sum of the total energy of the components comprising the energy contribution of the MO formed between the participating atoms, E(basis energies), the change in the energy of the AOs or HOs upon forming the bond (E_{T}(atom−atom,msp³.AO)), the energy of oscillation in the transition state, and the change in magnetic energy with bond formation, E_{mag}. From Eq. (15.61), the total energy of the group E_{T}(Group) is

$$( 15.62 )$$

$${E}_{T} ( {}_{Group} ) = ( \begin{matrix}( \begin{matrix}E ( basis energies ) + \\ {E}_{T} ( atom—atom , {msp}^{3} . AO )\end{matrix} ) [ 1 + \sqrt{\frac{2 ℏ \sqrt{\frac{\frac{{C}_{1 o} {C}_{2 o} {e}^{2}}{4 π {ɛ}_{0} {R}^{3}}}{{m}_{e}}}}{{m}_{e} {c}^{2}}} ] \\ {n}_{1} {\overline{E}}_{Kvib} + {E}_{mag}\end{matrix} + ) \qquad$$

The change in magnetic energy E_{mag} which arises due to the formation of unpaired electrons in the corresponding fragments relative to the bonded group is given by

$${E}_{mag} = {c}_{3} \frac{2 π {μ}_{0} {e}^{2} {ℏ}^{2}}{{m}_{e}^{2} {r}^{3}} = {c}_{3} \frac{8 π {μ}_{0} {μ}_{B}^{2}}{{r}^{3}} \qquad ( 15.63 )$$

where r³ is the radius of the atom that reacts to form the bond and c₃ is the number of electron pairs.

$$( 15.64 )$$

$${E}_{T} ( {}_{Group} ) = ( \begin{matrix}( \begin{matrix}E ( basis energies ) + \\ {E}_{T} ( atom—atom , {msp}^{3} . AO )\end{matrix} ) [ 1 + \sqrt{\frac{2 ℏ \sqrt{\frac{\frac{{C}_{1 o} {C}_{2 o} {e}^{2}}{4 π {ɛ}_{0} {R}^{3}}}{{m}_{e}}}}{{m}_{e} {c}^{2}}} ] \\ {n}_{1} {\overline{E}}_{Kvib} + {c}_{3} \frac{8 π {μ}_{0} {μ}_{B}^{2}}{{r}^{3}}\end{matrix} + ) \qquad$$

The total bond energy of the group E_{D}(Group) is the negative difference of the total energy of the group (Eq. (15.64)) and the total energy of the starting species given by the sum of C₄Eᵢₙᵢₜᵢₐₗ(c₄ AO/HO) and c₅Eᵢₙᵢₜᵢₐₗ (c₅ AO/HO):

$$( 15.65 )$$

$${E}_{D} ( {}_{Group} ) = - ( \begin{matrix}( \begin{matrix}E ( basis energies ) + \\ {E}_{T} ( atom—atom , {msp}^{3} . AO )\end{matrix} ) [ 1 + \sqrt{\frac{2 ℏ \sqrt{\frac{\frac{{C}_{1 o} {C}_{2 o} {e}^{2}}{4 π {ɛ}_{0} {R}^{3}}}{{m}_{e}}}}{{m}_{e} {c}^{2}}} ] \\ {n}_{1} {\overline{E}}_{Kvib} + {c}_{3} \frac{8 π {μ}_{0} {μ}_{B}^{2}}{{r}_{n}^{3}} - ( \begin{matrix}{c}_{4} {E}_{initial} ( AO / HO ) + \\ {c}_{5} {E}_{initial} ( {c}_{5} AO / HO )\end{matrix} )\end{matrix} + )$$

In the case of organic molecules, the atoms of the functional groups are energy matched to the C2sp³ HO such that

E(AO/HO=−14.63489 eV (15.66)

For examples of E_{mag} from previous sections:

$$\begin{matrix}\begin{matrix}{E}_{mag} ( C 2 {sp}^{3} ) = {c}_{3} \frac{8 π {μ}_{0} {μ}_{B}^{2}}{{r}^{3}} = {c}_{3} \frac{8 π {μ}_{0} {μ}_{B}^{2}}{{( 0.91771 {a}_{0} )}^{3}} \\ = {c}_{3} 0.14803 eV\end{matrix} & ( 15.67 ) \\ {E}_{mag} ( O 2 p ) = {c}_{3} \frac{8 π {μ}_{0} {μ}_{B}^{2}}{{r}^{3}} = {c}_{3} \frac{8 π {μ}_{0} {μ}_{B}^{2}}{{a}_{0}^{3}} = {c}_{3} 0.11441 eV & ( 15.68 ) \\ \begin{matrix}{E}_{mag} ( N 2 p ) = {c}_{3} \frac{8 π {μ}_{0} {μ}_{B}^{2}}{{r}^{3}} = {c}_{3} \frac{8 π {μ}_{0} {μ}_{B}^{2}}{{( 0.93084 {a}_{0} )}^{3}} \\ = {c}_{3} 0.14185 eV\end{matrix} & ( 15.69 )\end{matrix}$$

In the general case of the solution of an organic functional group, the geometric bond parameters are solved from the semimajor axis and the relationships between the parameters by first using Eq. (15.51) to arrive at a. Then, the remaining parameters are determined using Eqs. (15.1-15.5). Next, the energies are given by Eqs. (15.61-15.68). To meet the equipotential condition for the union of the H₂-type-ellipsoidal-MO and the HO or AO of the atom of a functional group, the factor c₂ of a H₂-type ellipsoidal MO in principal Eqs. (15.51) and (15.61) may given by

(i) one:

c₂=1 (15.70)

(ii) the ratio that is less than one of 13.605804 eV, the magnitude of the Coulombic energy between the electron and proton of H given by Eq. (1.243), and the magnitude of the Coulombic energy of the participating AO or HO of the atom, E_{Coulomb}(MO.atom,msp³) given by Eqs. (15.19) and (15.31-15.32). For |E_{Coulomb}(MO.atom,msp³)|>13.605804 eV:

$$\begin{matrix}{c}_{2} = \frac{\frac{{e}^{2}}{8 π {ɛ}_{0} {a}_{0}}}{\frac{{e}^{2}}{8 π {ɛ}_{0} {r}_{A - B A or {Bsp}^{3}}}} = \frac{13.605804 eV}{\vert {E}_{Coulomb} ( MO . atom , {msp}^{3} ) \vert} \\ For \vert {E}_{Coulomb} ( MO . atom , {msp}^{3} ) \vert < 13.605804 eV \text{:} & ( 15.71 ) \\ {c}_{2} = \frac{\frac{{e}^{2}}{8 π {ɛ}_{0} {r}_{A - B A or {Bsp}^{3}}}}{\frac{{e}^{2}}{8 π {ɛ}_{0} {a}_{0}}} = \frac{\vert {E}_{Coulomb} ( MO . atom , {msp}^{3} ) \vert}{13.605804 eV} & ( 15.72 )\end{matrix}$$

(iii) the ratio that is less than one of 13.605804 eV, the magnitude of the Coulombic energy between the electron and proton of H given by Eq. (1.243), and the magnitude of the valence energy, E(valence), of the participating AO or HO of the atom where E(valence) is the ionization energy or E(MO.atom,msp³) given by Eqs. (15.20) and (15.31-15.32). For 1E(valence)|>13.605804 eV:

$${c}_{2} = \frac{\frac{{e}^{2}}{8 π {ɛ}_{0} {a}_{0}}}{\frac{{e}^{2}}{8 π {ɛ}_{0} {r}_{A - B A or {Bsp}^{3}}}} = \frac{13.605804 eV}{\vert E ( valence ) \vert} \qquad ( 15.73 )$$

For |E(valence)|<13.605804 eV:

$${c}_{2} = \frac{\frac{{e}^{2}}{8 π {ɛ}_{0} {r}_{A - B A or {Bsp}^{3}}}}{\frac{{e}^{2}}{8 π {ɛ}_{0} {a}_{0}}} = \frac{\vert E ( valence ) \vert}{13.605804 eV} \qquad ( 15.74 )$$

(iv) the ratio that is less than one of the magnitude of the Coulombic energy of the participating AO or HO of a first atom, E_{Coulomb}(MO.atom,msp³) given by Eqs. (15.19) and (15.31-15.32), and the magnitude of the valence energy, E(valence), of the participating AO or HO of a second atom to which the first is energy matched where E(valence) is the ionization energy or E(MO.atom,msp³) given by Eqs. (15.20) and (15.31-15.32). For |E_{Coulomb}(MO.atom,msp³)|>E(valence):

$$\begin{matrix}{c}_{2} = \frac{\vert E ( valence ) \vert}{\vert {E}_{Coulomb} ( MO . atom , {msp}^{3} ) \vert} \\ For \vert {E}_{Coulomb} ( MO . atom , {msp}^{3} ) \vert < E ( valence ) \text{:} & ( 15.75 ) \\ {c}_{2} = \frac{\vert {E}_{Coulomb} ( MO . atom , {msp}^{3} ) \vert}{\vert E ( valence ) \vert} & ( 15.76 )\end{matrix}$$

(v) the ratio of the magnitude of the valence-level energies, Eₙ (valence), of the AO or HO of the nth participating atom of two that are energy matched where E(valence) is the ionization energy or E(MO.atom,msp³) given by Eqs. (15.20) and (15.31-15.32):

$${c}_{2} = \frac{{E}_{1} ( valence )}{{E}_{2} ( valence )} \qquad ( 15.77 )$$

(vi) the factor that is the ratio of the hybridization factor c₂ (1) of the valence AO or HO of a first atom and the hybridization factor c₂ (2) of the valence AO or HO of a second atom to which the first is energy matched where c₂ (n) is given by Eqs. (15.71-15.77); alternatively c₂ is the hybridization factor c₂ (1) of the valence AOs or HOs a first pair of atoms and the hybridization factor c₂ (2) of the valence AO or HO a third atom or second pair to which the first two are energy matched:

$${c}_{2} = \frac{{c}_{2} ( 1 )}{{c}_{2} ( 2 )} \qquad ( 15.78 )$$

(vii) the factor that is the product of the hybridization factor c₂ (1) of the valence AO or HO of a first atom and the hybridization factor c₂ (2) of the valence AO or HO of a second atom to which the first is energy matched where c₂ (n) is given by Eqs. (15.71-15.78); alternatively c₂ is the hybridization factor c₂ (1) of the valence AOs or HOs a first pair of atoms and the hybridization factor c₂ (2) of the valence AO or HO a third atom or second pair to which the first two are energy matched:

c₂=c₂(1)c₂(2) (15.79)

The hybridization factor c₂ corresponds to the force constant k (Eqs. (11.65) and (13.58)). In the case that the valence or Coulombic energy of the AO or HO is less than 13.605804 eV, the magnitude of the Coulombic energy between the electron and proton of H given by Eq. (1.243), then C₂ corresponding to k′ (Eq. (15.1)) is given by Eqs. (15.71-15.79).

Specific examples of the factors c₂ and C₂ of a H₂-type ellipsoidal MO of Eq. (15.60) given in following sections are

$$\begin{matrix}{c}_{2} ( C 2 {sp}^{3} HO to F ) = \frac{E ( C , 2 {sp}^{3} )}{E ( F )} {c}_{2} ( C 2 {sp}^{3} HO ) \\ = \frac{- 14.63489 eV}{- 17.42282 eV} ( 0.91771 ) \\ = 0.77087 ;\end{matrix}$$

$$\begin{matrix}{C}_{2} ( C 2 {sp}^{3} HO to Cl ) = \frac{E ( Cl )}{E ( C , 2 {sp}^{3} )} {c}_{2} ( C 2 {sp}^{3} HO ) \\ = \frac{- 12.96764 eV}{- 14.63489 eV} ( 0.91771 ) \\ = 0.81317 ;\end{matrix}$$

$$\begin{matrix}{C}_{2} ( C 2 {sp}^{3} HO to Br ) = \frac{E ( Br )}{E ( C , 2 {sp}^{3} )} {c}_{2} ( C 2 {sp}^{3} HO ) \\ = \frac{- 11.81381 eV}{- 14.63489 eV} ( 0.91771 ) \\ = 0.74081 ;\end{matrix}$$

$$\begin{matrix}{C}_{2} ( C 2 {sp}^{3} HO to I ) = \frac{E ( I )}{E ( C , 2 {sp}^{3} )} {c}_{2} ( C 2 {sp}^{3} HO ) \\ = \frac{- 10.45126 eV}{- 14.63489 eV} ( 0.91771 ) \\ = 0.65537 ;\end{matrix}$$

$$\begin{matrix}{c}_{2} ( C 2 {sp}^{3} HO to O ) = \frac{E ( O )}{E ( C , 2 {sp}^{3} )} {c}_{2} ( C 2 {sp}^{3} HO ) \\ = \frac{- 13.61806 eV}{- 14.63489 eV} ( 0.91771 ) \\ = 0.85395 ;\end{matrix}$$

$${c}_{2} ( H to 1 ° N ) = \frac{E ( N )}{E ( C , 2 {sp}^{3} )} = \frac{- 14.53414 eV}{- 15.35946 eV} = 0.94627 ;$$

$$\begin{matrix}{c}_{2} ( C 2 {sp}^{3} HO to N ) = \frac{E ( N )}{E ( C , 2 {sp}^{3} )} {c}_{2} ( C 2 {sp}^{3} HO ) \\ = \frac{- 14.53414 eV}{- 14.63489 eV} ( 0.91771 ) \\ = 0.91140 ;\end{matrix}$$

$${c}_{2} ( H to 2 ° N ) = \frac{E ( N )}{E ( C , 2 {sp}^{3} )} = \frac{- 14.53414 eV}{- 15.56407 eV} = 0.93383 ;$$

$${C}_{2} ( S 3 p to H ) = \frac{E ( S , 3 p )}{E ( H )} = \frac{- 10.36001 eV}{- 13.60580 eV} = 0.76144 ;$$

$$\begin{matrix}{C}_{2} ( C 2 {sp}^{3} HO to S ) = \frac{E ( S )}{E ( C , 2 {sp}^{3} )} {c}_{2} ( C 2 {sp}^{3} HO ) \\ = \frac{- 10.36001 eV}{- 14.63489 eV} ( 0.91771 ) \\ = 0.64965 ;\end{matrix}$$

$$\begin{matrix}{c}_{2} ( O to S 3 {sp}^{3} to C 2 {sp}^{3} HO ) = \frac{E ( O )}{E ( S )} {c}_{2} ( C 2 {sp}^{3} HO ) \\ = \frac{- 13.61806 eV}{- 10.36001 eV} ( 0.91771 ) \\ = 1.20632 ;\end{matrix}$$

$${c}_{2} ( S 3 {sp}^{3} ) = \frac{{E}_{Coulomb} ( S 3 {sp}^{3} )}{E ( H )} = \frac{- 11.57099 eV}{- 13.60580 eV} = 0.85045 ;$$

$$\begin{matrix}{C}_{2} ( C 2 {sp}^{3} HO to S 3 {sp}^{3} ) = \frac{E ( S 3 {sp}^{3} )}{E ( C , 2 {sp}^{3} )} {c}_{2} ( S 3 {sp}^{3} ) \\ = \frac{- 11.52126 eV}{- 14.63489 eV} ( 0.85045 ) \\ = 0.66951 ;\end{matrix}$$

$$\begin{matrix}{C}_{2} ( S 3 {sp}^{3} to O to C2 {sp}^{3} HO ) = \frac{E ( S 3 {sp}^{3} )}{E ( O , 2 p )} {c}_{2} ( C 2 {sp}^{3} HO ) \\ = \frac{- 11.52126 eV}{- 13.61806 eV} ( 0.91771 ) \\ = 0.77641 ;\end{matrix}$$

$$\begin{matrix}{c}_{2} ( O to N 2 p to C 2 {sp}^{3} HO ) = \frac{E ( O )}{E ( N )} {c}_{2} ( C 2 {sp}^{3} HO ) \\ = \frac{- 13.61806 eV}{- 14.53414 eV} ( 0.91771 ) \\ = 0.85987 ;\end{matrix}$$

$${c}_{2} ( N 2 p to O 2 p ) = \frac{{c}_{2} ( C 2 {sp}^{3} HO to N )}{{c}_{2} ( C 2 {sp}^{3} HO to O )} = \frac{0.91140}{0.85395} = 1.06727 ;$$

$$\begin{matrix}{C}_{2} ( benzene C 2 {sp}^{3} HO ) = {c}_{2} ( benzene C 2 {sp}^{3} HO ) \\ = \frac{13.605804 eV}{15.95955 eV} \\ = 0.85252 ;\end{matrix}$$

$$\begin{matrix}{c}_{2} ( aryl C 2 {sp}^{3} HO to O ) = \frac{E ( O )}{E ( C , 2 {sp}^{3} )} {c}_{2} ( aryl C 2 {sp}^{3} HO ) \\ = \frac{- 13.61806 eV}{- 14.63489 eV} ( 0.85252 ) \\ = 0.79329 ;\end{matrix}$$

$${c}_{2} ( H to anline N ) = \frac{E ( N )}{E ( C , 2 {sp}^{3} )} = \frac{- 14.53414 eV}{- 15.76868 eV} = 0.92171 ;$$

$$\begin{matrix}{c}_{2} ( aryl C 2 {sp}^{3} HO to N ) = \frac{E ( N )}{E ( C , 2 {sp}^{3} )} {c}_{2} ( aryl C 2 {sp}^{3} HO ) \\ = \frac{- 14.53414 eV}{- 14.63489 eV} ( 0.85252 ) \\ = 0.84665 ,\end{matrix}$$

$$and$$

$$\begin{matrix}{C}_{2} ( S 3 p to aryl \text{-} type C 2 {sp}^{3} HO ) = \frac{E ( S , 3 p )}{E ( C , 2 {sp}^{3} )} \\ = \frac{- 10.36001 eV}{- 15.76868 eV} \\ = 0.65700 .\end{matrix}$$

### Mo Intercept Angles and Distances

Consider the general case of Eqs. (13.84-13.95), wherein the nucleus of a B atom and the nucleus of a A atom comprise the foci of each H₂-type ellipsoidal MO of an A-B bond. The parameters of the point of intersection of each H₂-type ellipsoidal MO and the A-atom AO are determined from the polar equation of the ellipse:

$$r = {r}_{0} \frac{1 + e}{1 + e cos {θ}^{′}} \qquad ( 15.80 )$$

The radius of the A shell is r_{A}, and the polar radial coordinate of the ellipse and the radius of the A shell are equal at the point of intersection such that

$${r}_{A} = ( a - {c}^{′} ) \frac{1 + \frac{{c}^{′}}{a}}{1 + \frac{{c}^{′}}{a} cos {θ}^{′}} \qquad ( 15.81 )$$

The polar angle θ′ at the intersection point is given by

$${θ}^{′} = {cos}^{- 1} ( \frac{a}{{c}^{′}} ( ( a - {c}^{′} ) \frac{1 + \frac{{c}^{′}}{a}}{{r}_{A}} - 1 ) ) \qquad ( 15.82 )$$

Then, the angle θ_{A AO} the radial vector of the A AO makes with the internuclear axis is

θ_{A AO}=180°−θ′ (15.83)

The distance from the point of intersection of the orbitals to the internuclear axis must be the same for both component orbitals such that the angle ωt=θ_{H}_{₂}_{MO} between the internuclear axis and the point of intersection of each H₂-type ellipsoidal MO with the A radial vector obeys the following relationship:

r_{A} sin θ_{A AO}=b sin θ_{H}_{₂}_{MO} (15.84)

such that

$${θ}_{{H}_{2} MO} = {sin}^{- 1} \frac{{r}_{a} sin {θ}_{AAO}}{b} \qquad ( 15.85 )$$

The distance d_{H}_{₂}_{MO} along the internuclear axis from the origin of H₂-type ellipsoidal MO to the point of intersection of the orbitals is given by

d_{H}_{₂}_{MO}=a cos θ_{H}_{₂}_{MO} (15.86)

The distance d_{A AO} along the internuclear axis from the origin of the A atom to the point of intersection of the orbitals is given by

d_{A AO}=c′−d_{H}_{₂}_{MO} (15.87)

### Bond Angles

Further consider an ACB MO comprising a linear combination of C-A-bond and C—B-bond MOs where C is the general central atom. A bond is also possible between the A and B atoms of the C-A and C—B bonds. Such A-B bonding would decrease the C-A and C—B bond strengths since electron density would be shifted from the latter bonds to the former bond. Thus, the ∠ACB bond angle is determined by the condition that the total energy of the H₂-type ellipsoidal MO between the terminal A and B atoms is zero. The force constant k′ of a H₂-type ellipsoidal MO due to the equivalent of two point charges of at the foci is given by:

$${k}^{′} = \frac{{C}_{1} {C}_{2} 2 {e}^{2}}{4 {πɛ}_{0}} \qquad ( 15.88 )$$

where C₁ is the fraction of the H₂-type ellipsoidal MO basis function of a chemical bond of the molecule which is 0.75 (Eq. (13.59)) for a terminal A-H (A is H or other atom) and 1 otherwise and C₂ is the factor that results in an equipotential energy match of the participating at least two atomic orbitals of the chemical bond and is equal to the corresponding factor of Eqs. (15.51) and (15.61). The distance from the origin of the MO to each focus c′ of the A-B ellipsoidal MO is given by:

$${c}^{′} = a \sqrt{\frac{{ℏ}^{2} 4 {πɛ}_{0}}{{m}_{e} {e}^{2} 2 {C}_{1} {C}_{2} a}} = \sqrt{\frac{{aa}_{0}}{2 {C}_{1} {C}_{2}}} \qquad ( 15.89 )$$

The internuclear distance is

$$2 {c}^{′} = 2 \sqrt{\frac{{aa}_{0}}{2 {C}_{1} {C}_{2}}} \qquad ( 15.90 )$$

The length of the semiminor axis of the prolate spheroidal A-B MO b=c is given by Eq. (15.4).

The component energies and the total energy, E_{T}(H₂MO), of the A-B bond are given by the energy equations (Eqs. (11.207-11.212), (11.213-11.217), and (11.239)) of H₂ except that the terms based on charge are multiplied by c_{BO}, the bond-order factor which is 1 for a single bond and when the MO comprises n₁ equivalent single bonds as in the case of functional groups. c_{BO} is 4 for an independent double bond as in the case of the CO₂ and NO₂ molecules. The kinetic energy term is multiplied by c′₈₀ which is 1 for a single bond, 2 for a double bond, and 9/2 for a triple bond. The electron energy terms are multiplied by c₁, the fraction of the H₂-type ellipsoidal MO basis function of a terminal chemical bond which is 0.75 (Eq. (13.233)) for a terminal A-H (A is H or other atom) and 1 otherwise, The electron energy terms are further multiplied by c′₂, the hybridization or energy-matching factor that results in an equipotential energy match of the participating at least two atomic orbitals of each terminal bond. Furthermore, when A-B comprises atoms other than H, E_{T}(atom−atom,msp³.AO), the energy component due to the AO or HO's charge donation to the terminal MO, is added to the other energy terms to give E_{T}(H₂MO):

$${E}_{T ( {H}_{2} MO )} = \frac{- {e}^{2}}{8 {πɛ}_{0} {c}^{′}} [ {c}_{1} {c}_{2}^{′} ( 2 {c}_{BO} - {c}_{BO}^{′} \frac{{a}_{0}}{a} ) ln \frac{a + {c}^{′}}{a - {c}^{′}} - 1 ] + {E}_{T} ( atom - atom , {msp}^{3} . AO ) \qquad ( 15.91 )$$

The radiation reaction force in the case of the vibration of A-B in the transition state corresponds to the Doppler energy, E_{D}, given by Eq. (11.181) that is dependent on the motion of the electrons and the nuclei. The total energy that includes the radiation reaction of the A-B MO is given by the sum of E_{T}(H₂MO) (Eq. (15.91)) and Ē_{osc} given Eqs. (11.213-11.220), (11.231-11.236), and (11.239-11.240). Thus, the total energy E_{T}(A-B) of the A-B MO including the Doppler term is

$${E}_{T} ( A - B ) = [ \begin{matrix}( \begin{matrix}\frac{- {e}^{2}}{8 {πɛ}_{0} {c}^{′}} [ {c}_{1} {c}_{2}^{′} ( 2 {c}_{BO} - {c}_{BO}^{′} \frac{{a}_{0}}{a} ) ln \frac{a + {c}^{′}}{a - {c}^{′}} - 1 ] + \\ {E}_{T} ( atom - atom , {msp}^{3} . AO )\end{matrix} ) \\ \begin{matrix}[ 1 + \sqrt{\frac{2 ℏ \sqrt{\frac{{c}_{BO} \frac{{C}_{1 o} {C}_{2 o} {e}^{2}}{4 {πɛ}_{0} {a}^{3}}}{{m}_{e}}}}{{m}_{e} {c}^{2}}} ] + \\ \frac{1}{2} ℏ \sqrt{\frac{{c}_{BO} \frac{{c}_{1} {c}_{2}^{′} {e}^{2}}{8 {πɛ}_{0} {a}^{3}} - \frac{{c}_{BO} {e}^{2}}{8 {{πɛ}_{0} ( a + {c}^{′} )}^{3}}}{μ}}\end{matrix}\end{matrix} ] \qquad ( 15.92 )$$

where C₁ₒ is the fraction of the H₂-type ellipsoidal MO basis function of the oscillatory transition state of the A-B bond which is 0.75 (Eq. (13.233)) in the case of H bonding to a central atom and 1 otherwise, C₂ₒ is the factor that results in an equipotential energy match of the participating at least two atomic orbitals of the transition state of the chemical bond, and

$$μ = \frac{{m}_{1} {m}_{2}}{{m}_{1} + {m}_{2}}$$

is the reduced mass of the nuclei given by Eq. (11.154). To match the boundary condition that the total energy of the A-B ellipsoidal MO is zero, E_{T}(A-B) given by Eq. (15.92) is set equal to zero. Substitution of Eq. (15.90) into Eq. (15.92) gives

$$0 = [ \begin{matrix}( \begin{matrix}\frac{- {e}^{2}}{8 {πɛ}_{0} \sqrt{\frac{{aa}_{0}}{2 {C}_{1} {C}_{2}}}} [ \begin{matrix}{c}_{1} {c}_{2}^{′} ( 2 {c}_{BO} - {c}_{BO}^{′} \frac{{a}_{0}}{a} ) \\ ln \frac{a + \sqrt{\frac{{aa}_{0}}{2 {C}_{1} {C}_{2}}}}{a - \sqrt{\frac{{aa}_{0}}{2 {C}_{1} {C}_{2}}}} - 1\end{matrix} ] + \\ {E}_{T} ( atom - atom , {msp}^{3} . AO )\end{matrix} ) \\ \begin{matrix}[ 1 + \sqrt{\frac{2 ℏ \sqrt{\frac{{c}_{BO} \frac{{C}_{1 o} {C}_{2 o} {e}^{2}}{4 {πɛ}_{0} {a}^{3}}}{{m}_{e}}}}{{m}_{e} {c}^{2}}} ] + \\ \frac{1}{2} ℏ \sqrt{\frac{{c}_{BO} \frac{{c}_{1} {c}_{2}^{′} {e}^{2}}{8 {πɛ}_{0} {a}^{3}} - \frac{{c}_{BO} {e}^{2}}{8 {{πɛ}_{0} ( a + \sqrt{\frac{{aa}_{0}}{2 {C}_{1} {C}_{2}}} )}^{3}}}{μ}}\end{matrix}\end{matrix} ] \qquad ( 15.93 )$$

The vibrational energy-term of Eq. (15.93) is determined by the forces between the central field and the electrons and those between the nuclei (Eqs. (11.141-11.145)). The electron-central-field force and its derivative are given by

$$\begin{matrix}f ( a ) = - {c}_{BO} \frac{{c}_{1} {c}_{2}^{′} {e}^{2}}{4 {πɛ}_{0} {a}^{3}} \\ and & ( 15.94 ) \\ {f}^{′} ( a ) = - 2 {c}_{BO} \frac{{c}_{1} {c}_{2}^{′} {e}^{2}}{4 {πɛ}_{0} {a}^{3}} & ( 15.95 )\end{matrix}$$

The nuclear repulsion force and its derivative are given by

$$\begin{matrix}f ( a + {c}^{′} ) = \frac{{e}^{2}}{8 {{πɛ}_{0} ( a + {c}^{′} )}^{2}} \\ and & ( 15.96 ) \\ {f}^{′} ( a + {c}^{′} ) = - \frac{{e}^{2}}{4 {{πɛ}_{0} ( a + {c}^{′} )}^{3}} & ( 15.97 )\end{matrix}$$

such that the angular frequency of the oscillation is given by

$$ω = \sqrt{\frac{[ \frac{- 3}{a} f ( a ) - {f}^{′} ( a ) ]}{μ}} = \sqrt{\frac{k}{{m}_{e}}} = \sqrt{\frac{{c}_{BO} \frac{{c}_{1} {c}_{2}^{′} {e}^{2}}{4 {πɛ}_{0} {a}^{3}} - \frac{{e}^{2}}{8 {{πɛ}_{0} ( a + {c}^{′} )}^{2}}}{μ}} \qquad ( 15.98 )$$

Since both terms of Ē_{osc}=Ē_{D}+Ē_{Kvib} are small due to the large values of a and c′, to very good approximation, a convenient form of Eq. (15.93) which is evaluated to determine the bond angles of functional groups is given by

$$0 = [ \begin{matrix}( \begin{matrix}\frac{- {e}^{2}}{8 {πɛ}_{0} \sqrt{\frac{{aa}_{0}}{2 {C}_{1} {C}_{2}}}} [ {c}_{1} {c}_{2}^{′} ( 2 - \frac{{a}_{0}}{a} ) ln \frac{a + \sqrt{\frac{{aa}_{0}}{2 {C}_{1} {C}_{2}}}}{a - \sqrt{\frac{{aa}_{0}}{2 {C}_{1} {C}_{2}}}} - 1 ] + \\ {E}_{T} ( atom - atom , {msp}^{3} . AO )\end{matrix} ) \\ \begin{matrix}[ 1 + \sqrt{\frac{2 ℏ \sqrt{\frac{\frac{{c}_{1} {e}^{2}}{4 {πɛ}_{0} {a}^{3}}}{{m}_{e}}}}{{m}_{e} {c}^{2}}} ] + \\ \frac{1}{2} ℏ \sqrt{\frac{\frac{{c}_{1} {e}^{2}}{8 {πɛ}_{0} {a}^{3}} - \frac{{e}^{2}}{8 {{πɛ}_{0} ( a + \sqrt{\frac{{aa}_{0}}{2 {C}_{1} {C}_{2}}} )}^{3}}}{μ}}\end{matrix}\end{matrix} ] \qquad ( 15.99 )$$

From the energy relationship given by Eq. (15.99) and the relationship between the axes given by Eqs. (15.2-15.5), the dimensions of the A-B MO can be solved. The most convenient way to solve Eq. (15.99) is by the reiterative technique using a computer.

A factor c₂ of a given atom in the determination of c; for calculating the zero of the total A-B bond energy is typically given by Eqs. (15.71-15.74). In the case of a H—H terminal bond of an alkyl or alkenyl group, c; is typically the ratio of c₂ of Eq. (15.71) for the H—H bond which is one and c₂ of the carbon of the corresponding C—H bond:

$${c}_{2}^{′} = \frac{1}{{c}_{2} ( C 2 {sp}^{3} )} = \frac{{E}_{Coulomb} ( C \text{-} H C 2 {sp}^{3} )}{13.605804 eV} \qquad ( 15.100 )$$

In the case of the determination of the bond angle of the ACH MO comprising a linear combination of C-A-bond and C—H-bond MOs where A and C are general, C is the central atom, and c₂ for an atom is given by Eqs. (15.71-15.79), c; of the A-H terminal bond is typically the ratio of c₂ of the A atom for the A-H terminal bond and c₂ of the C atom of the corresponding C—H bond:

$${c}_{2}^{′} = \frac{{c}_{2} ( A ( A \text{-} H ) {msp}^{3} )}{{c}_{2} ( C ( C \text{-} H ) ( {msp}^{3} )} \qquad ( 15.101 )$$

In the case of the determination of the bond angle of the COH MO of an alcohol comprising a linear combination of C—O-bond and O—H-bond MOs where C, O, and H are carbon, oxygen, and hydrogen, respectively, c; of the C—H terminal bond is typically 0.91771 since the oxygen and hydrogen atoms are at the Coulomb potential of a proton and an electron (Eqs. (1.236) and (10.162), respectively) that is energy matched to the C2sp³ HO.

In the determination of the hybridization factor c′₂ of Eq. (15.99) from Eqs. (15.71-15.79), the Coulombic energy, E_{Coulomb}(MO.atom,msp³), or the energy, E(MO.atom,msp³), the radius r_{A-B AorBsp}_{³} of the A or B AO or HO of the heteroatom of the A-B terminal bond MO such as the C2sp³ HO of a terminal C—C bond is calculated using Eq. (15.32) by considering ΣE_{T}_{ₘₒₗ}(MO,2sp³), the total energy donation to each bond with which it participates in bonding as it forms the terminal bond. The Coulombic energy E_{Coulomb}(MO.atom,msp3) of the outer electron of the atom msp³ shell is given by Eq. (15.19). In the case that during hybridization, at least one of the spin-paired AO electrons is unpaired in the hybridized orbital (HO), the energy change for the promotion to the unpaired state is the magnetic energy E(magnetic) (Eq. (15.15)) at the initial radius r of the AO electron. Then, the energy E(MO.atom,msp³) of the outer electron of the atom msp³ shell is given by the sum of E_{Coulomb}(MO.atom,msp³) and E(magnetic) (Eq. (15.20)).

In the specific case of the terminal bonding of two carbon atoms, the c₂ factor of each carbon given by Eq. (15.71) is determined using the Coulombic energy E_{Coulomb}(C—C C2sp³) of the outer electron of the C2sp³ shell given by Eq. (15.19) with the radius r_{C—C C}2sp_{³} of each C2sp³ HO of the terminal C—C bond calculated using Eq. (15.32) by considering ΣE_{T}_{ₘₒₗ}(MO,2sp³), the total energy donation to each bond with which it participates in bonding as it forms the terminal bond including the contribution of the methylene energy, 0.92918 eV (Eq. (14.513)), corresponding to the terminal C—C bond. The corresponding E_{T}(atom−atom,msp³.AO) in Eq. (15.99) is E_{T}(C—C C2sp³)=−1.85836 eV.

In the case that the terminal atoms are carbon or other heteroatoms, the terminal bond comprises a linear combination of the HOs or AOs; thus, c′₂ is the average of the hybridization factors of the participating atoms corresponding to the normalized linear sum:

$${c}_{2}^{′} = \frac{1}{2} ( {c}_{2}^{′} ( atom 1 ) + {c}_{2}^{′} ( atom 2 ) ) \qquad ( 15.102 )$$

In the exemplary cases of C—C, O—O, and N—N where C is carbon:

$$\begin{matrix}{c}_{2}^{′} = \frac{1}{2} ( \frac{\frac{{e}^{2}}{8 {πɛ}_{0} {a}_{0}}}{\frac{{e}^{2}}{8 {πɛ}_{0} {r}_{A \text{-} A {A}_{1} AO / HO}}} + \frac{\frac{{e}^{2}}{8 {πɛ}_{0} {a}_{0}}}{\frac{{e}^{2}}{8 {πɛ}_{0} {r}_{A \text{-} A {A}_{2} AO / HO}}} ) \\ = \frac{1}{2} ( \begin{matrix}\frac{13.605804 eV}{{E}_{Coulomb} ( A \text{-} A . {A}_{1} AO / HO )} + \\ \frac{13.605804 eV}{{E}_{Coulomb} ( A \text{-} A . {A}_{2} AO / HO )}\end{matrix} )\end{matrix} \qquad ( 15.103 )$$

In the exemplary cases of C—N, C—O, and C—S,

$${c}_{2}^{′} = \frac{1}{2} ( \frac{13.605804 eV}{{E}_{Coulomb} ( C \text{-} B C 2 {sp}^{3} )} + {c}_{2} ( C to B ) ) \qquad ( 15.104 )$$

where C is carbon and c₂ (C to B) is the hybridization factor of Eqs. (15.61) and (15.93) that matches the energy of the atom B to that of the atom C in the group. For these cases, the corresponding E_{T}(atom−atom,msp³.AO) term in Eq. (15.99) depends on the hybridization and bond order of the terminal atoms in the molecule, but typical values matching those used in the determination of the bond energies (Eq. (15.65)) are

E_{T}(C—O C2sp³.O2p)=−1.44915 eV; E_{T}(C—O C2sp³.O2p)=−1.65376 eV;

E_{T}(C—N C2sp³.N2p)=−1.44915 eV; E_{T}(C—S C2sp³.S2p)=−0.72457 eV;

E_{T}(O—O O2p. O2p)=−1.44915 eV; E_{T}(O—O O2p. O2p)=−1.65376 eV;

E_{T}(N—N N2p.N2p)=−1.44915 eV; E_{T}(N—O N2p. O2p)=−1.44915 eV;

E_{T}(F—F F2p.F2p)=−1.44915 eV; E_{T}(Cl—Cl Cl3p.C13p)=−0.92918 eV;

E_{T}(Br—Br Br4p.Br4p)=−0.92918 eV; E_{T}(I—I I5p.I5p)=−0.36229 eV;

E_{T}(C—F C2sp³.F2p)=−1.85836 eV; E_{T}(C—Cl C2sp³.C13p)=−0.92918 eV;

E_{T}(C—Br C2sp³.Br4p)=−0.72457 eV; E_{T}(C—I C2sp³.I5p)=−0.36228 eV, and

E_{T}(O—O O2p.C13p)=−0.92918 eV.

In the case that the terminal bond is X—X where X is a halogen atom, c₁ is one, and c′₂ is the average (Eq. (15.102)) of the hybridization factors of the participating halogen atoms given by Eqs. (15.71-15.72) where E_{Coulomb}(MO.atom,msp³) is determined using Eq. (15.32) and E_{Coulomb}(MO.atom,msp³)=13.605804 eV for X═I. The factor C₁ of Eq. (15.99) is one for all halogen atoms. The factor C₂ of fluorine is one since it is the only halogen wherein the ionization energy is greater than that 13.605804 eV, the magnitude of the Coulombic energy between the electron and proton of H given by Eq. (1.243). For each of the other halogens, Cl, Br, and I, C₂ is the hybridization factor of Eq. (15.61) given by Eq. (15.79) with c₂ (1) being that of the halogen given by Eq. (15.77) that matches the valence energy of X (E₁ (valence)) to that of the C2sp³ HO (E₂(valence)=−14.63489 eV, Eq. (15.25)) and to the hybridization of C2sp³ HO (c₂ (2)=0.91771, Eq. (13.430)). E_{T}(atom−atom, msp³.AO) of Eq. (15.99) is the maximum for the participating atoms which is −1.44915 eV, −0.92918 eV, −0.92918 eV, and −0.33582 eV for F, Cl, Br, and I, respectively.

Consider the case that the terminal bond is C—X where C is a carbon atom and X is a halogen atom. The factors c₁ and C, of Eq. (15.99) are one for all halogen atoms. For X═F, c′₂ is the average (Eq. (15.104)) of the hybridization factors of the participating carbon and F atoms where c₂ for carbon is given by Eq. (15.71) and c₂ for fluorine matched to carbon is given by Eq. (15.79) with c₂ (1) for the fluorine atom given by Eq. (15.77) that matches the valence energy of F (E₁(valence)=−17.42282 eV) to that of the C2sp³ HO (E₂(valence)=−14.63489 eV, Eq. (15.25)) and to the hybridization of C2sp³ HO (c₂ (2)=0.91771, Eq. (13.430)). The factor C₂ of fluorine is one since it is the only halogen wherein the ionization energy is greater than that 13.605804 eV, the magnitude of the Coulombic energy between the electron and proton of H given by Eq. (1.243). For each of the other halogens, Cl, Br, and I, c′₂ is the hybridization factor of the participating carbon atom since the halogen atom is energy matched to the carbon atom. C₂ of the terminal-atom bond matches that used to determine the energies of the corresponding C—X-bond MO. Then, C₂ is the hybridization factor of Eq. (15.61) given by Eq. (15.79) with c₂ (1) for the halogen atom given by Eq. (15.77) that matches the valence energy of X (E₁ (valence)) to that of the C2sp³ HO (E₂(valence)=−14.63489 eV, Eq. (15.25)) and to the hybridization of C2sp³ HO (c₂(2)=0.91771, Eq. (13.430)). E_{T}(atom−atom,msp³.AO) of Eq. (15.99) is the maximum for the participating atoms which is −1.85836 eV, −0.92918 eV, −0.72457 eV, and −0.33582 eV for F, Cl, Br, and I, respectively.

Consider the case that the terminal bond is H—X corresponding to the angle of the atoms HCX where C is a carbon atom and X is a halogen atom. The factors c₁ and C₁ of Eq. (15.99) are 0.75 for all halogen atoms. For X═F, c′₂ is given by Eq. (15.78) with c₂ of the participating carbon and F atoms given by Eq. (15.71) and Eq. (15.74), respectively. The factor C₂ of fluorine is one since it is the only halogen wherein the ionization energy is greater than that 13.605804 eV, the magnitude of the Coulombic energy between the electron and proton of H given by Eq. (1.243). For each of the other halogens, Cl, Br, and I, c′₂ is also given by Eq. (15.78) with c₂ of the participating carbon given by Eq. (15.71) and c₂ of the participating X atom given by c₂=0.91771 (Eq. (13.430)) since the X atom is energy matched to the C2sp³ HO. In these cases, C₂ is given by Eq. (15.74) for the corresponding atom X where C₂ matches the energy of the atom X to that of H.

Using the distance between the two atoms A and B of the general molecular group ACB when the total energy of the corresponding A-B MO is zero, the corresponding bond angle can be determined from the law of cosines:

s₁²+s₂²−2s₁s₂cosine θ=s₃² (15.105)

With s₁=2c′_{C-A}, the internuclear distance of the C-A bond, s₂=2c′_{C—B}, the internuclear distance of each C—B bond, and s₃=2c′_{A-B} the internuclear distance of the two terminal atoms, the bond angle θ_{∠ACB} between the C-A and C—B bonds is given by

$$\begin{matrix}{( 2 {c}_{C \text{-} A}^{′} )}^{2} + ( 2 {c}_{C \text{-} B}^{′} ) - 2 ( 2 {c}_{C \text{-} A}^{′} ) ( 2 {c}_{C \text{-} B}^{′} ) cosine θ = {( 2 {c}_{A \text{-} B}^{′} )}^{2} & ( 15.106 ) \\ {θ}_{∠ABC} = {cos}^{- 1} ( \frac{{( 2 {c}_{C \text{-} A}^{′} )}^{2} + {( 2 {c}_{C \text{-} B}^{′} )}^{2} - {( 2 {c}_{A \text{-} B}^{′} )}^{2}}{2 ( 2 {c}_{C \text{-} A}^{′} ) ( 2 {c}_{C \text{-} B}^{′} )} ) & ( 15.107 )\end{matrix}$$

Consider the exemplary structure C_{b}Cₐ(Oₐ)O_{b} wherein Cₐ is bound to C_{b}, Oₐ and O_{b}. In the general case that the three bonds are coplanar and two of the angles are known, say θ₁ and θ₂, then the third θ₃ can be determined geometrically:

θ₃=360−θ₁−θ₂ (15.108)

In the general case that two of the three coplanar bonds are equivalent and one of the angles is known, say θ₁, then the second and third can be determined geometrically:

$${θ}_{2} = {θ}_{3} = \frac{( 360 - {θ}_{1} )}{2} \qquad ( 15.109 )$$

Angles and Distances for an Mo that Forms an Isosceles Triangle
In the general case where the group comprises three A-B bonds having B as the central atom at the apex of a pyramidal structure formed by the three bonds with the A atoms at the base in the xy-plane. The C₃ᵥ axis centered on B is defined as the vertical or z-axis, and any two A-B bonds form an isosceles triangle. Then, the angle of the bonds and the distances from and along the z-axis are determined from the geometrical relationships given by Eqs. (13.412-13.416):

the distance d_{origin-B} from the origin to the nucleus of a terminal B atom is given by

$${d}_{origin—B} = \frac{2 {c}_{B \text{-} B}^{′}}{2 sin 60 °} \qquad ( 15.110 )$$

the height along the z-axis from the origin to the A nucleus d_{height} is given by

d_{height}=\sqrt{(2c′_{A-B})²−(d_{origin-B})₂}, and (15.111)

the angle θᵥ of each A-B bond from the z-axis is given by

$${θ}_{v} = {tan}^{- 1} ( \frac{{d}_{origin - B}}{{d}_{height}} ) \qquad ( 15.112 )$$

Consider the case where the central atom B is further bound to a fourth atom C and the B—C bond is along the z-axis. Then, the bond θ_{∠ABC} given by Eq. (14.206) is

θ_{∠ABC}=180−θᵥ (15.113)

### Dihedral Angle

Consider the plane defined by a general ACA MO comprising a linear combination of two C-A-bond MOs where C is the central atom. The dihedral angle θ_{∠BCI ACA} between the ACA-plane and a line defined by a third bond with C, specifically that corresponding to a C—B-bond MO, is calculated from the bond angle θ_{∠ACA} and the distances between the A, B, and C atoms. The distance d₁ along the bisector of θ_{∠ACA} from C to the internuclear-distance line between A and A, 2c′_{A-A} is given by

$${d}_{1} = 2 {c}_{C \text{-} A}^{′} cos \frac{{θ}_{∠ ACA}}{2} \qquad ( 15.114 )$$

where 2c′_{C-A} is the internuclear distance between A and C. The atoms A, A, and B define the base of a pyramid. Then, the pyramidal angle θ_{∠ABA} can be solved from the internuclear distances between A and A, 2c′_{A-A} and between A and B, 2c′_{A-B} using the law of cosines (Eq. (15.107)):

$${θ}_{∠ ABA} = {cos}^{- 1} ( \frac{{( 2 {c}_{A \text{-} B}^{′} )}^{2} + {( 2 {c}_{A \text{-} B}^{′} )}^{2} - {( 2 {c}_{A \text{-} A}^{′} )}^{2}}{2 ( 2 {c}_{A \text{-} B}^{′} ) ( 2 {c}_{A \text{-} B}^{′} )} ) \qquad ( 15.115 )$$

Then, the distance d₂ along the bisector of θ_{∠ABA} from B to the internuclear-distance line 2c′_{A-A} is given by

$${d}_{2} = 2 {c}_{A \text{-} B}^{′} cos \frac{{θ}_{∠ ACA}}{2} \qquad ( 15.116 )$$

The lengths d₁, d₂, and 2c′_{C—B} define a triangle wherein the angle between d₁ and the internuclear distance between B and C, 2c′_{C—B} is the dihedral angle θ_{∠BCI ACA} that can be solved using the law of cosines (Eq. (15.107)):

$${θ}_{∠ BC / ACA} = {cos}^{- 1} ( \frac{{d}_{1}^{2} + {( 2 {c}_{C \text{-} B}^{′} )}^{2} - {d}_{2}^{2}}{2 {d}_{1} ( 2 {c}_{C \text{-} B}^{′} )} ) \qquad ( 15.117 )$$

### General Dihedral Angle

Consider the plane defined by a general ACB MO comprising a linear combination of C-A and C—B-bond MOs where C is the central atom. The dihedral angle θ_{∠CDI ACB} between the ACB-plane and a line defined by a third bond of C with D, specifically that corresponding to a C-D-bond MO, is calculated from the bond angle θ_{∠ACB} and the distances between the A, B, C, and D atoms. The distance d₁ from C to the bisector of the internuclear-distance line between A and B, 2c′_{A-B} is given by two equations involving the law of cosines (Eq. (15.105)). One with s₁=2c′_{C-A}, the internuclear distance of the C-A bond, s₂=d₁,

$${s}_{3} = \frac{2 {c}_{A \text{-} B}^{′}}{2} ,$$

half the internuclear distance between A and B, and θ=θ_{∠ACd}_{₁}, the angle between d₁ and the C-A bond is given by

$${( 2 {c}_{C \text{-} A}^{′} )}^{2} + {( {d}_{1} )}^{2} - 2 ( 2 {c}_{C \text{-} A}^{′} ) ( {d}_{1} ) cosine {θ}_{{∠ ACd}_{1}} = {( \frac{2 {c}_{A—B}^{′}}{2} )}^{2} \qquad ( 15.118 )$$

The other with s₁=2c′_{C—B}, the internuclear distance of the C—B bond, s₂=d₁,

$${s}_{3} = \frac{2 {c}_{A - B}^{′}}{2} ,$$

and θ=θ_{∠ACB}−θ_{∠ACd}_{₁} where θ_{∠ACB} is the bond angle between the C-A and C—B bonds is given by

$${( 2 {c}_{C - B}^{′ } )}^{2} + {( {d}_{1} )}^{2} - 2 ( 2 {c}_{C - B}^{′} ) ( {d}_{1} ) cosine ( {θ}_{∠ ACB} - {θ}_{{∠ AC d}_{1}} ) = {( \frac{2 {c}_{A - B}^{′}}{2} )}^{2} \qquad ( 15.119 )$$

Subtraction of Eq. (15.119) from Eq. (15.118) gives

$${d}_{1} = \frac{{( 2 {c}_{C - A}^{′} )}^{2} - {( 2 {c}_{C - B}^{′} )}^{2}}{2 ( \begin{matrix}( 2 {c}_{C - A}^{′} ) cosine {θ}_{{∠ AC d}_{1}} - \\ ( 2 {c}_{C - B}^{′} ) cosine ( {θ}_{∠ ACB} - {θ}_{{∠ AC d}_{1}} )\end{matrix} )} \qquad ( 15.120 )$$

Substitution of Eq. (15.120) into Eq. (15.118) gives

$$( 15.121 )$$

$$( \begin{matrix} {( 2 {c}_{C - A}^{′} )}^{2} + {( \frac{{( 2 {c}_{C - A}^{′} )}^{2} - {( 2 {c}_{C - B}^{′} )}^{2}}{2 ( \begin{matrix}( 2 {c}_{C - A}^{′} ) cosine {θ}_{{∠ AC d}_{1}} - \\ ( 2 {c}_{C - B}^{′} ) cosine ( {θ}_{∠ ACB} - {θ}_{{∠ AC d}_{1}} )\end{matrix} )} )}^{2} \\ - 2 ( 2 {c}_{C - A}^{′} ) ( \frac{{( 2 {c}_{C - A}^{′} )}^{2} - {( 2 {c}_{C - B}^{′} )}^{2}}{2 ( \begin{matrix}( 2 {c}_{C - A}^{′} ) cosine {θ}_{{∠ AC d}_{1}} - \\ ( 2 {c}_{C - B}^{′} ) cosine ( {θ}_{∠ ACB} - {θ}_{{∠ AC d}_{1}} )\end{matrix} )} ) cosine {θ}_{{∠ AC d}_{1}} \\ - {( \frac{2 {c}_{A - B}^{′}}{2} )}^{2}\end{matrix} ) = 0 \qquad$$

The angle between d₁ and the C-A bond, θ_{∠ACd}_{₁}, can be solved reiteratively using Eq. (15.121), and the result can be substituted into Eq. (15.120) to give d₁.

The atoms A, B, and D define the base of a pyramid. Then, the pyramidal angle θ_{∠ADB} can be solved from the internuclear distances between A and D, 2c′_{A-D}, between B and D, 2c′_{B-D}, and between A and B, 2c′_{A-B}, using the law of cosines (Eq. (15.107)):

$${θ}_{∠ ADB} = {cos}^{- 1} ( \frac{{( 2 {c}_{A - D}^{′} )}^{2} + {( 2 {c}_{B - D}^{′} )}^{2} - {( 2 {c}_{A - B}^{′} )}^{2}}{2 ( 2 {c}_{A - D}^{′} ) ( 2 {c}_{B - D}^{′} )} ) \qquad ( 15.122 )$$

Then, the distance d₂ from D to the bisector of the internuclear-distance line between A and B,2c′_{A-B}, is given by two equations involving the law of cosines (Eq. (15.105)). One with s₁=2c_{A-D}, the internuclear distance between A and D, s₂=d₂,

$${s}_{3} = \frac{2 {c}_{A - B}^{′}}{2} ,$$

half the internuclear distance between A and B, and θ=θ_{∠ADd}_{₂}, the angle between d₂ and the A-D axis is given by

$${( 2 {c}_{A - D}^{′} )}^{2} + {( {d}_{2} )}^{2} - 2 ( 2 {c}_{A - D}^{′} ) ( {d}_{2} ) cosine {θ}_{∠ {ADd}_{2}} = {( \frac{2 {c}_{A - B}^{′}}{2} )}^{2} \qquad ( 15.123 )$$

The other with s₁=2c′_{B-D}, the internuclear distance between B and D, s₂=d₂, and θ=θ_{∠ADB}−θ_{∠ADd}_{₂} where θ_{∠ADB} is the bond angle between the A-D and B-D axes is given by

$${( 2 {c}_{B - D}^{′} )}^{2} + {( {d}_{2} )}^{2} - 2 ( 2 {c}_{B - D}^{′} ) ( {d}_{2} ) cosine ( {θ}_{∠ ADB} - {θ}_{∠ {ADd}_{2}} ) = {( \frac{2 {c}_{A - B}^{′}}{2} )}^{2} \qquad ( 15.124 )$$

Subtraction of Eq. (15.124) from Eq. (15.123) gives

$${d}_{2} = \frac{{( 2 {c}_{A - D}^{′} )}^{2} - {( 2 {c}_{B - D}^{′} )}^{2}}{2 ( \begin{matrix}( 2 {c}_{A - D}^{′} ) cosine {θ}_{{∠ AD d}_{2}} - \\ ( 2 {c}_{B - D}^{′} ) cosine ( {θ}_{∠ ADB} - {θ}_{{∠ AD d}_{2}} )\end{matrix} )} \qquad ( 15.125 )$$

Substitution of Eq. (15.125) into Eq. (15.123) gives

$$( 15.126 )$$

$$( \begin{matrix} {( 2 {c}_{A - D}^{′} )}^{2} + {( \frac{{( 2 {c}_{A - D}^{′} )}^{2} - {( 2 {c}_{B - D}^{′} )}^{2}}{2 ( \begin{matrix}( 2 {c}_{A - D}^{′} ) cosine {θ}_{{∠ AD d}_{2}} - \\ ( 2 {c}_{B - D}^{′} ) cosine ( {θ}_{∠ ADB} - {θ}_{{∠ AD d}_{2}} )\end{matrix} )} )}^{2} \\ - 2 ( 2 {c}_{A - D}^{′} ) ( \frac{{( 2 {c}_{A - D}^{′} )}^{2} - {( 2 {c}_{B - D}^{′} )}^{2}}{2 ( \begin{matrix}( 2 {c}_{A - D}^{′} ) cosine {θ}_{{∠ AD d}_{2}} - \\ ( 2 {c}_{B - D}^{′} ) cosine ( {θ}_{∠ ADB} - {θ}_{{∠ AD d}_{2}} )\end{matrix} )} ) cosine {θ}_{{∠ AD d}_{2}} \\ - {( \frac{2 {c}_{A - B}^{′}}{2} )}^{2}\end{matrix} ) = 0 \qquad$$

The angle between d₂ and the A-D axis, θ_{∠ADd}_{₂}, can be solved reiteratively using Eq. (15.126), and the result can be substituted into Eq. (15.125) to give d₂.

The lengths d₁, d₂, and 2c′_{C—B} define a triangle wherein the angle between d₁ and the internuclear distance between C and D, 2c′_{C-D} is the dihedral angle θ_{∠CDI ACB} that can be solved using the law of cosines (Eq. (15.107)):

$${θ}_{∠ CD / ACB} = {cos}^{- 1} ( \frac{{d}_{1}^{2} + {( 2 {c}_{C - D}^{′} )}^{2} - {d}_{2}^{2}}{2 {d}_{1} ( 2 {c}_{C - D}^{′} )} ) \qquad ( 15.127 )$$

### Solution of Geometrical and Energy Parameters of Major Functional Groups and Corresponding Organic Molecules

The exemplary molecules given in the following sections were solved using the solutions of organic chemical functional groups as basis elements wherein the structures and energies where linearly added to achieve the molecular solutions. Each functional group can be treated as a building block to form any desired molecular solution from the corresponding linear combination. Each functional group element was solved using the atomic orbital and hybrid orbital spherical orbitsphere solutions bridged by molecular orbitals comprised of the H₂-type prolate spheroidal solution given in the Nature of the Chemical Bond of Hydrogen-Type Molecules section. The energy of each MO was matched at the HO or AO by matching the hybridization and total energy of the MO to the AOs and HOs. The energy E_{mag} (e.g. given by Eq. (15.67)) for a C2sp³ HO and Eq. (15.68) for an O2p AO) was subtracted for each set of unpaired electrons created by bond breakage.

The bond energy is not equal to the component energy of each bond as it exists in the molecule; although, they are close. The total energy of each group is its contribution to the total energy of the molecule as a whole. The determination of the bond energies for the creation of the separate parts must take into account the energy of the formation of any radicals and any redistribution of charge density within the pieces and the corresponding energy change with bond cleavage. Also, the vibrational energy in the transition state is dependent on the other groups that are bound to a given functional group. This will effect the functional-group energy. But, because the variations in the energy based on the balance of the molecular composition are typically of the order of a few hundreds of electron volts at most, they were neglected.

The energy of each functional-group MO bonding to a given carbon HO is independently matched to the HO by subtracting the contribution to the change in the energy of the HO from the total MO energy given by the sum of the MO contributions and E(C,2sp³)=−14.63489 eV (Eq. (13.428)). The intercept angles are determined from Eqs. (15.80-15.87) using the final radius of the HO of each atom. The final carbon-atom radius is determined using Eqs. (15.32) wherein the sum of the energy contributions of each atom to all the MOs in which it participates in bonding is determined. This final radius is used in Eqs. (15.19) and (15.20) to calculate the final valence energy of the HO of each atom at the corresponding final radius. The radius of any bonding heteroatom that contributes to σ MO is calculated in the same manner, and the energy of its outermost shell is matched to that of the MO by the hybridization factor between the carbon-HO energy and the energy of the heteroatomic shell. The donation of electron density to the AOs and HOs reduces the energy. The donation of the electron density to the MO's at each AO or HO is that which causes the resulting energy to be divided equally between the participating AOs or HOs to achieve energy matching.

The molecular solutions can be used to design synthetic pathways and predict product yields based on equilibrium constants calculated from the heats of formation. New stable compositions of matter can be predicted as well as the structures of combinatorial chemistry reactions. Further important pharmaceutical applications include the ability to graphically or computationally render the structures of drugs that permit the identification of the biologically active parts of the molecules to be identified from the common spatial charge-density functions of a series of active molecules. Drugs can be designed according to geometrical parameters and bonding interactions with the data of the structure of the active site of the drug.

To calculate conformations, folding, and physical properties, the exact solutions of the charge distributions in any given molecule are used to calculate the fields, and from the fields, the interactions between groups of the same molecule or between groups on different molecules are calculated wherein the interactions are distance and relative orientation dependent. The fields and interactions can be determined using a finite-element-analysis approach of Maxwell's equations.

### Pharmaceutical Molecular Functional Groups and Molecules

### General Considerations of the Bonding in Pharmaceuticals

Pharmaceutical molecules comprising an arbitrary number of atoms can be solved using similar principles and procedures as those used to solve general organic molecules of arbitrary length and complexity. Pharmaceuticals can be considered to be comprised of functional groups such those of alkanes, branched alkanes, alkenes, branched alkenes, alkynes, alkyl fluorides, alkyl chlorides, alkyl bromides, alkyl iodides, alkene halides, primary alcohols, secondary alcohols, tertiary alcohols, ethers, primary amines, secondary amines, tertiary amines, aldehydes, ketones, carboxylic acids, carboxylic esters, amides, N-alkyl amides, N,N-dialkyl amides, ureas, acid halides, acid anhydrides, nitriles, thiols, sulfides, disulfides, sulfoxides, sulfones, sulfites, sulfates, nitro alkanes, nitrites, nitrates, conjugated polyenes, aromatics, heterocyclic aromatics, substituted aromatics, and others given in the Organic Molecular Functional Groups and Molecules section. The solutions of the functional groups can be conveniently obtained by using generalized forms of the geometrical and energy equations. The functional-group solutions can be made into a linear superposition and sum, respectively, to give the solution of any pharmaceutical molecule comprising these groups. The total bond energies of exemplary pharmaceutical molecules such as aspirin are calculated using the functional group composition and the corresponding energies derived in the previous sections.

### Aspirin (Acetylsalicylic Acid)

Aspirin comprises salicylic acid (ortho-hydroxybenzoic acid) with the H of the phenolic OH group replaced by an acetyl group. Thus, aspirin comprises the benzoic acid C—C(O)—OH moiety that comprises C═O and OH functional groups that are the same as those of carboxylic acids given in the corresponding section. The single bond of aryl carbon to the carbonyl carbon atom, C—C(O), is also a functional group given in the Benzoic Acid Compounds section. The aromatic

$$C {=}^{3 e} C$$

and C—H functional groups are equivalent to those of benzene given in Aromatic and Heterocyclic Compounds section. The phenolic ester C—O functional group is equivalent to that given in the Phenol section. The acetyl O—C(O)—CH₃ moiety comprises (i) C═O and C—C functional groups that are the same as those of carboxylic acids and esters given in the corresponding sections, (ii) a CH₃ group that is equivalent to that of alkanes given in the corresponding sections, (iii) and a C—O bridging the carbonyl carbon and the phenolic ester which is equivalent to that of esters given in the corresponding section.

The symbols of the functional groups of aspirin are given in Table 16.1.

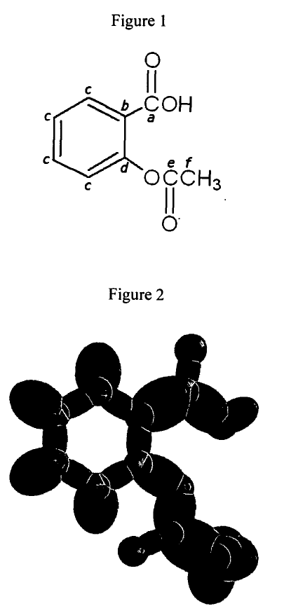

The corresponding designations of aspirin are shown in FIG. 1. The geometrical (Eqs. (15.1-15.5) and (15.51)), intercept (Eqs. (15.80-15.87)), and energy (Eqs. (15.6-15.11) and (15.17-15.65)) parameters of aspirin are given in Tables 16.2, 16.3, and 16.4, respectively (all as shown in the priority document). The total energy of aspirin given in Table 16.5 (as shown in the priority document) was calculated as the sum over the integer multiple of each E_{D} (Group) of Table 16.4 (as shown in the priority document) corresponding to functional-group composition of the molecule. The bond angle parameters of aspirin determined using Eqs. (15.88-15.117) are given in Table 16.6 (as shown in the priority document). The color scale, translucent view of the charge-density of aspirin comprising the concentric shells of atoms with the outer shell bridged by one or more H₂-type ellipsoidal MOs or joined with one or more hydrogen MOs is shown in FIG. 2.

TABLE 16.1
The symbols of functional groups of aspirin.

| Functional Group | Group Symbol |
|---|---|
| CC (aromatic bond) | $C {\overline{—}}_{ }^{3 e} C$ |
| CH (aromatic) | CH |
| Aryl C—C(O) | C—C(O) (i) |
| Alkyl C—C(O) | C—C(O) (ii) |
| C═O (aryl carboxylic acid) | C═O |
| Aryl (O)C—O | C—O (i) |
| Alkyl (O)C—O | C—O (ii) |
| Aryl C—O | C—O (iii) |
| OH group | OH |
| CH₃ group | CH₃ |

### REFERENCES

1. D. R. Lide, CRC Handbook of Chemistry and Physics, 86th Edition, CRC Press, Taylor & Francis, Boca Raton, (2005-6), pp. 9-19 to 9-45.
2. G. A. Sim, J. M. Robertson, T. H. Goodwin, “The crystal and molecular structure of benzoic acid”, Acta Cryst., Vol. 8, (1955), pp. 157-164.
3. G. Herzberg, Molecular Spectra and Molecular Structure II. Infrared and Raman Spectra of Polyatomic Molecules, Van Nostrand Reinhold Company, New York, N.Y., (1945), pp. 362-369.
4. acetic acid at http://webbook.nist.gov/.
5. G. Herzberg, Molecular Spectra and Molecular Structure II Infrared and Raman Spectra of Polyatomic Molecules, Krieger Publishing Company, Malabar, Fla., (1991), p. 195.
6. D. Lin-Vien. N. B. Colthup, W. G. Fateley, J. G. Grasselli, The Handbook of Infrared and Raman Frequencies of Organic Molecules, Academic Press, Inc., Harcourt Brace Jovanovich, Boston, (1991), p. 138.
7. methyl formate at http://webbook.nist.gov/.
8. methanol at http://webbook.nist.gov/.
9. K. P. Huber, G. Herzberg, Molecular Spectra and Molecular Structure, IV Constants of Diatomic Molecules, Van Nostrand Reinhold Company, New York, (1979).
10. J. Crovisier, Molecular Database—Constants for molecules of astrophysical interest in the gas phase: photodissociation, microwave and infrared spectra, Ver. 4.2, Observatoire de Paris, Section de Meudon, Meudon, France, May 2002, pp. 34-37, available at http://wwwusr.obspm.fr/˜crovisie/.
11. W. I. F. David, R. M. Ibberson, G. A. Jeffrey, J. R. Ruble, “The structure analysis of deuterated benzene and deuterated nitromethane by pulsed-neutron powder diffraction: a comparison with single crystal neutron analysis”, Physica B (1992), 180 & 181, pp. 597-600.
12. G. A. Jeffrey, J. R. Ruble, R. K. McMullan, J. A. Pople, “The crystal structure of deuterated benzene,” Proceedings of the Royal Society of London. Series A, Mathematical and Physical Sciences, Vol. 414, No. 1846, (Nov. 9, 1987), pp. 47-57.
13. H. B. Burgi, S. C. Capelli, “Getting more out of crystal-structure analyses,” Helvetica Chimica Acta, Vol. 86, (2003), pp. 1625-1640.

### Nature of the Solid Molecular Bond of the Three Allotropes of Carbon

### General Considerations of the Solid Molecular Bond

The solid molecular bond of a material comprising an arbitrary number of atoms can be solved using similar principles and procedures as those used to solve organic molecules of arbitrary length. Molecular solids are also comprised of functional groups. Depending on the material, exemplary groups are C—C, C═C, C—O, C—N, C—S, and others given in the Organic Molecular Functional Groups and Molecules section. The solutions of these functional groups or any others corresponding to the particular solid can be conveniently obtained by using generalized forms of the geometrical and energy equations given in the Derivation of the General Geometrical and Energy Equations of Organic Chemistry section. The appropriate functional groups with the their geometrical parameters and energies can be added as a linear sum to give the solution of any molecular solid.

### Diamond

It is demonstrated in this Diamond section as well as the Fullerene (C₆₀) and Graphite sections, that very complex macromolecules can be simply solved from the groups at each vertex carbon atom of the structure. Specifically, for fullerene a C═C group is bound to two C—C bonds at each vertex carbon atom of C₆₀. The solution of the macromolecule is given by superposition of the geometrical and energy parameters of the corresponding two groups. In graphite, each sheet of joined hexagons can be constructed with a C═C group bound to two C—C bonds at each vertex carbon atom that hybridize to an aromatic-like functional group,

$$C {=}^{8 / 3 e} C ,$$

with 8/3 electron-number per bond compared to the pure aromatic functional group,

$$C {=}^{3 e} C ,$$

with 3 electron-number per bond as given the Aromatics section. Similarly, diamond comprising, in principle, an infinite network of carbons can be solved using the functional group solutions where the task is also simple since diamond has only one functional group, the diamond C—C functional group.

The diamond C—C bonds are all equivalent, and each C—C bond can be considered bound to a t-butyl group at the corresponding vertex carbon. Thus, the parameters of the diamond C—C functional group are equivalent to those of the t-butyl C—C group of branched alkanes given in the Branched Alkanes section. Based on symmetry, the parameter R in Eqs. (15.56) and (15.61) is the semimajor axis a, and the vibrational energy in the Ē_{acs} term is that of diamond. Also, the C2sp³ HO magnetic energy E_{mag} given by Eq. (15.67) was subtracted for each t-butyl group of alkyl fluorides, alkyl chlorides, alkyl iodides, thiols, sulfides, disulfides, and nitroalkanes as given in the corresponding sections of Chapter 15 due to a set of unpaired electrons being created by bond breakage. Since each C—C group of diamond bonds with a t-butyl group at each vertex carbon, c₃ of Eq. (15.65) is one, and E_{mag} is given by Eq. (15.67).

The symbol of the functional group of diamond is given in Table 17.1. The geometrical (Eqs. (15.1-15.5) and (15.51)) parameters of diamond are given in Table 17.2. The lattice parameter aₗ was calculated from the bond distance using the law of cosines:

s₁²+s₂²−2s₁s₂cosine θ=s₃² (17.1)

With the bond angle θ_{∠CCC}=109.5° [1] and s₁=s₂=2c′_{C—C}, the internuclear distance of the C—C bond, s₃=2c′_{C}_{₁}_{-C}_{₁}, the internuclear distance of the two terminal C atoms is given by

2c′_{C}_{₁}_{-C}_{₁}={square root over (2(2c′_{C}_{₁}_{-C}_{₁})²(1−cosine(109.5°)} (17.2)

Two times the distance 2c′_{C}_{₁}_{-C}_{₁} is the hypotenuse of the isosceles triangle having equivalent sides of length equal to the lattice parameter a₁. Using Eq. (17.2) and 2c′_{C}_{₁}_{-C}_{₁}=1.53635 Å from Table 17.2, the lattice parameter a₁ for the cubic diamond structure is given by

$$\begin{matrix}{a}_{l} = \frac{2 ( 2 {c}_{{C}_{t} - {C}_{t}} )}{\sqrt{2}} = \sqrt{2} \sqrt{2 {( 2 {c}_{C - C}^{′} )}^{2} ( 1 - cosine ( 109.5 ° ) )} \\ = 3.54867 Å\end{matrix} \qquad ( 17.3 )$$

The intercept (Eqs. (15.80-15.87)) and energy (Eqs. (15.6-15.11) and (15.17-15.65)) parameters of diamond are given in Tables 17.2, 17.3 (as shown in priority document), and 17.4, respectively. The total energy of diamond given in Table 17.5 was calculated as the sum over the integer multiple of each E_{D} (Group) of Table 17.4 corresponding to functional-group composition of the molecular solid. The experimental C—C bond energy of diamond, E_{D}_{ₑₓₚ}(C—C) at 298 K, is given by the difference between the enthalpy of formation of gaseous carbon atoms from graphite (ΔH_{f}(C_{graphite}(gas))) and the heat of formation of diamond (ΔH_{f} (C (diamond))) wherein graphite has a defined heat of formation of zero (ΔH_{f} (C(graphite)=0):

$${E}_{{D}_{exp}} ( C - C ) = \frac{1}{2} [ Δ {H}_{f} ( {C}_{graphite} ( gas ) ) - Δ {H}_{f} ( C ( diamond ) ) ] \qquad ( 17.4 )$$

where the heats of formation of atomic carbon and diamond are [2]:

ΔH_{f}(C_{graphite}(gas))=716.68 kJ/mole(7.42774 eV/atom) (17.5)

ΔH_{f}(C(diamond))=1.9 kJ/mole(0.01969 eV/atom) (17.6)

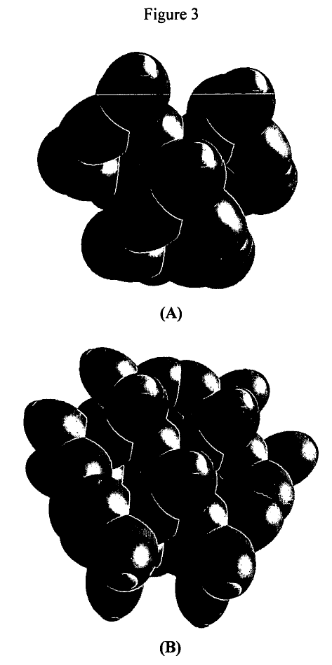

### Using Eqs. (17.4-17.6), E_{D}_{ₑₓₚ}(C—C) is

$$\begin{matrix}{E}_{{D}_{exp}} ( C - C ) = \frac{1}{2} [ 7.42774 eV - 0.01969 eV ] \\ = 3.704 eV\end{matrix} \qquad ( 17.7 )$$

where the factor of one half corresponds to the ratio of two electrons per bond and four electrons per carbon atom. The bond angle parameters of diamond determined using Eqs. (15.88-15.117) are given in Table 17.6 (as shown in priority document). The structure of diamond is shown in FIG. 3.

TABLE 17.1
The symbols of the functional group of diamond.

| Functional Group | Group Symbol |
|---|---|
| CC bond (diamond-C) | C—C |

TABLE 17.2
The geometrical bond parameters of
diamond and experimental values [1, 3].

| | C—C |
|---|---|
| Parameter | Group |
| a (a₀) | 2.10725 |
| c′ (a₀) | 1.45164 |
| Bond Length 2c′ (Å) | 1.53635 |
| Exp. Bond Length (Å) | 1.54428 |
| b, c (a₀) | 1.52750 |
| e | 0.68888 |
| Lattice Parameter aₗ (Å) | 3.54867 |
| Exp. Lattice Parameter aₗ (Å) | 3.5670 |

TABLE 17.4
The energy parameters (eV) of the functional group of diamond.

| | C—C |
|---|---|
| Parameters | Group |
| n₁ | 1 |
| n₂ | 0 |
| n₃ | 0 |
| C₁ | 0.5 |
| C₂ | 1 |
| c₁ | 1 |
| c₂ | 0.91771 |
| c₃ | 1 |
| c₄ | 2 |
| c₅ | 0 |
| C₁ₒ | 0.5 |
| C₂ₒ | 1 |
| Vₑ (eV) | −29.10112 |
| Vₚ (eV) | 9.37273 |
| T (eV) | 6.90500 |
| Vₘ (eV) | −3.45250 |
| E (AO/HO) (eV) | −15.35946 |
| ΔE_{H}_{₂}_{MO} (AO/HO) (eV) | 0 |
| E_{T} (AO/HO) (eV) | −15.35946 |
| E_{T} (H₂MO) (eV) | −31.63535 |
| E_{T} (atom-atom, msp³ · AO) (eV) | −1.44915 |
| E_{T} (MO) (eV) | −33.08452 |
| ω (10¹⁵ rad/s) | 9.55643 |
| E_{K} (eV) | 6.29021 |
| Ē_{D} (eV) | −0.16416 |
| Ē_{Kvib} (eV) | 0.16515 [4] |
| Ē_{osc} (eV) | −0.08158 |
| E_{mag} (eV) | 0.14803 |
| E_{T} (Group) (eV) | −33.16610 |
| Eᵢₙᵢₜᵢₐₗ (c₄ AO/HO) (eV) | −14.63489 |
| Eᵢₙᵢₜᵢₐₗ (c₅ AO/HO) (eV) | 0 |
| E_{D} (Group) (eV) | 3.74829 |

TABLE 17.5
The total bond energy of diamond calculated using
the functional group composition and the energy of
Table 17.4 compared to the experimental value [1-2].

| | | | Calculated | Experimental | |
|---|---|---|---|---|---|
| | | | Total Bond | Total Bond | Relative |
| Formula | Name | C—C | Energy (eV) | Energy (eV) | Error |
| Cₙ | Diamond | 1 | 3.74829 | 3.704 | −0.01 |

### Fullerene (C₆₀)

C₆₀ comprises 60 equivalent carbon atoms that are bound as 60 single bonds and 30 double bonds in the geometric form of a truncated icosahedron: twelve pentagons and twenty hexagons joined such that no two pentagons share an edge. To achieve this minimum energy structure each equivalent carbon atom serves as a vertex incident with one double and two single bonds. Each type of bond serves as a functional group which has aromatic character. The aromatic bond is uniquely stable and requires the sharing of the electrons of multiple H₂-type MOs. The results of the derivation of the parameters of the benzene molecule given in the Benzene Molecule (C₆H₆) section was generalized to any aromatic functional group of aromatic and heterocyclic compounds in the Aromatic and Heterocyclic Compounds section. Ethylene serves as a basis element for the

$$C {=}^{3 e} C$$

bonding of the aromatic bond wherein each of the

$$C {=}^{3 e} C$$

aromatic bonds comprises (0.75)(4)=3 electrons according to Eq. (15.161) wherein C₂ of Eq. (15.51) for the aromatic C^{3e}═C-bond MO given by Eq. (15.162) is C₂(aromaticC2sp³HO)=c₂ (aromaticC2sp³HO)=0.85252 and E_{T}(atom−atom,msp³.AO)=−2.26759 eV. In C₆₀, the minimum energy structure with equivalent carbon atoms wherein each carbon forms bonds with three other such carbons requires a redistribution of charge within an aromatic system of bonds. The C═C functional group of C₆₀ comprises the aromatic bond with the exception that it comprises four electrons. Thus, E_{T}(Group) and E_{D} (Group) are given by Eqs. (15.165) and (15.166), respectively, with f₁=1, c₄=4, and Ē_{Kvib} (eV) is that of C₆₀.

In addition to the C═C bond, each vertex carbon atom of C₆₀ is bound to two C—C bonds that substitute for the aromatic

$$C {=}^{3 e} C$$

and C—H bonds. As in the case of the C—C-bond MO of naphthalene, to match energies within the MO that bridges single and double-bond MOs, E(A0/HO) and ΔE_{H}_{₂}_{MO}(AO/HO) in Eq. (15.51) are −14.63489 eV and −2.26759 eV, respectively.

To meet the equipotential condition of the union of the C2sp³ HOs of the C—C single bond bridging double bonds, the parameters c₁, C₂, and C₂ₒ of Eq. (15.51) are one for the C—C group, C₁ₒ and C₁ are 0.5, and c₂ given by Eq. (13.430) is c₂ (C2sp³HO=0.91771. To match the energies of the functional groups with the electron-density shift to the double bond, E_{T}(atom−atom,msp³.AO) of each of the equivalent C—C-bond MOs in Eq. (15.61) due to the charge donation from the C atoms to the MO can be considered a linear combination of that of C—C-bond MO of toluene, −1.13379 eV and the that of the aromatic C—H-bond MO,

$$\frac{- 1.13379 eV}{2} .$$

Thus, E_{T}(atom−atom,msp³.AO) of each C—C-bond MO of C₆₀ is

$$\begin{matrix}\frac{- 1.13379 eV + 0.5 ( - 1.13379 eV )}{2} = 0.75 ( - 1.13379 eV ) \\ = - 0.85034 eV .\end{matrix}$$

As in the case of the aromatic C—H bond, c₃=1 in Eq. (15.65) with E_{mag}, given by Eq. (15.67), and Ē_{Kvib}(eV) is that of C₆₀.

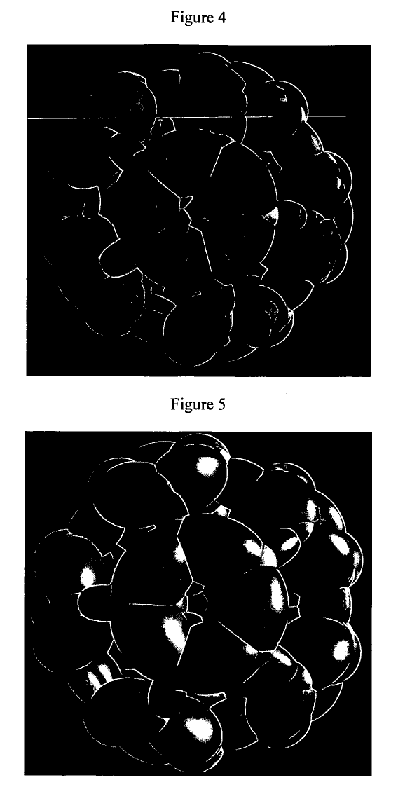

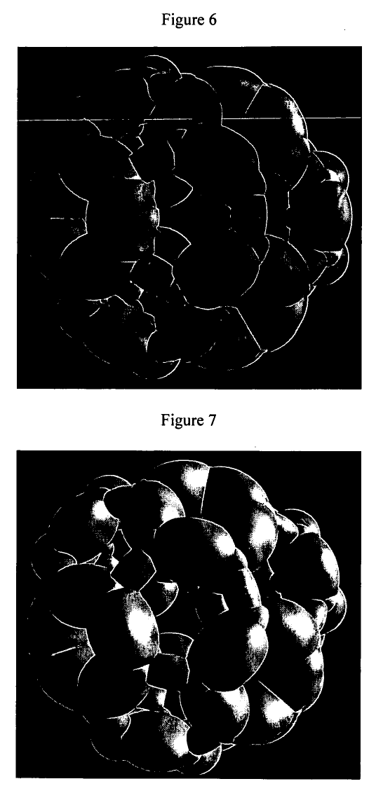

The symbols of the functional groups of C₆₀ are given in Table 17.7. The geometrical (Eqs. (15.1-15.5) and (15.51)), intercept (Eqs. (15.80-15.87)), and energy (Eqs. (15.6-15.11), (15.17-15.65), and (15.165-15.166)) parameters of C₆₀ are given in Tables 17.8, 17.9 (as shown in priority document), and 17.10, respectively. The total energy of C₆₀ given in Table 17.11 was calculated as the sum over the integer multiple of each E_{D} (Group) of Table 17.10 corresponding to functional-group composition of the molecule. The bond angle parameters of C₆₀ determined using Eqs. (15.87-15.117) are given in Table 17.12 (as shown in the priority document). The structure of C₆₀ is shown in FIGS. 4 and 7. The fullerene vertex-atom group comprising a double and two single bonds can serve as a basis element to form other higher-order fullerene-type macromolecules, hyperfullerenes, and complex hybrid conjugated carbon and aromatic structures comprising a mixture of elements from the group of fullerene, graphitic, and diamond carbon described in the corresponding sections.

TABLE 17.7
The symbols of functional groups of C₆₀.

| Functional Group | Group Symbol |
|---|---|
| C═C (aromatic-type) | C═C |
| C—C (bound to C═C aromatic-type) | C—C |

TABLE 17.8
The geometrical bond parameters of C₆₀ and
experimental values [5].

| | C═C | C—C |
|---|---|---|
| Parameter | Group | Group |
| a (a₀) | 1.47348 | 1.88599 |
| c′ (a₀) | 1.31468 | 1.37331 |
| Bond Length 2c′ (Å) | 1.39140 | 1.45345 |
| Exp. Bond Length | 1.391 | 1.455 |
| (Å) | (C₆₀) | (C₆₀) |
| b, c (a₀) | 0.66540 | 1.29266 |
| e | 0.89223 | 0.72817 |

TABLE 17.10
The energy parameters (eV) of functional groups of C₆₀.

| | C═C | C—C |
|---|---|---|
| Parameters | Group | Group |
| f₁ | 1 | 1 |
| n₁ | 2 | 1 |
| n₂ | 0 | 0 |
| n₃ | 0 | 0 |
| C₁ | 0.5 | 0.5 |
| C₂ | 0.85252 | 1 |
| c₁ | 1 | 1 |
| c₂ | 0.85252 | 0.91771 |
| c₃ | 0 | 1 |
| c₄ | 4 | 2 |
| c₅ | 0 | 0 |
| C₁ₒ | 0.5 | 0.5 |
| C₂ₒ | 0.85252 | 1 |
| Vₑ (eV) | −101.12679 | −33.63376 |
| Vₚ (eV) | 20.69825 | 9.90728 |
| T (eV) | 34.31559 | 8.91674 |
| Vₘ (eV) | −17.15779 | −4.45837 |
| E (AO/HO) (eV) | 0 | −14.63489 |
| ΔE_{H}_{₂}_{MO} (AO/HO) (eV) | 0 | −2.26759 |
| E_{T} (AO/HO) (eV) | 0 | −12.36730 |
| E_{T} (H₂MO) (eV) | −63.27075 | −31.63541 |
| E_{T} (atom-atom, msp³ · AO) (eV) | −2.26759 | −0.85034 |
| E_{T} (MO) (eV) | −65.53833 | −32.48571 |
| ω (10¹⁵ rad/s) | 49.7272 | 19.8904 |
| E_{K} (eV) | 32.73133 | 13.09221 |
| Ē_{D} (eV) | −0.35806 | −0.23254 |
| Ē_{Kvib} (eV) | 0.17727 [6] | 0.14667 [6] |
| Ē_{osc} (eV) | −0.26942 | −0.15921 |
| E_{mag} (eV) | 0.14803 | 0.14803 |
| E_{T} (Group) (eV) | −66.07718 | −32.49689 |
| Eᵢₙᵢₜᵢₐₗ (c₄ AO/HO) (eV) | −14.63489 | −14.63489 |
| Eᵢₙᵢₜᵢₐₗ (c₅ AO/HO) (eV) | 0 | 0 |
| E_{D} (Group) (eV) | 7.53763 | 3.22711 |

TABLE 17.11
The total bond energies of C₆₀ calculated using
the functional group composition and the energies of
Table 17.10 compared to the experimental values [7].

| | | | | Calculated | | |
|---|---|---|---|---|---|---|
| | | | | Total | Experimental | |
| | | | | Bond | Total Bond | |
| | | | | Energy | Energy | Relative |
| Formula | Name | C═C | C—C | (eV) | (eV) | Error |
| C₆₀ | Fullerene | 30 | 60 | 419.75539 | 419.73367 | −0.00005 |

### Fullerene Dihedral Angles

For C₆₀ the bonding at each vertex atom C_{b} comprises two single bonds, Cₐ—C_{b}—Cₐ, and a double bond, C_{b}═C_{c}. The dihedral angle θ_{∠C═C/C—C—C} between the plane defined by the Cₐ—C_{b}—Cₐ moiety and the line defined by the corresponding C_{b}═C_{c} moiety is calculated using the results given in Table 17.12 (as shown in the priority document) and Eqs. (15.114-15.117). The distance d₁ along the bisector of θ_{∠C}_{ₐ}_{—C}_{_{b}}_{—C}_{ₐ} from C_{b} to the internuclear-distance line between one Cₐ and the other Cₐ, 2c′_{C}_{ₐ}_{—C}_{ₐ}, is given by

$$\begin{matrix}{d}_{1} = 2 {c}_{{C}_{b} - {C}_{a}}^{′} cos \frac{{θ}_{{∠C}_{a} - {C}_{b} - Ca}}{2} \\ = 2.74663 {a}_{0} cos \frac{{180.00}^{°}}{2} \\ = 1.61443 {a}_{0}\end{matrix} \qquad ( 17.8 )$$

where 2c′_{C}_{_{b}}_{—C}_{ₐ} is the internuclear distance between C_{b} and Cₐ. The atoms Cₐ, Cₐ, and C_{c} define the base of a pyramid. Then, the pyramidal angle θ_{∠C}_{ₐ}_{C}_{_{c}}_{C}_{ₐ} can be solved from the internuclear distances between C_{c} and Cₐ, 2c′_{C}_{ₐ}_{—C}_{ₐ}, and between Cₐ and Cₐ, 2c′_{C}_{ₐ}_{—C}_{ₐ}, using the law of cosines (Eq. (15.115)):

$$\begin{matrix}{θ}_{{∠C}_{a} {C}_{b} {C}_{a}} = {cos}^{- 1} ( \frac{{( 2 {c}_{{C}_{c} - {C}_{a}}^{′} )}^{2} + {( 2 {c}_{{C}_{c} - {C}_{a}}^{′} )}^{2} - {( 2 {c}_{{C}_{a} - {C}_{a}}^{′} )}^{2}}{2 ( 2 {c}_{{C}_{c} - {C}_{a}}^{′} ) ( 2 {c}_{{C}_{c} - {C}_{a}}^{′} )} ) \\ = {cos}^{- 1} ( \frac{\begin{matrix}{( 4.65618 {a}_{0} )}^{2} + {( 4.65618 {a}_{0} )}^{2} - \\ {( 4.4441 {a}_{0} )}^{2}\end{matrix}}{2 ( 4.65618 {a}_{0} ) ( 4.65618 {a}_{0} )} ) \\ = {57.01}^{°}\end{matrix} \qquad ( 17.9 )$$

Then, the distance d₂ along the bisector of θ_{∠C}_{ₐ}_{C}_{_{c}}_{C}_{ₐ} from C_{c} to the internuclear-distance line 2c′_{C}_{ₐ}_{—C}_{ₐ}, is given by

$$\begin{matrix}{d}_{2} = 2 {c}_{{C}_{c} - {C}_{a}}^{′} cos \frac{{θ}_{{∠C}_{a} {C}_{c} {C}_{a}}}{2} \\ = 4.65618 {a}_{0} cos \frac{{57.01}^{°}}{2} \\ = 4.09176 {a}_{0}\end{matrix} \qquad ( 17.10 )$$

The lengths d₁, d₂, and 2c′_{C}_{_{b}}_{=C}_{_{c}} define a triangle wherein the angle between d₁ and the internuclear distance between C_{b} and C_{c}, 2c′_{C}_{_{b}}_{=C}_{_{c}}, is the dihedral angle θ_{∠C═C/C—C—C} that can be solved using the law of cosines (Eq. (15.117)):

$$\begin{matrix}{θ}_{∠C = C / C - C - C} = {cos}^{- 1} ( \frac{{d}_{1}^{2} + {( 2 {c}_{{C}_{b} = {C}_{c}}^{′} )}^{2} - {d}_{2}^{2}}{2 {d}_{1} ( 2 {c}_{{C}_{b} = {C}_{c}}^{′} )} ) \\ = {cos}^{- 1} ( \frac{\begin{matrix}{( 1.61443 {a}_{0} )}^{2} + {( 2.62936 {a}_{0} )}^{2} - \\ {( 4.09176 {a}_{0} )}^{2}\end{matrix}}{2 ( 1.61443 {a}_{0} ) ( 2.62936 {a}_{0} )} ) \\ = {148.29}^{°}\end{matrix} \qquad ( 17.11 )$$

The dihedral angle for a truncated icosahedron corresponding to θ_{∠C═C/C—C—C} is

θ_{∠C═C/C—C—C} (17.12)

The dihedral angle θ_{∠C—C/C—C═C} between the plane defined by the Cₐ—C_{b}═C_{c} moiety and the line defined by the corresponding C_{b}—Cₐ moiety is calculated using the results given in Table 17.12 (as shown in the priority document) and Eqs. (15.118-15.127). The parameter d₁ is the distance from C_{b} to the internuclear-distance line between Cₐ and C_{c}, 2c′_{C}_{ₐ}_{—C}_{_{c}}. The angle between d₁ and the C_{b}—Cₐ bond, θ_{∠C}_{ₐ}_{C}_{_{b}}_{d}_{₁}, can be solved reiteratively using Eq. (15.121):

$$\begin{matrix} ( 17.13 ) \\ ( \begin{matrix}{( 2 {c}_{{C}_{b} - {C}_{a}}^{′} )}^{2} + {( \frac{{( 2 {c}_{{C}_{b} - {C}_{a}}^{′} )}^{2} - {( 2 {c}_{{C}_{b} - {C}_{c}}^{′} )}^{2}}{2 ( \begin{matrix}( 2 {c}_{{C}_{b} - {C}_{a}}^{′} ) cosine {θ}_{{∠C}_{a} {C}_{b} {d}_{1}} - \\ ( 2 {c}_{{C}_{b} - {C}_{c}}^{′} ) cosine \\ ( {θ}_{{∠C}_{a} {C}_{b} {C}_{c}} - {θ}_{{∠C}_{a} {C}_{b} {d}_{1}} )\end{matrix} )} )}^{2} \\ - 2 ( 2 {c}_{{C}_{b} - {C}_{a}}^{′} ) ( \frac{{( 2 {c}_{{C}_{b} - {C}_{a}}^{′} )}^{2} - {( 2 {c}_{{C}_{b} - {C}_{c}}^{′} )}^{2}}{2 ( \begin{matrix}( 2 {c}_{{C}_{b} - {C}_{a}}^{′} ) cosine {θ}_{{∠C}_{a} {C}_{b} {d}_{1}} - \\ ( 2 {c}_{{C}_{b} - {C}_{c}}^{′} ) cosine \\ ( {θ}_{{∠C}_{a} {C}_{b} {C}_{c}} - {θ}_{{∠C}_{a} {C}_{b} {d}_{1}} )\end{matrix} )} ) cosine {θ}_{{∠C}_{a} {C}_{b} {d}_{1}} \\ - {( \frac{2 {c}_{{C}_{a} - {C}_{c}}^{′}}{2} )}^{2}\end{matrix} ) = 0 \\ ( \begin{matrix}{( 2.74663 {a}_{0} )}^{2} + {( \frac{{( 2.74663 {a}_{0} )}^{2} - {( 2.62936 {a}_{0} )}^{2}}{2 ( \begin{matrix}( 2.74663 {a}_{0} ) cosine {θ}_{{∠C}_{a} {C}_{b} {d}_{1}} - \\ ( 2.62936 {a}_{0} ) cosine \\ ( {120.00}^{°} - {θ}_{{∠C}_{a} {C}_{b} {d}_{1}} )\end{matrix} )} )}^{2} \\ - ( 2 ( 2.74663 {a}_{0} ) ( \frac{{( 2.74663 {a}_{0} )}^{2} - {( 2.62936 {a}_{0} )}^{2}}{2 ( \begin{matrix}( 2.74663 {a}_{0} ) cosine {θ}_{{∠C}_{a} {C}_{b} {d}_{1}} - \\ ( 2.62936 {a}_{0} ) cosine \\ ( {120.00}^{°} - {θ}_{{∠C}_{a} {C}_{b} {d}_{1}} )\end{matrix} )} ) cosine {θ}_{{∠C}_{a} {C}_{b} {d}_{1}} ) \\ - {( \frac{4.6562 {a}_{0}}{2} )}^{2}\end{matrix} ) = 0\end{matrix}$$

The solution of Eq. (17.13) is

θ_{C}_{ₐ}_{C}_{ₐ}_{d}_{₁}=57.810° (17.14)

Eq. (17.14) can be substituted into Eq. (15.120) to give d₁:

$$\begin{matrix}{d}_{1} = \frac{{( 2 {c}_{{C}_{b} - {C}_{a}}^{′} )}^{2} - {( 2 {c}_{{C}_{b} - {C}_{c}}^{′} )}^{2}}{2 ( \begin{matrix}( 2 {c}_{{C}_{b} - {C}_{a}}^{′} ) cosine {θ}_{{∠C}_{a} {C}_{b} {d}_{1}} - ( 2 {c}_{{C}_{b} - {C}_{c}}^{′} ) \\ cosine ( {θ}_{{∠C}_{a} {C}_{b} {C}_{c}} - {θ}_{{∠C}_{a} {C}_{b} {d}_{1}} )\end{matrix} )} \\ = \frac{{( 2.74663 {a}_{0} )}^{2} - {( 2.62936 {a}_{0} )}^{2}}{2 ( \begin{matrix}( 2.74663 {a}_{0} ) cosine ( {57.810}^{°} ) - \\ ( 2.62936 {a}_{0} ) cosine ( {120.00}^{°} - {57.810}^{°} )\end{matrix} )} \\ = 1.33278 {a}_{0}\end{matrix} \qquad ( 17.15 )$$

The atoms Cₐ, Cₐ, and C_{c} define the base of a pyramid. Then, the pyramidal angle θ∠_{C}_{ₐ}_{C}_{ₐ}_{C}_{_{c}} can be solved from the internuclear distances between Cₐ and Cₐ, 2c′_{C}_{ₐ}_{—C}_{ₐ}, and between Cₐ and C_{c}, 2c′_{C}_{ₐ}_{—C}_{_{c}}, using the law of cosines (Eq. (15.115)):

$$\begin{matrix}{θ}_{{∠C}_{a} {C}_{a} {C}_{c}} = {cos}^{- 1} ( \frac{{( 2 {c}_{{C}_{a} - {C}_{a}}^{′} )}^{2} + {( 2 {c}_{{C}_{a} - {C}_{c}}^{′} )}^{2} - {( 2 {c}_{{C}_{a} - {C}_{c}}^{′} )}^{2}}{2 ( 2 {c}_{{C}_{a} - {C}_{a}}^{′} ) ( 2 {c}_{{C}_{a} - {C}_{c}}^{′} )} ) \\ = {cos}^{- 1} ( \frac{\begin{matrix}{( 4.44410 {a}_{0} )}^{2} + {( 4.65618 {a}_{0} )}^{2} - \\ {( 4.65618 {a}_{0} )}^{2}\end{matrix}}{2 ( 4.44410 {a}_{0} ) ( 4.65618 {a}_{0} )} ) \\ = {61.50}^{°}\end{matrix} \qquad ( 17.16 )$$

The parameter d₂ is the distance from Cₐ to the bisector of the internuclear-distance line between Cₐ and C_{c}, 2c′C_{ₐ}_{—C}_{_{c}}. The angle between d₂ and the Cₐ—Cₐ axis, θ_{∠C}_{ₐ}_{C}_{ₐ}_{d}_{₂}, can be solved reiteratively using Eq. (15.126):

$$\begin{matrix} ( 17.17 ) \\ ( \begin{matrix}{( 2 {c}_{{C}_{a} - {C}_{a}}^{′} )}^{2} + {( \frac{{( 2 {c}_{{C}_{a} - {C}_{a}}^{′} )}^{2} - {( 2 {c}_{{C}_{a} - {C}_{c}}^{′} )}^{2}}{2 ( \begin{matrix}( 2 {c}_{{C}_{a} - {C}_{a}}^{′} ) cosine {θ}_{{∠C}_{a} {C}_{a} {d}_{2}} - \\ ( 2 {c}_{{C}_{a} - {C}_{c}}^{′} ) cosine \\ ( {θ}_{{∠C}_{a} {C}_{a} {C}_{c}} - {θ}_{{∠C}_{a} {C}_{a} {d}_{2}} )\end{matrix} )} )}^{2} \\ - 2 ( 2 {c}_{{C}_{b} - {C}_{a}}^{′} ) ( \frac{{( 2 {c}_{{C}_{a} - {C}_{a}}^{′} )}^{2} - {( 2 {c}_{{C}_{a} - {C}_{c}}^{′} )}^{2}}{2 ( \begin{matrix}( 2 {c}_{{C}_{a} - {C}_{a}}^{′} ) cosine {θ}_{{∠C}_{a} {C}_{a} {d}_{2}} - \\ ( 2 {c}_{{C}_{a} - {C}_{c}}^{′} ) cosine \\ ( {θ}_{{∠C}_{a} {C}_{a} {C}_{c}} - {θ}_{{∠C}_{a} {C}_{a} {d}_{2}} )\end{matrix} )} ) cosine {θ}_{{∠C}_{a} {C}_{b} {d}_{2}} \\ - {( \frac{2 {c}_{{C}_{a} - {C}_{c}}^{′}}{2} )}^{2}\end{matrix} ) = 0 \\ ( \begin{matrix}{( 4.44410 {a}_{0} )}^{2} + {( \frac{{( 4.44410 {a}_{0} )}^{2} - {( 4.65618 {a}_{0} )}^{2}}{2 ( \begin{matrix}( 4.44410 {a}_{0} ) cosine {θ}_{{∠C}_{a} {C}_{a} {d}_{2}} - \\ ( 4.65618 {a}_{0} ) cosine \\ ( {61.50}^{°} - {θ}_{{∠C}_{a} {C}_{a} {d}_{2}} )\end{matrix} )} )}^{2} \\ - ( 2 ( 4.44410 {a}_{0} ) ( \frac{{( 4.44410 {a}_{0} )}^{2} - {( 4.65618 {a}_{0} )}^{2}}{2 ( \begin{matrix}( 4.44410 {a}_{0} ) cosine {θ}_{{∠C}_{a} {C}_{a} {d}_{2}} - \\ ( 4.65618 {a}_{0} ) cosine \\ ( {61.50}^{°} - {θ}_{{∠C}_{a} {C}_{a} {d}_{2}} )\end{matrix} )} ) cosine {θ}_{{∠C}_{a} {C}_{a} {d}_{2}} ) \\ - {( \frac{4.6562 {a}_{0}}{2} )}^{2}\end{matrix} ) = 0\end{matrix}$$

The solution of Eq. (17.17) is

θ_{∠C}_{ₐ}_{C}_{ₐ}_{d}_{₂}=31.542° (17.18) Eq. (17.18) can be substituted into Eq. (15.125) to give d₂:

$$\begin{matrix}{d}_{2} = \frac{{( 2 {c}_{{C}_{a} - {C}_{a}}^{′} )}^{2} - {( 2 {c}_{{C}_{a} - {C}_{c}}^{′} )}^{2}}{2 ( \begin{matrix}( 2 {c}_{{C}_{a} - {C}_{a}}^{′} ) cosine {θ}_{{∠C}_{a} {C}_{a} {d}_{2}} - ( 2 {c}_{{C}_{a} - {C}_{c}}^{′} ) \\ cosine ( {θ}_{{∠C}_{a} {C}_{a} {C}_{c}} - {θ}_{{∠C}_{a} {C}_{a} {d}_{2}} )\end{matrix} )} \\ = \frac{{( 4.44410 {a}_{0} )}^{2} - {( 4.65618 {a}_{0} )}^{2}}{2 ( \begin{matrix}( 4.44410 {a}_{0} ) cosine ( {31.542}^{°} ) - \\ ( 4.65618 {a}_{0} ) cosine ( {61.50}^{°} - {31.542}^{°} )\end{matrix} )} \\ = 3.91101 {a}_{0}\end{matrix} \qquad ( 17.19 )$$

The lengths d₁, d₂, and 2c′_{C}_{_{b}}_{—C}_{ₐ} define a triangle wherein the angle between d₁ and the internuclear distance between C_{b} and Cₐ, 2c′_{C}_{_{b}}_{—C}_{ₐ}, is the dihedral angle θ_{∠C—C/C—C═C} that can be solved using the law of cosines (Eq. (15.117)):

$$\begin{matrix}{θ}_{∠C - C / C - C = C} = {cos}^{- 1} ( \frac{{d}_{1}^{2} + {( 2 {c}_{{C}_{b} - {C}_{a}}^{′} )}^{2} - {d}_{2}^{2}}{2 {d}_{1} ( 2 {c}_{{C}_{b} - {C}_{a}}^{′} )} ) \\ = {cos}^{- 1} ( \frac{\begin{matrix}{( 1.33278 {a}_{0} )}^{2} + {( 2.74663 {a}_{0} )}^{2} - \\ {( 3.91101 {a}_{0} )}^{2}\end{matrix}}{2 ( 1.33278 {a}_{0} ) ( 2.74663 {a}_{0} )} ) \\ = {144.71}^{°}\end{matrix} \qquad ( 17.16 )$$

The dihedral angle for a truncated icosahedron corresponding to θ_{∠C—C/C—C═C} is

θ_{∠C—C/C—C═C}=144.24° (17.20)

### Graphite

In addition to fullerene and diamond described in the corresponding sections, graphite is the third allotrope of carbon. It comprises planar sheets of covalently bound carbon atoms arranged in hexagonal aromatic rings of a macromolecule of indefinite size. The sheets, in turn, are bound together by weaker intermolecular forces. It was demonstrated in the Fullerene (C₆₀) section, that a very complex macromolecule, fullerene, could be simply solved from the groups at each vertex carbon atom of the structure. Specifically, a C═C group is bound to two C—C bonds at each vertex carbon atom of C₆₀. The solution of the macromolecule is given by superposition of the geometrical and energy parameters of the corresponding two groups. Similarly, diamond comprising, in principle, an infinite network of carbons was also solved in the Diamond section using the functional group solutions, the diamond C—C functional group which is the only functional group of diamond.

The structure of the indefinite network of aromatic hexagons of a sheet of graphite can also be solved by considering the vertex atom. As in the case of fullerene, each sheet of joined hexagons can be constructed with a C═C group bound to two C—C bonds at each vertex carbon atom of graphite. However, an alternative bonding to that C₆₀ is possible for graphite due to the structure comprising repeating hexagonal units. In this case, the lowest energy structure is achieved with a single functional group, one which has aromatic character. The aromatic bond is uniquely stable and requires the sharing of the electrons of multiple H₂-type MOs. The results of the derivation of the parameters of the benzene molecule given in the Benzene Molecule (C₆H₆) section was generalized to any aromatic functional group of aromatic and heterocyclic compounds in the Aromatic and Heterocyclic Compounds section. Ethylene serves as a basis element for the C^{3e}═C bonding of the aromatic bond wherein each of the C^{3e}═C aromatic bonds comprises (0.75)(4)=3 electrons according to Eq. (15.161) wherein C₂ of Eq. (15.51) for the aromatic

$$C {=}^{3 e} C$$

-bond MO given by Eq. (15.162) is C₂(aromaticC2sp³HO)=c₂(aromaticC2sp³ HO)=0.85252 and E_{T}(atom−atom,msp³.AO)=−2.26759 eV.

In graphite, the minimum energy structure with equivalent carbon atoms wherein each carbon forms bonds with three other such carbons requires a redistribution of charge within an aromatic system of bonds. Considering that each carbon contributes four bonding electrons, the sum of electrons of a vertex-atom group is four from the vertex atom plus two from each of the two atoms bonded to the vertex atom where the latter also contribute two each to the juxtaposed group. These eight electrons are distributed equivalently over the three bonds of the group such that the electron number assignable to each bond is 8/3. Thus, the

$$C {=}^{8 / 3 e} C$$

functional group of graphite comprises the aromatic bond with the exception that the electron-number per bond is 8/3. E_{T}(Group) and E_{D} (Group) are given by Eqs. (15.165) and (15.166), respectively, with

$${f}_{1} = \frac{2}{3} and {c}_{4} = \frac{8}{3} .$$

As in the case of diamond comprising equivalent carbon atoms, the C2sp³ HO magnetic energy E_{mag} given by Eq. (15.67) was subtracted due to a set of unpaired electrons being created by bond breakage such that c₃ of Eqs. (15.165) and (15.166) is one.

The symbol of the functional group of graphite is given in Table 17.13. The geometrical (Eqs. (15.1-15.5) and (15.51)), intercept (Eqs. (15.80-15.87)), and energy (Eqs. (15.6-15.11), (15.17-15.65), and (15.165-15.166)) parameters of graphite are given in Tables 17.14, 17.15 (as shown in the priority document), and 17.16, respectively. The total energy of graphite given in Table 17.17 was calculated as the sum over the integer multiple of each E_{D} (Group) of Table 17.16 corresponding to functional-group composition of the molecular solid. The experimental

$$C {=}^{8 / 3 e} C$$

bond energy of graphite at 0 K,

$${E}_{{D}_{exp}} ( C {=}^{8 / 3 e} C ) ,$$

is given by the difference between the enthalpy of formation of gaseous carbon atoms from graphite, ΔH_{f} (C_{graph}(gas)), and the interplanar binding energy, Eₓ, wherein graphite solid has a defined heat of formation of zero (ΔH_{f} (C (graphite)=0):

$${E}_{{D}_{exp}} ( C {=}^{8 / 3 e} C ) = \frac{2}{3} [ Δ {H}_{f} ( {C}_{graphite} ( gas ) ) - {E}_{x} ] \qquad ( 17.21 )$$

The factor of 2/3 corresponds to the ratio of 8/3 electrons per bond and 4 electrons per carbon atom. The heats of formation of atomic carbon from graphite [9] and E_{x [}10] are:

ΔH_{f}(C_{graphite}(gas))=711.185 kJ/mole(7.37079 eV/atom) (17.22)

Eₓ=0.0228 eV/atom (17.23)

### Using Eqs. (17.21-17.23),

$${E}_{{D}_{exp}} ( C {=}^{8 / 3 e} C )$$

is

$$\begin{matrix}{E}_{{D}_{exp}} ( C {=}^{8 / 3 e} C ) = \frac{2}{3} [ 7.37079 eV - 0.0228 eV ] \\ = 4.89866 eV\end{matrix} \qquad ( 17.24 )$$

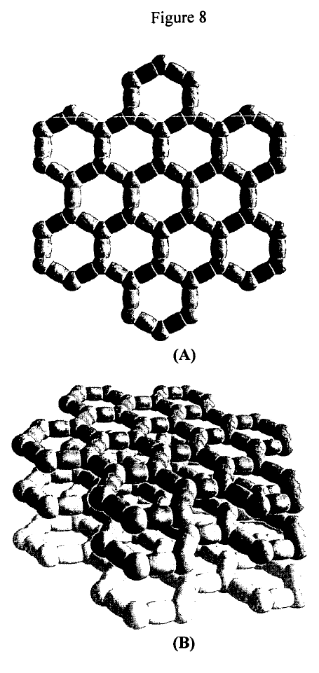

The bond angle parameters of graphite determined using Eqs. (15.87-15.117) are given in Table 17.18 (as shown in the priority document). The inter-plane distance for graphite of 3.5 Å is calculated using the same equation as used to determine the bond angles (Eq. (15.99)). The structure of graphite is shown in FIG. 8. The graphite

$$C {=}^{8 / 3 e} C$$

functional group can serve as a basis element to form additional complex polycyclic aromatic carbon structures such as nanotubes [11-15].

TABLE 17.13
The symbols of the functional froup of graphite.

| Functional Group | Group Symbol |
|---|---|
| CC bond (graphite-C) | $C {\overline{—}}_{ }^{8 / 3 e} C$ |

TABLE 17.14
The geometrical bond parameters of graphite and experimental values.

| Parameter | $C {\overline{—}}_{ }^{8 / 3 e} C$ Group |
|---|---|
| a (a₀) | 1.47348 |
| c′ (a₀) | 1.31468 |
| Bond Length 2c′ (Å) | 1.39140 |
| Exp. Bond Length (Å) | 1.42 |
| | (graphite) [11] |
| | 1.399 |
| | (benzene) [16] |
| b, c (a₀) | 0.66540 |
| e | 0.89223 |

TABLE 17.16
The energy parameters (eV) of the functional group of graphite.

| Parameters | $C {\overline{—}}_{ }^{8 / 3 e} C$ Group |
|---|---|
| f₁ | 2/3 |
| n₁ | 2 |
| n₂ | 0 |
| n₃ | 0 |
| C₁ | 0.5 |
| C₂ | 0.85252 |
| c₁ | 1 |
| c₂ | 0.85252 |
| c₃ | 1 |
| c₄ | 8/3 |
| c₅ | 0 |
| C₁ₒ | 0.5 |
| C₂ₒ | 0.85252 |
| Vₑ (eV) | −101.12679 |
| Vₚ (eV) | 20.69825 |
| T (eV) | 34.31559 |
| Vₘ (eV) | −17.15779 |
| E(_{AO/HO}) (eV) | 0 |
| ΔE_{H}_{₂}_{MO}(_{AO/HO}) (eV) | 0 |
| E_{T} (_{AO/HO}) (eV) | 0 |
| E_{T} (_{H}_{₂}_{MO}) (eV) | −63.27075 |
| E_{T} (atom − atom, msp³.AO) (eV) | −2.26759 |
| E_{T} (_{MO}) (eV) | −65.53833 |
| ω (10¹⁵ rad/s) | 49.7272 |
| E_{K} (eV) | 32.73133 |
| Ē_{D} (eV) | −0.35806 |
| Ē_{Kvib} (eV) | 0.19649 |
| | [17] |
| Ē_{osc} (eV) | −0.25982 |
| E_{mag} (eV) | 0.14803 |
| E_{T} (_{Group}) (eV) | −43.93995 |
| Eᵢₙᵢₜᵢₐₗ (_{c}_{₄}_{AO/HO}) (eV) | −14.63489 |
| Eᵢₙᵢₜᵢₐₗ (_{c}_{₅}_{AO/HO}) (eV) | 0 |
| E_{D} (_{Group}) (eV) | 4.91359 |

TABLE 17.17
The total bond energy of graphite calculated using
the functional group composition and the energy of
Table 17.16 compared to the experimental value [9-10].

| Formula | Name | $C {\overline{—}}_{ }^{8 / 3 e} C$ | Calculated Total Bond Energy (eV) | Experimental Total Bond Energy (eV) | Relative Error |
|---|---|---|---|---|---|
| Cₙ | Graphite | 1 | 4.91359 | 4.89866 | −0.00305 |

### REFERENCES

1. http://newton.ex.ac.uk/research/qsystems/people/sque/diamond/.
2. D. R. Lide, CRC Handbook of Chemistry and Physics, 86th Edition, CRC Press, Taylor & Francis, Boca Raton, (2005-6), pp. 5-18; 5-45.
3. D. R. Lide, CRC Handbook of Chemistry and Physics, 86th Edition, CRC Press, Taylor & Francis, Boca Raton, (2005-6), p. 4-150.
4. J. Wagner, Ch. Wild, P. Koidl, “Resonance effects in scattering from polycrystalline diamond films”, Appl. Phys. Lett. Vol. 59, (1991), pp. 779-781.
5. W. I. F. David, R. M. Ibberson, J. C. Matthewman, K. Prassides, T. J. S. Dennis, J. P. Hare, H. W. Kroto, R. Taylor, D. R. M. Walton, “Crystal structure and bonding of C₆₀”, Nature, Vol. 353, (1991), pp. 147-149.
6. B. Chase, N. Herron, E. Holler, “Vibrational spectroscopy of C₆₀ and C₇₀ temperature-dependent studies”, J. Phys. Chem., Vol. 96, (1992), pp. 4262-4266.
7. D. R. Lide, CRC Handbook of Chemistry and Physics, 86th Edition, CRC Press, Taylor & Francis, Boca Raton, (2005-6), pp. 9-63; 5-18 to 5-42.
8. J. M. Hawkins, “Osmylation of C₆₀: proof and characterization of the soccer-ball framework”, Acc. Chem. Res., (1992), Vol. 25, pp. 150-156.
9. M. W. Chase, Jr., C. A. Davies, J. R. Downey, Jr., D. J. Frurip, R. A. McDonald, A. N. Syverud, JANAF Thermochemical Tables, Third Edition, Part II, Cr—Zr, J. Phys. Chem. Ref. Data, Vol. 14, Suppl. 1, (1985), p. 536.
10. M. C. Schabel, J. L. Martins, “Energetics of interplanar binding in graphite”, Phys. Rev. B, Vol. 46, No. 11, (1992), pp. 7185-7188.
11. J. -C. Charlier, J. -P. Michenaud, “Energetics of multilayered carbon tubules”, Phys. Rev. Ltts., Vol. 70, No. 12, (19930, pp. 1858-1861.
12. J. P. Lu, “Elastic properties of carbon nanotubes and nanoropes,” Phys. Rev. Letts., (1997), Vol. 79, No. 7, pp. 1297-1300.
13. G. Zhang, X. Jiang, E. Wang, “Tubular graphite cones,” Science, (2003), vol. 300, pp. 472-474.
14. A. N. Kolmogorov, V. H. Crespi, M. H. Schleier-Smith, J. C. Ellenbogen, “Nanotube-substrate interactions: Distinguishing carbon nanotubes by the helical angle,” Phys. Rev. Letts., (2004), Vol. 92, No. 8, pp. 085503-1-085503-4.
15. J.-W. Jiang, H. Tang, B.-S. Wang, Z.-B. Su, “A lattice dynamical rreatment for the total potential of single-walled carbon nanontubes and its applications: Relaxed equilibrium structure, elastic properties, and vibrational modes of ultra-narrow tubes,” available at http://arxiv.org/PS_cache/cond-mat/pdf/0610/0610792.pdf, Oct. 28, 2006.
16. D. R. Lide, CRC Handbook of Chemistry and Physics, 86th Edition, CRC Press, Taylor & Francis, Boca Raton, (2005-6), p. 9-29.
17. G. Herzberg, Molecular Spectra and Molecular Structure II Infrared and Raman Spectra of Polyatomic Molecules, Van Nostrand Reinhold Company, New York, N.Y., (1945), pp. 362-369.
18. D. R. McKenzie, D. Muller, B. A. Pailthorpe, “Compressive-stress-induced formation of thin-film tetrahedral amorphous carbon”, Phys. Rev. Lett., (1991), Vol. 67, No. 6, pp. 773-776.
19. W. I. F. David, R. M. Ibberson, G. A. Jeffrey, J. R. Ruble, “The structure analysis of deuterated benzene and deuterated nitromethane by pulsed-neutron powder diffraction: a comparison with single crystal neutron analysis”, Physica B (1992), 180 & 181, pp. 597-600.
20. G. A. Jeffrey, J. R. Ruble, R. K. McMullan, J. A. Pople, “The crystal structure of deuterated benzene,” Proceedings of the Royal Society of London. Series A, Mathematical and Physical Sciences, Vol. 414, No. 1846, (Nov. 9, 1987), pp. 47-57.
21. H. B. Burgi, S. C. Capelli, “Getting more out of crystal-structure analyses,” Helvetica Chimica Acta, Vol. 86, (2003), pp. 1625-1640.

### The Nature of the Metallic Bond of Alkali Metals

### Generalization of the Nature of the Metallic Bond

Common metals comprise alkali, alkaline earth, and transition elements and have the properties of high electrical and thermal conductivity, opacity, surface luster, ductility, and malleability. From Maxwell's equations, the electric field inside of a metal conductor is zero. As shown in Appendix IV, the bound electron exhibits this feature. The charge is confined to a two dimensional layer and the field is normal and discontinuous at the surface. The relationship between the electric field equation and the electron source charge-density function is given by Maxwell's equation in two dimensions [1-3].

$$n \cdot ( {E}_{1} - {E}_{2} ) = \frac{σ}{{ɛ}_{0}} \qquad ( 19.1 )$$

where n is the normal unit vector, E₁=0 (E₁ is the electric field inside of the MO), E₂ is the electric field outside of the MO and σ is the surface charge density. The properties of metals can be accounted for the existence of free electrons bound to the corresponding lattice of positive ions. Based on symmetry, the natural coordinates are Cartesian. Then, the problem of the solution of the nature of the metal bonds reduces to a familiar electrostatics problem—the fields and the two-dimensional surface charge density induced on a planar conductor by a point charge such that a zero potential inside of the conductor is maintained according to Maxwell's equations.

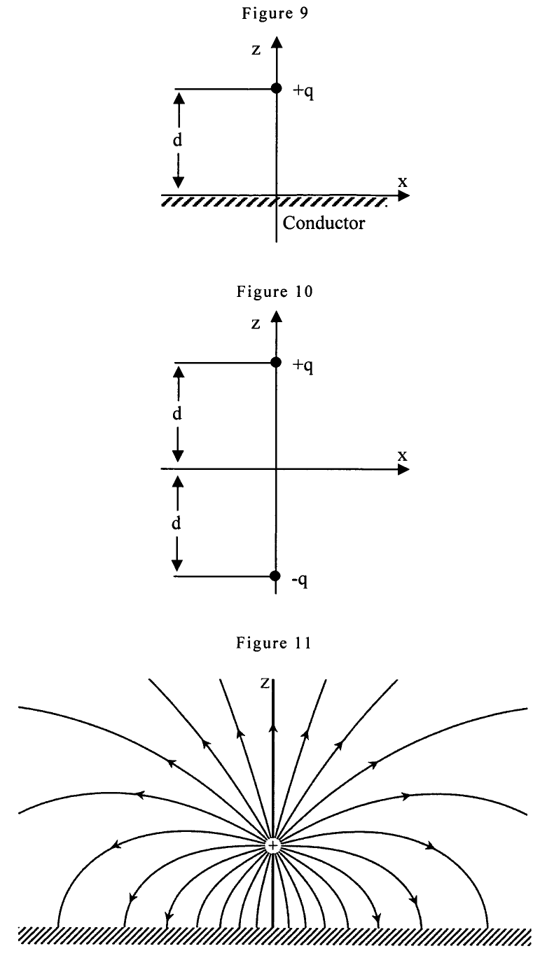

There are many examples of charges located near a conductor such as an electron emitted from a cathode or a power line suspended above the conducting earth. Consider a point charge +e at a position (0,0,d) near an infinite planar conductor as shown in FIG. 9.

With the potential of the conductor set equal to zero, the potential Φ in the upper half space (z>0) is given by the Poisson equation (Eq. (I.30)), subject to the boundary condition that Φ=0 at z=0 and at z=∞. The potential for the point charge in free space is

$$Φ ( x , y , z ) = \frac{e}{4 {πɛ}_{0}} ( \frac{1}{\sqrt{{x}^{2} + {y}^{2} + {( z - d )}^{2}}} ) \qquad ( 19.2 )$$

The Poisson solution that meets the boundary condition that the potential is zero at the surface of the infinite planar conductor is that due to the point charge and an image charge of −e at the position (0,0,−d) as shown in FIG. 10.
The potential for the corresponding electrostatic dipole in the positive half space is

$$Φ ( x , y , z ) = \{ \begin{matrix}\frac{e}{4 {πɛ}_{0}} ( \begin{matrix}\frac{1}{\sqrt{{x}^{2} + {y}^{2} + {( z - d )}^{2}}} - \\ \frac{1}{\sqrt{{x}^{2} + {y}^{2} + {( z + d )}^{2}}}\end{matrix} ) & for z \geq 0 \\ 0 & for z \leq 0\end{matrix} \} \qquad ( 19.3 )$$

The electric field shown in FIG. 11 is nonzero only in the positive half space and is given by

$$\begin{matrix}E = - ∇ Φ \\ = \frac{e}{4 {πɛ}_{0}} ( \frac{{xi}_{x} + {yi}_{y} + ( z - d ) {i}_{z}}{{( {x}^{2} + {y}^{2} + {( z - d )}^{2} )}^{3 / 2}} - \frac{{xi}_{x} + {yi}_{y} + ( z + d ) {i}_{z}}{{( {x}^{2} + {y}^{2} + {( z + d )}^{2} )}^{3 / 2}} )\end{matrix} \qquad ( 19.4 )$$

At the surface (z=0), the electric field is normal to the conductor as required by Gauss' and Faraday's laws:

$$E ( x , y , 0 ) = \frac{- e {di}_{z}}{2 {{πɛ}_{0} ( {x}^{2} + {y}^{2} + {d}^{2} )}^{3 / 2}} \qquad ( 19.5 )$$

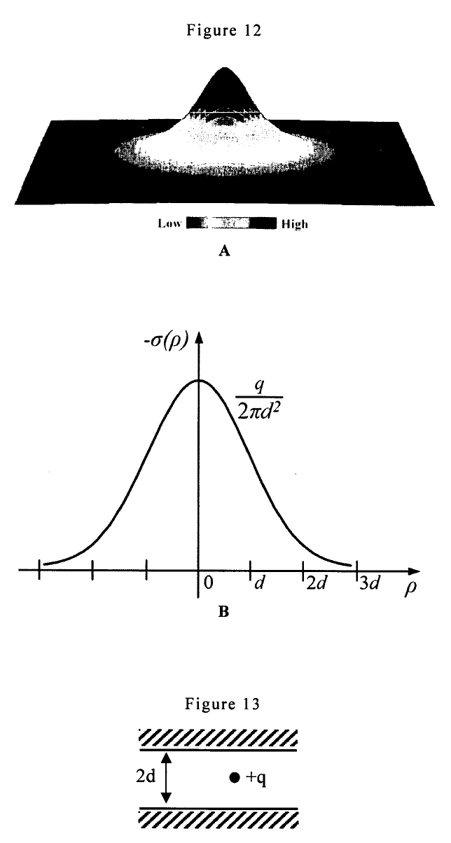

The surface charge density shown in FIG. 12 is given by Eq. (19.1) with n=i_{z} and E₂=0:

$$σ = \frac{- e d}{2 {π ( {x}^{2} + {y}^{2} + {d}^{2} )}^{3 / 2}} = \frac{- e d}{2 {π ( {ρ}^{2} + {d}^{2} )}^{3 / 2}} \qquad ( 19.6 )$$

The total induced charge is given by the integral of the density over the surface:

$$\begin{matrix}{q}_{induced} = \int σ d s \\ = {\int }_{- ∞}^{∞} {\int }_{- ∞}^{∞} \frac{- e d}{2 {π ( {x}^{2} + {y}^{2} + {d}^{2} )}^{3 / 2}} d y d x \\ = \frac{- e d}{2 π} {\int }_{- ∞}^{∞} {\int }_{- \frac{π}{2}}^{\frac{π}{2}} \frac{cos θ}{{x}^{2} + {d}^{2}} d θ d x \\ = \frac{- e d}{π} {\int }_{- ∞}^{∞} \frac{1}{{x}^{2} + {d}^{2}} d x \\ = \frac{- e d}{π} {\int }_{- \frac{π}{2}}^{\frac{π}{2}} \frac{1}{d} d {θ}^{′} \\ = - e\end{matrix} \qquad ( 19.7 )$$

wherein the change of variables

$$y = {( {x}^{2} + {d}^{2} )}^{\frac{1}{2}}$$

tan θ and x=d tan θ′ were used. The total surface charge induced on the surface of the conductor is exactly equal to the negative of the point charge located above the conductor.

Now consider the case where the infinite planar conductor is charged with a surface charge density σ corresponding to a total charge of a single electron, −e, and the point charge of +e is due to a metal ion M⁺. Then, according to Maxwell's equations, the potential function of M+ is given by Eq. (19.3), the electric field between M+ and σ is given by Eqs. (19.4-19.5), and σ is given by Eq. (19.6). The field lines of M+end on σ, and the electric field is zero in the metal and in the negative half space. The potential energy between M+ and σ at the surface (z=0) given by the product of Eq. (19.2) and Eq. (19.6) is

$$\begin{matrix}V = {\int }_{- ∞}^{∞} {\int }_{- ∞}^{∞} \frac{e}{4 {πɛ}_{o}} ( \frac{1}{\sqrt{{x}^{2} + {y}^{2} + {d}^{2}}} ) ( \frac{- e d}{2 {π ( {x}^{2} + {y}^{2} + {d}^{2} )}^{3 / 2}} ) d x d y & ( 19.8 ) \\ V = \frac{- {e}^{2} d}{8 {π}^{2} {ɛ}_{0}} {\int }_{- ∞}^{∞} {\int }_{- ∞}^{∞} \frac{1}{{( {x}^{2} + {y}^{2} + {d}^{2} )}^{2}} d x d y & ( 19.9 )\end{matrix}$$

Using a change of coordinates to cylindrical and integral # 47 of Lide [4] gives:

$$\begin{matrix}V = {\int }_{0}^{∞} {\int }_{0}^{2 π} \frac{- {e}^{2} d}{8 {π}^{2} {{ɛ}_{0} ( {ρ}^{2} + {d}^{2} )}^{2}} ρ d φ d ρ & ( 19.10 ) \\ V = \frac{- {e}^{2} d}{4 {πɛ}_{0}} {\int }_{0}^{∞} \frac{ρ}{{( {ρ}^{2} + {d}^{2} )}^{2}} d ρ & ( 19.11 ) \\ V = \frac{- {e}^{2} d}{4 {πɛ}_{0}} {( \frac{- 1}{2 ( {ρ}^{2} + {d}^{2} )} )}_{0}^{∞} & ( 19.12 ) \\ V = \frac{- {e}^{2}}{4 π {ɛ}_{0} ( 2 d )} & ( 19.13 )\end{matrix}$$

The corresponding force from the negative gradient as well as the integral of the product of the electric field (Eq. (19.5)) and the charge density (Eq. (19.6)) is

$$\begin{matrix}F = - ∇ V \\ = {\int }_{A} E ( x , y , 0 ) σ d A \\ = ( \frac{{e}^{2} {d}^{2}}{{( 2 π )}^{2} {ɛ}_{0}} {i}_{z} ) {\int }_{0}^{∞} {\int }_{0}^{2 π} \frac{ρ d φ d ρ}{{( {ρ}^{2} + {d}^{2} )}^{3}} \\ = 2 π ( \frac{{e}^{2} {d}^{2}}{{( 2 π )}^{2} {ɛ}_{0}} {i}_{z} ) {\int }_{0}^{∞} \frac{ρ d ρ}{{( {ρ}^{2} + {d}^{2} )}^{3}} \\ = 2 π ( \frac{{e}^{2} {d}^{2}}{{( 2 π )}^{2} {ɛ}_{0}} {i}_{z} ) \frac{1}{4 {d}^{4}} \\ = \frac{{e}^{2}}{8 {πɛ}_{0} {d}^{2}} {i}_{z}\end{matrix} \qquad ( 19.14 )$$

where d is treated as a variable to be solved as discussed below. The potential is equivalent to that of the charge and its image charge located a distance 2d apart. In addition, the potential and force are equivalent to those of the charge +e and an image charge

$$\frac{- e}{2}$$

located a distance d apart.

In addition to the infinite planar conductor at z=0 and the point charge +e at a position (0,0,d) near the infinite planar conductor as shown in FIG. 9, next consider the introduction of a second infinite planar conductor located at position z=2d as shown in FIG. 13.

As shown, by Kong [5], an image charge at (0,0,−d) meets the boundary condition of zero potential at the bottom plate, but it gives rise to a potential at the top. Similarly, an image charge at (0,0,3d), meets the boundary condition of zero potential at the top plate, but it gives rise to a potential at the bottom. Satisfaction of the boundary condition of zero potential at both plates due to the presence of the initial real charge requires an infinite series of alternating positive and negative image charges spaced a distance d apart with the potential given by the summation over the real point source and its point-source image charges of +e and −e. Since fields superimpose, by adding real charges in a periodic lattice, the image charges cancel except for one per each real charge at a distance 2d apart as in the original case considered in FIG. 9.

In the real world, the idealized infinite planar conductor is a planar metal sheet experimentally comprised of an essentially infinite lattice of metal ions M⁺ and free electrons that provide surface densities σ in response to an applied external field such as that due to an external charge of +e due to a metal ion M⁺. Then, it is required that the solutions of the external point charge at an infinite planar conductor are also those of the metal ions and free electrons of metals based on the uniqueness of solutions of Maxwell's equations and the constraint that the individual electrons in a metal conserve the classical physical laws of the macro-scale conductor. In metals, a superposition of planar free electrons given in the Electron in Free Space section replaces the infinite planar conductor. Then, the nature of the metal bond is a lattice of metal ions with field lines that end on the corresponding lattice of electrons wherein each has the two-dimensional charge density σ given by Eq. (19.6) to match the boundary conditions of equipotential, minimum energy, and conservation of charge and angular momentum for an ionized electron. Consider an infinite lattice of positive charges in the hollow Cartesian cavities whose walls are the intersecting planes of conductors and that each planar conductor comprises an electron. By Gauss' law, the field lines of each real charge end on each of the n planar-electron walls of the cavity wherein the surface charge density of contribution of each electron is that of image charge of

$$\frac{- e}{n}$$

equidistance across each wall from a given charge +e. Then, each electron contributes the charge

$$\frac{- e}{n}$$

to the corresponding ion where each is equivalent electrostatically to an image point charge at twice the distance from the point charge of +e due to M⁺.

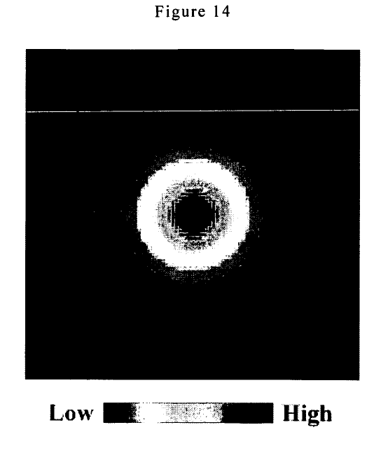

Thus, the metallic bond is equivalent to the ionic bond given in the Alkali-Hydride Crystal Structures section with a Madelung constant of one with each negative ion at a position of one half the distance between the corresponding positive ions, but electrostatically equivalent to being positioned at twice this distance, the M⁺-M⁺-separation distance. The surface charge density of a planar electron having an electric field equivalent to that of image point charge for the corresponding positive ion of the lattice is shown in FIG. 14.

### Alkali-Metal Crystal Structures

The alkali metals are lithium (Li), sodium (Na), potassium (K), rubidium (Rb), and cesium (Cs). These alkali metals each comprise an equal number of alkali cations and electrons in unit cells of a crystalline lattice. The crystal structure of these metals is the body-centered cubic CsCl structure [6-8]. This close-packed structure is expected since it gives the optimal approach of the positive ions and negative electrons. For a body-centered cell, there is an identical atom at

$$x + \frac{a}{2} , y + \frac{a}{2} , z + \frac{a}{2}$$

for each atom at x, y, z. The structure of the ions with lattice parameters a=b=c and electrons at the diagonal positions centered at

$$( x + \frac{a}{4} , y + \frac{a}{4} , z + \frac{a}{4} )$$

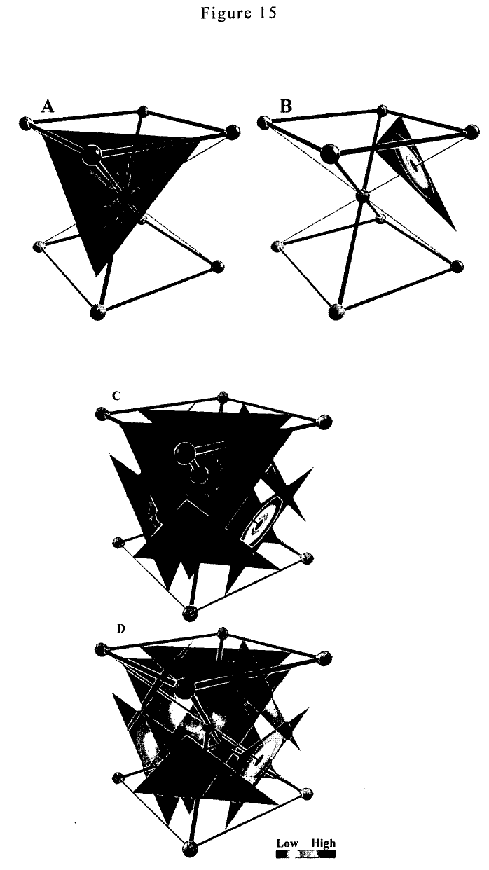

are shown in FIG. 15. In this case n=8 electron planes per body-centered ion are perpendicular to the four diagonal axes running from each corner of the cube through the center to the opposite corner. The planes intersect these diagonals at one half the distance from each corner to the center of the body-centered atom. The mutual intersection of the planes forms a hexagonal cavity about each ion of the lattice. The length l₁ to a perpendicular electron plane along the axis from a corner atom to a body-centered atom that is the midpoint of this axis is

$${l}_{1} = \sqrt{{( \frac{a}{4} )}^{2} + {( \frac{a}{4} )}^{2} + {( \frac{a}{4} )}^{2}} = \frac{a \sqrt{3}}{4} \qquad ( 19.15 )$$

The angle θ_{d} of each diagonal axis from the xy-plane of the unit cell is

$${θ}_{d} = {tan}^{- 1} ( \frac{\frac{1}{4}}{\frac{\sqrt{2}}{4}} ) = 35.26 ° \qquad ( 19.16 )$$

The angle θₚ from the horizontal to the electron plane that is perpendicular to the diagonal axis is

θₚ=180°−90°−35.26°=54.73° (19.17)

The length l₃ along a diagonal axis in the xy-plane from a corner atom to another at which point an electron plane intersects the xy-plane is

$${l}_{3} = \frac{{l}_{1}}{cos {θ}_{d}} = \frac{\frac{a \sqrt{3}}{4}}{cos ( 35.26 ° )} = \frac{\frac{a \sqrt{3}}{4}}{\sqrt{\frac{2}{3}}} = a \frac{3}{4 \sqrt{2}} \qquad ( 19.18 )$$

The length l₂ of the octagonal edge of the electron plane from a body-centered atom to the xy-plane defined by four corner atoms is

$${l}_{2} = {l}_{3} sin {θ}_{d} = a \frac{3}{4 \sqrt{2}} sin ( 35.26 ° ) = a \frac{3}{4 \sqrt{2}} \frac{1}{\sqrt{3}} = \frac{a}{4} \sqrt{\frac{3}{2}} \qquad ( 19.19 )$$

The length l₄ along the edge of the unit cell in the xy-plane from a corner atom to another at which point an electron plane intersects the xy-plane at this axis is

$${l}_{4} = \frac{{l}_{3}}{cos ( 45 ° )} = \frac{a \frac{3}{4 \sqrt{2}}}{cos ( 45 ° )} = \frac{3}{4} a \qquad ( 19.20 )$$

The dimensions and angles given by Eqs. (19.15-19.20) are shown in FIG. 15.

Each M⁺ is surrounded by six planar two-dimensional membranes that are comprised of electron density σ on which the electric field lines of the positive charges end. The resulting unit cell consists cations at the end of each edge and at the center of the cell with an electron membrane as the perpendicular bisector of the axis from an identical atom at

$$x + \frac{a}{2} , y + \frac{a}{2} , z + \frac{a}{2}$$

for each atom at x, y, z such that the unit cell contains two cations and two electrons. The ions and electrons of the unit cell are also shown in FIG. 15. The electron membranes exist throughout the metal, but they terminate on metal atomic orbitals or MOs of bonds between metal atoms and other reacted atoms such as the MOs of metal oxide bonds at the edges of the metal.

The interionic radius of each cation and electron membrane can be derived by considering the electron energies at these radii and by calculating the corresponding forces of the electrons with the ions. Then, the lattice energy is given by the sum over the crystal of the energy of the interacting ion and electron pairs at the radius of force balance between the electrons and ions.

For each point charge of +e due to a metal ion M⁺, the planar two-dimensional membrane comprised of electrons contributes a surface charge density a given by Eq. (19.6) corresponding to that of a point image charge having a total charge of a single electron, −e. The potential of each electron is double that of Eq. (19.13) since there are two mirror-image M⁺ ions per planar electron membrane:

$$V = \frac{- {e}^{2}}{4 {πɛ}_{0} d} \qquad ( 19.21 )$$

where d is treated as a variable to be solved. The same result is obtained from considering the integral of the product of two times the electric field (Eq. (19.5)) and the charge density (Eq. (19.6)) according to Eq. (19.14). In order to conserve angular momentum and maintain current continuity, the kinetic energy has two components. Since the free electron of a metal behaves as a point mass, one component using Eq. (1.47) with r=d is

$$T = \frac{1}{2} {m}_{e} {v}^{2} = \frac{1}{2} \frac{{ℏ}^{2}}{{m}_{e} {d}^{2}} \qquad ( 19.22 )$$

The other component of kinetic energy is given by integrating the mass density σₘ (r) (Eq. (19.6) with e replaced by mₑ and velocity v(r) (Eq. (1.47)) over their radial dependence (r=\sqrt{x²+y²+z²}=\sqrt{ρ²+d²}):

$$\begin{matrix}T = \frac{1}{2} \int σ {v}^{2} d A \\ = \frac{1}{2} {\int }_{0}^{∞} {\int }_{0}^{2 π} \frac{{m}_{e} d}{2 {π ( {ρ}^{2} + {d}^{2} )}^{3 / 2}} \frac{{ℏ}^{2}}{{m}_{e}^{2} ( {ρ}^{2} + {d}^{2} )} ρ d φ d ρ \\ = \frac{{ℏ}^{2} d}{4 π {m}_{e}} {\int }_{0}^{∞} {\int }_{0}^{2 π} \frac{ρ}{{( {ρ}^{2} + {d}^{2} )}^{5 / 2}} d φ d ρ \\ = \frac{2 {πℏ}^{2} d}{4 π {m}_{e}} {( \frac{- 1}{2 ( \frac{3}{2} ) {( {ρ}^{2} + {d}^{2} )}^{3 / 2}} )}_{0}^{∞} \\ = ( \frac{1}{3} ) ( \frac{1}{2} \frac{{ℏ}^{2}}{{m}_{e} {d}^{2}} )\end{matrix} \qquad ( 19.23 )$$

where integral #47 of Lide [4] was used. Thus, the total kinetic energy given by the sum of Eqs. (19.22) and (19.23) is

$$T = ( 1 + \frac{1}{3} ) ( \frac{1}{2} \frac{{ℏ}^{2}}{{m}_{e} {d}^{2}} ) = \frac{4}{3} ( \frac{1}{2} \frac{{ℏ}^{2}}{{m}_{e} {d}^{2}} ) \qquad ( 19.24 )$$

Each metal M (M=Li, Na, K, Rb, Cs) is comprised of M⁺ and e⁻ ions. The structure of the ions comprises lattice parameters a=b=c and electrons at the diagonal positions centered at

$$( x + \frac{a}{4} , y + \frac{a}{4} , z + \frac{a}{4} ) .$$

Thus, the separation distance d between each M⁺ and the corresponding electron membrane is

$$\begin{matrix}d = \sqrt{{( \frac{Δ x}{2} )}^{2} + {( \frac{Δ y}{2} )}^{2} + {( \frac{Δ z}{2} )}^{2}} \\ = \sqrt{{( \frac{1}{3} a )}^{2} + {( \frac{1}{4} a )}^{2} + {( \frac{1}{4} a )}^{2}} \\ = \frac{\sqrt{3}}{4} a\end{matrix} \\ where Δ x = Δ y = Δ z = \frac{a}{2} . \qquad ( 19.25 )$$

Thus, the lattice parameter a is given by

$$a = \frac{4 d}{\sqrt{3}} \qquad ( 19.26 )$$

The molar metal bond energy E_{D} is given by Avogadro's number N times the negative sum of the potential energy, kinetic energy, and ionization or binding energy (BE(M)) of M:

$$\begin{matrix}{E}_{D} = - N ( V + T + BE ( M ) ) \\ = N ( \frac{{e}^{2}}{4 {πɛ}_{0} d} - \frac{4}{3} ( \frac{1}{2} \frac{{ℏ}^{2}}{{m}_{e} {d}^{2}} ) - BE ( M ) )\end{matrix} \qquad ( 19.27 )$$

The separation distance d between each M⁺ and the corresponding electron membrane is given by the force balance between the outward centrifugal force and the sum of the electric, paramagnetic and diamagnetic forces as given in the Three-Through Twenty-Electron Atoms section. The electric force Fₑₗₑ corresponding to Eq. (19.21) given by its negative gradient is

$${F}_{ele} = \frac{{e}^{2}}{4 {πɛ}_{0} {d}^{2}} {i}_{z} \qquad ( 19.28 )$$

where inward is taken as the positive direction. The centrifugal force F_{centrifugal} is given by negative gradient of Eq. (19.24) times two since the charge and mass density are doubled due to the presence of mirror image M⁺ ion pairs across the electron membrane at the origin for any given ion.

$${F}_{centrifugal} = - \frac{8}{3} \frac{{ℏ}^{2}}{{m}_{e} {d}^{3}} {i}_{z} \qquad ( 19.29 )$$

where d is treated as a variable to be solved. In addition, there is an outward spin-pairing force F_{mag} between the electron density elements of two opposing ions that is given by Eqs. (7.24) and (10.52):

$${F}_{mag} = - \frac{1}{Z} \frac{{ℏ}^{2}}{{m}_{e} {d}^{3}} \sqrt{s ( s + 1 )} {i}_{z} \\ where s = \frac{1}{2} . \qquad ( 19.30 )$$

The remaining magnetic forces are determined by the electron configuration of the particular atom as given for the examples of lithium, sodium, and potassium metals in the corresponding sections.

### Lithium Metal

For Li⁺, there are two spin-paired electrons in an orbitsphere with

$${r}_{1} = {r}_{2} = {a}_{0} [ \frac{1}{2} - \frac{\sqrt{\frac{3}{4}}}{6} ] \qquad ( 19.31 )$$

as given by Eq. (7.35) where rₙ is the radius of electron n which has velocity vₙ. For the next electron that contributes to the metal-electron membrane, the outward centrifugal force on electron 3 is balanced by the electric force and the magnetic forces (on electron 3). The radius of the metal-band electron is calculated by equating the outward centrifugal force (Eq. (19.29)) to the sum of the electric (Eq. (19.28)) and diamagnetic (Eq. (19.30)) forces as follows:

$$\begin{matrix}\frac{8}{3} \frac{{ℏ}^{2}}{{m}_{e} {d}^{3}} = \frac{{e}^{2}}{4 {πɛ}_{0} {d}^{2}} - \frac{{ℏ}^{2}}{{Zm}_{e} {d}^{3}} \sqrt{\frac{3}{4}} & ( 19.32 ) \\ d = ( \frac{8}{3} + \frac{\sqrt{\frac{3}{4}}}{3} ) {a}_{0} = 2.95534 {a}_{0} = 1.56390 X {10}^{- 10} m & ( 19.33 )\end{matrix}$$

where Z=3. Using Eq. (19.26), the lattice parameter a is

a=6.82507a₀=3.61167×10⁻¹⁰ m (19.34)

The experimental lattice parameter a [7] is

a=6.63162a₀=3.5093×10⁻¹⁰ m (19.35)

The calculated Li—Li distance is in reasonable agreement with the experimental distance given the experimental difficulty of performing X-ray diffraction on lithium due to the low electron densities.

Using Eq. (19.27) and the experimental binding energy of lithium, BE(Li)=5.39172 eV=8.63849×10⁻¹⁹ J [9], the molar metal bond energy E_{D} is

$${E}_{D} = N ( \begin{matrix}\frac{{e}^{2}}{4 {πɛ}_{0} 1.56390 \times {10}^{- 10} m} - \\ \frac{4}{3} ( \frac{1}{2} \frac{{ℏ}^{2}}{{{m}_{e} ( 1.56390 \times {10}^{- 10} m )}^{2}} ) - \\ 8.63849 \times {10}^{- 19} J\end{matrix} ) = 167.76 kJ \text{/} mole \qquad ( 19.36 )$$

This agrees well with the experimental lattice [10] energy of

E_{D}=159.3 kJ/mole (19.37)

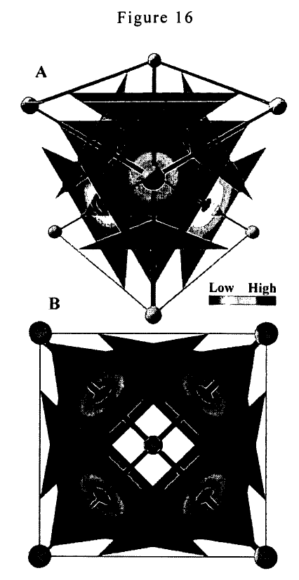

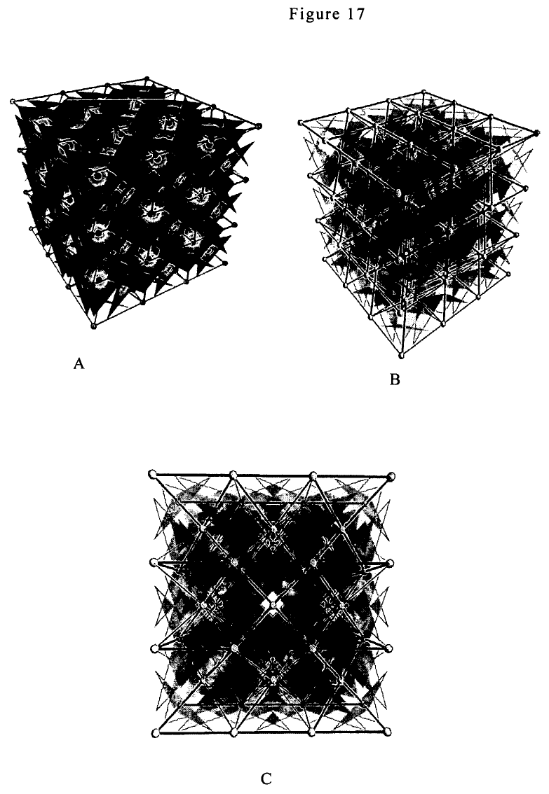

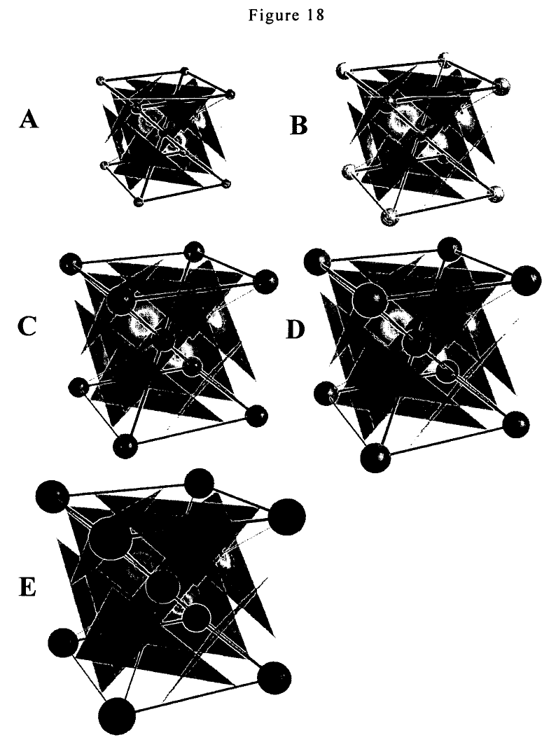

and confirms that Li metal comprises a precise packing of discrete ions, Li⁺ and e⁻. Using the Li—Li and Li⁺−e⁻ distances and the calculated (Eq. (7.35)) Li⁺ ionic radius of 0.35566a₀=0.18821 Å, the crystalline lattice structure of the unit cell of Li metal is shown in FIG. 16, a portion of the crystalline lattice of Li metal is shown in FIG. 17, and the Li unit cell is shown relative to the other alkali metals in FIG. 18.

### Sodium Metal

For Na⁺, there are two indistinguishable spin-paired electrons in an orbitsphere with radii rᵢ and r₂ both given by Eq. (7.35) (Eq. (10.51)), two indistinguishable spin-paired electrons in an orbitsphere with radii r₃ and r₄ both given by Eq. (10.62), and three sets of paired electrons in an orbitsphere at r₁₀ given by Eq. (10.212). For Z=11, the next electron which binds to contribute to the metal electron membrane to form the metal bond is attracted by the central Coulomb field and is repelled by diamagnetic forces due to the 3 sets of spin-paired inner electrons.

In addition to the spin-spin interaction between electron pairs, the three sets of 2p electrons are orbitally paired. The metal electron of the sodium atom produces a magnetic field at the position of the three sets of spin-paired 2p electrons. In order for the electrons to remain spin and orbitally paired, a corresponding diamagnetic force, F_{diamagnetic 3}, on electron eleven from the three sets of spin-paired electrons follows from Eqs. (10.83-10.84) and (10.220):

$${F}_{diamagnetic 3} = - \frac{1}{Z} \frac{10 {ℏ}^{2}}{{m}_{e} {d}^{3}} \sqrt{s ( s + 1 )} {i}_{z} \qquad ( 19.38 )$$

corresponding to the pₓ and p_{y} electrons with no spin-orbit coupling of the orthogonal p_{z} electrons (Eq. (10.84)). The outward centrifugal force on electron 11 is balanced by the electric force and the magnetic forces (on electron 11). The radius of the outer electron is calculated by equating the outward centrifugal force (Eq. (19.29)) to the sum of the electric (Eq. (19.28)) and diamagnetic (Eqs. (19.30) and (19.38)) forces as follows:

$$\begin{matrix}\frac{8}{3} \frac{{ℏ}^{2}}{{m}_{e} {d}^{3}} = \frac{{e}^{2}}{4 {πɛ}_{0} {d}^{2}} - \frac{{ℏ}^{2}}{{Zm}_{e} {d}^{3}} \sqrt{\frac{3}{4}} - \frac{1}{Z} \frac{10 {ℏ}^{2}}{{m}_{e} {d}^{3}} \sqrt{\frac{3}{4}} & ( 19.39 ) \\ d = ( \frac{8}{3} + \frac{11 \sqrt{\frac{3}{4}}}{11} ) {a}_{0} = 3.53269 {a}_{0} = 1.86942 \times {10}^{- 10} m \\ where Z = 11 and s = \frac{1}{2} . & ( 19.40 )\end{matrix}$$

Using Eq. (19.26), the lattice parameter a is

a=8.15840a₀=4.31724×10⁻¹⁰ m (19.41)

The experimental lattice parameter a [7] is

a=8.10806a₀=4.2906×10⁻¹⁰ m (19.42)

The calculated Na—Na distance is in good agreement with the experimental distance.

Using Eq. (19.27) and the experimental binding energy of sodium, BE(Na)=5.13908 eV=8.23371×10⁻¹⁹ J [9], the molar metal bond energy E_{D} is

$${E}_{D} = N ( \begin{matrix}\frac{{e}^{2}}{4 {πɛ}_{0} 1.86942 \times {10}^{- 10} m} - \\ \frac{4}{3} ( \frac{1}{2} \frac{{ℏ}^{2}}{{{m}_{e} ( 1.86942 \times {10}^{- 10} m )}^{2}} ) - 8.23371 \times {10}^{- 19} J\end{matrix} ) = 107.10 kJ \text{/} mole$$

This agrees well with the experimental lattice [10] energy of

E_{D}=107.5 kJ/mole (19.44)

and confirms that Na metal comprises a precise packing of discrete ions, Na⁺ and e⁻. Using the Na—Na and Na⁺ −e⁻ distances and the calculated (Eq. (10.212)) Na⁺ ionic radius of 0.56094a₀=0.29684 Å, the crystalline lattice structure of Na metal is shown in FIG. 18B.

### Potassium Metal

For K₊, there are two indistinguishable spin-paired electrons in an orbitsphere with radii r₁ and r₂ both given by Eq. (7.35) (Eq. (10.51)), two indistinguishable spin-paired electrons in an orbitsphere with radii r₃ and r₄ both given by Eq. (10.62), three sets of paired electrons in an orbitsphere at r₁₀, given by Eq. (10.212), two indistinguishable spin-paired electrons in an orbitsphere with radii r₁₁ and r₁₂ both given by Eq. (10.255), and three sets of paired electrons in an orbitsphere with radius r₁₈ given by Eq. (10.399). With Z=19, the next electron which binds to contribute to the metal electron membrane to form the metal bond is attracted by the central Coulomb field and is repelled by diamagnetic forces due to the 3 sets of spin-paired inner 3p electrons.

The spherically symmetrical closed 3p shell of nineteen-electron atoms produces a diamagnetic force, F_{diamagnetic}, that is equivalent to that of a closed s shell given by Eq. (10.11) with the appropriate radii. The inner electrons remain at their initial radii, but cause a diamagnetic force according to Lenz's law that is

$${F}_{diamagnetic} = - \frac{{ℏ}^{2}}{4 {m}_{e} {d}^{2} {r}_{18}} \sqrt{s ( s + 1 )} {i}_{z} \qquad ( 19.45 )$$

The diamagnetic force, F_{diamagnetic 3}, on electron nineteen from the three sets of spin-paired electrons given by Eq. (10.409) is

$${F}_{diamagnetic 3} = - \frac{1}{Z} \frac{12 ℏ}{{m}_{e} {d}^{3}} \sqrt{s ( s + 1 )} {i}_{z} \qquad ( 19.46 )$$

corresponding to the 3 pₓ, p_{y}, and p_{z}, electrons.

The outward centrifugal force on electron 19 is balanced by the electric force and the magnetic forces (on electron 19). The radius of the outer electron is calculated by equating the outward centrifugal force (Eq. (19.29)) to the sum of the electric (Eq. (19.28)) and diamagnetic (Eqs. (19.30), (19.45), and (19.46)) forces as follows:

$$\begin{matrix}\frac{8}{3} \frac{{ℏ}^{2}}{{m}_{e} {d}^{3}} = \frac{{e}^{2}}{4 π {ɛ}_{0} {d}^{2}} - \frac{{ℏ}^{2}}{{Zm}_{e} {d}^{3}} \sqrt{\frac{3}{4}} - \frac{1}{Z} \frac{12 {ℏ}^{2}}{{m}_{e} {d}^{3}} \sqrt{\frac{3}{4}} - \frac{{ℏ}^{2}}{4 {m}_{e} {d}^{2} {r}_{18}} \sqrt{\frac{3}{4}} where s = \frac{1}{2} . & ( 19.47 ) \\ d = \frac{{a}_{0} ( \frac{8}{3} + \frac{13}{Z} \sqrt{\frac{3}{4}} )}{( Z - 18 ) - \frac{\sqrt{\frac{3}{4}}}{4 \frac{{r}_{18}}{{a}_{0}}}} = \frac{{a}_{0} ( \frac{8}{3} + \frac{13}{19} \sqrt{\frac{3}{4}} )}{1 - \frac{\sqrt{\frac{3}{4}}}{4 \frac{{r}_{18}}{{a}_{0}}}} & ( 19.48 )\end{matrix}$$

### Substitution of

$$\frac{{r}_{18}}{{a}_{0}} = 0.85215$$

(Eq. (10.399) with Z=19) into Eq. (19.48) gives

d=4.36934a₀=2.31215×10⁻¹⁰ m (19.49)

Using Eq. (19.26), the lattice parameter a is

a=10.09055a₀=5.33969×10⁻¹ m (19.50)

The experimental lattice parameter a [7] is

a=10.05524a₀=5.321×10⁻¹⁰ m (19.51)

The calculated K—K distance is in good agreement with the experimental distance.

Using Eq. (19.27) and the experimental binding energy of potassium, BE(K)=4.34066 eV=6.9545×10⁻¹⁹ J [9], the molar metal bond energy E_{D} is

$${E}_{D} = N ( \begin{matrix}\frac{{e}^{2}}{4 {πɛ}_{0} 2.31215 \times {10}^{- 10} m} - \\ \frac{4}{3} ( \frac{1}{2} \frac{{ℏ}^{2}}{{{m}_{e} ( 2.31215 \times {10}^{- 10} m )}^{2}} ) - \\ 6.9545 \times {10}^{- 19} J\end{matrix} ) = 90.40 kJ \text{/} mole$$

This agrees well with the experimental lattice [10] energy of

E_{D}=89 kJ/mole (19.53)

and confirms that K metal comprises a precise packing of discrete ions, K⁺ and e⁻. Using the K—K and K⁺ −e⁻ distances and the calculated (Eq. (10.399)) K⁺ ionic radius of 0.85215a₀=0.45094 Å, the crystalline lattice structure of K metal is shown in FIG. 18C.

### Rubidium and Cesium Metals

Rubidium and cesium provide further examples of the nature of the bonding in alkali metals. The distance d between each metal ion M⁺ and the corresponding electron membrane is calculated from the experimental parameter a, and then the molar metal bond energy E_{D} is calculated using Eq. (19.27).

The experimental lattice parameter a [7] for rubidium is

a=10.78089a₀=5.705×10⁻¹⁰ m (19.54)

Using Eq. (19.25), the lattice parameter d is

d=4.66826a₀=2.47034×10⁻¹⁰ m (19.55)

Using Eqs. (19.27) and (19.55) and the experimental binding energy of rubidium, BE(Rb)=4.17713 eV=6.6925×10⁻¹⁹ J [9], the molar metal bond energy E_{D} is

$${E}_{D} = N ( \begin{matrix}\frac{{e}^{2}}{4 {πɛ}_{0} 2.47034 \times {10}^{- 10} m} - \\ \frac{4}{3} ( \frac{1}{2} \frac{{ℏ}^{2}}{{{m}_{e} ( 2.47034 \times {10}^{- 10} m )}^{2}} ) - \\ 6.6925 \times {10}^{- 19} J\end{matrix} ) = 79.06 kJ \text{/} mole \qquad ( 19.56 )$$

This agrees well with the experimental lattice [10] energy of

E_{D}=80.9 kJ/mole (19.57)

and confirms that Rb metal comprises a precise packing of discrete ions, Rb⁺ and e⁻. Using the Rb—Rb and Rb⁺-e⁻ distances and the Rb⁺ ionic radius of 0.52766 Å calculated using Eq. (10.102) and the experimental ionization energy of Rb⁺, 27.2895 eV [9], the crystalline lattice structure of Rb metal is shown in FIG. 18D.

The experimental lattice parameter a [7] for cesium is

a=11.60481a₀=6.141×10⁻¹⁰ m (19.58)

Using Eq. (19.25), the lattice parameter d is

d=5.02503a₀=2.65913×10⁻¹⁰ m (19.59)

Using Eqs. (19.27) and (19.59) and the experimental binding energy of cesium, BE(Cs)=3.8939 eV=6.23872×10⁻¹⁹ J [9], the molar metal bond energy E_{D} is

$${E}_{D} = N ( \begin{matrix}\frac{{e}^{2}}{4 {πɛ}_{0} 2.65913 \times {10}^{- 10} m} - \\ \frac{4}{3} ( \frac{1}{2} \frac{{ℏ}^{2}}{{{m}_{e} ( 2.65913 \times {10}^{- 10} m )}^{2}} ) - \\ 6.23872 \times {10}^{- 19} J\end{matrix} ) = 77.46 kJ \text{/} mole$$

This agrees well with the experimental lattice [10] energy of

E_{D}=76.5 kJ/mole (19.61)

and confirms that Cs metal comprises a precise packing of discrete ions, Cs⁺ and e⁻. Using the Cs—Cs and Cs⁺−e⁻ distances and the Cs⁺ ionic radius of 0.62182 Å calculated using Eq. (10.102) and the experimental ionization energy of Cs⁺, 23.15744 eV [9], the crystalline lattice structure of Cs metal is shown in FIG. 18E.

Other metals can be solved in a similar manner. Iron, for example, is also a body-centered cubic lattice, and the solution of the lattice spacing and energies are given by Eqs. (19.21-19.30). The parameter d is given by the iron force balance which has a corresponding form to those of alkali metals such as that of lithium given by Eqs. (19.32-19.35). In addition, the changes in radius and energy of the second 4s electron due to the ionization of the first of the two 4s electrons to the metal band is calculated in the similar manner as those of the atoms of diatomic molecules such as N₂ given by Eqs. (19.621-19.632). This energy term is added to those of Eq. (19.27) to give the molar metal bond energy E_{D}.

### Physical Implications of the Nature of Free Electrons in Metals

The extension of the free-electron membrane throughout the crystalline lattice is the reason for the high thermal and electrical conductivity of metals. Electricity can be conduced on the extended electron membranes by the application of an electron field and a connection with a source of electrons to maintain current continuity. Heat can be transferred by radiation or by collisions, or by infrared-radiation-induced currents propagated through the crystal. The surface luster and opacity is due to the reflection of electromagnetic radiation by mirror currents on the surfaces of the free-planar electron membranes. Ductility and malleability result from the feature that the field lines of a given ion end on the induced electron surface charge of the planar, perfectly conducting electron membrane. Thus, layers of the metal lattice can slide over each other without juxtaposing charges of the same sign which causes ionic crystals to fracture.

The electrons in metals have surface-charge distributions that are merely equivalent to the image charges of the ions. When there is vibration of the ions, the thermal electron kinetic energy can be directed through channels of least resistance from collisions. The resulting kinetic energy distribution over the population of electrons can be modeled using Fermi Dirac statistics wherein the specific heat of a metal is dominated by the motion of the ions since the electrons behave as image charges. Based on the physical solution of the nature of the metallic bond, the small electron contribution to the specific heat of a metal is predicted to be proportional to the ratio of the temperature to the electron kinetic energy [11]. Based on Fermi-Dirac statistics, the electron contribution to the specific heat of a metal given by Eq. (23.68) is

$${C}_{Ve} = \frac{{π}^{2}}{2} ( \frac{kT}{{ɛ}_{F}} ) R \qquad ( 19.62 )$$

Now that the true structure of metals has been solved, it is interesting to relate the Fermi energy to the electron kinetic energy. The relationships between the electron velocity, the de Broglie wavelength, and the lattice spacing used calculate the Fermi energy in the Electron-Energy Distribution section are also used in the kinetic energy derivation. The Fermi energy given by Eq. (23.61) is

$${ɛ}_{F} = \frac{{h}^{2}}{2 m} {( \frac{3 N}{8 π V} )}^{2 / 3} = \frac{{h}^{2}}{2 {m}_{e}} {( \frac{3}{8 π} )}^{2 / 3} {n}^{2 / 3} \qquad ( 19.63 )$$

where the electron density parameter for alkali metals is two electrons per body-centered cubic cell of lattice spacing a. Since in the physical model, the field lines of two mirror-image ions M⁺ end on opposite sides per section of the two-dimensional electron membrane, the kinetic energy equivalent to the Fermi energy is twice that given by Eq. (19.24). Then, the ratio R_{ε}_{_{F}}_{/T} of the Fermi energy to the kinetic energy provides a comparison of the statistical model to the solution of the nature of the metallic bond in the determination of electron contribution to the specific heat:

$$\begin{matrix}{R}_{{ɛ}_{F} / T} = \frac{{ɛ}_{F}}{T} \\ = \frac{\frac{{h}^{2}}{2 {m}_{e}} {( \frac{3}{8 π} )}^{2 / 3} {n}^{2 / 3}}{\frac{8}{3} ( \frac{1}{2} \frac{{ℏ}^{2}}{{m}_{e} {d}^{2}} )} = \frac{\frac{{h}^{2}}{2 {m}_{e}} {( \frac{3}{8 π} )}^{2 / 3} {( \frac{2}{{a}^{3}} )}^{2 / 3}}{\frac{8}{3} ( \frac{1}{2} \frac{{ℏ}^{2}}{{m}_{e} {d}^{2}} )} \\ = \frac{\frac{{h}^{2}}{2 {m}_{e}} {( \frac{3}{8 π} )}^{2 / 3} {( \frac{2}{{( \frac{4 d}{\sqrt{3}} )}^{3}} )}^{2 / 3}}{( \frac{8}{3} ) {( \frac{1}{2 π} )}^{2} ( \frac{{h}^{2}}{2 {m}_{e} {d}^{2}} )} = 1.068\end{matrix} \qquad ( 19.64 )$$

where Eq. (19.26) was used to convert the parameter a to d.

From the physical nature of the current, the electrical and thermal conductivities corresponding to the currents can be determined. The electrical current is classically given by

$$i = e ν = σ \frac{{ɛ}_{F}}{he} \qquad ( 19.65 )$$

where the energy and angular momentum of the conduction electrons are quantized according to and Planck's equation (Eq. (4.8)), respectively. From Eq. (19.65), the electrical conductivity is given by

$$σ = \frac{{e}^{2} h ν}{{ɛ}_{F}} \qquad ( 19.66 )$$

where v is the frequency of the unit current carried by each electron. The thermal current is also carried by the kinetic energy of the electron plane waves. Since there are two degrees of freedom in the plane of each electron rather than three, the thermal conductivity κ is given by

$$κ = \frac{2}{3} \frac{{C}_{Ve}}{{N}_{0} h} = \frac{{π}^{2}}{3} ( \frac{{k}_{B}^{2} T}{{ɛ}_{F} / h} ) \qquad ( 19.67 )$$

The Wiedemann-Franz law gives the relationship of the thermal conductivity κ to the electrical conductivity σ and absolute temperature T. Thus, using Eqs. (19.66-19.67), the constant L₀ is given by

$${L}_{0} = \frac{κ}{σ T} = \frac{\frac{{π}^{2}}{3} ( \frac{{hk}_{B}^{2}}{{ɛ}_{F}} )}{\frac{{he}^{2}}{{ɛ}_{F}}} = \frac{{π}^{2}}{3} {( \frac{{k}_{B}}{e} )}^{2} \qquad ( 19.68 )$$

From Eqs. (19.64) and (19.68), the statistical model is reasonably close to the physical model to be useful in modeling the specific-heat contribution of electrons in metals based on their inventory of thermal energy and the thermal-energy distribution in the crystal. However, the correct physical nature of the current carriers comprising two-dimensional electron planes is required in cases where the simplistic statistical model fails as in the case of the anisotropic violation of the Wiedemann-Franz law [12-13].

Semiconductors comprise covalent bonds wherein the electrons are of sufficiently high energy that excitation creates an ion and a free electron. The free electron forms a membrane as in the case of metals. This membrane has the same planar structure throughout the crystal. This feature accounts for the high conductivity of semiconductors when the electrons are excited by the application of external fields or electromagnetic energy that causes ion-pair (M⁺-e⁻) formation.

Superconductors comprise free-electron membranes wherein current flows in a reduced dimensionality of two or one dimensions with the bonding being covalent along the remaining directions such that electron scattering from other planes does not interfere with the current flow. In addition, the spacing of the electrons along the membrane is such that the energy is band-passed with respect to magnetic interactions of conducting electrons as given in the superconductivity section.

### REFERENCES

1. J. D. Jackson, Classical Electrodynamics, Second Edition, John Wiley & Sons, New York, (1975), pp. 17-22.
2. H. A. Haus, J. R. Melcher, “Electromagnetic Fields and Energy”, Department of Electrical Engineering and Computer Science, Massachusetts Institute of Technology, (1985), Sec. 5.3.
3. J. A. Stratton, Electromagnetic Theory, McGraw-Hill Book Company, (1941), p. 195.
4. D. R. Lide, CRC Handbook of Chemistry and Physics, 86th Edition, CRC Press, Taylor & Francis, Boca Raton, (2005-6), p. A-23.
5. J. A. Kong, Electromagnetic Wave Theory, Second Edition, John Wiley & Sons, Inc., New York, (1990), pp. 330-331.
6. A. Beiser, Concepts of Modern Physics, Fourth Edition, McGraw-Hill, New York, (1987), p. 372.
7. D. R. Lide, CRC Handbook of Chemistry and Physics, 86th Edition, CRC Press, Taylor & Francis, Boca Raton, (2005-6), pp. 12-15 to 12-18.
8. A. K. Cheetham, P. Day, Editors, Solid State Chemistry Techniques, Clarendon Press, Oxford, (1987), pp. 52-57.
9. D. R. Lide, CRC Handbook of Chemistry and Physics, 86th Edition, CRC Press, Taylor & Francis, Boca Raton, (2005-6), pp. 10-202 to 10-204.
10. D. R. Lide, CRC Handbook of Chemistry and Physics, 86th Edition, CRC Press, Taylor & Francis, Boca Raton, (2005-6), pp. 5-4 to 5-18.
11. E. C. Stoner, “Collective electron specific heat and spin paramagnetism in metals”, Proceedings of the Royal Society of London. Series A, Mathematical and Physical Sciences, Vol. 154, No. 883 (May 1, 1936), pp. 656-678.
12. M. A. Tanatar, J. Paglione, C. Petrovic, L. Taillefer, “Anisotropic violation of the Wiedemann-Franz law at a quantum critical point,” Science, Vol. 316, (2007), pp. 1320-1322.
13. P. Coleman, “Watching electrons break up,” Science, Vol. 316, (2007), pp. 1290-1291.

### Silicon Molecular Functional Groups and Molecules

### General Considerations of the Silicon Molecular Bond

Silane molecules comprising an arbitrary number of atoms can be solved using similar principles and procedures as those used to solve organic molecules of arbitrary length and complexity. Silanes can be considered to be comprised of functional groups such as SiH₃, SiH₂, SiH, Si—Si, and C—Si. The solutions of these functional groups or any others corresponding to the particular silane can be conveniently obtained by using generalized forms of the force balance equation given in the Force Balance of the σ MO of the Carbon Nitride Radical section for molecules comprised of silicon and hydrogen only and the geometrical and energy equations given in the Derivation of the General Geometrical and Energy Equations of Organic Chemistry section for silanes further comprised of heteroatoms such as carbon. The appropriate functional groups with the their geometrical parameters and energies can be added as a linear sum to give the solution of any silane.

### Silanes (SiₙH₂ₙ₊₂)

As in the case of carbon, the bonding in the silicon atom involves four sp³ hybridized orbitals formed from the 3p and 3s electrons of the outer shells. Si—Si and Si—H bonds form between Si3sp³ HOs and between a Si3sp³ HO and a H1s AO to yield silanes. The geometrical parameters of each Si—Si and SiHₙ₌₁₂₃ functional group is solved from the force balance equation of the electrons of the corresponding σ-MO and the relationships between the prolate spheroidal axes. Then, the sum of the energies of the H₂-type ellipsoidal MOs is matched to that of the Si3sp³ shell as in the case of the corresponding carbon molecules. As in the case of ethane given in the Ethane Molecule section, the energy of the Si—Si functional group is determined for the effect of the donation of 25% electron density from the each participating Si3sp³ HO to the Si—Si-bond MO.

The energy of silicon is less than the Coulombic energy between the electron and proton of H given by Eq. (1.243). A minimum energy is achieved while matching the potential, kinetic, and orbital energy relationships given in the Hydroxyl Radical (OH) section with the donation of 75% electron density from the participating Si3sp³ HO to each Si—H-bond MO. As in the case of acetylene given in the Acetylene Molecule section, the energy of each Si—Hₙ functional group is determined for the effect of the charge donation.

The 3sp³ hybridized orbital arrangement after Eq. (13.422) is

$$\begin{matrix}3 {sp}^{3} state \\ \frac{↑}{0 , 0} \frac{↑}{1 , - 1} \frac{↑}{1 , 0} \frac{↑}{1 , 1}\end{matrix} \qquad ( 20.1 )$$

where the quantum numbers (l, mₜ) are below each electron. The total energy of the state is given by the sum over the four electrons. The sum E_{T}(Si 3sp³) of experimental energies [1] of Si, Si⁺, Si²⁺, and Si³⁺ is

$$\begin{matrix}{E}_{T} ( Si , 3 {sp}^{3} ) = 45.14181 eV + 33.49302 eV + 8.15168 eV \\ = 103.13235 eV\end{matrix} \qquad ( 20.2 )$$

By considering that the central field decreases by an integer for each successive electron of the shell, the radius r₃ₛₚ_{³} of the Si3sp³ shell may be calculated from the Coulombic energy using Eq. (15.13):

$$\begin{matrix}{r}_{3 {sp}^{3}} = {\sum }_{n = 10}^{13} \frac{( Z - n ) {e}^{2}}{8 {πɛ}_{0} ( e 103.13235 eV )} \\ = \frac{10 {e}^{2}}{8 {πɛ}_{0} ( e 103.13235 eV )} \\ = 1.31926 {a}_{0}\end{matrix} \qquad ( 20.3 )$$

where Z=14 for silicon. Using Eq. (15.14), the Coulombic energy E_{Coulomb}(Si,3sp³) of the outer electron of the Si3sp³ shell is

$$\begin{matrix}{E}_{Coulomb} ( Si , 3 {sp}^{3} ) = \frac{- {e}^{2}}{8 {πɛ}_{0} {r}_{3 {sp}^{3}}} \\ = \frac{- {e}^{2}}{8 {πɛ}_{0} 1.31926 {a}_{0}} \\ = - 10.31324 eV\end{matrix} \qquad ( 20.4 )$$

During hybridization, one of the spin-paired 3s electrons is promoted to Si3sp³ shell as an unpaired electron. The energy for the promotion is the magnetic energy given by Eq. (15.15) at the initial radius of the 3s electrons. From Eq. (10.255) with Z=14, the radius rᵤ of Si3s shell is

r₁₂=1.25155a₀ (20.5)

Using Eqs. (15.15) and (20.5), the unpairing energy is

$$E ( magnetic ) = \frac{2 {πμ}_{0} {e}^{2} {ℏ}^{2}}{{{m}_{e}^{2} ( {r}_{12} )}^{3}} = \frac{8 {πμ}_{o} {μ}_{B}^{2}}{{( 1.25155 {a}_{0} )}^{3}} = 0.05836 eV \qquad ( 20.6 )$$

Using Eqs. (20.4) and (20.6), the energy E(Si,3sp³) of the outer electron of the Si3sp³ shell is

$$\begin{matrix}E ( Si , 3 {sp}^{3} ) = \frac{- {e}^{2}}{8 {πɛ}_{0} {r}_{3 {sp}^{3}}} + \frac{2 {πμ}_{0} {e}^{2} {ℏ}^{2}}{{{m}_{e}^{2} ( {r}_{12} )}^{3}} \\ = 10.31324 e V + 0.05836 eV \\ = - 10.25487 eV\end{matrix} \qquad ( 20.7 )$$

Next, consider the formation of the Si—Si-bond MO of silanes wherein each silicon atom has a Si3sp³ electron with an energy given by Eq. (20.7). The total energy of the state of each silicon atom is given by the sum over the four electrons. The sum E_{T}(Siₛᵢₗₐₙₑ,3sp³) of energies of Si3sp³ (Eq. (20.7)), Si⁺, Si²⁺, and Si³⁺ is

$$\begin{matrix}{E}_{T} ( {Si}_{silane} , 3 {sp}^{3} ) = - ( \begin{matrix}45.14181 eV + 33.49302 eV + \\ 16.34584 eV + E ( Si , 3 {sp}^{3} )\end{matrix} ) \\ = - ( \begin{matrix}45.14181 eV + 33.39302 eV + \\ 16.34584 eV + 10.25487 eV\end{matrix} ) \\ = - 105.23554 eV\end{matrix} \qquad ( 20.8 )$$

where E(Si,3sp³) is the sum of the energy of Si, −8.15168 eV, and the hybridization energy.

The sharing of electrons between two Si3sp³ HOs to form a Si—Si-bond MO permits each participating orbital to decrease in size and energy. In order to further satisfy the potential, kinetic, and orbital energy relationships, each Si3sp³ HO donates an excess of 25% of its electron density to the Si—Si-bond MO to form an energy minimum. By considering this electron redistribution in the silane molecule as well as the fact that the central field decreases by an integer for each successive electron of the shell, the radius rₛᵢₗₐₙₑ₃ₛₚ_{³}, of the Si3sp³ shell may be calculated from the Coulombic energy using Eq. (15.18):

$$\begin{matrix}{r}_{silane 3 {sp}^{3}} = ( {\sum }_{n = 10}^{13} ( Z - n ) - 0.25 ) \frac{{e}^{2}}{8 {πɛ}_{0} ( e 105.23554 eV )} \\ = \frac{9.75 {e}^{2}}{8 {πɛ}_{0} ( e 105.23554 eV )} \\ = 1.26057 {a}_{0}\end{matrix} \qquad ( 20.9 )$$

Using Eqs. (15.19) and (20.9), the Coulombic energy E_{Coulomb}(Siₛᵢₗₐₙₑ,3sp³) of the outer electron of the Si3sp³ shell is

$$\begin{matrix}{E}_{Coulomb} ( {Si}_{silane} , 3 {sp}^{3} ) = \frac{- {e}^{2}}{8 {πɛ}_{0} {r}_{silane 3 {sp}^{3}}} \\ = \frac{- {e}^{2}}{8 {πɛ}_{0} 1.26057 {a}_{0}} \\ = - 10.79339 eV\end{matrix} \qquad ( 20.10 )$$

During hybridization, one of the spin-paired 3s electrons is promoted to Si3sp³ shell as an unpaired electron. The energy for the promotion is the magnetic energy given by Eq. (20.6). Using Eqs. (20.6) and (20.10), the energy E(Sₛᵢₗₐₙₑ,3sp³) of the outer electron of the Si3sp³ shell is

$$\begin{matrix}E ( {Si}_{silane} , 3 {sp}^{3} ) = \frac{- {e}^{2}}{8 {πɛ}_{0} {r}_{silane 3 {sp}^{3}}} + \frac{2 {πμ}_{0} {e}^{2} {ℏ}^{2}}{{{m}_{e}^{2} ( {r}_{12} )}^{3}} \\ = - 10.79339 eV + 0.05836 eV \\ = - 10.73503 eV\end{matrix} \qquad ( 20.11 )$$

Thus, E_{T}(Si—Si,3sp³), the energy change of each Si3sp³ shell with the formation of the Si—Si-bond MO is given by the difference between Eq. (20.11) and Eq. (20.7):

$$\begin{matrix}{E}_{T} ( Si - Si , 3 {sp}^{3} ) = E ( {Si}_{silane} , 3 {sp}^{3} ) - E ( Si , 3 {sp}^{3} ) \\ = - 10.73503 eV - ( - 10.25487 eV ) \\ = - 0.48015 eV\end{matrix} \qquad ( 20.12 )$$

Next, consider the formation of the Si—H-bond MO of silanes wherein each silicon atom contributes a Si3sp³ electron having the sum E_{T}(Siₛᵢₗₐₙₑ3sp³) of energies of Si3sp³ (Eq. (20.7)), Si⁺, Si²⁺, and Si³⁺ given by Eq. (20.8). Each Si—H-bond MO of each functional group SiHₙ₌₁₂₃ forms with the sharing of electrons between each Si3sp³ HO and each H1s AO. As in the case of C—H, the H₂-type ellipsoidal MO comprises 75% of the Si—H-bond MO according to Eq. (13.429). Furthermore, the donation of electron density from each Si3sp³ HO to each Si—H-bond MO permits the participating orbital to decrease in size and energy. In order to further satisfy the potential, kinetic, and orbital energy relationships, each Si3sp³ HO donates an excess of 75% of its electron density to the Si—H-bond MO to form an energy minimum. By considering this electron redistribution in the silane molecule as well as the fact that the central field decreases by an integer for each successive electron of the shell, the radius rₛᵢₗₐₙₑ₃ₛₚ_{³} of the Si3sp³ shell may be calculated from the Coulombic energy using Eq. (15.18):

$$\begin{matrix}{r}_{silane 3 {sp}^{3}} = ( {\sum }_{n = 10}^{13} ( Z - n ) - 0.75 ) \frac{{e}^{2}}{8 {πɛ}_{0} ( e 105.23554 eV )} \\ = \frac{9.25 {e}^{2}}{8 {πɛ}_{0} ( e 105.23554 eV )} \\ = 1.19592 {a}_{0}\end{matrix} \qquad ( 20.13 )$$

Using Eqs. (15.19) and (20.13), the Coulombic energy E_{Coulomb}(Siₛᵢₗₐₙₑ,3sp³) of the outer electron of the Si3sp³ shell is

$$\begin{matrix}{E}_{Coulomb} ( {Si}_{silane} , 3 {sp}^{3} ) = \frac{- {e}^{2}}{8 {πɛ}_{0} {r}_{silane 3 {sp}^{3}}} \\ = \frac{- {e}^{2}}{8 {πɛ}_{0} 1.19592 {a}_{0}} \\ = - 11.37682 eV\end{matrix} \qquad ( 20.14 )$$

During hybridization, one of the spin-paired 3s electrons is promoted to Si3sp³ shell as an unpaired electron. The energy for the promotion is the magnetic energy given by Eq. (20.6). Using Eqs. (20.6) and (20.14), the energy E(Siₛᵢₗₐₙₑ,3sp³) of the outer electron of the Si3sp3 shell is

$$\begin{matrix}E ( {Si}_{silane} , 3 {sp}^{3} ) = \frac{- {e}^{2}}{8 {πɛ}_{0} {r}_{silane 3 {sp}^{3}}} + \frac{2 {πμ}_{0} {e}^{2} {ℏ}^{2}}{{{m}_{e}^{2} ( {r}_{12} )}^{3}} ] \\ = - 11.37682 eV + 0.05836 eV \\ = - 11.31845 eV\end{matrix} \qquad ( 20.15 )$$

Thus, E_{T}(Si—H,3sp³), the energy change of each Si3sp³ shell with the formation of the Si—H-bond MO is given by the difference between Eq. (20.15) and Eq. (20.7):

$$\begin{matrix}{E}_{T} ( Si - H , 3 {sp}^{3} ) = E ( {Si}_{silane} , 3 {sp}^{3} ) - E ( Si , 3 {sp}^{3} ) \\ = - 11.31845 eV - ( - 10.25487 eV ) \\ = - 1.06358 eV\end{matrix} \qquad ( 20.16 )$$

Silane (SiH₄) involves only Si—H-bond MOs of equivalent tetrahedral structure to form a minimum energy surface involving a linear combination of all four hydrogen MOs. Here, the donation of electron density from the Si3sp³ HO to each Si—H-bond MO permits the participating orbital to decrease in size and energy as well. However, given the resulting continuous electron-density surface and the equivalent MOs, the Si3sp³ HO donates an excess of 100% of its electron density to the Si—H-bond MO to form an energy minimum. By considering this electron redistribution in the silane molecule as well as the fact that the central field decreases by an integer for each successive electron of the shell, the radius rₛᵢₗₐₙₑ₃ₛₚ_{³}, of the Si3sp³ shell may be calculated from the Coulombic energy using Eq. (15.18):

$$\begin{matrix}{r}_{silane 3 {sp}^{3}} = ( {\sum }_{n = 10}^{13} ( Z - n ) - 1 ) \frac{{e}^{2}}{8 {πɛ}_{0} ( e 105.23554 eV )} \\ = \frac{9 {e}^{2}}{8 {πɛ}_{0} ( e 105.23554 eV )} \\ = 1.16360 {a}_{0}\end{matrix} \qquad ( 20.17 )$$

Using Eqs. (15.19) and (20.17), the Coulombic energy E_{Coulomb}(Siₛᵢₗₐₙₑ,3sp³) of the outer electron of the Si3sp³ shell is

$$\begin{matrix}{E}_{Coulomb} ( {Si}_{silane} , 3 {sp}^{3} ) = \frac{- {e}^{2}}{8 {πɛ}_{0} {r}_{silane 3 {sp}^{3}}} \\ = \frac{- {e}^{2}}{8 {πɛ}_{0} 1.16360 {a}_{0}} \\ = - 11.69284 eV\end{matrix} \qquad ( 20.18 )$$

During hybridization, one of the spin-paired 3s electrons is promoted to Si3sp³ shell as an unpaired electron. The energy for the promotion is the magnetic energy given by Eq. (20.6). Using Eqs. (20.6) and (20.18), the energy E(Siₛᵢₗₐₙₑ,3sp³) of the outer electron of the Si3sp³ shell is

$$\begin{matrix}E ( {Si}_{silane} , 3 {sp}^{3} ) = \frac{- {e}^{2}}{8 {πɛ}_{0} {r}_{silane 3 {sp}^{3}}} + \frac{2 {πμ}_{0} {e}^{2} {ℏ}^{2}}{{{m}_{e}^{2} ( {r}_{12} )}^{3}} \\ = - 11.69284 eV + 0.05836 eV \\ = - 11.63448 eV\end{matrix} \qquad ( 20.19 )$$

Thus, E_{T}(Si—H,3sp³), the energy change of each Si3sp³ shell with the formation of the Si—H-bond MO is given by the difference between Eq. (20.19) and Eq. (20.7):

$$\begin{matrix}{E}_{T} ( Si - H , 3 {sp}^{3} ) = E ( {Si}_{silane} , 3 {sp}^{3} ) - E ( Si , 3 {sp}^{3} ) \\ = - 11.63448 eV - ( - 10.25487 eV ) \\ = - 1.37960 eV\end{matrix} \qquad ( 20.20 )$$

Consider next the radius of the HO due to the contribution of charge to more than one bond. The energy contribution due to the charge donation at each silicon atom superimposes linearly. In general, the radius rₘₒₗ₃ₛₚ_{₃} of the Si3sp³ HO of a silicon atom of a given silane molecule is calculated after Eq. (15.32) by considering ΣE_{T}_{ₘₒₗ}(MO,3sp³), the total energy donation to all bonds with which it participates in bonding. The general equation for the radius is given by

$$\begin{matrix}{r}_{mol 3 {sp}^{3}} = \frac{- {e}^{2}}{8 {πɛ}_{0} ( \begin{matrix}{E}_{Coulomb} ( Si , 3 {sp}^{3} ) + \\ \sum {E}_{{T}_{mol}} ( MO , 3 {sp}^{3} )\end{matrix} )} \\ = \frac{{e}^{2}}{8 {πɛ}_{0} ( \begin{matrix}e 10.31324 eV + \\ \sum \vert {E}_{{T}_{mol}} ( MO , 3 {sp}^{3} ) \vert\end{matrix} )}\end{matrix} \qquad ( 20.21 )$$

where E_{Coulomb}(Si,3sp³) is given by Eq. (20.4). The Coulombic energy E_{Coulomb}(Si,3sp³) of the outer electron of the Si 3sp³ shell considering the charge donation to all participating bonds is given by Eq. (15.14) with Eq. (20.4). The energy E(Si,3sp³) of the outer electron of the Si 3sp³ shell is given by the sum of E_{Coulomb}(Si,3sp³) and E(magnetic) (Eq. (20.6)). The final values of the radius of the Si3sp³ HO, r₃ₛₚ_{³}, E_{Coulomb}(Si,3sp³), and E(Siₛᵢₗₐₙₑ3sp³) calculated using ΣE_{T}_{ₘₒₗ} (MO,3sp³), the total energy donation to each bond with which an atom participates in bonding are given in Table 20.1. These hybridization parameters are used in Eqs. (15.88-15.117) for the determination of bond angles given in Table 20.7 (as shown in the priority document).

TABLE 20.1
Hybridization parameters of atoms for determination of bond angles with final
values of r₃ₛₚ_{³}, E_{Coulomb} (Si, 3sp³), and E(Siₛᵢₗₐₙₑ 3SP³) calculated
using the appropriate values of ΣE_{T}_{ₘₒₗ} (MO, 3sp³) (E_{T}_{ₘₒₗ} (MO, 3sp³)
designated as E_{T}) for each corresponding terminal bond spanning each angle.

| Atom | | | | | | | E_{Coulomb} (Si, 3sp³) | E(Si, 3sp³) |
|---|---|---|---|---|---|---|---|---|
| Hybridization | | | | | | r₃ₛₚ_{³} | (eV) | (eV) |
| Designation | E_{T} | E_{T} | E_{T} | E_{T} | E_{T} | Final | Final | Final |
| 1 | 0 | 0 | 0 | 0 | 0 | 1.31926 | −10.31324 | −10.25487 |
| 2 | −0.48015 | 0 | 0 | 0 | 0 | 1.26057 | −10.79339 | −10.73503 |

The MO semimajor axis of each functional group of silanes is determined from the force balance equation of the centrifugal, Coulombic, and magnetic forces as given in the Polyatomic Molecular Ions and Molecules section and the More Polyatomic Molecules and Hydrocarbons section. The distance from the origin of the H₂-type-ellipsoidal-MO to each focus c′, the internuclear distance 2c′, and the length of the semiminor axis of the prolate spheroidal H₂-type MO b=c are solved from the semimajor axis a. Then, the geometric and energy parameters of the MO are calculated using Eqs. (15.1-15.117).

The force balance of the centrifugal force equated to the Coulombic and magnetic forces is solved for the length of the semimajor axis. The Coulombic force on the pairing electron of the MO is

$${F}_{Coulomb} = \frac{{e}^{2}}{8 {πɛ}_{0} {ab}^{2}} {Di}_{ξ} \qquad ( 20.22 )$$

The spin pairing force is

$${F}_{spin - pairing} = \frac{{ℏ}^{2}}{2 {m}_{e} {a}^{2} {b}^{2}} {Di}_{ξ} \qquad ( 20.23 )$$

The diamagnetic force is:

$${F}_{diamagneticMO 1} = - \frac{{n}_{e} {ℏ}^{2}}{4 {m}_{e} {a}^{2} {b}^{2}} {Di}_{ξ} \qquad ( 20.24 )$$

where nₑ is the total number of electrons that interact with the binding σ-MO electron. The diamagnetic force F_{diamagneticMO2} on the pairing electron of the σ MO is given by the sum of the contributions over the components of angular momentum:

$${F}_{diamagneticMO 2} = - {\sum }_{i , j} \frac{\vert {L}_{i} \vert ℏ}{{Z}_{j} 2 {m}_{e} {a}^{2} {b}^{2}} {Di}_{ξ} \qquad ( 20.25 )$$

where |L| is the magnitude of the angular momentum of each atom at a focus that is the source of the diamagnetism at the σ-MO. The centrifugal force is

$${F}_{centrifugalMO} = - \frac{{ℏ}^{2}}{{m}_{e} {a}^{2} {b}^{2}} {Di}_{ξ} \qquad ( 20.26 )$$

The force balance equation for the σ-MO of the Si—Si-bond MO with nₑ=3 and

$$\vert L \vert = 4 \sqrt{\frac{3}{4}} ℏ$$

corresponding to four electrons of the Si3sp³ shell is

$$\begin{matrix}\frac{{ℏ}^{2}}{{m}_{e} {a}^{2} {b}^{2}} D = \frac{{e}^{2}}{8 {πɛ}_{0} {ab}^{2}} D + \frac{{ℏ}^{2}}{2 {m}_{e} {a}^{2} {b}^{2}} D - ( \frac{3}{2} + \frac{4 \sqrt{\frac{3}{4}}}{Z} ) \frac{{ℏ}^{2}}{2 {m}_{e} {a}^{2} {b}^{2}} D & ( 20.27 ) \\ a = ( \frac{5}{2} + \frac{4 \sqrt{\frac{3}{4}}}{Z} ) {a}_{0} & ( 20.28 )\end{matrix}$$

With Z=14, the semimajor axis of the Si—Si-bond MO is

a=2.74744a₀ (20.29)

The force balance equation for each σ-MO of the Si—H-bond MO with nₑ=2 and

$$\vert L \vert = 4 \sqrt{\frac{3}{4}} ℏ$$

corresponding to four electrons of the Si3sp³ shell is

$$\begin{matrix}\frac{{ℏ}^{2}}{{m}_{e} {a}^{2} {b}^{2}} D = \frac{{e}^{2}}{8 {πɛ}_{0} {ab}^{2}} D + \frac{{ℏ}^{2}}{2 {m}_{e} {a}^{2} {b}^{2}} D - ( 1 + \frac{4 \sqrt{\frac{3}{4}}}{Z} ) \frac{{ℏ}^{2}}{2 {m}_{e} {a}^{2} {b}^{2}} D & ( 20.30 ) \\ a = ( 2 + \frac{4 \sqrt{\frac{3}{4}}}{Z} ) {a}_{0} & ( 20.31 )\end{matrix}$$

With Z=14, the semimajor axis of the Si—H-bond MO is

a=2.24744a₀ (20.32)

Using the semimajor axis, the geometric and energy parameters of the MO are calculated using Eqs. (15.1-15.117) in the same manner as the organic functional groups given in the Organic Molecular Functional Groups and Molecules section. For the Si—Si functional group, the Si3sp³ HOs are equivalent; thus, c₁=1 in both the geometry relationships (Eqs. (15.2-15.5)) and the energy equation (Eq. (15.61)). In order for the bridging MO to intersect the Si3sp³ HOs while matching the potential, kinetic, and orbital energy relationships given in the Hydroxyl Radical (OH) section, for the Si—Si functional group,

$${C}_{1} = \frac{0.75}{2}$$

in both the geometry relationships (Eqs. (15.2-15.5)) and the energy equation (Eq. (15.61)). This is the same value as C₁ of the chlorine molecule given in the corresponding section. The hybridization factor gives the parameters c₂ and C₂ for both as well. To meet the equipotential condition of the union of the two Si3sp³ HOs, c₂ and C₂ of Eqs. (15.2-15.5) and Eq. (15.61) for the Si—Si-bond MO is given by Eq. (15.72) as the ratio of 10.31324 eV, the magnitude of E_{Coulomb}(Siₛᵢₗₐₙₑ,3sp³) (Eq. (20.4)), and 13.605804 eV, the magnitude of the Coulombic energy between the electron and proton of H (Eq. (1.243)):

$$\begin{matrix}{C}_{2} ( silane Si 3 {sp}^{3} HO ) = {c}_{2} ( silane Si 3 {sp}^{3} HO ) \\ = \frac{10.31324 eV}{13.605804 eV} \\ = 0.75800\end{matrix} \qquad ( 20.33 )$$

The energy of the MO is matched to that of the Si3sp³ HO such that E(AO/HO) is E(Si,3sp³) given by Eq. (20.7) and E_{T}(atom−atom,msp³.AO) is two times E_{T}(Si—Si,3sp³) given by Eq. (20.12).

For the Si—H-bond MO of the SiHₙ₌₁₂₃ functional groups, c₁ is one and C₁=0.75 based on the orbital composition as in the case of the C—H-bond MO. In silanes, the energy of silicon is less than the Coulombic energy between the electron and proton of H given by Eq. (1.243). Thus, c₂ in Eq. (15.61) is also one, and the energy matching condition is determined by the C₂ parameter, the hybridization factor for the Si—H-bond MO given by Eq. (20.33). Since the energy of the MO is matched to that of the Si3sp³ HO, E(AO/HO) is E(Si,3sp³) given by Eq. (20.7) and E_{T}(atom−atom,msp³.AO) is E_{T}(Si—H,3sp³) given by Eq. (20.16). The energy E_{D} (SiHₙ₌₁₂₃) of the functional groups SiHₙ₌₁₂₃ is given by the integer n times that of Si—H:

E_{D}(SiH_{n=1,2,3})=nE_{D}(SiH) (20.34)

Similarly, for silane, E_{T}(atom−atom,msp³.AO) is E_{T}(Si—H,3sp³) given by Eq. (20.20). The energy E_{D} (SiH₄) of SiH₄ is given by the integer 4 times that of the SiHₙ₌₄ functional group:

E_{D}(SiH₄)=4E_{D}(SiHₙ₌₄) (20.35)

The symbols of the functional groups of silanes are given in Table 20.2. The geometrical (Eqs. (15.1-15.5), (20.1-20.16), (20.29), and (20.32-20.33)), intercept (Eqs. (15.80-15.87) and (20.21)), and energy (Eqs. (15.61), (20.1-20.16), and (20.33-20.35)) parameters of silanes are given in Tables 20.3, 20.4 (as shown in the priority document), and 20.5, respectively. The total energy of each silane given in Table 20.6 (as shown in the priority document) was calculated as the sum over the integer multiple of each E_{D} (Group) of Table 20.5 corresponding to functional-group composition of the molecule. E_{mag} of Table 20.5 is given by Eqs. (15.15) and (20.3). The bond angle parameters of silanes determined using Eqs. (15.88-15.117) are given in Table 20.7 (as shown in the priority document). In particular for silanes, the bond angle ∠HSiH is given by Eq. (15.99) wherein E_{T}(atom−atom,msp³.AO) is given by Eq. (20.16) in order to match the energy donated from the Si3sp³ HO to the Si—H-bond MO due to the energy of silicon being less than the Coulombic energy between the electron and proton of H given by Eq. (1.243). The parameter c′₂ is given by Eq. (15.100) as in the case of a H—H terminal bond of an alkyl or alkenyl group, except that c₂(Si3sp³) is given by Eq. (15.63) such that c′₂ is the ratio of c₂ of Eq. (15.72) for the H—H bond which is one and c₂ of the silicon of the corresponding Si—H bond considering the effect of the formation of the H—H terminal bond:

$$\begin{matrix}{c}_{2}^{′} = \frac{1}{{c}_{2} ( Si 3 {sp}^{3} )} \\ = \frac{13.605804 eV}{{E}_{Coulomb} ( Si - H Si 3 {sp}^{3} )}\end{matrix} \qquad ( 20.36 )$$

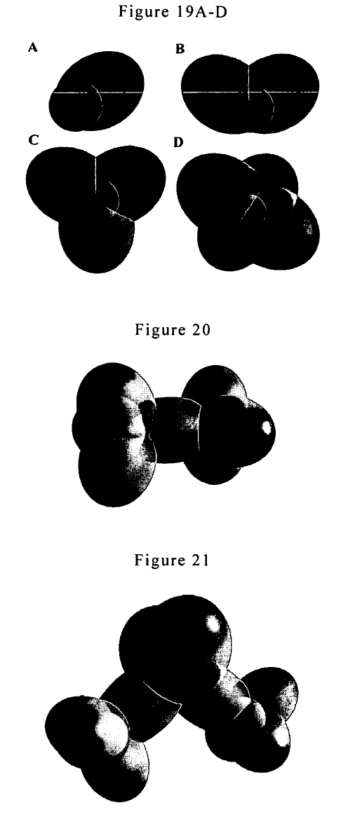

The color scale, translucent view of the charge-densities of the series Si comprising the concentric shells of the central Si atom of each member with the outer shell joined with one or more hydrogen MOs are shown in FIGS. 19A-D. The charge-density of disilane is shown in FIG. 20.

TABLE 20.2
The symbols of the functional groups of silanes.

| Functional Group | Group Symbol |
|---|---|
| SiH group of SiH_{n=1,2,3} | Si—H (i) |
| SiH group of SiHₙ₌₄ | Si—H (ii) |
| SiSi bond (n-Si) | Si—Si |

TABLE 20.3
The geometrical bond parameters of silanes
and experimental values [2].

| Parameter | Si—H (i) and (ii)Group | Si—Si Group |
|---|---|---|
| a (a₀) | 2.24744 | 2.74744 |
| c′ (a₀) | 1.40593 | 2.19835 |
| Bond Length 2c′ (Å) | 1.48797 | 2.32664 |
| Exp. Bond Length (Å) | 1.492 (Si₂H₆) | 2.331 (Si₂H₆) |
| | | 2.32 (Si₂Cl₆) |
| b, c (a₀) | 1.75338 | 1.64792 |
| e | 0.62557 | 0.80015 |

TABLE 20.4
The energy parameters (eV) of the functional groups of silanes.

| | Si—H (i) | Si—H (ii) | Si—Si |
|---|---|---|---|
| Parameters | Group | Group | Group |
| n₁ | 1 | 1 | 1 |
| n₂ | 0 | 0 | 0 |
| n₃ | 0 | 0 | 0 |
| C₁ | 0.75 | 0.75 | 0.37500 |
| C₂ | 0.75800 | 0.75800 | 0.75800 |
| c₁ | 1 | 1 | 1 |
| c₂ | 1 | 1 | 0.75800 |
| c₃ | 0 | 0 | 0 |
| c₄ | 1 | 1 | 2 |
| c₅ | 1 | 1 | 0 |
| C₁ₒ | 0.75 | 0.75 | 0.37500 |
| C₂ₒ | 0.75800 | 0.75800 | 0.75800 |
| Vₑ (eV) | −28.41703 | −28.41703 | −20.62357 |
| Vₚ (eV) | 9.67746 | 9.67746 | 6.18908 |
| T (eV) | 6.32210 | 6.32210 | 3.75324 |
| Vₘ (eV) | −3.16105 | −3.16105 | −1.87662 |
| E (AO/HO) (eV) | −10.25487 | −10.25487 | −10.25487 |
| ΔE_{H}_{₂}_{MO} (AO/HO) (eV) | 0 | 0 | 0 |
| E_{T} (AO/HO) (eV) | −10.25487 | −10.25487 | −10.25487 |
| E_{T} (H₂MO) (eV) | −25.83339 | −25.83339 | −22.81274 |
| E_{T} (atom-atom, msp³ · AO) (eV) | −1.06358 | −1.37960 | −0.96031 |
| E_{T} (MO) (eV) | −26.89697 | −27.21299 | −23.77305 |
| ω (10¹⁵ rad/s) | 13.4257 | 13.4257 | 4.83999 |
| E_{K} (eV) | 8.83703 | 8.83703 | 3.18577 |
| Ē_{D} (eV) | −0.15818 | −0.16004 | −0.08395 |
| Ē_{Kvib} (eV) | 0.25315 [3] | 0.25315 [3] | 0.06335 [3] |
| Ē_{osc} (eV) | −0.03161 | −0.03346 | −0.05227 |
| E_{mag} (eV) | 0.04983 | 0.04983 | 0.04983 |
| E_{T} (Group) (eV) | −26.92857 | −27.24646 | −23.82532 |
| Eᵢₙᵢₜᵢₐₗ (c₄ AO/HO) (eV) | −10.25487 | −10.25487 | −10.25487 |
| Eᵢₙᵢₜᵢₐₗ (c₅ AO/HO) (eV) | −13.59844 | −13.59844 | 0 |
| E_{D} (Group) (eV) | 3.07526 | 3.39314 | 3.31557 |
| Exp. E_{D} (Group) (eV) | 3.0398 (Si—H [4]) | | 3.3269 (H₃Si—SiH₃ [5]) |

Alkyl silanes and disilanes (Siₘ,CₙH₂₍ₘ₊ₙ₊₂, m,n=1,2,3,4,5 . . . ∞)

The branched-chain alkyl silanes and disilanes, Siₘ,CₙH₂₍ₘ₊ₙ₎₊₂, comprise at least a terminal methyl group (CH₃) and at least one Si bound by a carbon-silicon single bond comprising a C—Si group, and may comprise methylene (CH₂), methylyne (CH), C—C, SiH_{n=1,2,3}, and Si—Si functional groups. The methyl and methylene functional groups are equivalent to those of straight-chain alkanes. Six types of C—C bonds can be identified. The n-alkane C—C bond is the same as that of straight-chain alkanes. In addition, the C—C bonds within isopropyl ((CH₃)₂ CH) and t-butyl ((CH₃)₃C) groups and the isopropyl to isopropyl, isopropyl to t-butyl, and t-butyl to t-butyl C—C bonds comprise functional groups. These groups in branched-chain alkyl silanes and disilanes are equivalent to those in branched-chain alkanes, and the SiH_{n=1,2,3} functional groups of alkyl silanes are equivalent to those in silanes (SiₙH₂ₙ₊₂). The Si—Si functional group of alkyl silanes is equivalent to that in silanes; however, in dialkyl silanes, the Si—Si functional group is different due to an energy matching condition with the C—Si bond having a mutual silicon atom.

For the C—Si functional group, hybridization of the 2s and 2p AOs of each C and the 3s and 3p AOs of each Si to form single 2sp³ and 3sp³ shells, respectively, forms an energy minimum, and the sharing of electrons between the C2sp³ and Si3sp³ HOs to form a MO permits each participating orbital to decrease in radius and energy. In branched-chain alkyl silanes, the energy of silane is less than the Coulombic energy between the electron and proton of H given by Eq. (1.243). Thus, c₂ in Eq. (15.61) is one, and the energy matching condition is determined by the C₂ parameter. Then, the C2sp³ HO has an energy of E(C,2sp³)=−14.63489 eV (Eq. (15.25)), and the Si3sp³ HO has an energy of E(Si,3sp³)=−10.25487 eV (Eq. (20.7)). To meet the equipotential condition of the union of the C—Si H₂-type-ellipsoidal-MO with these orbitals, the hybridization factor C₂ of Eq. (15.61) for the C—Si-bond MO given by Eq. (15.77) is

$$\begin{matrix}{C}_{2} ( C 2 {sp}^{3} HO to Si 3 {sp}^{3} HO ) = \frac{E ( Si , 3 {sp}^{3} )}{E ( C , 2 {sp}^{3} )} \\ = \frac{- 10.25487 eV}{- 14.63489 eV} \\ = 0.70071\end{matrix} \qquad ( 20.37 )$$

For monosilanes, E_{T}(atom−atom,msp³.AO) of the C—Si-bond MO is −1.20473 eV corresponding to the single-bond contributions of carbon and silicon of −0.72457 eV given by Eq. (14.151) and −0.48015 eV given by Eq. (14.151) with s=1 in Eq. (15.18). The energy of the C—Si-bond MO is the sum of the component energies of the H₂-type ellipsoidal MO given in Eq. (15.51) with E(AO/HO)=E(Si,3sp³) given by Eq. (20.7) and ΔE_{H}_{₂}_{MO}(AO/HO)=E_{T}(atom−atom,msp³.AO) in order to match the energies of the carbon and silicon HOs.

For the co-bonded Si—Si group of the C—Si group of disilanes,

E_{T}(atom−atom,msp³.AO) is −0.96031 eV, two times E_{T}(Si—Si,3sp³) given by Eq. (20.12). Thus, in order to match the energy between these groups,
E_{T}(atom−atom,msp³.AO) of the C—Si-bond MO is −0.92918 eV corresponding to the single-bond methylene-type contribution of carbon given by Eq. (14.513). As in the case of monosilanes, E(AO/HO)=E(Si,3sp³) given by Eq. (20.7) and
ΔE_{H}_{₂}_{MO}(AO/HO)=E_{T}(atom−atom,msp³.AO) in order to match the energies of the carbon and silicon HOs.

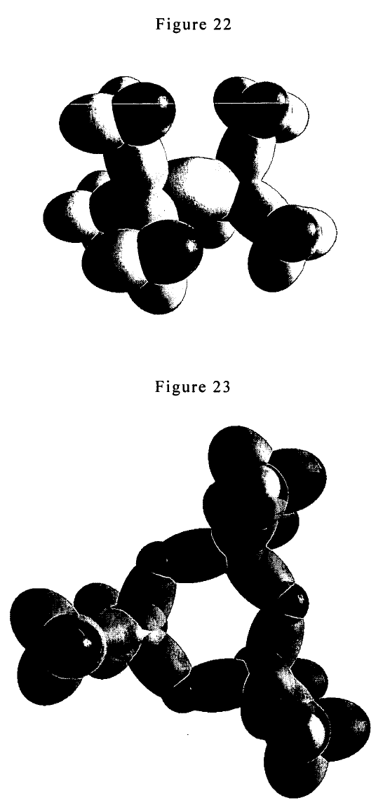

The symbols of the functional groups of alkyl silanes and disilanes are given in Table 20.8. The geometrical (Eqs. (15.1-15.5), (20.1-20.16), (20.29), (20.32-20.33) and (20.37)) and intercept (Eqs. (15.80-15.87) and (20.21)) parameters of alkyl silanes and disilanes are given in Tables 20.9 and 20.10 (as shown in the priority document), respectively. Since the energy of the Si3sp³ HO is matched to that of the C2sp³ HO, the radius rₘₒₗ₂ₛₚ_{³} of the Si3sp³ HO of the silicon atom and the C2sp³ HO of the carbon atom of a given C—Si-bond MO is calculated after Eq. (15.32) by considering ΣE_{T}_{ₘₒₗ}(MO,2sp³), the total energy donation to all bonds with which each atom participates in bonding. In the case that the MO does not intercept the Si HO due to the reduction of the radius from the donation of Si 3sp³ HO charge to additional MO's, the energy of each MO is energy matched as a linear sum to the Si HO by contacting it through the bisector current of the intersecting MOs as described in the Methane Molecule (CH₄) section. The energy (Eqs. (15.61), (20.1-20.16), and (20.33-20.37)) parameters of alkyl silanes and disilanes are given in Table 20.11 (as shown in the priority document). The total energy of each alkyl silane and disilane given in Table 20.12 (as shown in the priority document) was calculated as the sum over the integer multiple of each E_{D} (Group) of Table 20.11 (as shown in the priority document) corresponding to functional-group composition of the molecule. The bond angle parameters of alkyl silanes and disilanes determined using Eqs. (15.88-15.117) and Eq. (20.36) are given in Table 20.13 (as shown in the priority document). The charge-densities of exemplary alkyl silane, dimethylsilane and alkyl disilane, hexamethyldisilane comprising the concentric shells of atoms with the outer shell bridged by one or more H₂-type ellipsoidal MOs or joined with one or more hydrogen MOs are shown in FIGS. 21 and 22, respectively.

TABLE 20.8
The symbols of functional groups of alkyl silanes and disilanes.

| Functional Group | Group Symbol |
|---|---|
| CSi bond (monosilanes) | C—Si (i) |
| CSi bond (disilanes) | C—Si (ii) |
| SiSi bond (n-Si) | Si—Si |
| SiH group of SiH_{n=1,2,3} | Si—H |
| CH₃ group | C—H (CH₃) |
| CH₂ group | C—H (CH₂) |
| CH | C—H |
| CC bond (n-C) | C—C (a) |
| CC bond (iso-C) | C—C (b) |
| CC bond (tert-C) | C—C (c) |
| CC (iso to iso-C) | C—C (d) |
| CC (t to t-C) | C—C (e) |
| CC (t to iso-C) | C—C (f) |

### Silicon Oxides, Silicic Acids, Silanols, Siloxanes and Disiloxanes

The silicon oxides, silicic acids, silanols, siloxanes, and disiloxanes each comprise at least one Si—O group, and this group in disiloxanes is part of the Si—O—Si moiety. Silicic acids may have up to three Si—H bonds corresponding to the SiH_{n=1,2,3} functional groups of alkyl silanes, and silicic acids and silanols further comprise at least one OH group equivalent to that of alcohols. In addition to the SiH_{n=1,2,3} group of alkyl silanes, silanols, siloxanes, and disiloxanes may comprise the functional groups of organic molecules as well as the C—Si group of alkyl silanes. The alkyl portion of the alkyl silanol, siloxane, or disiloxane may comprise at least one terminal methyl group (CH₃) the end of each alkyl chain, and may comprise methylene (CH₂), and methylyne (CH) functional groups as well as C bound by carbon-carbon single bonds. The methyl and methylene functional groups are equivalent to those of straight-chain alkanes. Six types of C—C bonds can be identified. The n-alkane C—C bond is the same as that of straight-chain alkanes. In addition, the C—C bonds within isopropyl ((CH₃)₂ CH) and t-butyl ((CH₃)₃C) groups and the isopropyl to isopropyl, isopropyl to t-butyl, and t-butyl to t-butyl C—C bonds comprise functional groups. The branched-chain-alkane groups in silanols, siloxanes, and disiloxanes are equivalent to those in branched-chain alkanes. The alkene groups when present such as the C═C group are equivalent to those of the corresponding alkene. Siloxanes further comprise two types of C—O functional groups, one for methyl or t-butyl groups corresponding to the C and the other for general alkyl groups as given for ethers.

The distinguishing aspect of silicon oxides, silicic acids, silanols, siloxanes, and disiloxane is the nature of the corresponding Si—O functional group. In general, the sharing of electrons between a Si3sp³ HO and an O2p AO to form a Si—O-bond MO permits each participating orbital to decrease in size and energy. Consider the case wherein the Si3sp³ HO donates an excess of 50% of its electron density to the Si—O-bond MO to form an energy minimum while further satisfying the potential, kinetic, and orbital energy relationships. By considering this electron redistribution in the molecule comprising a Si—O bond as well as the fact that the central field decreases by an integer for each successive electron of the shell, the radius r_{Si—O3sp}_{³} of the Si3sp³ shell may be calculated from the Coulombic energy using Eq. (15.18):

$$\begin{matrix}{r}_{Si - O 3 {sp}^{3}} = ( {\sum }_{n = 10}^{13} ( Z - n ) - 0.5 ) \frac{{e}^{2}}{8 {πɛ}_{0} ( e 105.23554 eV )} \\ = \frac{9.5 {e}^{2}}{8 {πɛ}_{0} ( e 105.23554 eV )} \\ = 1.22825 {a}_{0}\end{matrix} \qquad ( 20.38 )$$

Using Eqs. (15.19) and (20.38), the Coulombic energy E_{Coulomb}(Si_{Si—O},3sp³) of the outer electron of the Si3sp³ shell is

$$\begin{matrix}{E}_{Coulomb} ( {Si}_{Si - O} , 3 {sp}^{3} ) = \frac{- {e}^{2}}{8 {πɛ}_{0} {r}_{Si - O 3 {sp}^{3}}} \\ = \frac{- {e}^{2}}{8 {πɛ}_{0} 1.22825 {a}_{0}} \\ = - 11.07743 eV\end{matrix} \qquad ( 20.39 )$$

During hybridization, the spin-paired 3s electrons are promoted to Si3sp³ shell as unpaired electrons. The energy for the promotion is the magnetic energy given by Eq. (20.6). Using Eqs. (20.6) and (20.39), the energy E(Si_{Si—O},3sp³) of the outer electron of the Si3sp³ shell is

$$\begin{matrix}E ( {Si}_{Si - O} , 3 {sp}^{3} ) = \frac{- {e}^{2}}{8 {πɛ}_{0} {r}_{silane 3 {sp}^{3}}} + \frac{2 {πμ}_{0} {e}^{2} {ℏ}^{2}}{{{m}_{e}^{2} ( {r}_{12} )}^{3}} \\ = - 11.07743 eV + 0.05836 eV \\ = - 11.01906 eV\end{matrix} \qquad ( 20.40 )$$

Thus, E_{T}(Si—O,3sp³), the energy change of each Si3sp³ shell with the formation of the Si—O-bond MO is given by the difference between Eq. (20.40) and Eq. (20.7):

E_{T}(Si—O,3sp³)=E(Si_{Si—O},3sp³)−E(Si,3sp³)=−11.01906 eV−(−10.25487 eV)=−0.76419 eV (20.41)

Using Eq. (15.28), to meet the energy matching condition in silanols and siloxanes for all σ MOs at the Si3sp³ HO and O2p AO of each Si—O-bond MO as well as with the C2sp³ HOs of the molecule, the energy E(Si_{RSi—OR′},3sp³) (R,R′ are alkyl or H) of the outer electron of the Si3sp³ shell of the silicon atom must be the average of E(Siₛᵢₗₐₙₑ,3sp³) (Eq. (20.11)) and E_{T}(Si—O,3sp³) (Eq. (20.40)):

$$\begin{matrix}E ( {Si}_{RSi - {OR}^{′}} , 3 {sp}^{3} ) = \frac{E ( {Si}_{silane} , 3 {sp}^{3} ) + E ( {Si}_{Si - O} , 3 {sp}^{3} )}{2} \\ = \frac{( - 10.73503 eV ) + ( - 11.01906 eV )}{2} \\ = - 10.87705 eV\end{matrix} \qquad ( 20.42 )$$

Using Eq. (15.29), E_{T}_{_{silanol, silazane}}(Si—O,3sp³), the energy change of each Si3sp³ shell with the formation of each RSi—OR′-bond MO, must be the average of E_{T}(Si—Si,3sp³) (Eq. (20.12)) and E_{T}(Si—O,3sp³) (Eq. (20.41)):

$$\begin{matrix}{E}_{{T}_{{silanol ,}_{siloxane}}} ( Si - O , 3 {sp}^{3} ) = \frac{{E}_{T} ( Si - Si , 3 {sp}^{3} ) + {E}_{T} ( Si - O , 3 {sp}^{3} )}{2} \\ = \frac{( - 0.48015 eV ) + ( - 0.76419 eV )}{2} \\ = - 0.62217 eV\end{matrix} \qquad ( 20.43 )$$

To meet the energy matching condition in silicic acids for all σ MOs at the Si3sp³ HO and O2p AO of each Si—O-bond MO as well as all H AOs, the energy E(Si_{H}_{ₙ}_{Si—(OH)}_{₄₋ₙ},3sp³) of the outer electron of the Si3sp³ shell of the silicon atom must be the average of E(Siₛᵢₗₐₙₑ,3sp³)(Eq. (20.15)) and E_{T}(Si—O,3sp³) (Eq. (20.40)):

$$\begin{matrix}E ( {Si}_{{H}_{n} Si - {( OH )}_{4 - n}} , 3 {sp}^{3} ) = \frac{E ( {Si}_{silane} , 3 {sp}^{3} ) + E ( {Si}_{Si - O} , 3 {sp}^{3} )}{2} \\ = \frac{( - 11.37682 eV ) + ( - 11.01906 eV )}{2} \\ = - 11.16876 eV\end{matrix} \qquad ( 20.44 )$$

Using Eq. (15.29), E_{T}_{_{silicic acid}}(Si—O,3sp³), the energy change of each Si3sp³ shell with the formation of each RSi—OR′-bond MO, must be the average of E_{T}(Si—H, 3sp³) (Eq. (20.16)) and E_{T}(Si—O, 3sp³) (Eq. (20.41)):

$$\begin{matrix}{E}_{{T}_{silicic acid}} ( Si - O , 3 {sp}^{3} ) = \frac{{E}_{T} ( Si - H , 3 {sp}^{3} ) + {E}_{T} ( Si - O , 3 {sp}^{3} )}{2} \\ = \frac{( - 1.06358 eV ) + ( - 0.76419 eV )}{2} \\ = - 0.91389 eV\end{matrix} \qquad ( 20.45 )$$

Using Eqs. (20.22-22.26), the general force balance equation for the σ-MO of the silicon to oxygen Si—O-bond MO in terms of nₑ and |Lᵢ| corresponding to the angular momentum terms of the 3sp³ HO shell is

$$\frac{{ℏ}^{2}}{{m}_{e} {a}^{2} {b}^{2}} D = \frac{{e}^{2}}{8 {πɛ}_{0} {ab}^{2}} D + \frac{{ℏ}^{2}}{2 {m}_{e} {a}^{2} {b}^{2}} D - ( \frac{{n}_{e}}{2} + {\sum }_{i} \frac{\vert {L}_{i} \vert}{Z} ) \frac{{ℏ}^{2}}{2 {m}_{e} {a}^{2} {b}^{2}} D \qquad ( 20.46 )$$

Having a solution for the semimajor axis a of

$$a = ( 1 + \frac{{n}_{e}}{2} + {\sum }_{i} \frac{\vert {L}_{i} \vert}{Z} ) {a}_{0} \qquad ( 20.47 )$$

In terms of the angular momentum L, the semimajor axis a is

$$a = ( 1 + \frac{{n}_{e}}{2} + \frac{L}{Z} ) {a}_{0} \qquad ( 20.48 )$$

Using the semimajor axis, the geometric and energy parameters of the MO are calculated using Eqs. (15.1-15.117) in the same manner as the organic functional groups given in the Organic Molecular Functional Groups and Molecules section. The semimajor axis a solutions given by Eq. (20.48) of the force balance equation, Eq. (20.46), for the σ-MO of the Si—O-bond MO of each functional group of silicon oxide, silicon dioxide, silicic acids, silanols, siloxanes, and disiloxanes are given in Table 20.15 (as shown in the priority document) with the force-equation parameters Z=14, nₑ, and L corresponding to the angular momentum of the Si3sp³ HO shell.

For the Si—O functional groups, hybridization of the 3s and 3p AOs of Si to form a single 3sp³ shell forms an energy minimum, and the sharing of electrons between the Si3sp³ HO and the O AO to form σ MO permits each participating orbital to decrease in radius and energy. The O AO has an energy of E(O)=−13.61805 eV, and the Si3sp³ HO has an energy of E(Si,3sp³)=−10.25487 eV (Eq. (20.7)). To meet the equipotential condition of the union of the Si—O H₂-type-ellipsoidal-MO with these orbitals, the corresponding hybridization factors c₂ and C₂ of Eq. (15.61) for silicic acids, silanols, siloxanes, and disiloxanes and the hybridization factor C₂ of silicon oxide and silicon dioxide given by Eq. (15.77) are

$$\begin{matrix}{c}_{2} ( O to Si 3 {sp}^{3} HO ) = {C}_{2} ( O to Si 3 {sp}^{3} HO ) \\ = \frac{E ( Si , 3 {sp}^{3} )}{E ( O )} \\ = \frac{- 10.25487 eV}{- 13.61805 eV} \\ = 0.75304\end{matrix} \qquad ( 20.49 )$$

Each bond of silicon oxide and silicon dioxide is a double bond such that c₁=2 and C₁=0.75 in the geometry relationships (Eqs. (15.2-15.5)) and the energy equation (Eq. (15.61)). Each Si—O bond in silicic acids, silanols, siloxanes, and disiloxanes is a single bond corresponding to c₁=1 and C₁=0.5 as in the case of alkanes (Eq. (14.152))).

Since the energy of the MO is matched to that of the Si3sp³ HO, E(AO/HO) in Eq. (15.61) is E(Si,3sp³) given by Eq. (20.7) and twice this value for double bonds. E_{T}(atom−atom,msp³.AO) of the Si—O-bond MO of each functional group is determined by energy matching in the molecule while achieving an energy minimum. For silicon oxide and silicon dioxide, E_{T}(atom−atom,msp³.AO) is three and two times −1.37960 eV given by Eq. (20.20), respectively. E_{T}(atom−atom,msp³.AO) of silicic acids is two times −0.91389 eV given by Eq. (20.45). E_{T}(atom−atom,msp³.AO) of silanols, siloxanes, and disiloxanes is two times −0.62217 eV given by Eq. (20.43).

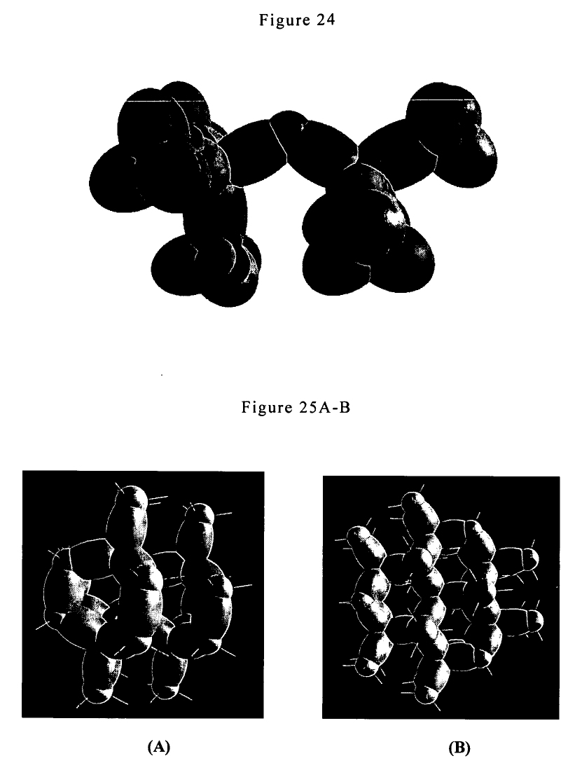

The symbols of the functional groups of silicon oxides, silicic acids, silanols, siloxanes, and disiloxanes are given in Table 20.14. The geometrical (Eqs. (15.1-15.5), (20.1-20.21), (20.29), (20.32-20.33), (20.37), and (20.46-20.49)) and intercept (Eqs. (15.80-15.87) and (20.21)) parameters are given in Tables 20.15 and 20.16, respectively (as shown in the priority document). The energy (Eqs. (15.61), (20.1-20.20), (20.33-20.35), (20.37-45), and (20.49)) parameters are given in Table 20.17 (as shown in the priority document). The total energy of each silicon oxide, silicic acid, silanol, siloxane, or disiloxane given in Table 20.18 (as shown in the priority document) was calculated as the sum over the integer multiple of each E_{D} (Group) of Table 20.17 (as shown in the priority document) corresponding to functional-group composition of the molecule. The bond angle parameters determined using Eqs. (15.88-15.117) are given in Table 20.19 (as shown in the priority document). The charge-densities of exemplary siloxane, ((CH₃)₂SiO)₃ and disiloxane, hexamethyldisiloxane comprising the concentric shells of atoms with the outer shell bridged by one or more H₂-type ellipsoidal MOs or joined with one or more hydrogen MOs are shown in FIGS. 23 and 24, respectively.

TABLE 20.14
The symbols of functional groups of silicon oxides, silicic
acids, silanols, siloxanes and disiloxanes.

| Functional Group | Group Symbol |
|---|---|
| SiO bond (silicon oxide) | Si—O (i) |
| SiO bond (silicon dioxide) | Si—O (ii) |
| SiO bond (silicic acid) | Si—O (iii) |
| SiO bond (silanol and siloxane) | Si—O (iv) |
| Si—OSi bond (disiloxane) | Si—O (v) |
| SiH group of SiH_{n=1,2,3} | Si—H |
| CSi bond | C—Si (i) |
| OH group | OH |
| CO (CH₃—O—and (CH₃)₃C—O—) | C—O (i) |
| CO (alkyl) | C—O (ii) |
| CH₃ group | C—H (CH₃) |
| CH₂ group | C—H (CH₂) |
| CH | C—H |
| CC bond (n-C) | C—C (a) |
| CC bond (iso-C) | C—C (b) |
| CC bond (tert-C) | C—C (c) |
| CC (iso to iso-C) | C—C (d) |
| CC (t to t-C) | C—C (e) |
| CC (t to iso-C) | C—C (f) |

### REFERENCES

1. D. R. Lide, CRC Handbook of Chemistry and Physics, 86th Edition, CRC Press, Taylor & Francis, Boca Raton, (2005-6), pp. 10-202 to 10-204.
2. D. R. Lide, CRC Handbook of Chemistry and Physics, 86th Edition, CRC Press, Taylor & Francis, Boca Raton, (2005-6), p. 9-26.
3. D. R. Lide, CRC Handbook of Chemistry and Physics, 86th Edition, CRC Press, Taylor & Francis, Boca Raton, (2005-6), p. 9-86.
4. D. R. Lide, CRC Handbook of Chemistry and Physics, 86th Edition, CRC Press, Taylor & Francis, Boca Raton, (2005-6), p. 9-57.
5. D. R. Lide, CRC Handbook of Chemistry and Physics, 86th Edition, CRC Press, Taylor & Francis, Boca Raton, (2005-6), p. 9-71.
6. B. H. Boo, P. B. Armentrout, “Reaction of silicon ion (²P) with silane (SiH₄, SiD₄). Heats of formation of SiHₙ, SiHₙ⁺ (n=1, 2, 3), and Si₂Hₙ⁺ (n=0, 1, 2, 3). Remarkable isotope exchange reaction involving four hydrogen shifts,” J. Am. Chem. Soc., (1987), Vol. 109, pp. 3549-3559.
7. G. Katzer, M. C. Ernst, A. F. Sax, J. Kalcher, “Computational thermochemistry of medium-sized silicon hydrides,” J. Phys. Chem. A, (1997), Vol. 101, pp. 3942-3958.
8. D. R. Lide, CRC Handbook of Chemistry and Physics, 86th Edition, CRC Press, Taylor & Francis, Boca Raton, (2005-6), pp. 9-19 to 9-45.
9. M. R. Frierson, M. R. Imam, V. B. Zalkow, N. L. Allinger, “The MM2 force field for silanes and polysilanes,” J. Org. Chem., Vol. 53, (1988), pp. 5248-5258.
10. D. Lin-Vien. N. B. Colthup, W. G. Fateley, J. G. Grasselli, The Handbook of Infrared and Raman Frequencies of Organic Molecules, Academic Press, Inc., Harcourt Brace Jovanovich, Boston, (1991), p. 256.
11. G. Herzberg, Molecular Spectra and Molecular Structure II. Infrared and Raman Spectra of Polyatomic Molecules, Van Nostrand Reinhold Company, New York, N.Y., (1945), p. 344.
12. R. J. Fessenden, J. S. Fessenden, Organic Chemistry, Willard Grant Press. Boston, Mass., (1979), p. 320.
13. cyclohexane at http://webbook.nist.gov/.
14. D. R. Lide, CRC Handbook of Chemistry and Physics, 86th Edition, CRC Press, Taylor & Francis, Boca Raton, (2005-6), p. 5-28.
15. M. J. S. Dewar, C. Jie, “AM 1 calculations for compounds containing silicon”, Organometallics, Vol. 6, (1987), pp. 1486-1490.
16. R. Walsh, “Certainties and uncertainties in the heats of formation of the methylsilylenes”, Organometallics, Vol. 8, (1989), pp. 1973-1978.
17. R. W. Kilb, L. Pierce, “Microwave spectrum, structure, and internal barrier of methyl silane,” J. Chem. Phys., Vol. 27, No. 1, (1957), pp. 108-112.
18. M. W. Chase, Jr., C. A. Davies, J. R. Downey, Jr., D. J. Frurip, R. A. McDonald, A. N. Syverud, JANAF Thermochemical Tables, Third Edition, Part II, Cr—Zr, J. Phys. Chem. Ref Data, Vol. 14, Suppl. 1, (1985), p. 1728.
19. M. W. Chase, Jr., C. A. Davies, J. R. Downey, Jr., D. J. Frurip, R. A. McDonald, A. N. Syverud, JANAF Thermochemical Tables, Third Edition, Part II, Cr—Zr, J. Phys. Chem. Ref Data, Vol. 14, Suppl. 1, (1985), p. 1756.
20. D. Nyfeler, T. Armbruster, “Silanol groups in minerals and inorganic compounds”, American Mineralogist, Vol. 83, (1998), pp. 119-125.
21. K. P. Huber, G. Herzberg, Molecular Spectra and Molecular Structure, IV. Constants of Diatomic Molecules, Van Nostrand Reinhold Company, New York, (1979).
22. J. Crovisier, Molecular Database—Constants for molecules of astrophysical interest in the gas phase: photodissociation, microwave and infrared spectra, Ver. 4.2, Observatoire de Paris, Section de Meudon, Meudon, France, May 2002, pp. 34-37, available at http://wwwusr.obspm.fr/˜crovisie/.
23. dimethyl ether at http://webbook.nist.gov/.
24. R. J. Fessenden, J. S. Fessenden, Organic Chemistry, Willard Grant Press. Boston, Mass., (1979), p. 320.
25. fluoroethane at http://webbook.nist.gov/.
26. G. Herzberg, Molecular Spectra and Molecular Structure II Infrared and Raman Spectra of Polyatomic Molecules, Van Nostrand Reinhold Company, New York, N.Y., (1945), p. 326.
27. M. D. Allendorf, C. F. Melius, P. Ho, M. R. Zachariah, “Theoretical study of the thermochemistry of molecules in the Si—O—H system,” J. Phys. Chem., Vol. 99, (1995), pp. 15285-15293.
28. N. S. Jacobson, E. J. Opila, D. L. Myers, E. H. Copeland, “Thermodynamics of gas phase species in the Si—O—H system,” J. Chem. Thermodynamics, Vol. 37, (2005), pp. 1130-1137.
29. J. D. Cox, G. Pilcher, Thermochemistry of Organometallic Compounds, Academic Press, New York, (1970), pp. 468-469.
30. J. C. S. Chu, R. Soller, M. C. Lin, C. F. Melius, “Thermal decomposition of tetramethyl orthoscilicate in the gas phase: An experimental and theoretical study of the initiation process, J. Phys. Chem., Vol. 99, (1995), pp. 663-672.
31. R. Becerra, R. Walsh, In The Chemistry of Organic Silicon Compounds; Z. Rappaport, Y. Apeloig, Eds.; Thermochemistry, Vol. 2; Wiley, New York, (1998), Chp. 4.
32. C. L. Darling, H. B. Schlegel, “Heats of formation of SiHₙO and SiHₙO₂ calculated by ab initio molecular orbital methods at the G-2 level of theory,” J. Phys. Chem. Vol. 97, (1993), 8207-8211.
33. A. C. M. Kuo, In Polymer Data Handbook; Poly(dimethylsiloxane); Oxford University Press, (1999), p 419.

### The Nature of the Semiconductor Bond of Silicon

### Generalization of the Nature of the Semiconductor Bond

Semiconductors are solids that have properties intermediate between insulators and metals.

For an insulator to conduct, high energy and power are required to excite electrons into a conducing state in sufficient numbers. Application of high energy to cause electron ionization to the continuum level or to cause electrons to transition to conducing molecular orbitals (MOs) will give rise to conduction when the power is adequate to maintain a high population density of such states. Only high temperatures or extremely high-strength electric fields will provide enough energy and power to achieve an excited state population permissive of conduction. In contrast, metals are highly conductive at essentially any field strength and power. Diamond and alkali metals given in the corresponding sections are representative of insulator and metal classes of solids at opposite extremes of conductivity. It is apparent from the bonding of diamond comprising a network of highly stable MOs that it is an insulator, and the planar free-electron membranes in metals give rise to their high conductivity.

Column IV elements silicon, germanium, and α-gray tin all have the diamond structure and are insulators under standard conditions. However, the electrons of these materials can be exited into a conducting excited state with modest amounts of energy compared to a pure insulator. As opposed to the 5.2 eV excitation energy for carbon, silicon, germanium, and α-gray tin have excitation energies for conduction of only 1.1 eV, 0.61 eV, and 0.078 eV, respectively. Thus, a semiconductor can carry a current by providing the relatively small amount of energy required to excite electrons to conducting excited states. As in the case of insulators, excitation can occur thermally by a temperature increase. Since the number of excited electrons increases with temperature, a concomitant increase in conductance is observed. This behavior is the opposite of that of metals. Alternatively, the absorption of photons of light causes the electrons in the ground state to be excited to a conducting state which is the basis of conversion of solar power into electricity in solar cells and detection and reception in photodetectors and fiber optic communications, respectively. In certain semiconductors, rather than decay by internal conversion to phonons, the energy of excited-state electrons is emitted as light as the electrons transition from the excited conducting state to the ground state. This photon emission process is the basis of light emitting diodes (LEDs) and semiconductor lasers which have broad application in industry.

In addition to elemental materials such as silicon and germanium, semiconductors may be compound materials such as gallium arsenide and indium phosphide, or alloys such as silicon germanium or aluminum arsenide. Conduction in materials such as silicon and germanium crystals can be enhanced by adding small amounts (e.g. 1-10 parts per million) of dopants such as boron or phosphorus as the crystals are grown. Phosphorous with five valance electrons has a free electron even after contributing four electrons to four singe bond-MOs of the diamond structure of silicon. Since this fifth electron can be ionized from a phosphorous atom with only 0.011 eV provided by an applied electric field, phosphorous as an electron donor makes silicon a conductor.

In an opposite manner to that of the free electrons of the dopant carrying electricity, an electron acceptor may also transform silicon to a conductor. Atomic boron has only three valance electrons rather than the four needed to replace a silicon atom in the diamond structure of silicon. Consequently, a neighboring silicon atom has an unpaired electron per boron atom. These electrons can be ionized to carry electricity as well. Alternatively, a valance electron of a silicon atom neighboring a boron atom can be excited to ionize and bind to the boron. The resulting negative boron ion can remain stationary as the corresponding positive center on silicon migrates from atom to atom in response to an applied electric field. This occurs as an electron transfers from a silicon atom with four electrons to one with three to fill the vacant silicon orbital. Concomitantly, the positive center is transferred in the opposite direction. Thus, inter-atomic electron transfer can carry current in a cascade effect as the propagation of a “hole” in the opposite direction as the sequentially transferring electrons.

The ability of the conductivity of semiconductors to transition from that of insulators to that of metals with the application of sufficient excitation energy implies a transition of the excited electrons from covalent to a metallic-bond electrons. The bonding in diamond shown in the Nature of the Molecular Bond of Diamond section is a network of covalent bonds. Semiconductors comprise covalent bonds wherein the electrons are of sufficiently high energy that excitation creates an ion and a free electron. The free electron forms a membrane as in the case of metals given in the Nature of the Metallic Bond of Alkali Metals section. This membrane has the same planar structure throughout the crystal. This feature accounts for the high conductivity of semiconductors when the electrons are excited by the application of external fields or electromagnetic energy that causes ion-pair (M+−e⁻) formation.

It was demonstrated in the Nature of the Metallic Bond of Alkali Metals section that the solutions of the external point charge at an infinite planar conductor are also those of the metal ions and free electrons of metals based on the uniqueness of solutions of Maxwell's equations and the constraint that the individual electrons in a metal conserve the classical physical laws of the macro-scale conductor. The nature of the metal bond is a lattice of metal ions with field lines that end on the corresponding lattice of electrons comprising two-dimensional charge density σ given by Eq. (19.6) where each is equivalent electrostatically to a image point charge at twice the distance from the point charge of +e due to M⁺. Thus, the metallic bond is equivalent to the ionic bond given in the Alkali-Hydride Crystal Structures section with a Madelung constant of one with each negative ion at a position of one half the distance between the corresponding positive ions, but electrostatically equivalent to being positioned at twice this distance, the M⁺-M⁺-separation distance. Then, the properties of semiconductors can be understood as due to the excitation of a bound electron from a covalent state such as that of the diamond structure to a metallic state such as that of an alkali metal. The equations are the same as those of the corresponding insulators and metals.

### Nature of the Insulator-Type Semiconductor Bond

As given in the Nature of the Solid Molecular Bond of Diamond section, diamond C—C bonds are all equivalent, and each C—C bond can be considered bound to a t-butyl group at the corresponding vertex carbon. Thus, the parameters of the diamond C—C functional group are equivalent to those of the t-butyl C—C group of branched alkanes given in the Branched Alkanes section. Silicon also has the diamond structure. The diamond Si—Si bonds are all equivalent, and each Si—Si bond can be considered bound to three other Si—Si bonds at the corresponding vertex silicon. Thus, the parameters of the crystalline silicon Si—Si functional group are equivalent to those of the Si—Si group of silanes given in the Silanes (SiₙH₂ₙ₊₂) section except for the E_{T}(atom−atom,msp³.AO) term of Eq. (15.61). Since bonds in pure crystalline silicon are only between Si3sp³ HOs having energy less than the Coulombic energy between the electron and proton of H given by Eq. (1.243) E_{T}(atom−atom,msp³.AO)=0. Also, as in the case of the C—C functional group of diamond, the Si3sp³ HO magnetic energy E_{mag} is subtracted due to a set of unpaired electrons being created by bond breakage such that c₃ of Eq. (15.65) is one, and E_{mag} is given by Eqs. (15.15) and (20.3):

$$\begin{matrix}{E}_{mag} ( Si 3 {sp}^{3} ) = {c}_{3} \frac{8 {πμ}_{0} {μ}_{B}^{2}}{{r}^{3}} \\ = {c}_{3} \frac{8 {πμ}_{0} {μ}_{B}^{2}}{{( 1.31926 {a}_{0} )}^{3}} \\ = {c}_{3} 0.04983 eV\end{matrix} \qquad ( 21.1 )$$

The symbols of the functional group of crystalline silicon is given in Table 21.1. The geometrical (Eqs. (15.1-15.5), (20.3-20.7), (20.29), and (20.33)) parameters of crystalline silicon are given in Table 21.2. Using the internuclear distance 2c′, the lattice parameter a of crystalline silicon is given by Eq. (17.3). The intercept (Eqs. (15.80-15.87), (20.3), and (20.21)) and energy (Eqs. (15.61), (20.3-20.7), and (20.33)) parameters of crystalline silicon are given in Tables 21.2, 21.3 (as shown in the priority document), and 21.4, respectively.

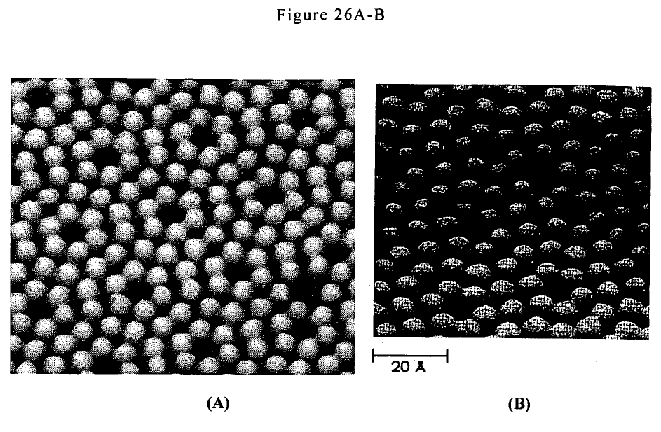

The total energy of crystalline silicon given in Table 21.5 was calculated as the sum over the integer multiple of each E_{D} (Group) of Table 21.4 corresponding to functional-group composition of the solid. The bond angle parameters of crystalline silicon determined using Eqs. (15.88-15.117), (20.4), (20.33), and (21.1) are given in Table 21.6 (as shown in the priority document). The diamond structure of silicon in the insulator state is shown in FIG. 25. The predicted structure matches the experimental images of silicon determined using STM [1] as shown in FIG. 26.

TABLE 21.1
The symbols of the functional group of crystalline silicon.

| Functional Group | Group Symbol |
|---|---|
| SiSi bond (diamond-type-Si) | Si—Si |

TABLE 21.2
The geometrical bond parameters of crystalline
silicon and experimental values.

| | Si—Si |
|---|---|
| Parameter | Group |
| a (a₀) | 2.74744 |
| c′ (a₀) | 2.19835 |
| Bond Length 2c′ (Å) | 2.32664 |
| Exp. Bond Length (Å) | 2.35 [2] |
| b, c (a₀) | 1.64792 |
| e | 0.80015 |
| Lattice Parameter a₁ (Å) | 5.37409 |
| Exp. Lattice Parameter a₁ (Å) | 5.4306 [3] |

TABLE 21.4
The energy parameters (eV) of the functional
group of crystalline silicon.

| | Si—Si |
|---|---|
| Parameters | Group |
| n₁ | 1 |
| n₂ | 0 |
| n₃ | 0 |
| C₁ | 0.37500 |
| C₂ | 0.75800 |
| c₁ | 1 |
| c₂ | 0.75800 |
| c₃ | 0 |
| c₄ | 2 |
| c₅ | 0 |
| C₁ₒ | 0.37500 |
| C₂ₒ | 0.75800 |
| Vₑ (eV) | −20.62357 |
| Vₚ (eV) | 6.18908 |
| T (eV) | 3.75324 |
| Vₘ (eV) | −1.87662 |
| E (AO/HO) (eV) | −10.25487 |
| ΔE_{H}_{₂}_{MO} (AO/HO) (eV) | 0 |
| E_{T} (AO/HO) (eV) | −10.25487 |
| E_{T} (H₂MO) (eV) | −22.81274 |
| E_{T} (atom-atom, msp³ · AO) (eV) | 0 |
| E_{T} (MO) (eV) | −22.81274 |
| ω (10¹⁵ rad/s) | 4.83999 |
| E_{K} (eV) | 3.18577 |
| Ē_{D} (eV) | −0.08055 |
| Ē_{Kvib} (eV) | 0.06335 [4] |
| Ē_{osc} (eV) | −0.04888 |
| E_{mag} (eV) | 0.04983 |
| E_{T} (Group) (eV) | −22.86162 |
| Eᵢₙᵢₜᵢₐₗ (c₄ AO/HO) (eV) | −10.25487 |
| Eᵢₙᵢₜᵢₐₗ (c₅ AO/HO) (eV) | 0 |
| E_{D} (Group) (eV) | 2.30204 |

TABLE 21.5
The total bond energy of crystalline silicon calculated using
the functional group composition and the energy of Table 21.4
compared to the experimental value [5].

| | | | Calculated | Experimental | |
|---|---|---|---|---|---|
| | | | Total Bond | Total Bond | Relative |
| Formula | Name | Si—Si | Energy (eV) | Energy (eV) | Error |
| Siₙ | Crystalline | 1 | 2.30204 | 2.3095 | 0.003 |
| | silicon | | | | |

### Nature of the Conductor-Type Semiconductor Bond

With the application of excitation energy equivalent to at least the band gap in the form of photons for example, electrons in silicon transition to conducting states. The nature of these states are equivalent to those of the electrons of metals with the appropriate lattice parameters and boundary conditions of silicon. Since the planar electron membranes are in contact throughout the crystalline matrix, the Maxwellian boundary condition that an equipotential must exist between contacted perfect conductors maintains that all of the planar electrons are at the energy of the highest energy state electron. This condition with the availability of a multitude of states with different ion separation distances and corresponding energies coupled with a near continuum of phonon states and corresponding energies gives rise to a continuum energy band or conduction band in the excitation spectrum. Thus, the conducting state of silicon comprises a background covalent diamond structure with free metal-type electrons and an equal number of silicon cations dispersed in the covalent lattice wherein excitation has occurred. The band gap can be calculated from the difference between the energy of the free electrons at the minimum electron-ion separation distance (the parameter d given in the Nature of the Metallic Bond of Alkali Metals section) and the energy of the covalent-type electrons of the diamond-type bonds given in the Nature of the Insulator-Type Semiconductor Bond section.

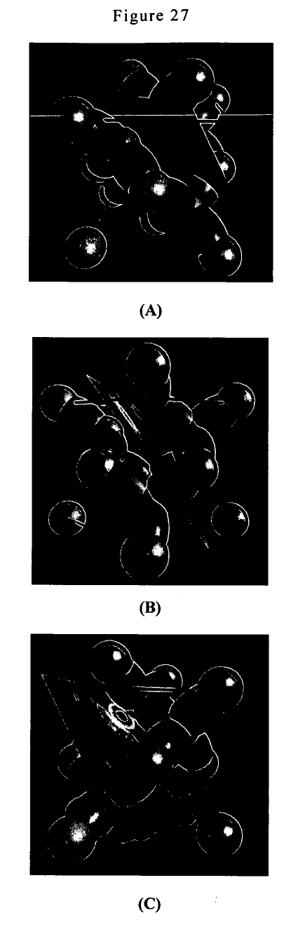

The band gap is the lowest energy possible to form free electrons and corresponding Si⁺ ions. Since the gap is the energy difference between the total energy of the free electrons and the MO electrons, a minimum gap corresponds to the lowest energy state of the free electrons. With the ionization of silicon atoms, planar electron membranes form with the corresponding ions at initial positions of the corresponding bond in the silicon lattice. The potential energy between the electrons and ions is a maximum if the electron membrane comprises the superposition of the two electrons ionized from a corresponding Si—Si bond, and the orientation of the membrane is the transverse bisector of the former bond axis such that the magnitude of the potential is four times that of a single Si+−e⁻ pair. In this case, the potential is given by two times Eq. (19.21). Furthermore, all of the field lines of the silicon ions end on the intervening electrons. Thus, the repulsion energy between Si⁺ ions is zero such the energy of the ionized state is a minimum. Using the parameters from Tables 21.1 and 21.6 (as shown in the priority document), the Si⁺−e⁻ distance of c′=1.16332 Å, and the calculated Si⁺ ionic radius of rₛᵢ₊₃ₛₚ_{³}=1.16360a₀=0.61575 Å (Eq. 20.17), the lattice structure of crystalline silicon in a conducting state is shown in FIG. 27.

The optimal Si⁺ ion-electron separation distance parameter d is given by

d=c′=2.19835a₀=1.16332×10⁻¹⁰ m (21.2)

The band gap is given by the difference in the energy of the free electrons at the optimal Si⁺-electron separation distance parameter d given by Eq. (21.2) and the energy of the electrons in the initial state of the Si—Si-bond MO. The total energy of electrons of a covalent Si—Si-bond MO E_{T}(Si_{Si—SiMO}) given by Eq. (15.65) and Table 20.4 is

$$\begin{matrix}{E}_{T} ( {Si}_{Si - SiMO} ) = {E}_{T} ( MO ) + {\overline{E}}_{osc} - {E}_{mag} \\ = - 22.81274 eV + 0.04888 - 0.04983 eV \\ = - 22.81179 eV\end{matrix} \qquad ( 21.3 )$$

The minimum energy of a free-conducting electron in silicon for the determination of the band gap E_{T(band gap)}(free e⁻ in Si) is given by the sum twice the potential energy and the kinetic energy given by Eqs. (19.21) and (19.24), respectively.

$$\begin{matrix}{E}_{T ( band gap )} ( free {e}^{-} in Si ) = V + T \\ = \frac{- 2 {e}^{2}}{4 {πɛ}_{0} d} + \frac{4}{3} ( \frac{1}{2} \frac{{ℏ}^{2}}{{m}_{e} {d}^{2}} )\end{matrix} \qquad ( 21.4 )$$

In addition, the ionization of the MO electrons increases the charge on the two corresponding Si3sp³ HO with a corresponding energy decrease, E_{T}(atom−atom,msp³.AO) given by one half that of Eq. (20.20). With d given by Eq. (21.2), E_{T(band gap)}(free e⁻ in Si) is

$${E}_{T ( band gap )} ( free {e}^{-} in Si ) = ( \begin{matrix}\frac{- 2 {e}^{2}}{4 {πɛ}_{0} ( 1.16332 \times {10}^{- 10} m )} + \\ \frac{4}{3} ( \frac{1}{2} \frac{{ℏ}^{2}}{{{m}_{e} ( 1.16332 \times {10}^{- 10} m )}^{2}} ) + \\ {E}_{T} ( atom - atom , {msp}^{3} \cdot AO )\end{matrix} ) = - 24.75614 eV + 3.75374 eV - \frac{1.37960}{2} eV = - 21.69220 eV \qquad ( 21.5 )$$

The band gap in silicon E_{g} given by the difference between E_{T(band gap)}(free e⁻ in Si) (Eq. (21.5)) and E_{T}(Si_{Si—SiMO}) (Eq. (213)) is

$$\begin{matrix}{E}_{g} = {E}_{T ( band gap )} ( free {e}^{-} in Si ) - {E}_{T} ( {Si}_{Si - SiMO} ) \\ = - 21.69220 eV - ( - 22.81179 eV ) \\ = 1.120 eV\end{matrix} \qquad ( 21.6 )$$

The experimental band gap for silicon [6] is

E=1.12 eV (21.7)

The calculated band gap is in excellent agreement with the experimentally measured value. This result along with the prediction of the correct lattice parameters, cohesive energy, and bond angles given in Tables 21.2, 21.5, and 21.6 (as shown in the priority document), respectively, confirms that conductivity in silicon is due the creation of discrete ions, Si+ and e⁻, with the excitation of electrons from covalent bonds. The current carriers are free metal-type electrons that exist as planar membranes with current propagation along these structures shown in FIG. 27. Since the conducting electrons are equivalent to those of metals, the resulting kinetic energy distribution over the population of electrons can be modeled using the statistics of electrons in metals, Fermi Dirac statistics given in the Fermi-Dirac section and the Physical Implications of Free Electrons in Metals section.

### REFERENCES

1. H. N. Waltenburg, J. T. Yates, “Surface chemistry of silicon”, Chem. Rev., Vol. 95, (1995), pp. 1589-1673.
2. D. W. Palmer, www.semiconductors.co.uk, (2006), September.
3. D. R. Lide, CRC Handbook of Chemistry and Physics, 86th Edition, CRC Press, Taylor & Francis, Boca Raton, (2005-6), p. 12-18.
4. D. R. Lide, CRC Handbook of Chemistry and Physics, 86th Edition, CRC Press, Taylor & Francis, Boca Raton, (2005-6), p. 9-86.
5. B. Farid, R. W. Godby, “Cohesive energies of crystals”, Physical Review B, Vol. 43 (17), (1991), pp. 14248-14250.
6. D. R. Lide, CRC Handbook of Chemistry and Physics, 86th Edition, CRC Press, Taylor & Francis, Boca Raton, (2005-6), p. 12-82.

### Boron Molecular Functional Groups and Molecules

### General Considerations of the Boron Molecular Bond

Boron molecules comprising an arbitrary number of atoms can be solved using similar principles and procedures as those used to solve organic molecules of arbitrary length and complexity. Boron molecules can be considered to be comprised of functional groups such as B—B, B—C, B—H, B—O, B—N, B—X (X is a halogen atom), and the alkyl functional groups of organic molecules. The solutions of these functional groups or any others corresponding to the particular boron molecule can be conveniently obtained by using generalized forms of the force balance equation given in the Force Balance of the σ MO of the Carbon Nitride Radical section for molecules comprised of boron and hydrogen only and the geometrical and energy equations given in the Derivation of the General Geometrical and Energy Equations of Organic Chemistry section for boron molecules further comprised of heteroatoms such as carbon. The appropriate functional groups with the their geometrical parameters and energies can be added as a linear sum to give the solution of any molecule containing boron.

### Boranes (BₓH_{y})

As in the case of carbon, silicon, and aluminum, the bonding in the boron atom involves four sp³ hybridized orbitals formed from the 2p and 2s electrons of the outer shells except that only three HOs are filled. Bonds form between the B2sp³ HOs of two boron atoms and between a B2sp³ HO and a H1s AO to yield boranes. The geometrical parameters of each B—H and B—B functional group is solved from the force balance equation of the electrons of the corresponding σ-MO and the relationships between the prolate spheroidal axes. Then, the sum of the energies of the H₂-type ellipsoidal MOs is matched to that of the B2sp³ shell as in the case of the corresponding carbon molecules. As in the case of ethane (C—C functional group given in the Ethane Molecule section) and silane (Si—Si functional group given in the Silanes section), the energy of the B—B functional group is determined for the effect of the donation of 25% electron density from the each participating B2sp³ HO to the B—B-bond MO.

The energy of boron is less than the Coulombic energy between the electron and proton of H given by Eq. (1.243). A minimum energy is achieved while matching the potential, kinetic, and orbital energy relationships given in the Hydroxyl Radical (OH) section with the donation of 25% electron density from each participating B2sp³ HO to each B—H and B—B-bond MO. As in the case of acetylene given in the Acetylene Molecule section, the energies of the B—H and B—B functional groups are determined for the effect of the charge donation.

The 2sp³ hybridized orbital arrangement is

$$\begin{matrix}2 {sp}^{3} state \\ \frac{↑}{0 , 0} \frac{↑}{1 , - 1} \frac{↑}{1 , 0} \frac{ }{1 , 1}\end{matrix} \qquad ( 22.1 )$$

where the quantum numbers (l, mₜ) are below each electron. The total energy of the state is given by the sum over the four electrons. The sum E_{T}(B, 2sp³) of experimental energies [1] of B, B⁺, and B²⁺ is

E_{T}(B,2sp³)=37.93064 eV+25.1548 eV+8.29802 eV=71.38346 eV (22.2)

By considering that the central field decreases by an integer for each successive electron of the shell, the radius r₂ₛₚ_{³}, of the B2sp³ shell may be calculated from the Coulombic energy using Eq. (15.13):

$$\begin{matrix}{r}_{2 {sp}^{3}} = {\sum }_{n = 2}^{4} \frac{( Z - n ) {e}^{2}}{8 {πɛ}_{0} ( e 71.38346 eV )} \\ = \frac{6 {e}^{2}}{8 {πɛ}_{0} ( e 71.38346 eV )} \\ = 1.14361 {a}_{0}\end{matrix} \qquad ( 22.3 )$$

where Z=5 for boron. Using Eq. (15.14), the Coulombic energy E_{Coulomb}(B,2sp³) of the outer electron of the B2sp³ shell is

$$\begin{matrix}{E}_{Coulomb} ( B , 2 {sp}^{3} ) = \frac{- {e}^{2}}{8 {πɛ}_{0} {r}_{2 {sp}^{3}}} \\ = \frac{- {e}^{2}}{8 {πɛ}_{0} 1.14361 {a}_{0}} \\ = - 11.89724 eV\end{matrix} \qquad ( 22.4 )$$

During hybridization, one of the spin-paired 2s electrons is promoted to B2sp³ shell as an unpaired electron. The energy for the promotion is the magnetic energy given by Eq. (15.15) at the initial radius of the 2s electrons. From Eq. (10.62) with Z=5, the radius r₃ of B2s shell is

r₃=1.07930a₀ (22.5)

Using Eqs. (15.15) and (22.5), the unpairing energy is

$$\begin{matrix}E ( magnetic ) = \frac{2 {πμ}_{0} {e}^{2} {ℏ}^{2}}{{{m}_{e}^{2} ( {r}_{3} )}^{3}} \\ = \frac{8 {πμ}_{0} {μ}_{B}^{2}}{{( 1.07930 {a}_{0} )}^{3}} \\ = 0.09100 eV\end{matrix} \qquad ( 22.6 )$$

Using Eqs. (24.4) and (22.6), the energy E(B,2sp³) of the outer electron of the B2sp³ shell is

$$\begin{matrix}E ( B , 2 {sp}^{3} ) = \frac{- {e}^{2}}{8 {πɛ}_{0} {r}_{2 {sp}^{3}}} + \frac{2 {πμ}_{0} {e}^{2} {ℏ}^{2}}{{{m}_{e}^{2} ( {r}_{3} )}^{3}} \\ = - 11.89724 eV + 0.09100 eV \\ = - 11.80624 eV\end{matrix} \qquad ( 22.7 )$$

Next, consider the formation of the B—H and B—B-bond MOs of boranes wherein each boron atom has a B2sp³ electron with an energy given by Eq. (22.7). The total energy of the state of each boron atom is given by the sum over the three electrons. The sum E_{T}(B_{borane},2sp³) of energies of B2sp³ (Eq. (22.7)), and B²+ is

$$\begin{matrix}{E}_{T} ( {B}_{borane} , 2 {sp}^{3} ) = - ( 37.93064 eV + 25.1548 eV + E ( B , 2 {sp}^{3} ) ) \\ = - ( 37.93064 eV + 25.1548 eV + 11.80624 eV ) \\ = - 74.89168 eV\end{matrix} \qquad ( 22.8 )$$

where E(B,2sp³) is the sum of the energy of B, −8.29802 eV, and the hybridization energy.

Each B—H-bond MO forms with the sharing of electrons between each B2sp³ HO and each H1s AO. As in the case of C—H, the H₂-type ellipsoidal MO comprises 75% of the B—H-bond MO according to Eq. (13.429) and Eq. (13.59). Similarly to the case of C—C, the B—B H₂-type ellipsoidal MO comprises 50% contribution from the participating B2sp³ HOs according to Eq. (14.152). The sharing of electrons between a B2sp³ HO and one or more H1s AOs to form B—H-bond MOs or between two B2sp³ HOs to form a B—B-bond MO permits each participating orbital to decrease in size and energy. As shown below, the boron HOs have spin and orbital angular momentum terms in the force balance which determines the geometrical parameters of each σ MO. The angular momentum term requires that each σ MO be treated independently in terms of the charge donation. In order to further satisfy the potential, kinetic, and orbital energy relationships, each B2sp³ HO donates an excess of 25% of its electron density to the B—H or B—B-bond MO to form an energy minimum. By considering this electron redistribution in the borane molecule as well as the fact that the central field decreases by an integer for each successive electron of the shell, the radius r_{borane2sp}_{³}, of the B2sp³ shell may be calculated from the Coulombic energy using Eq. (15.18):

$$\begin{matrix}{r}_{borane 2 {sp}^{3}} = ( {\sum }_{n = 2}^{4} ( Z - n ) - 0.25 ) \frac{{e}^{2}}{8 {πɛ}_{0} ( e 74.89168 eV )} \\ = \frac{5.75 {e}^{2}}{8 {πɛ}_{0} ( e 74.89168 eV )} \\ = 1.04462 {a}_{0}\end{matrix} \qquad ( 22.9 )$$

Using Eqs. (15.19) and (22.9), the Coulombic energy E_{Coulomb}(B_{borane},2sp³) of the outer electron of the B2sp³ shell is

$$\begin{matrix}{E}_{Coulomb} ( {B}_{borane} , 2 {sp}^{3} ) = \frac{- {e}^{2}}{8 {πɛ}_{0} {r}_{borane 2 {sp}^{3}}} \\ = \frac{- {e}^{2}}{8 {πɛ}_{0} 1.04462 {a}_{0}} \\ = - 13.02464 eV\end{matrix} \qquad ( 22.10 )$$

During hybridization, one of the spin-paired 2s electrons are promoted to B2sp³ shell as an unpaired electron. The energy for the promotion is the magnetic energy given by Eq. (22.6). Using Eqs. (22.6) and (22.10), the energy E(B_{borane},2sp³) of the outer electron of the B2sp³ shell is

$$\begin{matrix}E ( {B}_{borane} , 2 {sp}^{3} ) = \frac{- {e}^{2}}{8 {πɛ}_{0} {r}_{borane 2 {sp}^{3}}} + \frac{2 {πμ}_{0} {e}^{2} {ℏ}^{2}}{{{m}_{e}^{2} ( {r}_{3} )}^{3}} \\ = - 13.02464 eV + 0.09100 eV \\ = - 12.93364 eV\end{matrix} \qquad ( 22.11 )$$

Thus, E_{T}(B—H,2sp³) and E_{T}(B —B,2sp³), the energy change of each B2sp³ shell with the formation of the B—H and B—B-bond MO, respectively, is given by the difference between Eq. (22.11) and Eq. (22.7):

$$\begin{matrix}{E}_{T} ( B - H , 2 {sp}^{3} ) = {E}_{T} ( B - B , 2 {sp}^{3} ) \\ = E ( {B}_{borane} , 2 {sp}^{3} ) - E ( B , 2 {sp}^{3} ) \\ = - 12.93364 eV - ( - 11.80624 eV ) \\ = - 1.12740 eV\end{matrix} \qquad ( 22.12 )$$

Next, consider the case that each B2sp³ HO donates an excess of 50% of its electron density to the σ MO to form an energy minimum. By considering this electron redistribution in the borane molecule as well as the fact that the central field decreases by an integer for each successive electron of the shell, the radius r_{borane2sp}_{³} of the B2sp³ shell may be calculated from the Coulombic energy using Eq. (15.18):

$$\begin{matrix}{r}_{borane 2 {sp}^{3}} = ( {\sum }_{n = 2}^{4} ( Z - n ) - 0.5 ) \frac{{e}^{2}}{8 {πɛ}_{0} ( e 74.89168 eV )} \\ = \frac{5.5 {e}^{2}}{8 {πɛ}_{0} ( e 74.89168 eV )} \\ = 0.99920 {a}_{0}\end{matrix} \qquad ( 22.13 )$$

Using Eqs. (15.19) and (22.13), the Coulombic energy E_{Coulomb}(B_{borane},2sp³) of the outer electron of the B2sp³ shell is

$$\begin{matrix}{E}_{Coulomb} ( {B}_{borane} , 2 {sp}^{3} ) = \frac{- {e}^{2}}{8 {πɛ}_{0} {r}_{borane 2 {sp}^{3}}} \\ = \frac{- {e}^{2}}{8 {πɛ}_{0} 0.99920 {a}_{0}} \\ = - 13.61667 eV\end{matrix} \qquad ( 22.14 )$$

During hybridization, one of the spin-paired 2s electrons is promoted to B2sp³ shell as an unpaired electron. The energy for the promotion is the magnetic energy given by Eq. (22.6). Using Eqs. (22.6) and (22.14), the energy E(B_{borane},2sp³) of the outer electron of the B2sp³ shell is

$$\begin{matrix}E ( {B}_{borane} , 2 {sp}^{3} ) = \frac{- {e}^{2}}{8 {πɛ}_{0} {r}_{borane 2 {sp}^{3}}} + \frac{2 {πμ}_{0} {e}^{2} {ℏ}^{2}}{{{m}_{e}^{2} ( {r}_{3} )}^{3}} \\ = - 13.61667 eV + 0.09100 eV \\ = - 13.52567 eV\end{matrix} \qquad ( 22.15 )$$

Thus, E_{T}(B−atom,2sp³), the energy change of each B2sp³ shell with the formation of the B−atom-bond MO is given by the difference between Eq. (22.15) and Eq. (22.7):

$$\begin{matrix}{E}_{T} ( B - atom , 2 {sp}^{3} ) = E ( {B}_{borane} , 2 {sp}^{3} ) - E ( B , 2 {sp}^{3} ) \\ = - 13.52567 eV - ( - 11.80624 eV ) \\ = - 1.711943 eV\end{matrix} \qquad ( 22.16 )$$

Consider next the radius of the HO due to the contribution of charge to more than one bond. The energy contribution due to the charge donation at each boron atom superimposes linearly. In general, the radius rₘₒₗ₂ₛₚ_{³} of the B2sp³ HO of a boron atom of a given borane molecule is calculated after Eq. (15.32) by considering ΣE_{T}_{ₘₒₗ}(MO,2sp³), the total energy donation to all bonds with which it participates in bonding. The general equation for the radius is given by

$$\begin{matrix}{r}_{mol 3 {sp}^{3}} = \frac{- {e}^{2}}{8 {πɛ}_{0} ( {E}_{Coulomb} ( B , 2 {sp}^{3} ) + \sum {E}_{{T}_{mol}} ( MO , 2 {sp}^{3} ) )} \\ = \frac{{e}^{2}}{8 {πɛ}_{0} ( e 11.89724 eV + \sum \vert {E}_{{T}_{mol}} ( MO , 2 {sp}^{3} ) \vert )}\end{matrix} \qquad ( 22.17 )$$

where E_{Coulomb}(B, 2sp³) is given by Eq. (22.4). The Coulombic energy E_{Coulomb}(B, 2sp³) of the outer electron of the B 2sp³ shell considering the charge donation to all participating bonds is given by Eq. (15.14) with Eq. (22.4). The energy E(B,2sp³) of the outer electron of the B 2sp³ shell is given by the sum of E_{Coulomb}(B, 2sp³) and E(magnetic) (Eq. (22.6)). The final values of the radius of the B2sp³ HO, r₂ₛₚ_{³}, E_{Coulomb}(B,2sp3), and E(B_{borane}2sp³) calculated using ΣE_{T}_{ₘₒₗ}(MO,2sp³), the total energy donation to each bond with which an atom participates in bonding are given in Table 22.1. These hybridization parameters are used in Eqs. (15.88-15.117) for the determination of bond angles given in Table 22.7 (as shown in the priority document).

TABLE 22.1
Atom hybridization designation (# first column) and hybridization
parameters of atoms for determination of bond angles with final values
of r₂ₛₚ_{³}, E_{Coulomb} (B, 2sp³) (designated as E_{Coulomb}), and E(B_{borane} 2sp³)
(designated as E) calculated using the appropriate values of ΣE_{T}_{ₘₒₗ} (MO, 2sp³)
(designated as E_{T}) for each corresponding terminal bond spanning each angle.

| | | | | | | r₃ₛₚ_{³} | E_{Coulomb} (eV) | E (eV) |
|---|---|---|---|---|---|---|---|---|
| # | E_{T} | E_{T} | E_{T} | E_{T} | E_{T} | Final | Final | Final |
| 1 | 0 | 0 | 0 | 0 | 0 | 1.14361 | 11.89724 | 11.80624 |
| 2 | −1.71943 | 0 | 0 | 0 | 0 | 0.99920 | −13.61667 | −13.52567 |
| 3 | −1.18392 | −1.18392 | 0 | 0 | 0 | 0.95378 | −14.26508 | −14.17408 |
| 4 | −1.12740 | −1.12740 | −0.56370 | 0 | 0 | 0.92458 | −14.71574 | −14.62474 |

The MO semimajor axes of the B—H and B—B functional groups of boranes are determined from the force balance equation of the centrifugal, Coulombic, and magnetic forces as given in the Polyatomic Molecular Ions and Molecules section and the More Polyatomic Molecules and Hydrocarbons section. In each case, the distance from the origin of the H₂-type-ellipsoidal-MO to each focus c′, the internuclear distance 2c′, and the length of the semiminor axis of the prolate spheroidal H₂-type MO b=c are solved from the semimajor axis a. Then, the geometric and energy parameters of each MO are calculated using Eqs. (15.1-15.117).

The force balance of the centrifugal force equated to the Coulombic and magnetic forces is solved for the length of the semimajor axis. The Coulombic force on the pairing electron of the MO is

$${F}_{Coulomb} = \frac{{e}^{2}}{8 {πɛ}_{0} a {b}^{2}} D {i}_{ξ} \qquad ( 22.18 )$$

The spin-pairing force is

$${F}_{spin \text{-} pairing} = \frac{{ℏ}^{2}}{2 {m}_{e} {a}^{2} {b}^{2}} D {i}_{ξ} \qquad ( 22.19 )$$

The diamagnetic force is:

$${F}_{diamagneticMO 1} = - \frac{{n}_{e} {ℏ}^{2}}{4 {m}_{e} {a}^{2} {b}^{2}} D {i}_{ξ} \qquad ( 22.20 )$$

where nₑ is the total number of electrons that interact with the binding σ-MO electron. The diamagnetic force F_{diamagneticMO2} on the pairing electron of the σ MO is given by the sum of the contributions over the components of angular momentum:

$${F}_{diamagneticMO 2} = - {\sum }_{i , j} \frac{\vert {L}_{i} \vert ℏ}{{Z}_{j} 2 {m}_{e} {a}^{2} {b}^{2}} D {i}_{ξ} \qquad ( 22.21 )$$

where |L| is the magnitude of the angular momentum of each atom at a focus that is the source of the diamagnetism at the σ-MO. The centrifugal force is

$${F}_{centrifugalMO} = - \frac{{ℏ}^{2}}{{m}_{e} {a}^{2} {b}^{2}} D {i}_{ξ} \qquad ( 22.22 )$$

The force balance equation for the σ-MO of the two-center B—H-bond MO is the given by centrifugal force given by Eq. (22.22) equated to the sum of the Coulombic (Eq. (22.18)), spin-pairing (Eq. (22.19)), and F_{diamagneticMO2} (Eq. (22.21)) with

$$\vert L \vert = 4 \sqrt{\frac{3}{4}} ℏ$$

corresponding to the four B2sp³ HOs:

$$\begin{matrix}\frac{{ℏ}^{2}}{{m}_{e} {a}^{2} {b}^{2}} D = \frac{{e}^{2}}{8 {πɛ}_{0} a {b}^{2}} D + \frac{{ℏ}^{2}}{2 {m}_{e} {a}^{2} {b}^{2}} D - \frac{4 \sqrt{\frac{3}{4}}}{Z} \frac{{ℏ}^{2}}{2 {m}_{e} {a}^{2} {b}^{2}} D & ( 22.23 ) \\ a = ( 1 + \frac{4 \sqrt{\frac{3}{4}}}{Z} ) {a}_{0} & ( 22.24 )\end{matrix}$$

With Z=5, the semimajor axis of the B—H-bond MO is

a=1.69282a₀ (22.25)

The force balance equation for each σ-MO of the B—B-bond MO with nₑ=2 and

$$\vert L \vert = 3 \sqrt{\frac{3}{4}} ℏ$$

corresponding to three electrons of the B2sp³ shell is

$$\begin{matrix}\frac{{ℏ}^{2}}{{m}_{e} {a}^{2} {b}^{2}} D = \frac{{e}^{2}}{8 {πɛ}_{0} a {b}^{2}} D + \frac{{ℏ}^{2}}{2 {m}_{e} {a}^{2} {b}^{2}} D - ( 1 + \frac{3 \sqrt{\frac{3}{4}}}{Z} ) \frac{{ℏ}^{2}}{2 {m}_{e} {a}^{2} {b}^{2}} D & ( 22.26 ) \\ a = ( 2 + \frac{3 \sqrt{\frac{3}{4}}}{Z} ) {a}_{0} & ( 22.27 )\end{matrix}$$

With Z=5, the semimajor axis of the B—B-bond MO is

a=2.51962a₀ (22.28)

Using the semimajor axis, the geometric and energy parameters of the MO are calculated using Eqs. (15.1-15.127) in the same manner as the organic functional groups given in the Organic Molecular Functional Groups and Molecules section. For the B—H functional group, c₁ is one and C₁=0.75 based on the MO orbital composition as in the case of the C—H-bond MO. In boranes, the energy of boron is less than the Coulombic energy between the electron and proton of H given by Eq. (1.243). Thus, the energy matching condition is determined by the c₂ and C₂ parameters in Eqs. (15.51) and (15.61). Then, the hybridization factor for the B—H-bond MO given by the ratio of 11.89724 eV, the magnitude of E_{Coulomb}(B_{borane},2sp³) (Eq. (22.4)), and 13.605804 eV, the magnitude of the Coulombic energy between the electron and proton of H (Eq. (1.243)):

$${c}_{2} = {C}_{2} ( borane 2 {sp}^{3} HO ) = \frac{11.89724 eV}{13.605804 eV} = 0.87442 \qquad ( 22.29 )$$

Since the energy of the MO is matched to that of the B2sp³ HO, E(AO/HO) in Eqs. (15.51) and (15.61) is E(B,2sp³) given by Eq. (22.7), and E_{T}(atom−atom,msp³.AO) is one half of −1.12740 eV corresponding the independent single-bond charge contribution (Eq. (22.12)) of one center.

For the B—B functional group, c₁ is one and C₁=0.5 based on the MO orbital composition as in the case of the C—C-bond MO. The energy matching condition is determined by the c₂ and C₂ parameters in Eqs. (15.51) and (15.61), and the hybridization factor for the B—B-bond MO given is by Eq. (22.29). Since the energy of the MO is matched to that of the B2sp³ HO, E(AO/HO) in Eqs. (15.51) and (15.61) is E(B,2sp³) given by Eq. (22.7), and E_{T}(atom−atom,msp³.AO) is two times −1.12740 eV corresponding the independent single-bond charge contributions (Eq. (22.12)) from each of the two B2sp³ HOs.

### Bridging Bonds of Boranes (B—H—B and B—B—B)

As in the case of the Al 3sp³ HOs given in the Organoaluminum Hydrides (Al—H—Al and Al—C—Al) section, the B2sp³ HOs comprise four orbitals containing three electrons as given by Eq. (23.1) that can form three-center as well as two-center bonds. The designation for a three-center bond involving two B2sp³ HOs and a H1s AO is B—H—B, and the designation for a three-center bond involving three B2sp³ HOs is B—B—B.

The parameters of the force balance equation for the σ-MO of the B—H—B-bond MO are nₑ=2 and |L|=0 due to the cancellation of the angular momentum between borons:

$$\frac{{ℏ}^{2}}{{m}_{e} {a}^{2} {b}^{2}} D = \frac{{e}^{2}}{8 {πɛ}_{0} a {b}^{2}} D + \frac{{ℏ}^{2}}{2 {m}_{e} {a}^{2} {b}^{2}} D - \frac{{ℏ}^{2}}{2 {m}_{e} {a}^{2} {b}^{2}} D \qquad ( 22.30 )$$

From Eq. (22.30), the semimajor axis of the B—H—B-bond MO is

a=2a₀ (22.31)

The parameters in Eqs. (15.51) and (15.61) are the same as those of the B—H—B functional group except that E_{T}(atom−atom,msp³.AO) is two times −1.12740 eV corresponding the independent single-bond charge contributions (Eq. (22.12)) from each of the two B2sp³ HOs. The force balance equation and the semimajor axis for the σ-MO of the B—B—B-bond MO are the same as those of the B—B-bond MO given by Eqs. (22.30) and (22.31), respectively. The parameters in Eqs. (15.51) and (15.61) are the same as those of the B—B functional group except that E_{T}(atom−atom,msp³.AO) is three times −1.12740 eV corresponding the independent single-bond charge contributions (Eq. (22.12)) from each of the three B2sp³ HOs.

The H₂-type ellipsoidal MOs of the B—H—B three-center intersect and form a continuous single surface. However, in the case of the B—B—B-bond MO the current of each B—B MO forms a bisector current described in the Methane Molecule (CH₄) section that is continuous with the center B2sp³-HO shell (Eqs. (15.36-15.44)). Based on symmetry, the polar angle φ at which the B—H—B H₂-type ellipsoidal MOs intersect is given by the bisector of the external angle between the B—H bonds:

$$φ = \frac{360 ° - {θ}_{∠ BHB}}{2} = \frac{360 ° - 85.4 °}{2} = 137.3 ° \qquad ( 22.32 )$$

where [2]

θ_{∠BHB}=85.4° (22.33)

The polar radius rᵢ at this angle is given by Eqs. (13.84-13.85):

$${r}_{i} = ( a - {c}^{′} ) \frac{1 + \frac{{c}^{′}}{a}}{1 + \frac{{c}^{′}}{a} cos {φ}^{′}} \qquad ( 22.34 )$$

Substitution of the parameters of Table 22.2 into Eq. (22.34) gives

rᵢ=2.26561a₀=1.19891×10⁻¹⁰ m (22.35)

The polar angle φ at which the B—B—B H₂-type ellipsoidal MOs intersect is given by the bisector of the external angle between the B—B bonds:

$$φ = \frac{360 ° - {θ}_{∠ BBB}}{2} = \frac{360 ° - 58.9 °}{2} = 150.6 ° \qquad ( 22.36 )$$

where [3]

θ_{∠BHB}=58.9° (22.37)

The polar radius rᵢ at this angle is given by Eqs. (13.84-13.85):

$${r}_{i} = ( a - {c}^{′} ) \frac{1 + \frac{{c}^{′}}{a}}{1 + \frac{{c}^{′}}{a} cos {φ}^{′}} \qquad ( 22.38 )$$

Substitution of the parameters of Table 22.2 into Eq. (22.38) gives

rᵢ=3.32895a₀=1.76160×10⁻¹⁰ m (22.39)

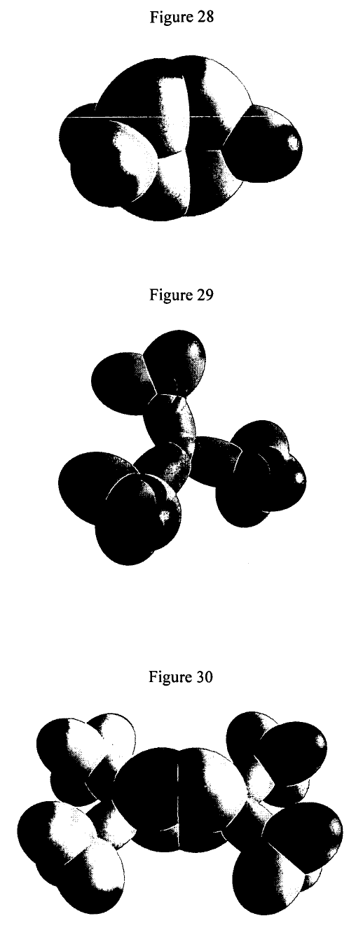

The symbols of the functional groups of boranes are given in Table 22.2. The geometrical (Eqs. (15.1-15.5) and (22.23-22.39)), intercept (Eqs. (15.80-15.87) and (22.17)), and energy (Eq. (15.61), (22.4), (22.7), (22.12), and (22.29)) parameters of boranes are given in Tables 22.3, 22.4 (as shown in the priority document), and 22.5, respectively. In the case that the MO does not intercept the B HO due to the reduction of the radius from the donation of Bsp³ HO charge to additional MO's, the energy of each MO is energy matched as a linear sum to the B HO by contacting it through the bisector current of the intersecting MOs as described in the Methane Molecule (CH₄) section. The total energy of each borane given in Table 22.6 (as shown in the priority document) was calculated as the sum over the integer multiple of each E_{D} (Group) of Table 22.5 corresponding to functional-group composition of the molecule. E_{mag} of Table 22.5 is given by Eqs. (15.15) and (22.3). The bond angle parameters of boranes determined using Eqs. (15.88-15.117) and (20.36) with B2sp³ replacing Si3sp³ are given in Table 22.7 (as shown in the priority document). The charge-density in diborane is shown in FIG. 28.

TABLE 22.2
The symbols of the functional groups of boranes.

| Functional Group | Group Symbol |
|---|---|
| BH group | B—H |
| BHB (bridged H) | B—H—B |
| BB bond | B—B |
| BBB (bridged B) | B—B—B |

TABLE 22.3
The geometrical bond parameters of boranes
and experimental values.

| | | | B—B |
|---|---|---|---|
| | | | and |
| | B—H | B—H—B | B—B—B |
| Parameter | Group | Group | Groups |
| a (a₀) | 1.69282 | 2.00000 | 2.51962 |
| c′ (a₀) | 1.13605 | 1.23483 | 1.69749 |
| Bond Length | 1.20235 | 1.30689 | 1.79654 |
| 2c′ (Å) | | | |
| Exp. Bond | 1.19 [4] | 1.32 [4] | 1.798 [3] |
| Length | (diborane) | (diborane) | (B₁₃H₁₉) |
| (Å) | | | |
| b, c (a₀) | 1.25500 | 1.57327 | 1.86199 |
| e | 0.67110 | 0.61742 | 0.67371 |

TABLE 22.5
The energy parameters (eV) of functional groups of boranes.

| | B—H | B—H—B | B—B | B—B—B |
|---|---|---|---|---|
| Parameters | Group | Group | Group | Group |
| n₁ | 1 | 1 | 1 | 1 |
| n₂ | 0 | 0 | 0 | 0 |
| n₃ | 0 | 0 | 0 | 0 |
| C₁ | 0.75 | 0.75 | 0.5 | 0.5 |
| C₂ | 0.87442 | 0.87442 | 0.87442 | 0.87442 |
| c₁ | 1 | 1 | 1 | 1 |
| c₂ | 0.87442 | 0.87442 | 0.87442 | 0.87442 |
| c₃ | 0 | 0 | 0 | 0 |
| c₄ | 1 | 1 | 2 | 2 |
| c₅ | 1 | 1 | 0 | 0 |
| C₁ₒ | 0.75 | 0.75 | 0.5 | 0.5 |
| C₂ₒ | 0.87442 | 0.87442 | 0.87442 | 0.87442 |
| Vₑ (eV) | −34.04561 | −27.77951 | −22.91867 | −22.91867 |
| Vₚ (eV) | 11.97638 | 11.01833 | 8.01527 | 8.01527 |
| T (eV) | 10.05589 | 6.94488 | 4.54805 | 4.54805 |
| Vₘ (eV) | −5.02794 | −3.47244 | −2.27402 | −2.27402 |
| E (AO/HO) (eV) | −11.80624 | −11.80624 | −11.80624 | −11.80624 |
| ΔE_{H}_{₂}_{MO} (AO/HO) (eV) | 0 | 0 | 0 | 0 |
| E_{T} (AO/HO) (eV) | −11.80624 | −11.80624 | −11.80624 | −11.80624 |
| E_{T} (H₂MO) (eV) | −28.84754 | −25.09498 | −24.43561 | −24.43561 |
| E_{T} (atom-atom, msp³ · AO) (eV) | −0.56370 | −2.25479 | −2.25479 | −3.38219 |
| E_{T} (MO) (eV) | −29.41123 | −29.60457 | −26.69041 | −27.81781 |
| ω (10¹⁵ rad/s) | 15.2006 | 23.9931 | 6.83486 | 6.83486 |
| E_{K} (eV) | 10.00529 | 15.79265 | 4.49882 | 4.49882 |
| Ē_{D} (eV) | −0.18405 | −0.23275 | −0.11200 | −0.11673 |
| Ē_{Kvib} (eV) | 0.29346 [5] | 0.09844 [6] | 0.13035 [5] | 0.13035 [5] |
| Ē_{osc} (eV) | −0.03732 | −0.18353 | −0.04682 | −0.05156 |
| E_{mag} (eV) | 0.07650 | 0.07650 | 0.07650 | 0.07650 |
| E_{T} (Group) (eV) | −29.44855 | −29.78809 | −26.73723 | −27.86936 |
| Eᵢₙᵢₜᵢₐₗ (c₄ AO/HO) (eV) | −11.80624 | −11.80624 | −11.80624 | −11.80624 |
| Eᵢₙᵢₜᵢₐₗ (c₅ AO/HO) (eV) | −13.59844 | −13.59844 | 0 | 0 |
| E_{D} (Group) (eV) | 4.04387 | 4.38341 | 3.12475 | 4.25687 |

### Alkyl Boranes (RₓB_{y}H_{z}; R=Alkyl)

The alkyl boranes may comprise at least a terminal methyl group (CH₃) and at least one B bound by a carbon-boron single bond comprising a C—B group, and may comprise methylene (CH₂), methylyne (CH), C—C, B—H, B—B, B—H—B, and B—B—B functional groups. The methyl and methylene functional groups are equivalent to those of straight-chain alkanes. Six types of C—C bonds can be identified. The n-alkane C—C bond is the same as that of straight-chain alkanes. In addition, the C—C bonds within isopropyl ((CH₃)₂ CH) and t-butyl ((CH₃)₃C) groups and the isopropyl to isopropyl, isopropyl to t-butyl, and t-butyl to t-butyl C—C bonds comprise functional groups. Additional groups include aromatics such as phenyl. These groups in alkyl boranes are equivalent to those in branched-chain alkanes and aromatics, and the B—H, B—B, B—H—B, and B—B—B functional groups of alkyl boranes are equivalent to those in boranes.

For the C—B functional group, hybridization of the 2s and 2p AOs of each C and B to form single 2sp³ shells forms an energy minimum, and the sharing of electrons between the C2sp³ and B2sp³ HOs to form σ MO permits each participating orbital to decrease in radius and energy. In alkyl boranes, the energy of boron is less than the Coulombic energy between the electron and proton of H given by Eq. (1.243). Thus, c₁ in Eq. (15.61) is one, and the energy matching condition is determined by the c₂ and C₂ parameters. Then, the C2sp³ HO has an energy of E(C,2sp³)=−14.63489 eV (Eq. (15.25)), and the B2sp³ HOs has an energy of E(B,2sp³=−11.80624 eV (Eq. (22.7)). To meet the equipotential condition of the union of the C—B H₂-type-ellipsoidal-MO with these orbitals, the hybridization factors c₂ and C₂ of Eq. (15.61) for the C—B-bond MO given by Eq. (15.77) is

$$\begin{matrix}{c}_{2} ( C 2 {sp}^{3} HO to B 2 {sp}^{3} HO ) = {C}_{2} ( C 2 {sp}^{3} HO to B 2 {sp}^{3} HO ) \\ = \frac{E ( B , 2 {sp}^{3} )}{E ( C , 2 {sp}^{3} )} \\ = \frac{- 11.80624 eV}{- 14.63489 eV} \\ = 0.80672\end{matrix} \qquad ( 22.40 )$$

E_{T}(atom−atom,msp³.AO) of the C—B-bond MO is −1.44915 eV corresponding to the single-bond contributions of carbon and boron of −0.72457 eV given by Eq. (14.151). The energy of the C—B-bond MO is the sum of the component energies of the H₂-type ellipsoidal MO given in Eq. (15.51) with E(AO/HO)=E(B,2sp³) given by Eq. (22.7) and ΔE_{H}_{₂}_{MO}(AO/HO)=E_{T}(atom−atom,msp³.AO) in order to match the energies of the carbon and boron HOs.

Consider next the radius of the HO due to the contribution of charge to more than one bond. The energy contribution due to the charge donation at each boron atom and carbon atom superimposes linearly. In general, since the energy of the B2sp³ HO is matched to that of the C2sp³ HO, the radius rₘₒₗ₂ₛₚ_{³} of the B2sp³ HO of a boron atom and the C2sp³ HO of a carbon atom of a given alkyl borane molecule is calculated after Eq. (15.32) by considering ΣE_{T}_{ₘₒₗ}(MO,2sp³), the total energy donation to all bonds with which it participates in bonding. The Coulombic energy E_{Coulomb}(atom, 2sp³) of the outer electron of the atom 2sp³ shell considering the charge donation to all participating bonds is given by Eq. (15.14). The hybridization parameters used in Eqs. (15.88-15.117) for the determination of bond angles of alkyl boranes are given in Table 22.8.

TABLE 22.8
Atom hybridization designation (# first column) and hybridization parameters
of atoms for determination of bond angles with final values of r₂ₛₚ_{³}, E_{Coulomb}
(atom, 2sp³) (designated as E_{Coulomb}), and E_{Coulomb}(atom_{alkylborane}2sp³)
(designated as E) calculated using the appropriate values of ΣE_{T}_{ₘₒₗ} (MO, 2sp³)
(designated as E_{T}) for each corresponding terminal bond spanning each angle.

| | | | | | | | E_{Coulomb} (eV) | E (eV) |
|---|---|---|---|---|---|---|---|---|
| # | E_{T} | E_{T} | E_{T} | E_{T} | E_{T} | r₃ₛₚ_{³} Final | Final | Final |
| 1 | −0.36229 | −0.92918 | 0 | 0 | 0 | 0.84418 | −16.11722 | −15.92636 |

The symbols of the functional groups of alkyl boranes are given in Table 22.9. The geometrical (Eqs. (15.1-15.5) and (22.23-22.40)), intercept (Eqs. (15.32) and (15.80-15.87)), and energy (Eq. (15.61), (22.4), (22.7), (22.12), (22.29), and (22.40)) parameters of alkyl boranes are given in Tables 22.10, 22.11, and 22.12, respectively (all as shown in the priority document). In the case that the MO does not intercept the B HO due to the reduction of the radius from the donation of B 2sp³ HO charge to additional MO's, the energy of each MO is energy matched as a linear sum to the B HO by contacting it through the bisector current of the intersecting MOs as described in the Methane Molecule (CH₄) section. The total energy of each alkyl borane given in Table 22.13 (as shown in the priority document) was calculated as the sum over the integer multiple of each E_{D} (Group) of Table 22.12 (as shown in the priority document) corresponding to functional-group composition of the molecule. E_{mag} of Table 22.13 (as shown in the priority document) is given by Eqs. (15.15) and (22.3) for B—H. The bond angle parameters of alkyl boranes determined using Eqs. (15.88-15.117) are given in Table 22.14 (as shown in the priority document). The charge-densities of exemplary alkyl borane, trimethylborane and alkyl diborane, tetramethyldiborane comprising the concentric shells of atoms with the outer shell bridged by one or more H₂-type ellipsoidal MOs or joined with one or more hydrogen MOs are shown in FIGS. 29 and 30, respectively.

TABLE 22.9
The symbols of the functional groups of alkyl boranes.

| Functional Group | Group Symbol |
|---|---|
| C—B bond | C—B |
| BH bond | B—H |
| BHB (bridged H) | B—H—B |
| BB bond | B—B |
| BBB (bridged B) | B—B—B |
| CC (aromatic bond) | C^{3e}═C |
| CH (aromatic) | CH (i) |
| CH₃ group | C—H (CH₃) |
| CH₂ group | C—H (CH₂) |
| CH | C—H (ii) |
| CC bond (n-C) | C—C (a) |
| CC bond (iso-C) | C—C (b) |
| CC bond (tert-C) | C—C (c) |
| CC (iso to iso-C) | C—C (d) |
| CC (t to t-C) | C—C (e) |
| CC (t to iso-C) | C—C (f) |

### Alkoxy Boranes ((RO)ₓ B_{y}H_{z}; R=Alkyl) and Aklyl Borinic Acids ((RO)_{q} BᵣHₛ(HO)ₜ)

The alkoxy boranes and borinic acids each comprise a B—O functional group, at least one boron-alkyl-ether moiety or a one or more hydroxyl groups, respectively, and in some cases one or more alkyl groups and borane moieties. Each alkoxy moiety, CₙH₂ₙ₊₁O, of alkoxy boranes comprises one of two types of C—O functional groups that are equivalent to those give in the Ethers (CₙH₂ₙ₊₂Oₘ, n=2,3,4,5 . . . ∞) section. One is for methyl or t-butyl groups, and the other is for general alkyl groups. Each hydroxyl functional group of borinic acids and alkyl borinic acids is equivalent to that given in the Alcohols (CₙH₂ₙ₊₂Oₘ, n=1,2,3,4,5 . . . ∞) section. The alkyl portion may be part of the alkoxy moiety, or an alkyl group may be bound to the central boron atom by a carbon-boron single bond comprising the C—B group of the Alkyl Boranes (RₓB_{y}H_{z}; R=alkyl) section. Each alkyl portion may comprise at least a terminal methyl group (CH₃) and methylene (CH₂), methylyne (CH), and C—C functional groups. The methyl and methylene functional groups are equivalent to those of straight-chain alkanes. Six types of C—C bonds can be identified. The n-alkane C—C bond is the same as that of straight-chain alkanes. In addition, the C—C bonds within isopropyl ((CH₃)₂ CH) and t-butyl ((CH₃)₃C) groups and the isopropyl to isopropyl, isopropyl to t-butyl, and t-butyl to t-butyl C—C bonds comprise functional groups. Additional R groups include aromatics such as phenyl. These groups in alkoxy boranes and alkyl borinic acids are equivalent to those in branched-chain alkanes and aromatics given in the corresponding sections. Furthermore, B—H, B—B, B—H—B, and B—B—B groups may be present that are equivalent to those in boranes as given in the Boranes (B_{z}H_{y}) section.

The MO semimajor axes of the B—O functional groups of alkoxy alkanes and borinic acids are determined from the force balance equation of the centrifugal, Coulombic, and magnetic forces as given in the Boranes (BₓH_{y}) section. In each case, the distance from the origin of the H₂-type-ellipsoidal-MO to each focus c′, the internuclear distance 2c′, and the length of the semiminor axis of the prolate spheroidal H₂-type MO b=c are solved from the semimajor axis a. Then, the geometric and energy parameters of each MO are calculated using Eqs. (15.1-15.117).

The parameters of the force balance equation for the σ-MO of the B—O-bond MO in Eqs. (22.18-22.22) are nₑ=2 and |L|=0:

$$\frac{{ℏ}^{2}}{{m}_{e} {a}^{2} {b}^{2}} D = \frac{{e}^{2}}{8 {πɛ}_{0} a {b}^{2}} D + \frac{{ℏ}^{2}}{2 {m}_{e} {a}^{2} {b}^{2}} D - \frac{{ℏ}^{2}}{2 {m}_{e} {a}^{2} {b}^{2}} D \qquad ( 22.41 )$$

From Eq. (22.41), the semimajor axis of the B—O-bond MO is

a=2a₀ (22.42)

For the B—O functional groups, hybridization of the 2s and 2p AOs of each C and B to form single 2sp³ shells forms an energy minimum, and the sharing of electrons between the C2sp³ and B2sp³ HOs to form σ MO permits each participating orbital to decrease in radius and energy. The energy of boron is less than the Coulombic energy between the electron and proton of H given by Eq. (1.243). Thus, in c₁ and c₂ in Eq. (15.61) is one, and the energy matching condition is determined by the C₂ parameter. The approach to the hybridization factor of O to B in boric acids is similar to that of the O to S bonding in the SO group of sulfoxides. The O AO has an energy of E(O)=−13.61805 eV, and the B2sp³ HOs has an energy of E(B,2sp³)=−11.80624 eV (Eq. (22.7)). To meet the equipotential condition of the union of the B—O H₂-type-ellipsoidal-MO with these orbitals in borinic acids and to energy match the OH group, the hybridization factor C₂ of Eq. (15.61) for the B—O-bond MO given by Eq. (15.77) is

$$\begin{matrix}{C}_{2} ( OAO to B 2 {sp}^{3} HO ) = \frac{E ( OAO )}{E ( B , 2 {sp}^{3} )} \\ = \frac{- 13.61805 eV}{- 11.80624 eV} \\ = 1.15346\end{matrix} \qquad ( 22.43 )$$

Since the energy of the MO is matched to that of the B2sp³ HO, E(AO/HO) in Eqs. (15.51) and (15.61) is E(B,2sp³) given by Eq. (22.7), and E_{T}(atom−atom,msp³.AO) is −1.12740 eV corresponding to the independent single-bond charge contribution (Eq. (22.12)) of one center.

The parameters of the B—O functional group of alkoxy boranes are the same as those of borinic acids except for C₁ and C₂. Rather than being bound to an H, the oxygen is bound to a C2sp³ HO, and consequently, the hybridization of the C—O given by Eq. (15.133) includes the C2sp³ HO hybridization factor of 0.91771 (Eq. (13.430)). To meet the equipotential condition of the union of the B—O H₂-type-ellipsoidal-MO with the B2sp³ HOs having an energy of E(B,2sp³)=−11.80624 eV (Eq. (22.7)) and the O AO having an energy of E(O)=−13.61805 eV such that the hybridization matches that of the C—O-bond MO, the hybridization factor C₂ of Eq. (15.61) for the B—O-bond MO given by Eqs. (15.77) and (15.79) is

$$\begin{matrix}{C}_{2} ( B 2 {sp}^{3} HO to O ) = \frac{E ( B , 2 {sp}^{3} )}{E ( O )} {c}_{2} ( C 2 {sp}^{3} HO ) \\ = \frac{- 11.80624 eV}{- 13.61805 eV} ( 0.91771 ) = 0.79562\end{matrix} \qquad ( 22.44 )$$

Furthermore, in order to form an energy minimum in the B—O-bond MO, oxygen acts as an H in bonding with B since the 2p shell of 0 is at the Coulomb energy between an electron and a proton (Eq. (10.163)). In this case, k′ is 0.75 as given by Eq. (13.59) such that C₁=0.75 in Eq. (15.61).

Consider next the radius of the HO due to the contribution of charge to more than one bond. The energy contribution due to the charge donation at each boron atom and oxygen atom superimposes linearly. In general, since the energy of the B2sp³ HO and O AO is matched to that of the C2sp³ HO when a the molecule contains a C—B-bond MO and a C—O-bond MO, respectively, the corresponding radius rₘₒₗₛₚ_{³} of the B2sp³ HO of a boron atom, the C2sp³ HO of a carbon atom, and the O AO of a given alkoxy borane or borinic acid molecule is calculated after Eq. (15.32) by considering ΣE_{T}_{ₘₒₗ}(MO,2sp³), the total energy donation to all bonds with which it participates in bonding. The Coulombic energy E_{Coulomb}(atom,2sp³) of the outer electron of the atom 2sp³ shell considering the charge donation to all participating bonds is given by Eq. (15.14). In the case that the boron or oxygen atom is not bound to a C2sp³ HO, rₘₒₗ₂ₛₚ_{³} is calculated using Eq. (15.31) where E_{Coulomb}(atom,msp³) is E_{Coulomb}(B2sp³)=11.89724 eV and E(O)=−13.61805 eV, respectively.

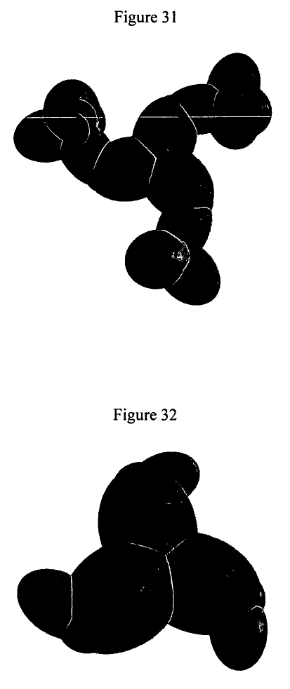

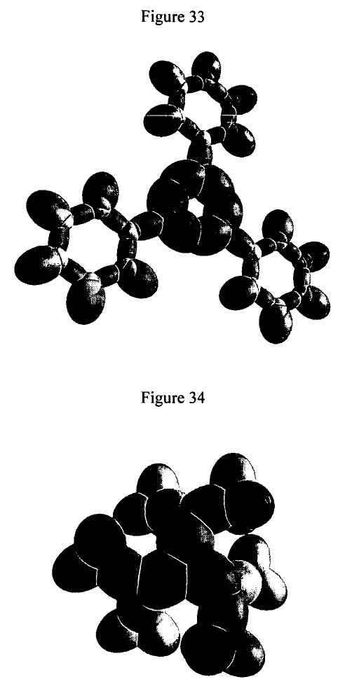

The symbols of the functional groups of alkoxy boranes and borinic acids are given in Table 22.15. The geometrical (Eqs. (15.1-15.5) and (22.42-22.44)), intercept (Eqs. (15.31-15.32) and (15.80-15.87)), and energy (Eq. (15.61), (22.4), (22.7), (22.12), (22.29), and (22.43-22.44)) parameters of alkoxy boranes and borinic acids are given in Tables 22.16, 22.17, and 22.18, respectively (all as shown in the priority document). In the case that the MO does not intercept the B HO due to the reduction of the radius from the donation of B 2sp³ HO charge to additional MO's, the energy of each MO is energy matched as a linear sum to the B HO by contacting it through the bisector current of the intersecting MOs as described in the Methane Molecule (CH₄) section. The total energy of each alkyl borane given in Table 22.19 (as shown in the priority document) was calculated as the sum over the integer multiple of each E_{D} (Group) of Table 22.18 (as shown in the priority document) corresponding to functional-group composition of the molecule. E_{mag} of Table 22.18 (as shown in the priority document) is given by Eqs. (15.15) and (22.3) for the B—O groups and the B—H, B—B, B—H—B, and B—B—B groups. E_{mag} of Table 22.18 (as shown in the priority document) is given by Eqs. (15.15) and (10.162) for the OH group. The bond angle parameters of alkoxy boranes and borinic acids determined using Eqs. (15.88-15.117) are given in Table 22.20 (as shown in the priority document). The charge-densities of exemplary alkoxy borane, trimethoxyborane, boric acid, and phenylborinic anhydride comprising the concentric shells of atoms with the outer shell bridged by one or more I I₂-type ellipsoidal MOs or joined with one or more hydrogen MOs are shown in FIGS. 31, 32, and 33, respectively.

TABLE 22.15
The symbols of the functional groups of alkoxy boranes and borinic
acids.

| Functional Group | Group Symbol |
|---|---|
| B—O bond (borinic acid) | B—O (i) |
| B—O bond (alkoxy borane) | B—O (ii) |
| OH group | OH |
| C—O (CH₃—O—and (CH₃)₃C—O—) | C—O (i) |
| C—O (alkyl) | C—O (ii) |
| C—B bond | C—B |
| BH bond | B—H |
| BHB (bridged H) | B—H—B |
| BB bond | B—B |
| BBB (bridged B) | B—B—B |
| CC (aromatic bond) | C^{3e}═C |
| CH (aromatic) | CH (i) |
| CH₃ group | C—H (CH₃) |
| CH₂ group | C—H (CH₂) |
| CH | C—H (ii) |
| CC bond (n-C) | C—C (a) |
| CC bond (iso-C) | C—C (b) |

### Tertiary and Quaternary Animoboranes and Borane Amines (R_{q}BᵣNₛRₜ; R═H; Alkyl)

The tertiary and quaternary amino boranes and borane amines each comprise at least one B bound by a boron-nitrogen single bond comprising a B—N group, and may comprise at least a terminal methyl group (CH₃), as well other alkyl and borane groups such as methylene (CH₂), methylyne (CH), C—C, B—H, B—C, B—H, B—B, B—H—B, and B—B—B functional groups. The methyl and methylene functional groups are equivalent to those of straight-chain alkanes. Six types of C—C bonds can be identified. The n-alkane C—C bond is the same as that of straight-chain alkanes. In addition, the C—C bonds within isopropyl ((CH₃)₂ CH) and t-butyl ((CH₃)₃C) groups and the isopropyl to isopropyl, isopropyl to t-butyl, and t-butyl to t-butyl C—C bonds comprise functional groups. These groups in tertiary and quaternary amino boranes and borane amines are equivalent to those in branched-chain alkanes, the B—C group is equivalent to that of alkyl boranes, and the B—H, B—B, B—H—B, and B—B—B functional groups are equivalent to those in boranes.

In tertiary amino boranes and borane amines, the nitrogen atom of each B—N bond is bound to two other atoms such that there are a total of three bounds per atom. The amino or amine moiety may comprise NH₂, N(H)R, and NR₂. The corresponding functional group for the NH₂ moiety is the NH₂ functional group given in the Primary Amines (CₙH₂ₙ₊₂₊ₘNₘ, n=1,2,3,4,5 . . . ∞) section. The N(H)R moiety comprises the NH functional group of the Secondary Amines (CₙH₂ₙ₊₂₊ₘNₘ, n=1,2,3,4,5 . . . ∞) section and the C—N functional group of the Primary Amines (CₙH₂ₙ₊₂₊ₘNₘ, n=1,2,3,4,5 . . . ∞) section. The NR₂ moiety comprises two types of C—N functional groups, one for the methyl group corresponding to the C of C—N and the other for general alkyl secondary amines given in the Secondary Amines (CₙH₂ₙ₊₂₊Nₘ, n=2,3,4,5 . . . ∞) section.

In quaternary amino boranes and borane amines, the nitrogen atom of each B—N bond is bound to three other atoms such that there are a total of four bounds per atom. The amino or amine moiety may comprise NH₃, N(H₂)R, N(H)R₂, and NR₃. The corresponding functional group for the NH₃ moiety is ammonia given in the Ammonia (NH₃) section. The N(H₂)R moiety comprises the NH₂ and the C—N functional groups given in the Primary Amines (CₙH₂ₙ₊₂₊ₘNₘ, n=1,2,3,4,5 . . . ∞) section. The N(H)R₂ moiety comprises the NH functional group and two types of C—N functional groups, one for the methyl group corresponding to the C of C—N and the other for general alkyl secondary amines given in the Secondary Amines (CₙH₂ₙ₊₂₊ₘNₘ, n=2,3,4,5 . . . ∞) section. The NR₃ moiety comprises the C—N functional group of tertiary amines given in the Tertiary Amines (CₙH₂ₙ₊₃N, n=3,4,5 . . . ∞) section.

The bonding in the B—N functional groups of tertiary and quaternary amino boranes and borane amines is similar to that of the B—O groups of alkoxy boranes and borinic acids given in the corresponding section. The MO semimajor axes of the B—N functional groups are determined from the force balance equation of the centrifugal, Coulombic, and magnetic forces as given in the Boranes (BₓH_{y}) section. In each case, the distance from the origin of the H₂-type-ellipsoidal-MO to each focus c′, the internuclear distance 2c′, and the length of the semiminor axis of the prolate spheroidal H₂-type MO b=c are solved from the semimajor axis a. Then, the geometric and energy parameters of each MO are calculated using Eqs. (15.1-15.117).

As in the case of the B—O-bond MOs, the σ-MOs of the tertiary and quaternary B—N-bond MOs is energy matched to the B2sp³ HO which determines that the parameters of the force balance equation based on electron angular momentum are determined by those of the boron atom. Thus, the parameters of the force balance equation for the σ-MO of the B—N-bond MOs in Eqs. (22.18-22.22) are nₑ=1 and

$$\vert L \vert = \frac{3 \sqrt{\frac{3}{4}}}{Z}$$

corresponding to the three electrons of the boron atom:

$$\begin{matrix}\frac{{ℏ}^{2}}{{m}_{e} {a}^{2} {b}^{2}} D = \frac{{e}^{2}}{8 {πɛ}_{0} a {b}^{2}} D + \frac{{ℏ}^{2}}{2 {m}_{e} {a}^{2} {b}^{2}} D - ( \frac{1}{2} + \frac{3 \sqrt{\frac{3}{4}}}{Z} ) \frac{{ℏ}^{2}}{2 {m}_{e} {a}^{2} {b}^{2}} D & ( 22.45 ) \\ a = ( \frac{3}{2} + \frac{3 \sqrt{\frac{3}{4}}}{Z} ) {a}_{0} & ( 22.46 )\end{matrix}$$

With Z=5, the semimajor axis of the tertiary B—N-bond MO is

a=2.01962a₀ (22.47)

For the B—N functional groups, hybridization of the 2s and 2p AOs of B to form single 2sp³ shells forms an energy minimum, and the sharing of electrons between the B2sp³ HO and N AO to form σ MO permits each participating orbital to decrease in radius and energy. The energy of boron is less than the Coulombic energy between the electron and proton of H given by Eq. (1.243). Thus, in c₁ and c₂ in Eq. (15.61) is one, and the energy matching condition is determined by the C₁ and C₂ parameters. The N AO has an energy of E(N)=−14.53414 eV, and the B2sp³ HOs has an energy of E(B,2sp³)=−11.80624 eV (Eq. (22.7)). To meet the equipotential condition of the union of the B—N H₂-type-ellipsoidal-MO with these orbitals, the hybridization factor C₂ of Eq. (15.61) for the B—N-bond MO given by Eq. (15.77) is

$$\begin{matrix}{C}_{2} ( NAO to B 2 {sp}^{3} HO ) = \frac{E ( B , 2 {sp}^{3} )}{E ( NAO )} \\ = \frac{- 11.80624 eV}{- 14.53414 eV} \\ = 0.81231\end{matrix} \qquad ( 22.48 )$$

Since the energy of the MO is matched to that of the B2sp³ HO, E(AO/HO) in Eqs. (15.51) and (15.61) is E(B,2sp³) given by Eq. (22.7), and E_{T}(atom−atom,msp³.AO) for ternary B—N is −1.12740 eV corresponding to the independent single-bond charge contribution (Eq. (22.12)) of one center as in the case of the alkoxy borane B—O functional group. Furthermore, k′ is 0.75 as given by Eq. (13.59) such that C₁=0.75 in Eq. (15.61) which is also equivalent to C₁ of the B—O alkoxy borane group. E_{T}(atom−atom,msp³.AO) of the quaternary B—N-bond MO is determined by considering that the bond involves an electron transfer from the nitrogen atom to the boron atom to form zwitterions such as R₃N⁺—B⁻R′₃. By considering the electron redistribution in the quaternary amino borane and borane amine molecule as well as the fact that the central field decreases by an integer for each successive electron of the shell, the radius r_{B-Nborane2sp}_{³} of the B2sp³ shell may be calculated from the Coulombic energy using Eq. (15.18), except that the sign of the charge donation is positive:

$$\begin{matrix}{r}_{B - Nborane 2 {sp}^{3}} = ( {\sum }_{n = 2}^{4} ( Z - n ) + 1 ) \frac{{e}^{2}}{8 {πɛ}_{0} ( e 74.89168 eV )} \\ = \frac{7 {e}^{2}}{8 {πɛ}_{0} ( e 74.89168 eV )} = 1.27171 {a}_{0}\end{matrix} \qquad ( 22.49 )$$

Using Eqs. (15.19) and (22.49), the Coulombic energy E_{Coulomb}(B_{B-Nborane},2sp³) of the outer electron of the B2sp³ shell is

$$\begin{matrix}{E}_{Coulomb} ( {B}_{B - Nborane} , 2 {sp}^{3} ) = \frac{- {e}^{2}}{8 {πɛ}_{0} {r}_{B - Nborane 2 {sp}^{3}}} \\ = \frac{- {e}^{2}}{8 {πɛ}_{0} 1.27171 {a}_{0}} \\ = - 10.69881 eV\end{matrix} \qquad ( 22.50 )$$

During hybridization, one of the spin-paired 2s electrons is promoted to B2sp³ shell as an unpaired electron. The energy for the promotion is the magnetic energy given by Eq. (22.6). Using Eqs. (22.6) and (22.50), the energy E(B_{B-Nborane},2sp³) of the outer electron of the B2sp³ shell is

$$\begin{matrix}E ( {B}_{B - Nborane} , 2 {sp}^{3} ) = \frac{- {e}^{2}}{8 {πɛ}_{0} {r}_{B - Nborane 2 {sp}^{3}}} + \frac{2 {πμ}_{0} {e}^{2} {ℏ}^{2}}{{{m}_{e}^{2} ( {r}_{3} )}^{3}} \\ = - 10.69881 eV + 0.09100 eV \\ = - 10.60781 eV\end{matrix} \qquad ( 22.51 )$$

Thus, E_{T}(B—N,2sp³), the energy change of each B2sp³ shell with the formation of the B—N-bond MO is given by the difference between Eq. (22.51) and Eq. (22.7):

$$\begin{matrix}{E}_{T} ( B - N , 2 {sp}^{3} ) = E ( {B}_{B - Nborane} , 2 {sp}^{3} ) - E ( B , 2 {sp}^{3} ) \\ = - 10.60781 eV - ( - 11.80624 eV ) \\ = 1.19843 eV\end{matrix} \qquad ( 22.52 )$$

Thus, E_{T}(atom−atom,msp³.AO) of the quaternary B—N-bond MO is 1.19843 eV.

Consider next the radius of the HO due to the contribution of charge to more than one bond. The energy contribution due to the charge donation at each boron atom and nitrogen atom superimposes linearly. In general, since the energy of the B2sp³ HO and N AO is matched to that of the C2sp³ HO when a the molecule contains a C—B-bond MO and a C—N-bond MO, respectively, the corresponding radius rₘₒₗ₂ₛₚ_{³} of the B2sp³ HO of a boron atom, the C2sp³ HO of a carbon atom, and the N AO of a given B—N-containing borane molecule is calculated after Eq. (15.32) by considering Z Eₘₒₗ(MO,2sp³), the total energy donation to all bonds with which it participates in bonding. The Coulombic energy E_{Coulomb}(atom, 2sp³) of the outer electron of the atom 2sp³ shell considering the charge donation to all participating bonds is given by Eq. (15.14). In the case that the boron or nitrogen atom is not bound to a C2sp³ HO, rₘₒₗ₂ₛₚ_{³} is calculated using Eq. (15.31) where E_{Coulomb}(atom,msP³) is E_{Coulomb}(B2sp³)=−11.89724 eV and E(N)=−14.53414 eV, respectively. The hybridization parameters used in Eqs. (15.88-15.117) for the determination of bond angles of tertiary and quaternary amino boranes and borane amines are given in Table 22.21.

TABLE 22.21
Atom hybridization designation (# first column) and hybridization parameters
of atoms for determination of bond angles with final values of r₂ₛₚ_{³}, E_{Coulomb}
(atom,2sp³) (designated as E_{Coulomb}), and E(atom_{B-Nborane} 2sp³) (designated as E)
calculated using the appropriate values of _{Σ}E_{T}_{ₘₒₗ} (MO,2sp³) (designated as E_{T})
for each corresponding terminal bond spanning each angle.

| | | | | | | | E_{Coulomb} | E |
|---|---|---|---|---|---|---|---|---|
| | | | | | | r₃ₛₚ_{³} | (eV) | (eV) |
| # | E_{T} | E_{T} | E_{T} | E_{T} | E_{T} | Final | Final | Final |
| 1 | −0.46459 | 0 | 0 | 0 | 0 | 0.88983 | −15.29034 | −15.09948 |
| | | | | | | (Eq. (15.32)) | | |
| 2 | −0.56370 | −0.56370 | −0.56370 | 0 | 0 | 0.82343 | −16.52324 | |
| | | | | | | (Eq. (15.32)) | | |

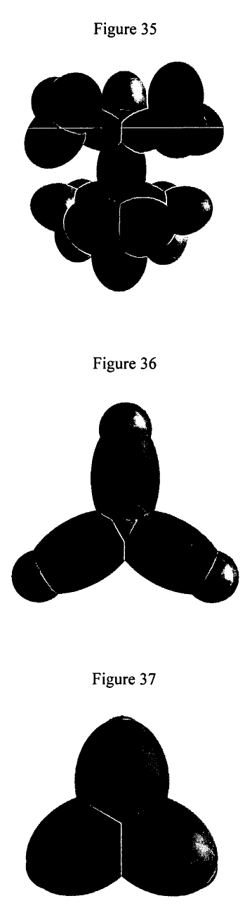

The symbols of the functional groups of tertiary and quaternary amino boranes and borane amines are given in Table 22.22. The geometrical (Eqs. (15.1-15.5) and (22.47)), intercept (Eqs. (15.31-15.32) and (15.80-15.87)), and energy (Eq. (15.61), (22.4), (22.7), (22.12), (22.48), and (22.52)) parameters of tertiary and quaternary amino boranes and borane amines are given in Tables 22.23, 22.24, and 22.25, respectively (all as shown in the priority document). In the case that the MO does not intercept the B HO due to the reduction of the radius from the donation of B 2sp³ HO charge to additional MO's, the energy of each MO is energy matched as a linear sum to the B HO by contacting it through the bisector current of the intersecting MOs as described in the Methane Molecule (CH₄) section. The total energy of each tertiary and quaternary amino borane or borane amine given in Table 22.26 ((as shown in the priority document) was calculated as the sum over the integer multiple of each E_{D} (Group) of Table 22.25 (as shown in the priority document) corresponding to functional-group composition of the molecule. E_{mag} of Table 22.26 (as shown in the priority document) is given by Eqs. (15.15) and (22.3) for the B—N groups and the B—H, B—B, B—H—B, and B—B—B groups. E_{mag} of Table 22.26 (as shown in the priority document) is given by Eqs. (15.15) and (10.142) for NH₃. The bond angle parameters of tertiary and quaternary amino boranes and borane amines determined using Eqs. (15.88-15.117) are given in Table 22.27 (as shown in the priority document). The charge-densities of exemplary tertiary amino borane, tris(dimethylamino)borane and quaternary amino borane, trimethylaminotrimethylborane comprising the concentric shells of atoms with the outer shell bridged by one or more H₂-type ellipsoidal MOs or joined with one or more hydrogen MOs are shown in FIGS. 34 and 35, respectively.

TABLE 22.22
The symbols of the functional groups of tertiary and quaternary amino
boranes and borane amines.

| Functional Group | Group Symbol |
|---|---|
| B—N bond 3° | B—N (i) |
| B—N bond 4° | B—N (ii) |
| C—N bond 1° amine | C—N (i) |
| C—N bond 2° amine (methyl) | C—N (ii) |
| C—N bond 2° amine (alkyl) | C—N (iii) |
| C—N bond 3° amine | C—N (iv) |
| NH₃ group | NH₃ |
| NH₂ group | NH₂ |
| NH group | NH |
| C—B bond | C—B |
| BH bond | B—H |
| BHB (bridged H) | B—H—B |
| BB bond | B—B |
| CH₃ group | C—H (CH₃) |
| CH₂ group | C—H (CH₂) |
| CH | C—H (i) |
| CC bond (n-C) | C—C (a) |

### Halidoboranes

The halidoboranes each comprise at least one B bound by a boron-halogen single bond comprising a B—X group where X═F, Cl, Br, I, and may further comprise one or more alkyl groups and borane moieties. The latter comprise alkyl and aryl moieties and B—C, B—H, B—B, B—H—B, and B—B—B functional groups wherein the B—C group is equivalent to that of alkyl boranes, and the B—H, B—B, B—H—B, and B—B—B functional groups are equivalent to those in boranes given in the corresponding sections. Alkoxy boranes and borinic acids moieties given in the Alkoxy Boranes and Alkyl Borinic Acids ((RO)_{q}BᵣHₛ(HO)ₜ) section may be bound to the B—X group by a B—O functional groups. The former further comprise at least one boron-alkyl-ether moiety, and the latter comprise one or more hydroxyl groups, respectively. Each alkoxy moiety, CₙH₂ₙ₊₁O, comprises one of two types of C—O functional groups that are equivalent to those give in the Ethers (CₙH₂ₙ₊₂Oₘ, n=2,3,4,5 . . . ∞) section. One is for methyl or t-butyl groups, and the other is for general alkyl groups. Each borinic acid hydroxyl functional group is equivalent to that given in the Alcohols (CₙH₂ₙ₊₂Oₘn=1,2,3,4,5 . . . ∞) section.

Tertiary amino-borane and borane-amine moieties given in the Tertiary and Quaternary Aminoboranes and Borane Amines (R_{q}BᵣNₛRₜ; R═H; alkyl) section can be bound to the B—X group by a B—N functional group. The nitrogen atom of each B—N functional group is bound to two other atoms such that there are a total of three bounds per atom. The amino or amine moiety may comprise NH₂, N(H)R, and NR₂. The corresponding functional group for the NH₂ moiety is the NH₂ functional group given in the Primary Amines (CₙH₂ₙ₊₂₊ₘNₘ, n=1,2,3,4,5 . . . ∞) section. The N(H)R moiety comprises the NH functional group of the Secondary Amines (CₙH₂ₙ₊₂₊ₘNₘ, n=2,3,4,5 . . . ∞) section and the C—N functional group of the Primary Amines (CₙH₂ₙ₊₂₊ₘNₘ, n=1,2,3,4,5 . . . ∞) section. The NR₂ moiety comprises two types of C—N functional groups, one for the methyl group corresponding to the C of C—N and the other for general alkyl secondary amines given in the Secondary Amines (CₙH₂ₙ₊₂₊ₘNₘ, n=2,3,4,5 . . . ∞) section.

Quaternary amino-borane and boraneamine moieties given in the Tertiary and Quaternary Aminoboranes and Borane Amines (R_{q}BᵣNₛRₜ; R═H; alkyl) section can be bound to the B—X group by a B—N functional group. The nitrogen atom of each B—N bond is bound to three other atoms such that there are a total of four bounds per atom. The amino or amine moiety may comprise NH₃, N(H₂) R, N(H)R₂, and NR₃. The corresponding functional group for the NH₃ moiety is ammonia given in the Ammonia (NH₃) section. The N(H₂) R moiety comprises the NH₂ and the C—N functional groups given in the Primary Amines (CₙH₂ₙ₊₂₊ₘNₘ, n=1,2,3,4,5 . . . ∞) section. The N(H)R₂ moiety comprises the NH functional group and two types of C—N functional groups, one for the methyl group corresponding to the C of C—N and the other for general alkyl secondary amines given in the Secondary Amines (CₙH₂ₙ₊₂₊ₘNₘ, n=2,3,4,5 . . . ∞) section. The NR₃ moiety comprises the C—N functional group of tertiary amines given in the Tertiary Amines (CₙH_{2N+3}N, n=3,4,5 . . . ∞) section.

The alkyl portion may be part of the alkoxy moiety, amino or amine moiety, or an alkyl group, or it may be bound to the central boron atom by a carbon-boron single bond comprising the C—B group of the Alkyl Boranes (R_{X}B_{y}H_{z}; R=alkyl) section. Each alkyl portion may comprise at least a terminal methyl group (CH₃) and methylene (CH₂), methylyne (CH), and C—C functional groups. The methyl and methylene functional groups are equivalent to those of straight-chain alkanes. Six types of C—C bonds can be identified. The n-alkane C—C bond is the same as that of straight-chain alkanes. In addition, the C—C bonds within isopropyl ((CH₃)₂ CH) and t-butyl ((CH₃)₃C) groups and the isopropyl to isopropyl, isopropyl to t-butyl, and t-butyl to t-butyl C—C bonds comprise functional groups. Additional R groups include aromatics such as phenyl and —HC═CH₂. These groups in halidobroanes are equivalent to those in branched-chain alkanes, aromatics, and alkenes given in the corresponding sections.

The bonding in the B—X functional groups of halidoboranes is similar to that of the B—O and B—N groups of alkoxy boranes and borinic acids and tertiary and quaternary amino boranes and borane amines given in the corresponding sections. The MO semimajor axes of the B—X functional groups are determined from the force balance equation of the centrifugal, Coulombic, and magnetic forces as given in the Boranes (B_{X}H_{Y}) section. In each case, the distance from the origin of the H₂-type-ellipsoidal-MO to each focus c′, the internuclear distance 2c′, and the length of the semiminor axis of the prolate spheroidal H₂-type MO b=c are solved from the semimajor axis a. Then, the geometric and energy parameters of each MO are calculated using Eqs. (15.1-15.117).

As in the case of the B—O— and B—N-bond MOs, the σ-MOs of the B—X-bond MOs are energy matched to the B2sp³ HO which determines that the parameters of the force balance equation based on electron angular momentum are determined by those of the boron atom. The parameters of the force balance equation for the σ-MO of the B—F-bond MO in Eqs. (22.18-22.22) are nₑ=1 and |L|=0:

$$\frac{{ℏ}^{2}}{{m}_{e} {a}^{2} {b}^{2}} D = \frac{{e}^{2}}{8 {πɛ}_{0} a {b}^{2}} D + \frac{{ℏ}^{2}}{2 {m}_{e} {a}^{2} {b}^{2}} D - ( \frac{1}{2} ) \frac{{ℏ}^{2}}{2 {m}_{e} {a}^{2} {b}^{2}} D \qquad ( 22.53 )$$

From Eq. (22.53), the semimajor axis of the tertiary B—F-bond MO is

a=1.5a₀ (22.54)

The force balance equation for each σ-MO of the B—Cl is equivalent to that of the B—B-bond MO with nₑ=2 and

$$\vert L \vert = 3 \sqrt{\frac{3}{4}} ℏ$$

corresponding to three electrons of the B2sp³ shell is

$$\begin{matrix}\frac{{ℏ}^{2}}{{m}_{e} {a}^{2} {b}^{2}} D = \frac{{e}^{2}}{8 {πɛ}_{0} {ab}^{2}} D + \frac{{ℏ}^{2}}{2 {m}_{e} {a}^{2} {b}^{2}} D - ( 1 + \frac{3 \sqrt{\frac{3}{4}}}{Z} ) \frac{{ℏ}^{2}}{2 {m}_{e} {a}^{2} {b}^{2}} D & ( 22.55 ) \\ a = ( 2 + \frac{3 \sqrt{\frac{3}{4}}}{Z} ) {a}_{0} & ( 22.56 )\end{matrix}$$

With Z=5, the semimajor axis of the B—Cl-bond MO is

a=2.51962a₀ (22.57)

The hybridization of the bonding in the B—X functional groups of halidoboranes is similar to that of the C—X groups of alkyl halides given in the corresponding sections. For the B—X functional groups, hybridization of the 2s and 2p AOs of B to form single 2sp³ shells forms an energy minimum, and the sharing of electrons between the B2sp³ HO and X AO to form σ MO permits each participating orbital to decrease in radius and energy. The F AO has an energy of E(F)=−17.42282 eV, and the B2sp³ HOs has an energy of E(B, 2sp³)=−11.80624 eV (Eq. (22.7)). To meet the equipotential condition of the union of the B—F H₂-type-ellipsoidal-MO with these orbitals, the hybridization factor c₂ of Eq. (15.61) for the B—F-bond MO given by Eq. (15.77) is

$$\begin{matrix}{c}_{2} ( F AO to B 2 {sp}^{3} HO ) = \frac{E ( B , 2 {sp}^{3} )}{E ( F AO )} \\ = \frac{- 11.80624 eV}{- 17.42282 eV} \\ = 0.68285\end{matrix} \qquad ( 22.58 )$$

Since the energy of the MO is matched to that of the B2sp³ HO, E(AO/HO) in Eqs. (15.51) and (15.61) is E(B,2sp³) given by Eq. (22.7).

E_{T}(atom−atom,msp³.AO) of the B—F-bond MO is determined by considering that the bond involves an electron transfer from the boron atom to the fluorine atom to form zwitterions such as H₂B⁺—F⁻. By considering the electron redistribution in the fluoroborane as well as the fact that the central field decreases by an integer for each successive electron of the shell, the radius r_{B-Fborane2sp}_{³} of the B2sp³ shell may be calculated from the Coulombic energy using Eq. (15.18):

$$\begin{matrix}{r}_{B—F borane 2 {sp}^{3}} = ( {\sum }_{n = 2}^{4} ( Z - n ) - 1 ) \frac{{e}^{2}}{8 {πɛ}_{0} ( e 74.89168 eV )} \\ = \frac{5 {e}^{2}}{8 {πɛ}_{0} ( e 74.89168 eV )} = 0.90837 {a}_{0}\end{matrix} \qquad ( 22.59 )$$

Using Eqs. (15.19) and (22.13), the Coulombic energy E_{Coulomb}(B_{B-Fboran},2sp³) of the outer electron of the B2sp³ shell is

$$\begin{matrix}{E}_{Coulomb} ( {B}_{B — F borane} , 2 {sp}^{3} ) = \frac{- {e}^{2}}{8 {πɛ}_{0} {r}_{B—F borane 2 {sp}^{3}}} \\ = \frac{- {e}^{2}}{8 {πɛ}_{0} 0.90837 {a}_{0}} \\ = - 14.97834 eV\end{matrix} \qquad ( 22.60 )$$

During hybridization, one of the spin-paired 2s electrons is promoted to B2sp³ shell as an unpaired electron. The energy for the promotion is the magnetic energy given by Eq. (22.6). Using Eqs. (22.6) and (22.60), the energy E(B_{B-Xborane},2sp³) of the outer electron of the B2sp³ shell is

$$\begin{matrix}E ( {B}_{B—F borante} , 2 {sp}^{3} ) = \frac{- {e}^{2}}{8 {πɛ}_{0} {r}_{B—F borane 2 {sp}^{3}}} + \frac{2 {πμ}_{0} {e}^{2} {ℏ}^{2}}{{{m}_{e}^{2} ( {r}_{3} )}^{3}} \\ = - 14.97834 eV + 0.09100 eV \\ = - 14.88734 eV\end{matrix} \qquad ( 22.61 )$$

Thus, E_{T}(B—F,2sp³), the energy change of each B2sp³ shell with the formation of the B—F-bond MO is given by the difference between Eq. (22.15) and Eq. (22.7):

$$\begin{matrix}{E}_{T} ( B — F , 2 {sp}^{3} ) = E ( {B}_{B—F borane} , 2 {sp}^{3} ) - E ( B , 2 {sp}^{3} ) \\ = - 14.88734 eV - ( - 11.80624 eV ) \\ = - 3.08109 eV\end{matrix} \qquad ( 22.62 )$$

Thus, E_{T}(atom−atom,msp³.AO) for ternary B—F is −6.16219 eV corresponding to the maximum charge contribution of an electron given by two times Eq. (22.62).

In chloroboranes, the energies of chorine and boron are less than the Coulombic energy between the electron and proton of H given by Eq. (1.243). Thus, in c₁ and c₂ in Eq. (15.61) is one, and the energy matching condition is determined by the C₂ parameter. The Cl AO has an energy of E(Cl)=−12.96764 eV, and the B2sp³ HOs has an energy of E(B,2sp³)=−11.80624 eV (Eq. (22.7)). To meet the equipotential condition of the union of the B—Cl H₂-type-ellipsoidal-MO with these orbitals, the hybridization factor c₂ of Eq. (15.61) for the B—Cl-bond MO given by Eq. (15.77) is

$$\begin{matrix}{C}_{2} ( Cl AO to B 2 {sp}^{3} HO ) = \frac{E ( B , 2 {sp}^{3} )}{E ( Cl AO )} \\ = \frac{- 11.80624 eV}{- 12.96764 eV} \\ = 0.91044\end{matrix} \qquad ( 22.63 )$$

Since the energy of the MO is matched to that of the B2sp³ HO, E(AO/HO) in Eqs. (15.51) and (15.61) is E(B,2sp³) given by Eq. (22.7), and E_{T}(atom−atom,msp³.AO) is given by two times Eq. (22.12) corresponding to the two centers.

Consider next the radius of the HO due to the contribution of charge to more than one bond. The energy contribution due to the charge donation at each boron atom and halogen atom superimposes linearly. In general, since the energy of the B2sp³ HO and X AO is matched to that of the C2sp³ HO when a the molecule contains a C—B-bond MO and a C—X-bond MO, respectively, the corresponding radius rₘₒₗ₂ₛₚ_{³}, of the B2sp³ HO of a boron atom, the C2sp³ HO of a carbon atom, and the X AO of a given halidoborane molecule is calculated after Eq. (15.32) by considering ΣE_{T}_{ₘₒₗ}(MO,2sp³), the total energy donation to all bonds with which it participates in bonding. The Coulombic energy E_{Coulomb}(atom,2sp³) of the outer electron of the atom 2sp³ shell considering the charge donation to all participating bonds is given by Eq. (15.14). In the case that the boron or halogen atom is not bound to a C2sp³ HO, rₘₒₗ₂ₛₚ_{³} is calculated using Eq. (15.31) where E_{Coulomb}(atom,msp³) is E_{Coulomb}(B2sp³)=−11.89724 eV, E(F)=−17.42282 eV, or E(Cl)=−12.96764 eV. The hybridization parameters used in Eqs. (15.88-15.117) for the determination of bond angles of halidoboranes are given in Table 22.28.

TABLE 22.28
Atom hybridization designation (# first column) and hybridization parameters
of atoms for determination of bond angles with final values of r₂ₛₚ_{³}, E_{Coulomb}
(atom, 2sp³) (designated as E_{Coulomb}), and E(atom_{B-Xborane} 2sp³)
(designated as E) calculated using the appropriate values of ΣE_{T}_{ₘₒₗ} (MO, 2sp³)
(designated as E_{T}) for each corresponding terminal bond spanning each angle.

| | | | | | | r₃ₛₚ_{³} | E_{Coulomb} (eV) | E (eV) |
|---|---|---|---|---|---|---|---|---|
| # | E_{T} | E_{T} | E_{T} | E_{T} | E_{T} | Final | Final | Final |
| 1 | −0.56370 | 0 | 0 | 0 | 0 | 0.95939 | −14.18175 | |
| | | | | | | (Eq. (15.31)) | | |
| 2 | −3.08109 | −3.08109 | 0 | 0 | 0 | 0.75339 | −18.05943 | −17.96843 |
| | | | | | | (Eq. (15.31)) | | |
| 3 | −3.08109 | 0 | 0 | | 0 | 0.66357 | −20.50391 | −20.26346 |
| | | | | | | (Eq. (15.31)) | | |

The symbols of the functional groups of halidoboranes are given in Table 22.29. The geometrical (Eqs. (15.1-15.5) and (22.47)), intercept (Eqs. (15.31-15.32) and (15.80-15.87)), and energy (Eq. (15.61), (22.4), (22.7), (22.12), (22.48), and (22.52)) parameters of halidoboranes are given in Tables 22.30, 22.31, and 22.32, respectively (all as shown in the priority document). In the case that the MO does not intercept the B HO due to the reduction of the radius from the donation of B 2sp³ HO charge to additional MO's, the energy of each MO is energy matched as a linear sum to the B HO by contacting it through the bisector current of the intersecting MOs as described in the Methane Molecule (CH₄) section. The total energy of each halidoborane given in Table 22.33 (as shown in the priority document) was calculated as the sum over the integer multiple of each E_{D} (Group) of Table 22.32 (as shown in the priority document) corresponding to functional-group composition of the molecule. E_{mag} of Table 22.33 (as shown in the priority document) is given by Eqs. (15.15) and (22.3) for the B—X groups and the B—O, B—N, B—H, B—B, B—H—B, and B—B—B groups. E_{mag} of Table 22.33 (as shown in the priority document) is given by Eqs. (15.15) and (10.162) for the OH group. The bond angle parameters of halidoboranes determined using Eqs. (15.88-15.117) are given in Table 22.34 (as shown in the priority document). The charge-densities of exemplary fluoroborane, boron trifluoride and choloroborane, boron trichloride comprising the concentric shells of atoms with the outer shell bridged by one or more H₂-type ellipsoidal MOs or joined with one or more hydrogen MOs are shown in FIGS. 36 and 28, respectively.

TABLE 22.29
The symbols of the functional groups of halidoboranes.

| Functional Group | Group Symbol |
|---|---|
| B—F bond | B—F |
| B—Cl bond | B—Cl |
| B—N bond 3° | B—N (i) |
| B—N bond 4° | B—N (ii) |
| C—N bond 1° amine | C—N (i) |
| C—N bond 2° amine (methyl) | C—N (ii) |
| C—N bond 2° amine (alkyl) | C—N (iii) |
| C—N bond 3° amine | C—N (iv) |
| NH₃ group | NH₃ |
| NH₂ group | NH₂ |
| NH group | NH |
| B—O bond (borinic acid) | B—O (i) |
| B—O bond (alkoxy borane) | B—O (ii) |
| OH group | OH |
| C—O (CH₃—O— and (CH₃)₃C—O—) | C—O (i) |
| C—O (alkyl) | C—O (ii) |
| C—B bond | C—B |
| BH bond | B—H |
| BHB (bridged H) | B—H—B |
| BB bond | B—B |
| BBB (bridged B) | B—B—B |
| CC (aromatic bond) | C^{3e}═C |
| CH (aromatic) | CH (i) |
| CH₃ group | C—H (CH₃) |
| CH₂ alkyl group | C—H (CH₂) (i) |
| CH | C—H (ii) |
| CC bond (n-C) | C—C (a) |
| CC bond (iso-C) | C—C (b) |
| HC═CH₂ (ethylene bond) | C═C |
| CH₂ alkenyl group | CH₂ (ii) |

### REFERENCES

1. D. R. Lide, CRC Handbook of Chemistry and Physics, 86th Edition, CRC Press, Taylor & Francis, Boca Raton, (2005-6), pp. 10-202 to 10-204.
2. V. Ramakrishna, B. J. Duke, “Can the bis(diboranyl) structure of be observed? The story”, Inorg. Chem., Vol. 43, No. 25, (2004), pp. 8176-8184.
3. J. C. Huffman, D. C. Moody, R. Schaeffer, “Studies of boranes. XLV. Crystal structure, improved synthesis, and reactions of tridecaborane(19)”, Inorg. Chem., Vol. 15, No. 1. (1976), pp. 227-232.
4. K. Kuchitsu, “Comparison of molecular structures determined by electron diffraction and spectroscopy. Ethane and diborane”, J. Chem. Phys., Vol. 49, No. 10, (1968), pp. 4456-4462.
5. D. R. Lide, CRC Handbook of Chemistry and Physics, 86th Edition, CRC Press, Taylor & Francis, Boca Raton, (2005-6), p. 9-82.
6. diborane (¹¹B₂H₆) at http://webbook.nist.gov/.
7. D. R. Lide, CRC Handbook of Chemistry and Physics, 86th Edition, CRC Press, Taylor & Francis, Boca Raton, (2005-6), pp. 9-63; 5-4 to 5-42.
8. W. N. Lipscomb, “The boranes and their relatives”, Nobel Lecture, Dec. 11, 1976.
9. A. B. Burg, R. Kratzer, “The synthesis of nonaborane, B₉H₁₁”, Inorg. Chem., Vol. 1, No. 4, (1962), pp. 725-730.
10. D. R. Lide, CRC Handbook of Chemistry and Physics, 86th Edition, CRC Press, Taylor & Francis, Boca Raton, (2005-6), p. 9-19 to 9-45.
11. BCCB at http://webbook.nist.gov/.
12. G. Herzberg, Molecular Spectra and Molecular Structure II Infrared and Raman Spectra of Polyatomic Molecules, Van Nostrand Reinhold Company, New York, N.Y., (1945), pp. 362-369.
13. G. Herzberg, Molecular Spectra and Molecular Structure II Infrared and Raman Spectra of Polyatomic Molecules, Van Nostrand Reinhold Company, New York, N.Y., (1945), p. 344.
14. R. J. Fessenden, J. S. Fessenden, Organic Chemistry, Willard Grant Press. Boston, Mass., (1979), p. 320.
15. cyclohexane at http://webbook.nist.gov/.
16. R. L. Hughes, I. C. Smith, E. W. Lawless, Production of the Boranes and Related Research, Ed. R. T. Holzmann, Academic Press, New York, (1967), pp. 390-396.
17. M. J. S. Dewar, C. Jie, E. G. Zoebisch, “AM1 calculations for compounds containing boron”, Organometallics, Vol. 7, (1988), pp. 513-521.
18. J. D. Cox, G. Pilcher, Thermochemistry of Organometallic Compounds, Academic Press, New York, (1970), pp. 454-465.
19. W. I. F. David, R. M. Ibberson, G. A. Jeffrey, J. R. Ruble, “The structure analysis of deuterated benzene and deuterated nitromethane by pulsed-neutron powder diffraction: a comparison with single crystal neutron analysis”, Physica B (1992), 180 & 181, pp. 597-600.
20. G. A. Jeffrey, J. R. Ruble, R. K. McMullan, J. A. Pople, “The crystal structure of deuterated benzene,” Proceedings of the Royal Society of London. Series A, Mathematical and Physical Sciences, Vol. 414, No. 1846, (Nov. 9, 1987), pp. 47-57.
21. H. B. Burgi, S. C. Capelli, “Getting more out of crystal-structure analyses,” Helvetica Chimica Acta, Vol. 86, (2003), pp. 1625-1640.
22. K. P. Huber, G. Herzberg, Molecular Spectra and Molecular Structure, IV. Constants of Diatomic Molecules, Van Nostrand Reinhold Company, New York, (1979).
23. J. Crovisier, Molecular Database—Constants for molecules of astrophysical interest in the gas phase: photodissociation, microwave and infrared spectra, Ver. 4.2, Observatoire de Paris, Section de Meudon, Meudon, France, May 2002, pp. 34-37, available at http://wwwusr.obspm.fr/˜crovisie/.
24. dimethyl ether at http://webbook.nist.gov/.
25. methylamine at http://webbook.nist.gov/.
26. D. Lin-Vien. N. B. Colthup, W. G. Fateley, J. G. Grasselli, The Handbook of Infrared and Raman Frequencies of Organic Molecules, Academic Press, Inc., Harcourt Brace Jovanovich, Boston, (1991), p. 482.
27. W. S. Benedict, E. K. Plyler, “Vibration-rotation bands of ammonia”, Can. J. Phys., Vol. 35, (1957), pp. 1235-1241.
28. T. Amano, P. F. Bernath, R. W. McKellar, “Direct observation of the v₁ and v₃ fundamental bands of NH₂ by difference frequency laser spectroscopy”, J. Mol. Spectrosc., Vol. 94, (1982), pp. 100-113.
29. D. R. Lide, CRC Handbook of Chemistry and Physics, 79th Edition, CRC Press, Boca Raton, Fla., (1998-9), pp. 9-80 to 9-85.
30. D. R. Lide, CRC Handbook of Chemistry and Physics, 86th Edition, CRC Press, Taylor & Francis, Boca Raton, (2005-6), p. 9-55.
31. G. Herzberg, Molecular Spectra and Molecular Structure II Infrared and Raman Spectra of Polyatomic Molecules, Van Nostrand Reinhold Company, New York, N.Y., (1945), p. 326.

### Organometallic and Coordinate Functional Groups and Molecules

### General Considerations of the Organometallic and Coordinate Bond

Organometallic and coordinate compounds comprising an arbitrary number of atoms can be solved using similar principles and procedures as those used to solve organic molecules of arbitrary length and complexity. Organometallic and coordinate compounds can be considered to be comprised of functional groups such as M—C, M—H, M—X (X═F, Cl, Br, I), M—OH, M—OR, and the alkyl functional groups of organic molecules. The solutions of these functional groups or any others corresponding to the particular organometallic or coordinate compound can be conveniently obtained by using generalized forms of the force balance equation given in the Force Balance of the σ MO of the Carbon Nitride Radical section for molecules comprised of metal and atoms other than carbon and the geometrical and energy equations given in the Derivation of the General Geometrical and Energy Equations of Organic Chemistry section for organometallic and coordinate compounds comprised of carbon. The appropriate functional groups with the their geometrical parameters and energies can be added as a linear sum to give the solution of any organometallic or coordinate compound.

### Alkyl Aluminum Hydrides (RₙAlH₃₋ₙ)

Similar to the case of carbon and silicon, the bonding in the aluminum atom involves four sp³ hybridized orbitals formed from the outer 3p and 3s shells except that only three HOs are filled. In organoaluminum compounds, bonds form between a Al3sp³ HO and at least one C2sp³ HO and one or more H1s AOs. The geometrical parameters of each AlH functional group is solved from the force balance equation of the electrons of the corresponding σ-MO and the relationships between the prolate spheroidal axes. Then, the sum of the energies of the H₂-type ellipsoidal MOs is matched to that of the Al3sp³ shell as in the case of the corresponding carbon and silicon molecules. As in the case of alkyl silanes given in the corresponding section, the sum of the energies of the H₂-type ellipsoidal MO of the Al—C functional group is matched to that of the Al3sp³ shell, and Eq. (15.51) is solved for the semimajor axis with n₁=1 in Eq. (15.50).

The energy of aluminum is less than the Coulombic energy between the electron and proton of H given by Eq. (1.243). A minimum energy is achieved while matching the potential, kinetic, and orbital energy relationships given in the Hydroxyl Radical (OH) section with the donation of 25% electron density from the participating Al3sp³ HO to each Al—H-bond MO.

The 3sp³ hybridized orbital arrangement after Eq. (13.422) is

$$\begin{matrix}3 {sp}^{3} state \\ \frac{↑}{0 \text{,} 0} \frac{↑}{1 \text{,} - 1} \frac{↑}{1 \text{,} 0} \frac{ }{1 \text{,} 1}\end{matrix} \qquad ( 23.1 )$$

where the quantum numbers (l,mₗ) are below each electron. The total energy of the state is given by the sum over the three electrons. The sum E_{T}(Al,3sp³) of experimental energies [1] of Al, Al⁺, and Al²⁺ is

E_{T}(Al,3sp³)=−(28.44765 eV+18.82856 eV+5.98577 eV)=−53.26198 eV(23.2) (23.2)

By considering that the central field decreases by an integer for each successive electron of the shell, the radius r₃ₛₚ_{³}, of the Al3sp³ shell may be calculated from the Coulombic energy using Eq. (15.13):

$$\begin{matrix}{r}_{3 {sp}^{3}} = {\sum }_{n = 10}^{12} \frac{( Z - n ) {e}^{2}}{8 {πɛ}_{0} ( e 53.26198 eV )} \\ = \frac{6 {e}^{2}}{8 {πɛ}_{0} ( e 53.26198 eV )} \\ = 1.53270 {a}_{0}\end{matrix} \qquad ( 23.3 )$$

where Z=13 for aluminum. Using Eq. (15.14), the Coulombic energy E_{Coulomb}(Al, 3sp³) of the outer electron of the Al3sp³ shell is

$$\begin{matrix}{E}_{Coulomb} ( Al , 3 {sp}^{3} ) = \frac{- {e}^{2}}{8 {πɛ}_{0} {r}_{3 {sp}^{3}}} \\ = \frac{- {e}^{2}}{8 {πɛ}_{0} {r}_{3 {sp}^{3}}} \\ = \frac{- {e}^{2}}{8 {πɛ}_{0} 1.53270 {a}_{0}} \\ = - 8.87700 eV\end{matrix} \qquad ( 23.4 )$$

During hybridization, the spin-paired 3s electrons are promoted to Al3sp³ shell as unpaired electrons. The energy for the promotion is the magnetic energy given by Eq. (15.15) at the initial radius of the 3s electrons. From Eq. (10.255) with Z=13, the radius r₁₂ of Al3s shell is

r₁₂=1.41133a₀ (23.5)

Using Eqs. (15.15) and (23.5), the unpairing energy is

$$E ( magnetic ) = \frac{2 {πμ}_{0} {e}^{2} {ℏ}^{2}}{{{m}_{e}^{2} ( {r}_{12} )}^{3}} = \frac{8 {πμ}_{0} {μ}_{B}^{2}}{{( 1.41133 {a}_{0} )}^{3}} = 0.04070 eV \qquad ( 23.6 )$$

Using Eqs. (23.4) and (23.6), the energy E(Al,3sp³) of the outer electron of the Al3sp³ shell is

$$\begin{matrix}E ( Al , 3 {sp}^{3} ) = \frac{- {e}^{2}}{8 {πɛ}_{0} {r}_{3 {sp}^{3}}} + \frac{2 {πμ}_{0} {e}^{2} {ℏ}^{2}}{{{m}_{e}^{2} ( {r}_{12} )}^{3}} \\ = - 8.87700 eV + 0.04070 eV \\ = - 8.83630 eV\end{matrix} \qquad ( 23.7 )$$

Next, consider the formation of the Al—H-bond MO of organoaluminum hydrides wherein each aluminum atom has an Al3sp³ electron with an energy given by Eq. (23.7). The total energy of the state of each aluminum atom is given by the sum over the three electrons. The sum E_{T}(Al_{organoAl}3sp³) of energies of Al3sp³ (Eq. (23.7)), Alt, and Al²⁺ is

$$\begin{matrix}{E}_{T} ( {Al}_{organoAl} 3 {sp}^{3} ) = - ( 28.44765 eV + 18.82856 eV + E ( Al , 3 {sp}^{3} ) ) \\ = - ( 28.44765 eV + 18.82856 eV + 8.83630 eV ) \\ = - 56.11251 eV\end{matrix} \qquad ( 23.8 )$$

where E(Al,3sp³) is the sum of the energy of Al, −5.98577 eV, and the hybridization energy.

Each Al—H-bond MO of each functional group AlH_{n=1,2,3} forms with the sharing of electrons between each Al3sp³ HO and each H1s AO. As in the case of C—H, the H₂-type ellipsoidal MO comprises 75% of the Al—H-bond MO according to Eq. (13.429). Furthermore, the donation of electron density from each Al3sp³ HO to each Al—H-bond MO permits the participating orbital to decrease in size and energy. As shown below, the aluminum HOs have spin and orbital angular momentum terms in the force balance which determines the geometrical parameters of the σ MO. The angular momentum term requires that each Al—H-bond MO be treated independently in terms of the charge donation. In order to further satisfy the potential, kinetic, and orbital energy relationships, each Al3sp³ HO donates an excess of 25% of its electron density to each Al—H-bond MO to form an energy minimum. By considering this electron redistribution in the organoaluminum hydride molecule as well as the fact that the central field decreases by an integer for each successive electron of the shell, the radius r_{organoAlH3sp}_{³} of the Al3sp³ shell may be calculated from the Coulombic energy using Eq. (15.18):

$$\begin{matrix}{r}_{organoAlH 3 {sp}^{3}} = ( {\sum }_{n = 10}^{12} ( Z - n ) - 0.25 ) \frac{{e}^{2}}{8 {πɛ}_{0} ( e 56.11251 eV )} \\ = \frac{5.75 {e}^{2}}{8 {πɛ}_{0} ( e 56.11251 eV )} = 1.39422 {a}_{0}\end{matrix} \qquad ( 23.9 )$$

Using Eqs. (15.19) and (23.9), the Coulombic energy E_{Coulomb}(Al_{organoAlH},3sp³) of the outer electron of the Al3sp³ shell is

$$\begin{matrix}{E}_{Coulomb} ( {Al}_{organoAlH} , 3 {sp}^{3} ) = \frac{- {e}^{2}}{8 {πɛ}_{0} {r}_{organoAlH 3 {sp}^{3}}} \\ = \frac{- {e}^{2}}{8 {πɛ}_{0} 1.39422 {a}_{0}} \\ = - 9.75870 eV\end{matrix} \qquad ( 23.10 )$$

During hybridization, the spin-paired 3s electrons are promoted to Al3sp³ shell as unpaired electrons. The energy for the promotion is the magnetic energy given by Eq. (23.6). Using Eqs. (23.6) and (23.10), the energy E(Al_{organoAlH},3sp³) of the outer electron of the Al3sp³ shell is

$$\begin{matrix}E ( {Al}_{organoAlH} , 3 {sp}^{3} ) = \frac{- {e}^{2}}{8 {πɛ}_{0} {r}_{3 {sp}^{3}}} = \frac{2 {πμ}_{0} {e}^{2} {ℏ}^{2}}{{{m}_{e}^{2} ( {r}_{12} )}^{3}} \\ = - 9.75870 eV + 0.04070 eV \\ = - 9.71800 eV\end{matrix} \qquad ( 23.11 )$$

Thus, E_{T}(Al—H,3sp³), the energy change of each Al3sp³ shell with the formation of the Al—H-bond MO is given by the difference between Eq. (23.11) and Eq. (23.7):

$$\begin{matrix}{E}_{T} ( Al - H , 3 {sp}^{3} ) = E ( {Al}_{organoAlH} , 3 {sp}^{3} ) - E ( Al , 3 {sp}^{3 } ) \\ = - 9.71800 eV - ( - 8.83630 eV ) \\ = - 0.88170 eV\end{matrix} \qquad ( 23.12 )$$

The MO semimajor axis of the Al—H functional group of organoaluminum hydrides is determined from the force balance equation of the centrifugal, Coulombic, and magnetic forces as given in the Polyatomic Molecular Ions and Molecules section and the More Polyatomic Molecules and Hydrocarbons section. The distance from the origin of the H₂-type-ellipsoidal-MO to each focus c′, the internuclear distance 2c′, and the length of the semiminor axis of the prolate spheroidal H₂-type MO b=c are solved from the semimajor axis a. Then, the geometric and energy parameters of the MO are calculated using Eqs. (15.1-15.117).

The force balance of the centrifugal force equated to the Coulombic and magnetic forces is solved for the length of the semimajor axis. The Coulombic force on the pairing electron of the MO is

$${F}_{Coulomb} = \frac{{e}^{2}}{8 {πɛ}_{0} {ab}^{2}} {Di}_{ξ} \qquad ( 23.13 )$$

The spin pairing force is

$${F}_{spin \text{-} pairing} = \frac{{ℏ}^{2}}{2 {m}_{e} {a}^{2} {b}^{2}} {Di}_{ξ} \qquad ( 23.14 )$$

The diamagnetic force is:

$${F}_{diamagneticMO 1} = - \frac{{n}_{e} {ℏ}^{2}}{4 {m}_{e} {a}^{2} {b}^{2}} {Di}_{ξ} \qquad ( 23.15 )$$

where nₑ is the total number of electrons that interact with the binding σ-MO electron. The diamagnetic force F_{diamagneticMO2} on the pairing electron of the σ MO is given by the sum of the contributions over the components of angular momentum:

$${F}_{diamagneticMO 2} = - {\sum }_{i , j} \frac{\vert {L}_{i} \vert ℏ}{{Z}_{j} 2 {m}_{e} {a}^{2} {b}^{2}} {Di}_{ξ} \qquad ( 23.16 )$$

where |L| is the magnitude of the angular momentum of each atom at a focus that is the source of the diamagnetism at the σ-MO. The centrifugal force is

$${F}_{centrifugalMO} = - \frac{{ℏ}^{2}}{{m}_{e} {a}^{2} {b}^{2}} {Di}_{ξ} \qquad ( 23.17 )$$

The force balance equation for the σ-MO of the Al—H-bond MO is the same as that of the Si—H except that Z=13 and there are three spin-unpaired electron in occupied orbitals rather than four, and the orbital with l, mₗ angular momentum quantum numbers of (1,1) is unoccupied. With

$${n}_{e} = 2 and \vert L \vert = 3 \sqrt{\frac{3}{4}} ℏ and \vert L \vert = 3 \sqrt{\frac{3}{4}} ℏ$$

corresponding to the spin and orbital angular momentum of the three occupied HOs of the Al3sp³ shell, the force balance equation is

$$\begin{matrix}\frac{{ℏ}^{2}}{{m}_{e} {a}^{2} {b}^{2}} D = \frac{{e}^{2}}{8 {πɛ}_{0} {ab}^{2}} D + \frac{{ℏ}^{2}}{2 {m}_{e} {a}^{2} {b}^{2}} D - ( 1 + \frac{6 \sqrt{\frac{3}{4}}}{Z} ) \frac{{ℏ}^{2}}{2 {m}_{e} {a}^{2} {b}^{2}} D & ( 23.18 ) \\ a = ( 2 + \frac{6 \sqrt{\frac{3}{4}}}{Z} ) {a}_{0} & ( 23.19 )\end{matrix}$$

With Z=13, the semimajor axis of the Al—H-bond MO is

a=2.39970a₀ (23.20)

Using the semimajor axis, the geometric and energy parameters of the MO are calculated using Eqs. (15.1-15.127) in the same manner as the organic functional groups given in the Organic Molecular Functional Groups and Molecules section. For the Al—H functional group, c₁ is one and C₁=0.75 based on the orbital composition as in the case of the C—H-bond MO. In organoaluminum hydrides, the energy of aluminum is less than the Coulombic energy between the electron and proton of H given by Eq. (1.243). Thus, c₂ in Eqs. (15.51) and (15.61) is also one, and the energy matching condition is determined by the C₂ parameter. Then, the hybridization factor for the Al—H-bond MO is given by the ratio of 8.87700 eV, the magnitude of E_{Coulomb}(Al_{organoAlH},3sp³)(Eq. (23.4)), and 13.605804 eV, the magnitude of the Coulombic energy between the electron and proton of H (Eq. (1.243)):

$${C}_{2} ( organo Al H 3 {sp}^{3} HO ) = \frac{8.87700 eV}{13.605804 eV} = 0.65244 \qquad ( 23.21 )$$

Since the energy of the MO is matched to that of the Al3sp³ HO, E(AO/HO) in Eqs. (15.51) and (15.61) is E(Al,3sp³) given by Eq. (23.7), and E_{T}(atom−atom,msp³.AO) is −0.88170 eV corresponding the independent single-bond charge contribution (Eq. (23.12)). The energies E_{D} (AlH_{n=1,2}) of the functional groups AlH_{n=1,2} of organoaluminum hydride molecules are each given by the corresponding integer n times that of Al—H:

E_{D}(AlH_{n=1,2})=nE_{D}(AlH) (23.22)

The branched-chain organoaluminum hydrides, RₙAlH₃₋ₙ, comprise at least a terminal methyl group (CH₃) and at least one Al bound by a carbon-aluminum single bond comprising a C—Al group, and may comprise methylene (CH₂), methylyne (CH), C—C, and AlH_{n=1,2} functional groups. The methyl and methylene functional groups are equivalent to those of straight-chain alkanes. Six types of C—C bonds can be identified. The n-alkane C—C bond is the same as that of straight-chain alkanes. In addition, the C—C bonds within isopropyl ((CH₃)₂ CH) and t-butyl ((CH₃)₃C) groups and the isopropyl to isopropyl, isopropyl to t-butyl, and t-butyl to t-butyl C—C bonds comprise functional groups. These groups in branched-chain organoaluminum hydrides are equivalent to those in branched-chain alkanes.

For the C—Al functional group, hybridization of the 2s and 2p AOs of each C and the 3s and 3p AOs of Al to form single 2sp³ and 3sp³ shells, respectively, forms an energy minimum, and the sharing of electrons between the C2sp³ and Al3sp³ HOs to form σ MO permits each participating orbital to decrease in radius and energy. Furthermore, the energy of aluminum is less than the Coulombic energy between the electron and proton of H given by Eq. (1.243). Thus, in organoaluminum hydrides, the C2sp³ HO has a hybridization factor of 0.91771 (Eq. (13.430)) with a corresponding energy of E(C,2sp³)=−14.63489 eV (Eq. (15.25)), and the Al HO has an energy of E(Al,3sp³)=−8.83630 eV. To meet the equipotential, minimum-energy condition of the union of the Al3sp³ and C2sp³ HOs, c₂ and C₂ of Eqs. (15.2-15.5), (15.51), and (15.61) for the Al—C-bond MO given by Eqs. (15.77) and (15.79) is

$$\begin{matrix}{C}_{2} ( C 2 {sp}^{3} HO to Al 3 {sp}^{3} HO ) = {c}_{2} ( C 2 {sp}^{3} HO to Al 3 {sp}^{3} HO ) \\ = \frac{E ( Al , 3 {sp}^{3} )}{E ( C , 2 {sp}^{3} )} {c}_{2} ( C 2 {sp}^{3} HO ) \\ = \frac{- 8.83630 eV}{- 14.63489 eV} ( 0.91771 ) \\ = 0.55410\end{matrix} \qquad ( 23.23 )$$

The energy of the C—Al-bond MO is the sum of the component energies of the H₂-type ellipsoidal MO given in Eq. (15.51). Since the energy of the MO is matched to that of the Al3sp³ HO, E(AO/HO) in Eqs. (15.51) and (15.61) is E(Al,3sp³) given by Eq. (23.7). Since the C2sp³ HOs have four electrons with a corresponding total field of ten in Eq. (15.13); whereas, the Al3sp³ HOs have three electrons with a corresponding total field of six, E_{T}(atom−atom,msp³.AO) is −0.72457 eV corresponding to the single-bond contributions of carbon (Eq. (14.151)). ΔE_{H}_{₂}_{MO}(AO/HO=E_{T}(atom−atom,msp³.AO) in order to match the energies of the carbon and aluminum HOs.

### Bridging Bonds of Organoaluminum Hydrides (Al—H—Al and Al—C—Al)

As given in the Nature of the Chemical Bond of Hydrogen-Type Molecules and Molecular Ions section, the Organic Molecular Functional Groups and Molecules section, and other sections on bonding in neutral molecules, the molecular chemical bond typically comprises an integer number of paired electrons. One exception given in the Benzene Molecule section and other sections on aromatic molecules such as naphthalene, toluene, chlorobenzene, phenol, aniline, nitrobenzene, benzoic acid, pyridine, pyrimidine, pyrazine, quinoline, isoquinoline, indole, adenine, fullerene, and graphite is that the paired electrons are distributed over a linear combination of bonds such that the bonding between two atoms involves less than an integer multiple of two electrons. In these aromatic cases, three electrons can be assigned to a given bond between two atoms wherein the electrons of the linear combination of bonded atoms are paired and comprise an integer multiple of two.

The Al3sp³ HOs comprise four orbitals containing three electrons as given by Eq. (23.1). These three occupied orbitals can form three single bonds with other atoms wherein each Al3sp³ HO and each orbital from the bonding atom contribute one electron each to the pair of the corresponding bond. However, an alternative bonding is possible that further lowers the energy of the resulting molecule wherein the remaining unoccupied orbital participates in bonding. (Actually an unoccupied orbital has no physical basis. It is only a convenient concept for the bonding electrons in this case additionally having the electron angular momentum state with l, mₗ quantum numbers of (1,1)). In this case the set of two paired electrons are distributed over three atoms and belong to two bonds. Such an electron deficient bonding involving two paired electrons centered on three atoms is called a three-center bond as opposed to the typical single bond called a two-center bond. The designation for a three-center bond involving two Al3sp³ HOs and a H1s AO is Al—H—Al, and the designation for a three-center bond involving two Al3sp³ HOs and a C2sp³ HO is Al—C—Al.

Each Al—H—Al-bond MO and Al—C—Al-bond MO comprises the corresponding single bond and forms with further sharing of electrons between each Al3sp³ HO and each H1s AO and C2sp³ HO, respectively. Thus, the geometrical and energy parameters of the three-center bond are equivalent to those of the corresponding two-center bonds except that the bond energy is increased in the former case since the donation of electron density from the unoccupied Al3sp³ HO to each Al—H—Al-bond MO and Al—C—Al-bond MO permits the participating orbital to decrease in size and energy. In order to further satisfy the potential, kinetic, and orbital energy relationships, the Al3sp³ HO donates an additional excess of 25% of its electron density to form the bridge (three-center-bond MO) to decrease the energy in the multimer. By considering this electron redistribution in the organoaluminum hydride molecule as well as the fact that the central field decreases by an integer for each successive electron of the shell, the radius r_{organoAlH3sp}_{³} of the Al3sp³ shell calculated from the Coulombic energy, the Coulombic energy E_{Coulomb}(Al_{organoAlH},3sp³) of the outer electron of the Al3sp³ shell, and the energy E(Al_{organoAlH},3sp³) of the outer electron of the Al3sp³ shell are given by Eqs. (23.9), (23.10), and (23.11), respectively. Thus, E(Al—H—Al, 3sp³) and E_{T}(Al—C—Al,3sp³), the energy change with the formation of the three-center-bond MO from the corresponding two-center-bond MO and the unoccupied Al3sp³ HO is given by the Eq. (23.12):

E_{T}(Al—H—Al,3sp³)=E_{T}(Al—C—Al,3sp³)=−0.88170 eV (23.24)

The upper range of the experimental association enthalpy per bridge for both of the reactions

2AlH(CH₃)₂[AlH(CH₃)₂]₂ (23.25)

and

2Al(CH₃)₃→[Al(CH₃)₃]₂ (23.26)

is [2]

E_{T}(Al—H—Al,3sp³)=E_{T}(Al—C—Al,3sp³)=−0.867 eV (23.27)

which agrees with Eq. (23.24) very well.

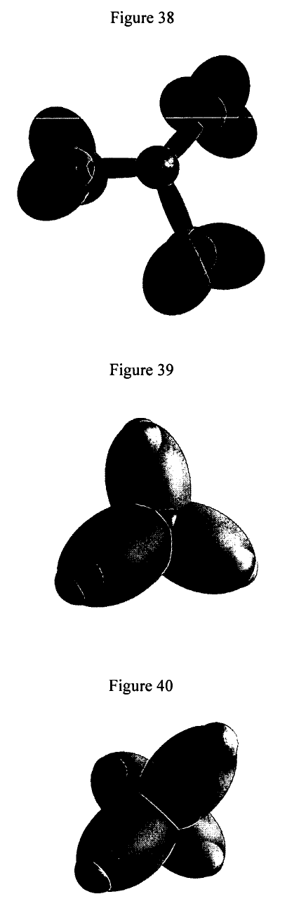

The symbols of the functional groups of alkyl organoaluminum hydrides are given in Table 23.1. The geometrical (Eqs. (15.1-15.5), (23.20), and (23.23) and intercept (Eqs. (15.80-15.87)) parameters of alkyl organoaluminum hydrides are given in Tables 23.2 and 23.3, respectively (both as shown in the priority document). Since the energy of the Al3sp³ HO is matched to that of the C2sp³ HO, the radius rₘₒₗ₂ₛₚ_{³} of the Al3sp³ HO of the aluminum atom and the C2sp³ HO of the carbon atom of a given C—Al-bond MO are calculated after Eq. (15.32) by considering ΣE_{T}_{ₘₒₗ}(MO,2sp³), the total energy donation to all bonds with which each atom participates in bonding. In the case that the MO does not intercept the Al HO due to the reduction of the radius from the donation of Al 3sp³ HO charge to additional MO's, the energy of each MO is energy matched as a linear sum to the Al HO by contacting it through the bisector current of the intersecting MOs as described in the Methane Molecule (CH₄) section. The energy (Eq. (15.61), (23.4), (23.7), and (23.21-23.23)) parameters of alkyl organoaluminum hydrides are given in Table 23.5 (as shown in the priority document). The total energy of each alkyl aluminum hydride given in Table 23.5 (as shown in the priority document) was calculated as the sum over the integer multiple of each E_{D} (Group) of Table 23.4 (as shown in the priority document) corresponding to functional-group composition of the molecule. E_{mag} of Table 23.4 (as shown in the priority document) is given by Eqs. (15.15) and (23.3). The bond angle parameters of organoaluminum hydrides determined using Eqs. (15.88-15.117) are given in Table 23.6 (as shown in the priority document). The charge-density in trimethyl aluminum is shown in FIG. 38.

TABLE 23.1
The symbols of the functional groups of organoaluminum hydrides.

| Functional Group | Group Symbol |
|---|---|
| AlH group of AlH_{n=1,2} | Al—H |
| AlHAl (bridged H) | Al—H—Al |
| CAl bond | C—Al |
| ALCAl (bridged C) | Al—C—Al |
| CH₃ group | C—H (CH₃) |
| CH₂ group | C—H (CH₂) |
| CH | C—H |
| CC bond (n-C) | C—C (a) |
| CC bond (iso-C) | C—C (b) |
| CC bond (tert-C) | C—C (c) |
| CC (iso to iso-C) | C—C (d) |
| CC (t to t-C) | C—C (e) |
| CC (t to iso-C) | C—C (f) |

### Transition Metal Organometallic and Coordinate Bond

The transition-metal atoms fill the 3d orbitals in the series Sc to Zn. The 4s orbitals are filled except in the cases of Cr and Cu wherein one 4s electron occupies a 3d orbital to achieve a half-filled and filled 3d shell, respectively. Experimentally the transition-metal elements ionize successively from the 4s shell to the 3d shell [12]. Thus, bonding in the transition metals involves the hybridization of the 3d and 4s electrons to form the corresponding number of 3d 4s HOs except for Cu and Zn which each have a filled inner 3d shell and one and two outer 4s electrons, respectively. Cu may form a single bond involving the 4s electron or the 3d and shells may hybridize to form multiple bonds with one or more ligands. The 4s shell of Zn hybridizes to form two 4s HOs that provide for two possible bonds, typically two metal-alkyl bonds.

For organometallic and coordinate compounds comprised of carbon, the geometrical and energy equations are given in the Derivation of the General Geometrical and Energy Equations of Organic Chemistry section. For metal-ligand bonds other than to carbon, the force balance equation is that developed in the Force Balance of the σ MO of the Carbon Nitride Radical section wherein the diamagnetic force terms include orbital and spin angular momentum contributions. The electrons of the 3d4s HOs may pair such that the binding energy of the HO is increased. The hybridization factor accordingly changes which effects the bond distances and energies. The diamagnetic terms of the force balance equations of the electrons of the MOs formed between the 3d4s HOs and the AOs of the ligands also changes depending on whether the nonbonding HOs are occupied by paired or unpaired electrons. The orbital and spin angular momentum of the HOs and MOs is then determined by the state that achieves a minimum energy including that corresponding to the donation of electron charge from the HOs and AOs to the MOs. Historically, according to “crystal field theory and molecular orbital theory [13] the possibility of a bonding metal atom achieving a so called “high-spin” or “low-spin” state having unpaired electrons occupying higher-energy orbitals versus paired electrons occupying lower-energy orbitals was due to the strength of the ligand crystal field or the interaction between metal orbitals and the ligands, respectively. Excited-state spectral data recorded on transition-metal organometallic and coordinate compounds has been misinterpreted. Excitation of an unpaired electron in a 3d4s HO to a 3d4s paired state is equivalent to an excitation of the molecule to a higher energy MO since the MOs change energy due to the corresponding change in the hybridization factor and diamagnetic force balance terms. But, levels misidentified as crystal field levels do not exist in the absence of excitation by a photon.

The parameters of the 3d4s HOs are determined using Eqs. (15.12-15.21). For transition metal atoms with electron configuration 3dⁿ4s², the spin-paired 4s electrons are promoted to 3d4s shell during hybridization as unpaired electrons. Also, for n>5 the electrons of the 3d shell are spin-paired and these electrons are promoted to 3d4s shell during hybridization as unpaired electrons. The energy for each promotion is the magnetic energy given by Eq. (15.15) at the initial radius of the 4s electrons and the paired 3d electrons determined using Eq. (10.102) with the corresponding nuclear charge Z of the metal atom and the number electrons n of the corresponding ion with the filled outer shell from which the pairing energy is determined. Typically, the electrons from the 4s and 3d shells successively fill unoccupied HOs until the HO shell is filled with unpaired electrons, then the electrons pair per HO. The magnetic energy of paring given by Eqs. (15.13) and (15.15) is added to E_{Coulomb}(atom,3d4s) the for each pair. Thus, after Eq. (15.16), the energy E(atom,3d4s) of the outer electron of the atom 3d4s shell is given by the sum of E_{Coulomb}(atom,3d4s) and E(magnetic):

$$E ( atom , 3 d 4 s ) = \frac{- {e}^{2}}{8 {πɛ}_{0} {r}_{3 d 4 s}} + \frac{2 {πμ}_{0} {e}^{2} {ℏ}^{2}}{{m}_{e}^{2} {r}_{4 s}^{3}} + {\sum }_{3 d pairs} \frac{2 {πμ}_{0} {e}^{2} {ℏ}^{2}}{{m}_{e}^{2} {r}_{3 d}^{3}} - {\sum }_{HO pairs} \frac{2 {πμ}_{0} {e}^{2} {ℏ}^{2}}{{m}_{e}^{2} {r}_{3 d 4 s}^{3}} \qquad ( 23.28 )$$

The sharing of electrons between the metal 3d4s HOs and the ligand AOs or HOs to form a M-L-bond MO (L not C) permits each participating hybridized or atomic orbital to decrease in radius and energy. Due to the low binding energy of the metal atom and the high electronegativity of the ligand, an energy minimum is achieved while further satisfying the potential, kinetic, and orbital energy relationships, each metal 3d4s HO donates an excess of an electron per bond of its electron density to the M-L-bond MO. In each case, the radius of the hybridized shell is calculated from the Coulombic energy equation by considering that the central field decreases by an integer for each successive electron of the shell and the total energy of the shell is equal to the total Coulombic energy of the initial AO electrons plus the hybridization energy. After Eq. (15.17), the total energy E_{T}(mol.atom,3d4s) of the HO electrons is given by the sum of energies of successive ions of the atom over the n electrons comprising total electrons of the initial AO shell and the hybridization energy:

$${E}_{T} ( mol . atom , 3 d 4 s ) = E ( atom , 3 d 4 s ) - {\sum }_{m = 2}^{n} {IP}_{m} \qquad ( 23.29 )$$

where IPₘ is the m th ionization energy (positive) of the atom and the sum −IP₁ of plus the hybridization energy is E(atom,3d4s). Thus, the radius r_{3d4s} of the hybridized shell due to its donation of a total charge −Qe to the corresponding MO is given by is given by:

$$\begin{matrix}{r}_{3 d 4 s} = ( {\sum }_{q = Z - n}^{Z - 1} ( Z - q ) - Q ) \frac{- {e}^{2}}{8 {πɛ}_{0} {E}_{T} ( mol . atom , 3 d 4 s )} \\ = ( {\sum }_{q = Z - n}^{Z - 1} ( Z - q ) - s ( 0.25 ) ) \frac{- {e}^{2}}{8 {πɛ}_{0} {E}_{T} ( mol . atom , 3 d 4 s )}\end{matrix} \qquad ( 23.30 )$$

where −e is the fundamental electron charge, s=1,2,3 for a single, double, and triple bond, respectively, and s=4 for typical coordinate and organometallic compounds wherein L is not carbon. The Coulombic energy E_{Coulomb}(mol.atom,3d4s) of the outer electron of the atom 3d4s shell is given by

$${E}_{Coulomb} ( mol . atom , 3 d 4 s ) = \frac{- {e}^{2}}{8 {πɛ}_{0} {r}_{3 d 4 s}} \qquad ( 23.31 )$$

In the case that during hybridization the metal spin-paired 4s AO electrons are unpaired to contribute electrons to the 3d4s HO, the energy change for the promotion to the unpaired state is the magnetic energy E(magnetic) at the initial radius r of the AO electron given by Eq. (15.15). In addition in the case that the 3d4s HO electrons are paired, the corresponding magnetic energy is added. Then, the energy E(mol.atom,3d4s) of the outer electron of the atom 3d4s shell is given by the sum of E_{Coulomb}(mol.atom,3d4s) and E(magnetic):

$$E ( mol \cdot atom , 3 d 4 s ) = \frac{- {e}^{2}}{8 {πɛ}_{0} {r}_{3 d 4 s}} + \frac{2 {πμ}_{0} {e}^{2} {ℏ}^{2}}{{m}_{e}^{2} {r}_{4 s}^{3}} - {\sum }_{HO pairs} \frac{2 {πμ}_{0} {e}^{2} {ℏ}^{2}}{{m}_{e}^{2} {r}_{3 d 4 s}^{3}} \qquad ( 23.32 )$$

E_{T}(atom−atom,3d4s), the energy change of each atom msp³ shell with the formation of the atom-atom-bond MO is given by the difference between E(mol.atom,3d4s) and E(atom,3d4s):

E_{T}(atom−atom,3d4s)=E(mol.atom,3d4s)−E(atom,3d4s) (23.33)

Any unpaired electrons of ligands typically pair with unpaired HO electrons of the metal. In the case that no such electrons of the metal are available, the ligand electrons pair and form a bond with an unpaired metal HO when available. An unoccupied HO may form by the pairing of the corresponding HO electrons to form an energy minimum due to the effect on the bond parameters such as the diamagnetic force term, hybridization factor, and the E_{T}(atom−atom,msp³.AO) term. In the case of carbonyls, the two unpaired Csp³ HO electrons on each carbonyl pair with any unpaired electrons of the metal HOs. Any excess carbonyl electrons pair in the formation of the corresponding MO and any remaining metal HO electrons pair where possible. In the latter case, the energy of the HO for the determination of the hybridization factor and other bonding parameters in Eqs. (15.51) and (15.65) is given by the Coulombic energy plus the pairing energy.

The force balance of the centrifugal force equated to the Coulombic and magnetic forces is solved for the length of the semimajor axis. The Coulombic force on the pairing electron of the MO is

$${F}_{Coulomb} = \frac{{e}^{2}}{8 {πɛ}_{0} {ab}^{2}} {Di}_{ξ} \qquad ( 23.34 )$$

The spin pairing force is

$${F}_{spin \text{-} pairing} = \frac{{ℏ}^{2}}{2 {m}_{e} {a}^{2} {b}^{2}} {Di}_{ξ} \qquad ( 23.35 )$$

The diamagnetic force is:

$${F}_{diamagneticMO 1} = - \frac{{n}_{e} {ℏ}^{2}}{4 {m}_{e} {a}^{2} {b}^{2}} {Di}_{ξ} \qquad ( 23.36 )$$

where nₑ is the total number of electrons that interact with the binding σ-MO electron. The diamagnetic force F_{diamagneticMO2} on the pairing electron of the σ-MO is given by the sum of the contributions over the components of angular momentum:

$${F}_{diamagneticMO 2} = - {\sum }_{i} \frac{\vert {L}_{i} \vert ℏ}{Z 2 {m}_{e} {a}^{2} {b}^{2}} {Di}_{ξ} \qquad ( 23.37 )$$

where |Lᵢ| is the magnitude of the angular momentum component of the metal atom at a focus that is the source of the diamagnetism at the σ-MO. The centrifugal force is

$${F}_{centrifugalMO} = - \frac{{ℏ}^{2}}{{m}_{e} {a}^{2} {b}^{2}} {Di}_{ξ} \qquad ( 23.38 )$$

The general force balance equation for the σ-MO of the metal (M) to ligand (L) M-L-bond MO in terms of nₑ and |Lᵢ| corresponding to the orbital and spin angular momentum terms of the 3d 4s HO shell is

$$\frac{{ℏ}^{2}}{{m}_{e} {a}^{2} {b}^{2}} D = \frac{{e}^{2}}{8 {πɛ}_{0} {ab}^{2}} D + \frac{{ℏ}^{2}}{2 {m}_{e} {a}^{2} {b}^{2}} D - ( \frac{{n}_{e}}{2} + {\sum }_{i} \frac{\vert {L}_{i} \vert}{Z} ) \frac{{ℏ}^{2}}{2 {m}_{e} {a}^{2} {b}^{2}} D \qquad ( 23.39 )$$

Having a solution for the semimajor axis a of

$$a = ( 1 + \frac{{n}_{e}}{2} + {\sum }_{i} \frac{\vert {L}_{i} \vert}{Z} ) {a}_{0} \qquad ( 23.40 )$$

In term of the total angular momentum L, the semimajor axis a is

$$a = ( 1 + \frac{{n}_{e}}{2} + \frac{L}{Z} ) {a}_{0} \qquad ( 23.41 )$$

Using the semimajor axis, the geometric and energy parameters of the MO are calculated using Eqs. (15.1-15.117) in the same manner as the organic functional groups given in the Organic Molecular Functional Groups and Molecules section.

Bond angles in organometallic and coordinate compounds are determined using the standard Eqs. (15.70-15.79) and (15.88-15.117) with the appropriate E_{T}(atom−atom,msp³.AO) for energy matching with the B—C terminal bond of the corresponding angle ∠BAC. For bond angles in general, if the groups can be maximally displaced in terms of steric interactions and magnitude of the residual E_{T} term is less that the steric energy, then the geometry that minimizes the steric interactions is the lowest energy. Steric-energy minimizing geometries include tetrahedral (T_{d}) and octahedral symmetry (Oₕ).

### Scandium Functional Groups and Molecules

The electron configuration of scandium is [Ar]4s²3d having the corresponding term ²D_{3/2}. The total energy of the state is given by the sum over the three electrons. The sum E_{T}(Sc,3d4s) of experimental energies [1] of Sc, Sc⁺, and Sc²⁺ is

E_{T}(Sc,3d4s)=−(24.75666 eV+12.79977 eV+6.56149 eV)=−44.11792 eV (23.42)

By considering that the central field decreases by an integer for each successive electron of the shell, the radius r_{3d4s} of the Sc3d4s shell may be calculated from the Coulombic energy using Eq. (15.13):

$$\begin{matrix}{r}_{3 d 4 s} = {\sum }_{n = 18}^{20} \frac{( Z - n ) {e}^{2}}{8 {πɛ}_{0} ( e 44.11792 eV )} \\ = \frac{6 {e}^{2}}{8 {πɛ}_{0} ( e 44.11792 eV )} \\ = 1.85038 {a}_{0}\end{matrix} \qquad ( 23.43 )$$

where Z=21 for scandium. Using Eq. (15.14), the Coulombic energy E_{Coulomb}(SC,3d 45) of the outer electron of the Sc3d4s shell is

$$\begin{matrix}{E}_{Coulomb} ( Sc , 3 d 4 s ) = \frac{- {e}^{2}}{8 {πɛ}_{0} {r}_{3 d 4 s}} \\ = \frac{- {e}^{2}}{8 {πɛ}_{0} 1.85038 {a}_{0}} \\ = - 7.35299 eV\end{matrix} \qquad ( 23.44 )$$

During hybridization, the spin-paired 4s electrons are promoted to Sc3d4s shell as unpaired electrons. The energy for the promotion is the magnetic energy given by Eq. (15.15) at the initial radius of the 4s electrons. From Eq. (10.102) with Z=21 and n=21, the radius r₂₁ of Sc4s shell is

r₂₁=2.07358a₀ (23.45)

Using Eqs. (15.15) and (23.45), the unpairing energy is

$$\begin{matrix}E ( magnetic ) = \frac{2 {πμ}_{0} {e}^{2} {ℏ}^{2}}{{{m}_{e}^{2} ( {r}_{21} )}^{3}} \\ = \frac{8 {πμ}_{0} {μ}_{B}^{2}}{{( 2.07358 {a}_{0} )}^{3}} \\ = 0.01283 eV\end{matrix} \qquad ( 23.46 )$$

Using Eqs. (23.44) and (23.46), the energy E(Sc,3d4s) of the outer electron of the Sc3d4s shell is

$$\begin{matrix}E ( Sc , 3 d 4 s ) = \frac{- {e}^{2}}{8 {πɛ}_{0} {r}_{3 d 4 s}} + \frac{2 {πμ}_{0} {e}^{2} {ℏ}^{2}}{{{m}_{e}^{2} ( {r}_{21} )}^{3}} \\ = - 7.352987 eV + 0.01283 eV \\ = - 7.34015 eV\end{matrix} \qquad ( 23.47 )$$

Next, consider the formation of the Sc-L-bond MO of wherein each scandium atom has an Sc3d4s electron with an energy given by Eq. (23.47). The total energy of the state of each scandium atom is given by the sum over the three electrons. The sum E_{T}(SC_{Sc-L}3d4s) of energies of Sc3d4s (Eq. (23.47)), Sc⁺, and Sc²⁺ is

$$\begin{matrix}{E}_{T} ( {Sc}_{Sc \text{-} L} 3 d 4 s ) = - ( \begin{matrix}24.75666 eV + 12.79977 eV + \\ E ( Sc , 3 d 4 s )\end{matrix} ) \\ = - ( \begin{matrix}24.75666 eV + 12.79977 eV + \\ 7.34015 eV\end{matrix} ) \\ = - 44.89658 eV\end{matrix} \qquad ( 23.48 )$$

where E(Sc,3d4s) is the sum of the energy of Sc, −6.56149 eV, and the hybridization energy.

The scandium HO donates an electron to each MO. Using Eq. (23.30), the radius radius r_{3d4s} of the Ti3d4s shell calculated from the Coulombic energy is

$$\begin{matrix}{r}_{Sc \text{-} L 3 d 4 s} = ( {\sum }_{n = 18}^{20} ( Z - n ) - 1 ) \frac{{e}^{2}}{8 {πɛ}_{0} ( e 44.89658 eV )} \\ = \frac{5 {e}^{2}}{8 {πɛ}_{0} ( e 44.89658 eV )} \\ = 1.51524 {a}_{0}\end{matrix} \qquad ( 23.49 )$$

Using Eqs. (15.19) and (23.49), the Coulombic energy E_{Coulomb}(Sc_{Sc-L},3d4s) of the outer electron of the Sc3d4s shell is

$$\begin{matrix}{E}_{Coulomb} ( {Sc}_{Sc - L} , 3 d 4 s ) = \frac{- {e}^{2}}{8 {πɛ}_{0} {r}_{Sc - L 3 d 4 s}} \\ = \frac{- {e}^{2}}{8 {πɛ}_{0} 1.51524 {a}_{0}} \\ = - 8.97932 eV\end{matrix} \qquad ( 23.50 )$$

The only magnetic energy term is that for unpairing of the 4s electrons given by Eq. (23.46). Using Eqs. (23.32), (23.46), and (23.50), the energy E(Sc_{Sc-L},3d4s) of the outer electron of the Sc3d4s shell is

$$\begin{matrix}E ( {Sc}_{Sc - L} , 3 d 4 s ) = \frac{- {e}^{2}}{8 {πɛ}_{0} {r}_{Sc - L 3 d 4 s}} + \frac{2 {πμ}_{0} {e}^{2} {ℏ}^{2}}{{{m}_{e}^{2} ( {r}_{21} )}^{3}} \\ = - 8.97932 eV + 0.01283 eV \\ = - 8.96648 eV\end{matrix} \qquad ( 23.51 )$$

Thus, E_{T}(Sc-L,3d4s), the energy change of each Sc3d4s shell with the formation of the Sc-L-bond MO is given by the difference between Eq. (23.51) and Eq. (23.47):

$$\begin{matrix}{E}_{T} ( Sc - L , 3 d 4 s ) = E ( {Sc}_{Sc - L} , 3 d 4 s ) - E ( Sc , 3 d 4 s ) \\ = - 8.96648 eV - ( - 7.34015 eV ) \\ = - 1.62633 eV\end{matrix} \qquad ( 23.52 )$$

The semimajor axis a solution given by Eq. (23.41) of the force balance equation, Eq. (23.39), for the σ-MO of the Sc-L-bond MO of ScLₙ is given in Table 23.8 (as shown in the priority document) with the force-equation parameters Z=21, nₑ, and L corresponding to the orbital and spin angular momentum terms of the 3d4s HO shell.

For the Sc-L functional groups, hybridization of the 4s and 3d AOs of Sc to form a single 3d4s shell forms an energy minimum, and the sharing of electrons between the Sc3d4s HO and L AO to form σ MO permits each participating orbital to decrease in radius and energy. The F AO has an energy of E(F)=−17.42282 eV, the CI AO has an energy of E(Cl)=−12.96764 eV, the O AO has an energy of E(O)=−13.61805 eV, and the Sc3d4s HOs has an energy of E(Sc,3d4s)=−7.34015 eV (Eq. (23.47)). To meet the equipotential condition of the union of the Sc-L H₂-type-ellipsoidal-MO with these orbitals, the hybridization factor(s), at least one of c₂ and C₂ of Eq. (15.61) for the Sc-L-bond MO given by Eq. (15.77) is

$$\begin{matrix}\begin{matrix}{c}_{2} ( FAO to Sc 3 d 4 sHO ) = {C}_{2} ( FAO to Sc 3 d 4 sHO ) \\ = \frac{E ( Sc , 3 d 4 s )}{E ( FAO )} \\ = \frac{- 7.34015 eV}{- 17.42282 eV} \\ = 0.42130\end{matrix} & ( 23.53 ) \\ \begin{matrix}{c}_{2} ( ClAO to Sc 3 d 4 sHO ) = {C}_{2} ( ClAO to Sc 3 d 4 sHO ) \\ = \frac{E ( Sc , 3 d 4 s )}{E ( ClAO )} \\ = \frac{- 7.34015 eV}{- 12.96764 eV} \\ = 0.56604\end{matrix} & ( 23.54 ) \\ \begin{matrix}{c}_{2} ( O to Sc 3 d 4 sHO ) = \frac{E ( Sc , 3 d 4 s )}{E ( O )} \\ = \frac{- 7.34015 eV}{- 13.61805 eV} \\ = 0.53900\end{matrix} & ( 23.55 )\end{matrix}$$

Since the energy of the MO is matched to that of the Sc3d4s HO, E(AO/HO) in Eq. (15.61) is E(Sc,3d4s) given by Eq. (23.47) and twice this value for double bonds. E_{T}(atom−atom,msp³.AO) of the Sc-L-bond MO is determined by considering that the bond involves an electron transfer from the scandium atom to the ligand atom to form partial ionic character in the bond as in the case of the zwitterions such as H₂B⁺—F⁻ given in the Halido Boranes section. E_{T}(atom−atom,msp³.AO) is −3.25266 eV, two times the energy of Eq. (23.52) for single bonds, and −6.50532 eV, four times the energy of Eq. (23.52) for double bonds.

The symbols of the functional groups of scandium coordinate compounds are given in Table 23.7. The geometrical (Eqs. (15.1-15.5) and (23.41)), intercept (Eqs. (15.31-15.32) and (15.80-15.87)), and energy (Eqs. (15.61) and (23.28-23.33)) parameters of scandium coordinate compounds are given in Tables 23.8, 23.9 (as shown in the priority document), and 23.10, respectively. The total energy of each scandium coordinate compounds given in Table 23.11 (as shown in the priority document) was calculated as the sum over the integer multiple of each E_{D} (Group) of Table 23.10 corresponding to functional-group composition of the compound. The charge-densities of exemplary scandium coordinate compound, scandium trifluoride comprising the concentric shells of atoms with the outer shell bridged by one or more H₂-type ellipsoidal MOs or joined with one or more hydrogen MOs is shown in FIG. 39.

TABLE 23.7
The symbols of the functional groups of scandium coordinate
compounds.

| Functional Group | Group Symbol |
|---|---|
| ScF group of ScF | Sc—F (a) |
| ScF group of ScF₂ | Sc—F (b) |
| ScF group of ScF₃ | Sc—F (c) |
| ScCl group of ScCl | Sc—Cl |
| ScO group of ScO | Sc—O |

TABLE 23.8
The geometrical bond parameters of scandium
coordinate compounds and experimental values.

| Para- | Sc—F (a) | Sc—F (b) | Sc—F (c) | Sc—Cl | Sc—O |
|---|---|---|---|---|---|
| meter | Group | Groups | Group | Group | Group |
| nₑ | 1 | 2 | 2 | 2 | 1 |
| L | $2 + \sqrt{\frac{3}{4}}$ | $4 \sqrt{\frac{3}{4}}$ | $2 + \sqrt{\frac{3}{4}}$ | $1 + 3 \sqrt{\frac{3}{4}}$ | $3 + 2 \sqrt{\frac{3}{4}}$ |
| a (a₀) | 1.63648 | 2.16496 | 2.13648 | 2.17134 | 1.72534 |
| c′ (a₀) | 1.60922 | 1.60294 | 1.59236 | 1.95858 | 1.51672 |
| Bond | 1.70313 | 1.69647 | 1.68528 | 2.07287 | 1.60523 |
| Length | | | | | |
| 2c′ (Å) | | | | | |
| Exp. | 1.788 [14] | 1.788 [14] | 1.788 [41] | 2.229 [15] | 1.668 [15] |
| Bond | (scandium | (scandium | (scandium | (scandium | (scandium |
| Length | fluoride) | fluoride) | fluoride) | chloride) | oxide) |
| (Å) | | | | | |
| b, c (a₀) | 0.29743 | 1.45521 | 1.45521 | 0.93737 | 0.82240 |
| e | 0.98335 | 0.74040 | 0.74040 | 0.90202 | 0.87909 |

TABLE 23.10
The energy parameters (eV) of functional groups of
scandium coordinate compounds.

| | Sc—F (a) | Sc—F (b) | Sc—F (c) | Sc—Cl | Sc—O |
|---|---|---|---|---|---|
| Parameters | Groups | Groups | Group | Group | Group |
| n₁ | 1 | 1 | 1 | 1 | 2 |
| n₂ | 0 | 0 | 0 | 0 | 0 |
| n₃ | 0 | 0 | 0 | 0 | 0 |
| C₁ | 0.75 | 1 | 1 | 0.5 | 0.375 |
| C₂ | 0.42130 | 0.42130 | 0.42130 | 0.56604 | 1 |
| c₁ | 1 | 1 | 1 | 1 | 1 |
| c₂ | 0.42130 | 1 | 1 | 0.56604 | 0.53900 |
| c₃ | 0 | 0 | 0 | 0 | 0 |
| c₄ | 1 | 1 | 1 | 1 | 2 |
| c₅ | 1 | 1 | 1 | 1 | 2 |
| C₁ₒ | 0.75 | 1 | 1 | 0.5 | 0.375 |
| C₂ₒ | 0.42130 | 0.42130 | 0.42130 | 0.56604 | 1 |
| Vₑ (eV) | −34.05166 | −32.30098 | −32.89066 | −23.32429 | −53.06036 |
| Vₚ (eV) | 8.45489 | 8.48805 | 8.54444 | 6.94677 | 17.94106 |
| T (eV) | 10.40395 | 7.45996 | 7.69741 | 5.37095 | 15.37682 |
| Vₘ (eV) | −5.20198 | −3.72998 | −3.84870 | −2.68548 | −7.68841 |
| E(AO/HO) (eV) | −7.34015 | −7.34015 | −7.34015 | −7.34015 | −14.68031 |
| ΔE_{H}_{₂}_{MO}(AO/HO) (eV) | 0 | 0 | 0 | 0 | 0 |
| E_{T}(AO/MO) (eV) | −7.34015 | −7.34015 | −7.34015 | −7.34015 | −14.68031 |
| E_{T}(H₂MO) (eV) | −27.73495 | −27.42310 | −27.83768 | −21.03220 | −42.11120 |
| E_{T}(atom-atom,msp³.AO) (eV) | −3.25266 | −3.25266 | −3.25266 | −3.25266 | −6.50532 |
| E_{T}(MO) (eV) | −30.98761 | −30.67576 | −31.09034 | −24.28486 | −48.61652 |
| ω (10¹⁵ rad/s) | 11.1005 | 15.2859 | 8.59272 | 6.87387 | 33.9452 |
| E_{K} (eV) | 7.30656 | 10.06142 | 5.65588 | 4.52450 | 22.34334 |
| Ē_{D} (eV) | −0.16571 | −0.19250 | −0.14628 | −0.10219 | −0.22732 |
| Ē_{Kvib} (eV) | 0.09120 | 0.09120 | 0.09120 | 0.04823 | 0.12046 |
| | [14] | [14] | [14] | [16] | [17] |
| Ē_{osc} (eV) | −0.12011 | −0.14690 | −0.10068 | −0.07808 | −0.16709 |
| E_{T}(Group) (eV) | −31.10771 | −30.82266 | −31.19102 | −24.36294 | −48.95069 |
| Eᵢₙᵢₜᵢₐₗ(c₄ AO/HO) (eV) | −7.34015 | −7.34015 | −7.34015 | −7.34015 | −7.34015 |
| Eᵢₙᵢₜᵢₐₗ(c₅ AO/HO) (eV) | −17.42282 | −17.42282 | −17.42282 | −12.96764 | −13.61806 |
| E_{D}(Group) (eV) | 6.34474 | 6.05969 | 6.42804 | 4.05515 | 7.03426 |

### Titanium Functional Groups and Molecules

The electron configuration of titanium is [Ar]4s²3d² having the corresponding term ³F₂. The total energy of the state is given by the sum over the four electrons. The sum E_{T} (Ti,3d 4s) of experimental energies [1] of Ti, Ti⁺, Ti²⁺, and Ti³⁺ is

$$\begin{matrix}{E}_{T} ( Ti , 3 d 4 s ) = - ( \begin{matrix}43.2672 eV + 27.4917 eV + \\ 13.5755 eV + 6.82812 eV\end{matrix} ) \\ = - 91.16252 eV\end{matrix} \qquad ( 23.56 )$$

By considering that the central field decreases by an integer for each successive electron of the shell, the radius r_{3d4s} of the Ti3d4s shell may be calculated from the Coulombic energy using Eq. (15.13):

$$\begin{matrix}{r}_{3 d 4 s} = {\sum }_{n = 18}^{21} \frac{( Z - n ) {e}^{2}}{8 {πɛ}_{0} ( e 91.16252 eV )} \\ = \frac{10 {e}^{2}}{8 {πɛ}_{0} ( e 91.16252 eV )} \\ = 1.49248 {a}_{0}\end{matrix} \qquad ( 23.57 )$$

where Z=22 for titanium. Using Eq. (15.14), the Coulombic energy E_{Coulomb} (Ti,3d4s) of the outer electron of the Ti3d4s shell is

$$\begin{matrix}{E}_{Coulomb} ( Ti , 3 d 4 s ) = \frac{- {e}^{2}}{8 {πɛ}_{0} {r}_{3 d 4 s}} \\ = \frac{- {e}^{2}}{8 {πɛ}_{0} 1.49248 {a}_{0}} \\ = - 9.11625 eV\end{matrix} \qquad ( 23.58 )$$

During hybridization, the spin-paired 4s electrons are promoted to Ti3d4s shell as unpaired electrons. The energy for the promotion is the magnetic energy given by Eq. (15.15) at the initial radius of the 4s electrons. From Eq. (10.102) with Z=22 and n=22, the radius r₂₂ of Ti4s shell is

r₂₂=1.99261a₀ (23.59)

Using Eqs. (15.15) and (23.59), the unpairing energy is

$$\begin{matrix}E ( magnetic ) = \frac{2 {πμ}_{0} {e}^{2} {ℏ}^{2}}{{{m}_{e}^{2} ( {r}_{22} )}^{3}} \\ = \frac{8 {πμ}_{0} {μ}_{B}^{2}}{{( 1.99261 {a}_{0} )}^{3}} \\ = 0.01446 eV\end{matrix} \qquad ( 23.60 )$$

Using Eqs. (23.58) and (23.60), the energy E(Ti,3d4s) of the outer electron of the Ti3d4s shell is

$$\begin{matrix}E ( Ti , 3 d 4 s ) = \frac{- {e}^{2}}{8 {πɛ}_{0} {r}_{3 d 4 s}} + \frac{2 {πμ}_{0} {e}^{2} {ℏ}^{2}}{{{m}_{e}^{2} ( {r}_{22} )}^{3}} \\ = - 9.11625 eV + 0.01446 eV \\ = - 9.10179 eV\end{matrix} \qquad ( 23.61 )$$

Next, consider the formation of the Ti-L-bond MO of wherein each titanium atom has an Ti3d4s electron with an energy given by Eq. (23.61). The total energy of the state of each titanium atom is given by the sum over the four electrons. The sum E_{T}(Ti_{Ti-L}3d4s) of energies of Ti3d4s (Eq. (23.61)), Ti⁺, Ti²⁺, and Ti³⁺ is

$$\begin{matrix}{E}_{T} ( {Ti}_{Ti - L} 3 d 4 s ) = - ( \begin{matrix}43.2672 eV + 27.4917 eV + \\ 13.5755 eV + E ( Ti , 3 d 4 s )\end{matrix} ) \\ = - ( \begin{matrix}43.2672 eV + 27.4917 eV + \\ 13.5755 eV + 9.10179 eV\end{matrix} ) \\ = - 93.43619 eV\end{matrix} \qquad ( 23.62 )$$

where E(Ti,3d4s) is the sum of the energy of Ti, −6.82812 eV, and the hybridization energy.

The titanium HO donates an electron to each MO. Using Eq. (23.30), the radius r_{3d4s} of the Ti3d4s shell calculated from the Coulombic energy is

$$\begin{matrix}{r}_{Ti - L 3 d 4 s} = ( {\sum }_{n = 18}^{21} ( Z - n ) - 1 ) \frac{{e}^{2}}{8 {πɛ}_{0} ( e 93.43619 eV )} \\ = \frac{9 {e}^{2}}{8 {πɛ}_{0} ( e 93.43619 eV )} \\ = 1.31054 {a}_{0}\end{matrix} \qquad ( 23.63 )$$

Using Eqs. (15.19) and (23.63), the Coulombic energy E_{Coulomb}(Ti_{Ti-L},3d4s) of the outer electron of the Ti3d4s shell is

$$\begin{matrix}{E}_{Coulomb} ( {Ti}_{Ti - L} , 3 d 4 s ) = \frac{- {e}^{2}}{8 {πɛ}_{0} {r}_{Ti - L 3 d 4 s}} \\ = \frac{- {e}^{2}}{8 {πɛ}_{0} 1.31054 {a}_{0}} \\ = - 10.38180 eV\end{matrix} \qquad ( 23.64 )$$

The only magnetic energy term is that for unpairing of the 4s electrons given by Eq. (23.60). Using Eqs. (23.32), (23.60), and (23.64), the energy E(Ti_{Ti-L},3d4s) of the outer electron of the Ti3d4s shell is

$$\begin{matrix}E ( {Ti}_{Ti - L} , 3 d 4 s ) = \frac{- {e}^{2}}{8 {πɛ}_{0} {r}_{Ti - L 3 d 4 s}} + \frac{2 {πμ}_{0} {e}^{2} {ℏ}^{2}}{{{m}_{e}^{2} ( {r}_{22} )}^{3}} \\ = - 10.38180 eV + 0.01446 eV \\ = - 10.36734 eV\end{matrix} \qquad ( 23.65 )$$

Thus, E_{T}(Ti-L,3d 4s), the energy change of each Ti3d4s shell with the formation of the Ti-L-bond MO is given by the difference between Eq. (23.65) and Eq. (23.61):

$$\begin{matrix}{E}_{T} ( Ti - L , 3 d 4 s ) = E ( {Ti}_{Ti - L} , 3 d 4 s ) - E ( Ti , 3 d 4 s ) \\ = - 10.36734 eV - ( - 9.10179 eV ) \\ = - 1.26555 eV\end{matrix} \qquad ( 23.66 )$$

The semimajor axis a solution given by Eq. (23.41) of the force balance equation, Eq. (23.39), for the σ-MO of the Ti-L-bond MO of TiLₙ, is given in Table 23.13 (as shown in the priority document) with the force-equation parameters Z=22, nₑ, and L corresponding to the orbital and spin angular momentum terms of the 3d4s HO shell.

For the Ti-L functional groups, hybridization of the 4s and 3d AOs of Ti to form a single 3d4s shell forms an energy minimum, and the sharing of electrons between the Ti3d4s HO and L AO to form σ MO permits each participating orbital to decrease in radius and energy. The F AO has an energy of E(F)=−17.42282 eV, the Cl AO has an energy of E(Cl)=−12.96764 eV, the Br AO has an energy of E(Br)=−11.8138 eV, the I AO has an energy of E(I)=−10.45126 eV, the O AO has an energy of E(O)=−13.61805 eV, and the Ti3d4s HOs has an energy of E(Ti,3d4s)=−9.10179 eV (Eq. (23.61)). To meet the equipotential condition of the union of the Ti-L H₂-type-ellipsoidal-MO with these orbitals, the hybridization factor(s), at least one of c₂ and C₂ of Eq. (15.61) for the Ti-L-bond MO given by Eq. (15.77) is

$$\begin{matrix}\begin{matrix}{C}_{2} ( FAO to Ti 3 d 4 sHO ) = \frac{E ( Ti , 3 d 4 s )}{E ( FAO )} \\ = \frac{- 9.10179 eV}{- 17.42282 eV} \\ = 0.52241\end{matrix} & ( 23.67 ) \\ \begin{matrix}{C}_{2} ( ClAO to Ti 3 d 4 sHO ) = \frac{E ( Ti , 3 d 4 s )}{E ( ClAO )} \\ = \frac{- 9.10179 eV}{- 12.96764 eV} \\ = 0.70188\end{matrix} & ( 23.68 ) \\ \begin{matrix}{c}_{2} ( BrAO to Ti 3 d 4 sHO ) = {C}_{2} ( BrAO to Ti 3 d 4 sHO ) \\ = \frac{E ( Ti , 3 d 4 s )}{E ( BrAO )} \\ = \frac{- 9.10179 eV}{- 11.8138 eV} \\ = 0.77044\end{matrix} & ( 23.69 ) \\ \begin{matrix}{c}_{2} ( IAO to Ti 3 d 4 sHO ) = {C}_{2} ( IAO to Ti 3 d 4 sHO ) \\ = \frac{E ( Ti , 3 d 4 s )}{E ( IAO )} \\ = \frac{- 9.10179 eV}{- 10.45126 eV} \\ = 0.87088\end{matrix} & ( 23.70 ) \\ \begin{matrix}{c}_{2} ( O to Ti 3 d 4 sHO ) = \frac{E ( Ti , 3 d 4 s )}{E ( O )} \\ = \frac{- 9.10179 eV}{- 13.61805 eV} \\ = 0.66836\end{matrix} & ( 23.71 )\end{matrix}$$

Since the energy of the MO is matched to that of the Ti3d4s HO, E(AO/HO) in Eq. (15.61) is E(Ti,3d4s) given by Eq. (23.61) and twice this value for double bonds. E_{T}(atom−atom,msp³.AO) of the Ti-L-bond MO is determined by considering that the bond involves an electron transfer from the titanium atom to the ligand atom to form partial ionic character in the bond as in the case of the zwitterions such as H₂B⁺—F⁻ given in the Halido Boranes section. E_{T}(atom−atom,msp³.AO) is −2.53109 eV, two times the energy of Eq. (23.66).

The symbols of the functional groups of titanium coordinate compounds are given in Table 23.12. The geometrical (Eqs. (15.1-15.5) and (23.41)), intercept (Eqs. (15.31-15.32) and (15.80-15.87)), and energy (Eqs. (15.61) and (23.28-23.33)) parameters of titanium coordinate compounds are given in Tables 23.13, 23.14, and 23.15, respectively (all (as shown in the priority document). The total energy of each titanium coordinate compounds given in Table 23.16 (as shown in the priority document) was calculated as the sum over the integer multiple of each E_{D} (Group) of Table 23.15 (as shown in the priority document) corresponding to functional-group composition of the compound. The bond angle parameters of titanium coordinate compounds determined using Eqs. (15.88-15.117) are given in Table 23.17 (as shown in the priority document). The E_{T}(atom−atom,msp³.AO) term for TiOCl₂ was calculated using Eqs. (23.30-23.33) as a linear combination of s=1 and s=2 for the energies of E(Ti,3d 4s) given by Eqs. (23.63-23.66) corresponding to a Ti—Cl single bond and a Ti═O double bond. The charge-densities of exemplary titanium coordinate compound, titanium tetrafluoride comprising the concentric shells of atoms with the outer shell bridged by one or more H₂-type ellipsoidal MOs or joined with one or more hydrogen MOs is shown in FIG. 40.

TABLE 23.12
The symbols of the functional groups of titanium coordinate
compounds.

| Functional Group | Group Symbol |
|---|---|
| TiF group of TiF | Ti—F (a) |
| TiF group of TiF₂ | Ti—F (b) |
| TiF group of TiF₃ | Ti—F (c) |
| TiF group of TiF₄ | Ti—F (d) |
| TiCl group of TiCl | Ti—Cl (a) |
| TiCl group of TiCl₂ | Ti—Cl (b) |
| TiCl group of TiCl₃ | Ti—Cl (c) |
| TiCl group of TiCl₄ | Ti—Cl (d) |
| TiBr group of TiBr | Ti—Br (a) |
| TiBr group of TiBr₂ | Ti—Br (b) |
| TiBr group of TiBr₃ | Ti—Br (c) |
| TiBr group of TiBr₄ | Ti—Br (d) |
| TiI group of TiI | Ti—I (a) |
| TiI group of TiI₂ | Ti—I (b) |
| TiI group of TiI₃ | Ti—I (c) |
| TiI group of TiI₄ | Ti—I (d) |
| TiO group of TiO | Ti—O (a) |
| TiO group of TiO₂ | Ti—O (b) |

### Vanadium Functional Groups and Molecules

The electron configuration of vanadium is [Ar]4s²3d³ having the corresponding term ⁴F_{3/2}. The total energy of the state is given by the sum over the five electrons. The sum E_{T}(V,3d 4s) of experimental energies [1] of V, V⁺, V²⁺, V³⁺, and V⁴⁺ is

E_{T}(V,3d4s)=−(65.2817 eV+46.709 eV+29.311 eV+14.618 eV+6.74619 eV)=−162.66589 eV (23.56)

By considering that the central field decreases by an integer for each successive electron of the shell, the radius r_{3d4s} of the V3d4s shell may be calculated from the Coulombic energy using Eq. (15.13):

$$\begin{matrix}{r}_{3 d 4 s} = {\sum }_{n = 18}^{22} \frac{( Z - n ) {e}^{2}}{8 {πɛ}_{0} ( e 162.66589 eV )} \\ = \frac{15 {e}^{2}}{8 {πɛ}_{0} ( e 162.66589 eV )} \\ = 1.25464 {a}_{0}\end{matrix} \qquad ( 23.72 )$$

where Z=23 for vanadium. Using Eq. (15.14), the Coulombic energy E_{Coulomb}(V,3d 4s) of the outer electron of the V3d4s shell is

$$\begin{matrix}{E}_{Coulomb} ( V , 3 d 4 s ) = \frac{- {e}^{2}}{8 {πɛ}_{0} {r}_{3 d 4 s}} \\ = \frac{- {e}^{2}}{8 {πɛ}_{0} 1.25464 {a}_{0}} \\ = - 10.844393 eV\end{matrix} \qquad ( 23.73 )$$

During hybridization, the spin-paired 4s electrons are promoted to V3d4s shell as unpaired electrons. The energy for the promotion is the magnetic energy given by Eq. (15.15) at the initial radius of the 4s electrons. From Eq. (10.102) with Z=23 and n=23, the radius r₂₃ of V4s shell is

r₂₃=2.01681a₀ (23.74)

Using Eqs. (15.15) and (23.74), the unpairing energy is

$$E ( magnetic ) = \frac{2 {πμ}_{0} {e}^{2} {ℏ}^{2}}{{{m}_{e}^{2} ( {r}_{23} )}^{3}} = \frac{8 {πμ}_{0} {μ}_{B}^{2}}{{( 2.01681 {a}_{0} )}^{3}} = 0.01395 eV \qquad ( 23.45 )$$

Using Eqs. (23.73) and (23.75), the energy E(V,3d4s) of the outer electron of the V3d4s shell is

$$\begin{matrix}E ( V , 3 d 4 s ) = \frac{- {e}^{2}}{8 {πɛ}_{0} {r}_{3 d 4 s}} + \frac{2 {πμ}_{0} {e}^{2} {ℏ}^{2}}{{{m}_{e}^{2} ( {r}_{23} )}^{3}} \\ = - 10.844393 eV + 0.01395 eV \\ = - 10.83045 eV\end{matrix} \qquad ( 23.76 )$$

Next, consider the formation of the V-L-bond MO of wherein each vanadium atom has an V3d4s electron with an energy given by Eq. (23.76). The total energy of the state of each vanadium atom is given by the sum over the five electrons. The sum E_{T}(V_{V-L}3d 4s) of energies of V3d4s (Eq. (23.76)), V⁺, V²⁺, V³⁺, and V⁴⁺ is

$$\begin{matrix}{E}_{T} ( {V}_{V - L} 3 d 4 s ) = - ( \begin{matrix}65.2817 eV + 46.709 eV + \\ 29.311 eV + \\ 14.618 eV + E ( V , 3 d 4 s )\end{matrix} ) \\ = - ( \begin{matrix}65.2817 eV + 46.709 eV + \\ 29.311 eV + \\ 14.618 eV + 10.83045\end{matrix} ) \\ = - 166.75015 eV\end{matrix} \qquad ( 23.77 )$$

where E(V,3d4s) is the sum of the energy of V, −6.74619 eV, and the hybridization energy.

The vanadium HO donates an electron to each MO. Using Eq. (23.30), the radius r_{3d4s} of the V3d4s shell calculated from the Coulombic energy is

$$\begin{matrix}{r}_{V - L 3 d 4 s} = ( {\sum }_{n = 18}^{22} ( Z - n ) - 1 ) \frac{{e}^{2}}{8 {πɛ}_{0} ( e 166.75015 eV )} \\ = \frac{14 {e}^{2}}{8 {πɛ}_{0} ( e 166.75015 eV )} \\ = 1.14232 {a}_{0}\end{matrix} \qquad ( 23.78 )$$

Using Eqs. (15.19) and (23.78), the Coulombic energy E_{Coulomb}(V_{V-L},3d4s) of the outer electron of the V3d4s shell is

$$\begin{matrix}{E}_{Coulomb} ( {V}_{V - L} , 3 d 4 s ) = \frac{- {e}^{2}}{8 {πɛ}_{0} {r}_{V - L 3 d 4 s}} \\ = \frac{- {e}^{2}}{8 {πɛ}_{0} 1.14232 {a}_{0}} \\ = - 11.91072 eV\end{matrix} \qquad ( 23.79 )$$

The only magnetic energy term is that for unpairing of the 4s electrons given by Eq. (23.75). Using Eqs. (23.32), (23.73), and (23.79), the energy E(V_{V-L},3d4s) of the outer electron of the V3d4s shell is

$$\begin{matrix}E ( {V}_{V - L} , 3 d 4 s ) = \frac{- {e}^{2}}{8 {πɛ}_{0} {r}_{V - L 3 d 4 s}} + \frac{2 {πμ}_{0} {e}^{2} {ℏ}^{2}}{{{m}_{e}^{2} ( {r}_{23} )}^{3}} \\ = - 11.91072 eV + 0.01446 eV \\ = - 11.89678 eV\end{matrix} \qquad ( 23.80 )$$

Thus, E_{T}(V-L,3d4s), the energy change of each V3d4s shell with the formation of the V-L-bond MO is given by the difference between Eq. (23.80) and Eq. (23.76):

$$\begin{matrix}{E}_{T} ( V - L , 3 d 4 s ) = E ( {V}_{V - L} , 3 d 4 s ) - E ( V , 3 d 4 s ) \\ = - 11.89678 eV - ( - 10.83045 eV ) \\ = - 1.06633 eV\end{matrix} \qquad ( 23.81 )$$

The semimajor axis a solution given by Eq. (23.41) of the force balance equation, Eq. (23.39), for the σ-MO of the V-L-bond MO of VLₙ is given in Table 23.19 (as shown in the priority document) with the force-equation parameters Z=23, nₑ, and L corresponding to the orbital and spin angular momentum terms of the 3d4s HO shell. The semimajor axis a of carbonyl and organometallic compounds are solved using Eq. (15.51).

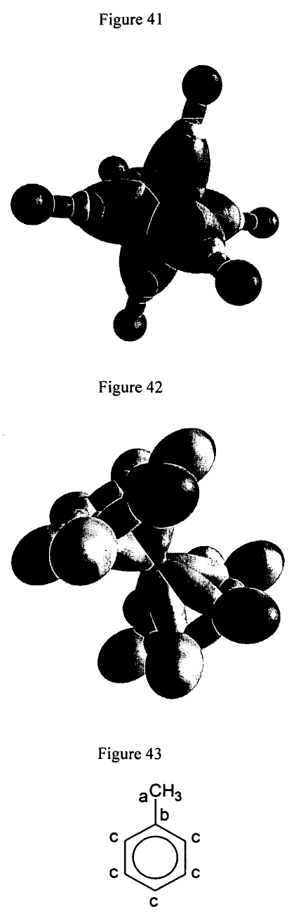

For the V-L functional groups, hybridization of the 4s and 3d AOs of V to form a single 3d4s shell forms an energy minimum, and the sharing of electrons between the V3d4s HO and L AO to form σ MO permits each participating orbital to decrease in radius and energy. The F AO has an energy of E(F)=−17.42282 eV, the Cl AO has an energy of E(Cl)=−12.96764 eV, the C_{aryl}2sp³ HO has an energy of E(C_{aryl},2sp³)=−15.76868 eV (Eq. (14.246)), the C2sp³ HO has an energy of E(C,2sp³)=−14.63489 eV (Eq. (15.25)), the N AO has an energy of E(N)=−14.53414 eV, the O AO has an energy of E(O)=−13.61805 eV, and the V3d4s HO has an energy of E_{Coulomb}(V,3d4s)=−10.84439 eV (Eq. (23.75)) and E(V,3d4s)=−10.83045 eV (Eq. (23.76)). To meet the equipotential condition of the union of the V-L H₂-type-ellipsoidal-MO with these orbitals, the hybridization factor(s), at least one of c₂ and C₂ of Eq. (15.61) for the V-L-bond MO given by Eq. (15.77) is

$$\begin{matrix}\begin{matrix} {C}_{2} ( F AO to V 3 d 4 s HO ) = \frac{E ( V , 3 d 4 s )}{E ( F AO )} \\ = \frac{- 10.83045 eV}{- 17.42282 eV} \\ = 0.62162 \end{matrix} & ( 23.82 ) \\ \begin{matrix} {C}_{2} ( Cl AO to V 3 d 4 s HO ) = \frac{E ( V , 3 d 4 s )}{E ( Cl AO )} \\ = \frac{- 10.83045 eV}{- 12.96764 eV} \\ = 0.83519\end{matrix} & ( 23.83 ) \\ \begin{matrix} {C}_{2} ( C 2 {sp}^{3} HO to V 3 d 4 s HO ) = \frac{{E}_{Coulomb} ( V , 3 d 4 s )}{E ( C , 2 {sp}^{3} )} {c}_{2} \\ ( C 2 {sp}^{3} HO ) \\ = \frac{- 10.84439 eV}{- 14.63489 eV} ( 0.91771 ) \\ = 0.68002\end{matrix} & ( 23.84 ) \\ {c}_{2} ( {C}_{aryl} 2 {sp}^{3} HO to V 3 d 4 s HO ) = {c}_{2} ( {C}_{aryl} 2 {sp}^{3} HO to V 3 d 4 s HO ) = \frac{{E}_{Coulomb} ( V , 3 d 4 s )}{E ( {C}_{aryl} , 2 {sp}^{3} )} = \frac{- 10.84439 eV}{- 15.76868 eV} = 0.68772 & ( 23.85 ) \\ \begin{matrix} {c}_{2} ( N AO to V 3 d 4 s HO ) = {C}_{2} ( N AO to V 3 d 4 s HO ) \\ = \frac{E ( V , 3 d 4 s )}{E ( NAO )} \\ = \frac{- 10.83045 eV}{- 14.53414 eV} \\ = 0.74517\end{matrix} & ( 23.86 ) \\ \begin{matrix} {c}_{2} ( O to V 3 d 4 s HO ) = \frac{E ( V , 3 d 4 s )}{E ( O )} \\ = \frac{- 10.83045 eV}{- 13.61805 eV} \\ = 0.79530\end{matrix} & ( 23.87 )\end{matrix}$$

where Eqs. (15.76), (15.79), and (13.430) were used in Eq. (23.84). Since the energy of the MO is matched to that of the V3d4s HO of coordinate compounds, E(A0/HO) in Eq. (15.61) is E(V,3d4s) given by Eq. (23.76) and twice this value for double bonds. For carbonyls and organometallics, the energy of the MO is matched to that of the Coulomb energy of the V3d4s HO such that E(AO/HO) in Eq. (15.61) is E_{Coulomb}(V,3d 4s) given by Eq. (23.73). E_{T}(atom−atom,msp³.AO) of the V-L-bond MO is determined by considering that the bond involves an electron transfer from the vanadium atom to the ligand atom to form partial ionic character in the bond as in the case of the zwitterions such as H₂B⁺—F⁻ given in the Halido Boranes section. For coordinate compounds, E_{T}(atom−atom,msp³.AO) is −2.53109 eV, two times the energy of Eq. (23.81). For carbonyl and organometallic compounds, E_{T}(atom−atom,msp³.AO) is −1.65376 eV and −2.26759 eV, respectively. The former is based on the energy match between the V3d4s HO and the C2sp³ HO of a carbonyl group and is given by the linear combination of −0.72457 eV (Eq. (14.151)) and −0.92918 eV (Eq. (14.513)), respectively. The latter is equivalent to that of ethylene and the aryl group, −2.26759 eV, given by Eq. (14.247). The C═O functional group of carbonyls is equivalent to that of formic acid given in Carboxylic Acids section except that Ē_{Kvib} corresponds to that of a metal carbonyl and E_{T}(AO/HO) of Eq. (15.47) is

$$\begin{matrix}{E}_{T} ( AO / HO ) = - Δ {E}_{{H}_{2} MO} ( AO / HO ) \\ = - ( - 14.63489 eV - 3.58557 eV ) \\ = 18.22046 eV\end{matrix} \qquad ( 23.88 )$$

wherein the additional E(AO/HO)=−14.63489 eV (Eq. (15.25)) component corresponds to the donation of both unpaired electrons of the C2sp³ HO of the carbonyl group to the metal-carbonyl bond. The benzene groups of organometallic, V(C₆H₆)₂ are equivalent to those given in the Aromatic and Heterocyclic Compounds section.
The symbols of the functional groups of vanadium coordinate compounds are given in Table 23.18. The geometrical (Eqs. (15.1-15.5) and (23.41)), intercept (Eqs. (15.31-15.32) and (15.80-15.87)), and energy (Eqs. (15.61) and (23.28-23.33)) parameters of vanadium coordinate compounds are given in Tables 23.19, 23.20, and 23.21, respectively (all as shown in the priority document). The total energy of each vanadium coordinate compounds given in Table 23.22 (as shown in the priority document) was calculated as the sum over the integer multiple of each E_{D} (Group) of Table 23.21 (as shown in the priority document) corresponding to functional-group composition of the compound. The bond angle parameters of vanadium coordinate compounds determined using Eqs. (15.88-15.117) are given in Table 23.23 (as shown in the priority document). The E_{T}(atom−atom,msp³.AO) term for VOCl₃ was calculated using Eqs. (23.30-23.33) with s=1 for the energies of E(V,3d4s) given by Eqs. (23.78-23.81). The charge-densities of exemplary vanadium carbonyl and organometallic compounds, vanadium hexacarbonyl (V (CO)₆) and dibenzene vanadium (V(C₆H₆)₂), respectively, comprising the concentric shells of atoms with the outer shell bridged by one or more H₂-type ellipsoidal MOs or joined with one or more hydrogen MOs are shown in FIGS. 41 and 42.

TABLE 23.18
The symbols of the functional groups of vanadium coordinate
compounds.

| Functional Group | Group Symbol |
|---|---|
| VF group of VF₅ | V—F |
| VCl group of VCl₄ | V—Cl |
| VN group of VN | V—N |
| VO group of VO and VO₂ | V—O |
| VCO group of V(CO)₆ | V—CO |
| C═O | C═O |
| VC_{aryl} group of V(C₆H₆)₂ | V—C₆H₆ |
| CC (aromatic bond) | C^{3e}═C |
| CH (aromatic) | CH |

### Chromium Functional Groups and Molecules

The electron configuration of chromium is [Ar]4s¹3d⁵ having the corresponding term ⁷S₃. The total energy of the state is given by the sum over the six electrons. The sum E_{T}(Cr,3d4s) of experimental energies [1] of Cr, Cr⁺, Cr²⁺, Cr³⁺, Cr⁴⁺, and Cr⁵⁺ is

$$\begin{matrix}{r}_{3 d 4 s} = {\sum }_{n = 18}^{23} \frac{( Z - n ) {e}^{2}}{8 {πɛ}_{0} ( e 263.46711 eV )} \\ = \frac{21 {e}^{2}}{8 {πɛ}_{0} ( e 263.46711 eV )} \\ = 1.08447 {a}_{0}\end{matrix} \qquad ( 23.90 )$$

By considering that the central field decreases by an integer for each successive electron of the shell, the radius r_{3d4s} of the Cr3d4s shell may be calculated from the Coulombic energy using Eq. (15.13):

$$\begin{matrix}{E}_{T} ( Cr , 3 d 4 s ) = - ( \begin{matrix}90.6349 eV + 69.46 eV + 49.16 eV + \\ 30.96 eV + 16.4857 eV + 6.76651 eV\end{matrix} ) \\ = - 263.46711 eV\end{matrix} \qquad ( 23.89 )$$

where Z=24 for chromium. Using Eq. (15.14), the Coulombic energy E_{Coulomb}(Cr,3d45) of the outer electron of the Cr3d4s shell is

$$\begin{matrix}{E}_{Coulomb} ( Cr , 3 d 4 s ) = \frac{- {e}^{2}}{8 {πɛ}_{0} {r}_{3 d 4 s}} \\ = \frac{- {e}^{2}}{8 {πɛ}_{0} 1.08447 {a}_{0}} \\ = - 12.546053 eV\end{matrix} \qquad ( 23.91 )$$

Next, consider the formation of the Cr-L-bond MO of wherein each chromium atom has an Cr3d4s electron with an energy given by Eq. (23.91). The total energy of the state of each chromium atom is given by the sum over the six electrons. The sum E_{T}(Cr_{Cr-L}3d4s) of energies of Cr3d4s (Eq. (23.91)), Cr⁺, Cr²⁺, Cr³⁺, Cr⁴⁺, and Cr⁵⁺ is

$$\begin{matrix}{E}_{T} ( {Cr}_{Cr - L} 3 d 4 s ) = - ( \begin{matrix}90.6349 eV + 69.46 eV + \\ 49.16 eV + 30.96 eV + \\ 16.4857 eV + {E}_{Coulomb} ( Cr , 3 d 4 s )\end{matrix} ) \\ = - ( \begin{matrix}90.6349 eV + 69.46 eV + \\ 49.16 eV + 30.96 eV + \\ 16.4857 eV + 12.546053 eV\end{matrix} ) \\ = - 269.24665 eV\end{matrix} \qquad ( 23.92 )$$

where E(Cr,3d4s) is the sum of the energy of Cr, −6.76651 eV, and the hybridization energy.

The chromium HO donates an electron to each MO. Using Eq. (23.30), the radius r_{3d4s} of the Cr3d4s shell calculated from the Coulombic energy is

$$\begin{matrix}{r}_{Cr - L 3 d 4 s} = ( {\sum }_{n = 18}^{23} ( Z - n ) - 1 ) \frac{{e}^{2}}{8 {πɛ}_{0} ( e 269.24665 e V )} \\ = \frac{20 {e}^{2}}{8 {πɛ}_{0} ( e 269.24665 e V )} = 1.01066 {a}_{0}\end{matrix} \qquad ( 23.93 )$$

Using Eqs. (15.19) and (23.93), the Coulombic energy E_{Coulomb}(Cr_{Cr-L},3 d 4s) of the outer electron of the Cr3d4s shell is

$$\begin{matrix}{E}_{Coulomb} ( {Cr}_{Cr - L} , 3 d 4 s ) = \frac{- {e}^{2}}{8 {πɛ}_{0} {r}_{Cr - L 3 d 4 s}} \\ = \frac{- {e}^{2}}{8 {πɛ}_{0} 1.01066 {a}_{0}} \\ = - 13.46233 e V\end{matrix} \qquad ( 23.94 )$$

Thus, E_{T}(Cr-L,3d4s), the energy change of each Cr3d4s shell with the formation of the Cr-L-bond MO is given by the difference between Eq. (23.94) and Eq. (23.91):

$$\begin{matrix}{E}_{T} ( Cr - L , 3 d 4 s ) = E ( {Cr}_{Cr - L} , 3 d 4 s ) - E ( Cr , 3 d 4 s ) \\ = - 13.46233 e V - ( - 12.546053 e V ) \\ = - 0.91628 e V\end{matrix} \qquad ( 23.95 )$$

The semimajor axis a solution given by Eq. (23.41) of the force balance equation, Eq. (23.39), for the σ-MO of the Cr-L-bond MO of CrLₙ, is given in Table 23.25 (as shown in the priority document) with the force-equation parameters Z=24, nₑ, and L corresponding to the orbital and spin angular momentum terms of the 3d4s HO shell. The semimajor axis a of carbonyl and organometallic compounds are solved using Eq. (15.51).

For the Cr-L functional groups, hybridization of the 4s and 3d AOs of Cr to form a single 3d4s shell forms an energy minimum, and the sharing of electrons between the Cr3d4s HO and L AO to form σ MO permits each participating orbital to decrease in radius and energy. The F AO has an energy of E(F)=−17.42282 eV, the Cl AO has an energy of E(Cl)=−12.96764 eV, the C_{aryl}2sp³ HO has an energy of E(C_{aryl},2sp³)=−15.76868 eV (Eq. (14.246)), the C2sp³ HO has an energy of E(C,2sp³)=−14.63489 eV (Eq. (15.25)), the O AO has an energy of E(O)=−13.61805 eV, and the Cr3d4s HO has an energy of E_{Coulomb}(Cr,3d4s)=−12.54605 eV (Eq. (23.91)). To meet the equipotential condition of the union of the Cr-L H₂-type-ellipsoidal-MO with these orbitals, the hybridization factor(s), at least one of c₂ and C₂ of Eq. (15.61) for the Cr-L-bond MO given by Eq. (15.77) is

$$\begin{matrix}\begin{matrix}{c}_{2} ( FAO to Cr 3 d 4 s ) = {C}_{2} ( FAO to Cr 3 d 4 s ) \\ = \frac{{E}_{Coulomb} ( Cr , 3 d 4 s )}{E ( FAO )} \\ = \frac{- 12.54605 eV}{- 17.42282 eV} = 0.72009\end{matrix} & ( 23.96 ) \\ \begin{matrix}{c}_{2} ( ClAO to Cr 3 d 4 s HO ) = {C}_{2} ( ClAO to Cr 3 d 4 s HO ) \\ = \frac{{E}_{Coulomb} ( Cr , 3 d 4 s )}{E ( ClAO )} \\ = \frac{- 12.54605 eV}{- 12.96764 eV} = 0.96749\end{matrix} & ( 23.97 ) \\ \begin{matrix}{c}_{2} ( C 2 {sp}^{3} HO to Cr 3 d 4 s HO ) = {C}_{2} ( C 2 {sp}^{3} HO to Cr 3 d 4 s HO ) \\ = \frac{{E}_{Coulomb} ( Cr , 3 d 4 s )}{E ( C , 2 {sp}^{3} )} \\ = \frac{- 12.54605 eV}{- 14.63489 eV} = 0.85727\end{matrix} & ( 23.98 ) \\ \begin{matrix}{C}_{2} ( {C}_{aryl} 2 {sp}^{3} HO to Cr 3 d 4 s HO ) = \frac{{E}_{Coulomb} ( Cr , 3 d 4 s )}{E ( {C}_{aryl} , 2 {sp}^{3} )} \\ = \frac{- 12.54605 eV}{- 15.76868 eV} = 0.79563\end{matrix} & ( 23.99 ) \\ \begin{matrix}{c}_{2} ( O to Cr 3 d 4 s HO ) = {C}_{2} ( O to Cr 3 d 4 s HO ) \\ = \frac{{E}_{Coulomb} ( Cr , 3 d 4 s )}{E ( O )} \\ = \frac{- 12.54605 eV}{- 13.61805 eV} = 0.92128\end{matrix} & ( 23.100 )\end{matrix}$$

Since the energy of the MO is matched to that of the V_{Coulomb}3d 4s HO, E(AO/HO) in Eq. (15.61) is E_{Coulomb}(Cr,3d4s) given by Eq. (23.91) and twice this value for double bonds. E_{T}(atom−atom,msp³.AO) of the Cr-L-bond MO is determined by considering that the bond involves an electron transfer from the chromium atom to the ligand atom to form partial ionic character in the bond as in the case of the zwitterions such as H₂B⁺—F⁻ given in the Halido Boranes section. For coordinate compounds, E_{T}(atom−atom,msp³.AO) is −1.83256 eV, two times the energy of Eq. (23.95). For carbonyl and organometallic compounds, E_{T}(atom−atom,msp³.AO) is −1.44915 eV (Eq. (14.151)), and the C═O functional group of carbonyls is equivalent to that of vanadium carbonyls. The benzene and substituted benzene groups of organometallics are equivalent to those given in the Aromatic and Heterocyclic Compounds section.

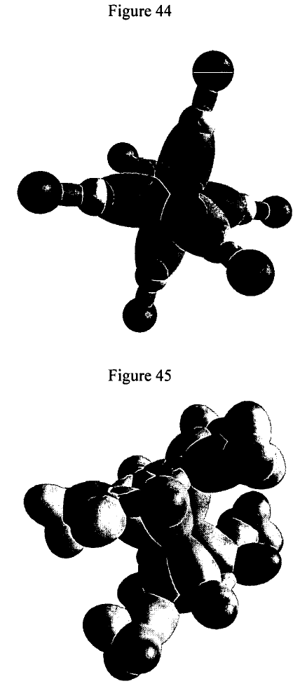

The symbols of the functional groups of chromium coordinate compounds are given in Table 23.24. The corresponding designation of the structure of the (CH₃)₃ C₆H₃ group of Cr((CH₃)₃C₆H₃)₂ is equivalent to that of toluene shown in FIG. 43. The geometrical (Eqs. (15.1-15.5) and (23.41)), intercept (Eqs. (15.31-15.32) and (15.80-15.87)), and energy (Eqs. (15.61) and (23.28-23.33)) parameters of chromium coordinate compounds are given in Tables 23.25, 23.26, and 23.27, respectively (all as shown in the priority document). The total energy of each chromium coordinate compounds given in Table 23.28 (as shown in the priority document) was calculated as the sum over the integer multiple of each E_{D} (Group) of Table 23.27 (as shown in the priority document) corresponding to functional-group composition of the compound. The bond angle parameters of chromium coordinate compounds determined using Eqs. (15.88-15.117) are given in Table 23.29 (as shown in the priority document). The E_{T}(atom−atom,msp³.AO) term for CrOCl₃ was calculated using Eqs. (23.30-23.33) with s=1 for the energies of E_{Coulomb}(Cr,3d4s) given by Eqs. (23.93-23.95). The charge-densities of exemplary chromium carbonyl and organometallic compounds, chromium hexacarbonyl (Cr (CO)₆) and di-(1,2,4-trimethylbenzene) chromium (Cr ((CH₃)₃ C₆H₃)₂), respectively, comprising the concentric shells of atoms with the outer shell bridged by one or more H₂-type ellipsoidal MOs or joined with one or more hydrogen MOs are shown in FIGS. 44 and 45.

TABLE 23.24
The symbols of the functional groups of chromium coordinate
compounds.

| Functional Group | Group Symbol |
|---|---|
| CrF group of CrF₂ | Cr—F |
| CrCl group of CrCl₂ | Cr—Cl |
| CrO group of CrO | Cr—O (a) |
| CrO group of CrO₂ | Cr—O (b) |
| CrO group of CrO₃ | Cr—O (c) |
| CrCO group of Cr(CO)₆ | Cr—CO |
| C═O | C═O |
| CrC_{aryl} group of Cr(C₆H₆)₂ and | Cr—C₆H₆ |
| Cr((CH₃)₃C₆H₃)₂ | |
| CC (aromatic bond) | C^{3e}═C |
| CH (aromatic) | CH |
| Cₐ—C_{b} (CH₃ to aromatic bond) | C—C |
| CH₃ group | C—H (CH₃) |

### Manganese Functional Groups and Molecules

The electron configuration of manganese is [Ar]4s²3d⁵ having the corresponding term ⁶S_{5/2}. The total energy of the state is given by the sum over the seven electrons. The sum E_{T}(Mn,3d4s) of experimental energies [1] of Mn, Mn⁺, Mn²⁺, Mn³⁺, Mn⁴⁺, Mn⁵⁺, and Mn⁶⁺ is

$$\begin{matrix}{E}_{T} ( Mn , 3 d 4 s ) = - ( \begin{matrix}119.203 eV + 95.6 eV + 72.4 eV + \\ 51.2 eV + 33.668 eV + \\ 15.6400 eV + 14.22133 eV\end{matrix} ) \\ = - 401.93233 eV\end{matrix} \qquad ( 23.101 )$$

By considering that the central field decreases by an integer for each successive electron of the shell, the radius r_{3d4s} of the Mn3d4s shell may be calculated from the Coulombic energy using Eq. (15.13):

$$\begin{matrix}{r}_{3 d 4 s} = {\sum }_{n = 18}^{24} \frac{( Z - n ) {e}^{2}}{8 {πɛ}_{0} ( e 395.14502 eV )} \\ = \frac{28 {e}^{2}}{8 {πɛ}_{0} ( e 395.14502 eV )} \\ = 0.96411 {a}_{0}\end{matrix} \qquad ( 23.102 )$$

where Z=25 for manganese. Using Eq. (15.14), the Coulombic energy E_{Coulomb}(Mn,3d4s) of the outer electron of the Mn3d4s shell is

$$\begin{matrix}{E}_{Coulomb} ( Mn , 3 d 4 s ) = \frac{- {e}^{2}}{8 {πɛ}_{0} {r}_{3 d 4 s}} \\ = \frac{- {e}^{2}}{8 {πɛ}_{0} 0.96411 {a}_{0}} \\ = - 14.112322 eV\end{matrix} \qquad ( 23.103 )$$

During hybridization, the spin-paired 4s electrons are promoted to Mn3d4s shell as unpaired electrons. The energy for the promotion is the magnetic energy given by Eq. (15.15) at the initial radius of the 4s electrons. From Eq. (10.102) with Z=25 and n=25, the radius r₂₅ of Mn4s shell is

r₂₅=1.83021a₀ (23.104)

Using Eqs. (15.15) and (23.104), the unpairing energy is

$$\begin{matrix}{E}_{4 s} ( magnetic ) = \frac{2 {πμ}_{0} {e}^{2} {ℏ}^{2}}{{{m}_{e}^{2} ( {r}_{25} )}^{3}} \\ = \frac{8 {πμ}_{0} {μ}_{B}^{2}}{{( 1.83021 {a}_{0} )}^{3}} \\ = 0.01866 eV\end{matrix} \qquad ( 23.105 )$$

The electrons from the 4s and 3d shells successively fill unoccupied HOs until the HO shell is filled with unpaired electrons, then the electrons pair per HO. In the case of the Mn3d4s shell having seven electrons and six orbitals, one set of electrons is paired. Using Eqs. (15.15) and (23.102), the paring energy is given by

$$\begin{matrix}{E}_{3 d 4 s} ( magnetic ) = - \frac{2 {πμ}_{0} {e}^{2} {ℏ}^{2}}{{{m}_{e}^{2} ( {r}_{3 d 4 s} )}^{3}} \\ = - \frac{8 {πμ}_{0} {μ}_{B}^{2}}{{( 0.96411 {a}_{0} )}^{3}} \\ = - 0.12767 eV\end{matrix} \qquad ( 23.105 )$$

Thus, after Eq. (23.28), the energy E(Mn,3d4s) of the outer electron of the Mn3d4s shell is given by adding the magnetic energy of unpairing the 4s electrons (Eq. (23.105)) and paring of one set of Mn3d4s electrons (Eq. (23.106)) to E_{Coulomb}(Mn,3d 4s) (Eq. (23.103)):

$$\begin{matrix}E ( Mn , 3 d 4 s ) = \frac{- {e}^{2}}{8 {πɛ}_{0} {r}_{3 d 4 s}} + \frac{2 {πμ}_{0} {e}^{2} {ℏ}^{2}}{{m}_{e}^{2} {r}_{4 s}^{3}} + \\ {\sum }_{3 d pairs} \frac{2 {πμ}_{0} {e}^{2} {ℏ}^{2}}{{m}_{e}^{2} {r}_{3 d}^{3}} - {\sum }_{HO pairs} \frac{2 {πμ}_{0} {e}^{2} {ℏ}^{2}}{{m}_{e}^{2} {r}_{3 d 4 s}^{3}} \\ = - 14.112322 eV + 0.01866 eV - \\ 0.12767 eV \\ = - 14.22133 eV\end{matrix} \qquad ( 23.107 )$$

Next, consider the formation of the Mn-L-bond MO of wherein each manganese atom has an Mn3d 4s electron with an energy given by Eq. (23.107). The total energy of the state of each manganese atom is given by the sum over the seven electrons. The sum E_{T}(Mn_{Mn-L}3d4s) of energies of Mn3d 4s (Eq. (23.107)), Mn⁺, Mn²⁺, Mn³⁺, Mn⁴⁺, Mn⁵⁺, and Mn⁶⁺ is

$$\begin{matrix}{E}_{T} ( {Mn}_{Mn - L} 3 d 4 s ) = - ( \begin{matrix}119.203 eV + 95.6 eV + \\ 72.4 eV + 51.2 eV + \\ \begin{matrix}33.668 eV + 15.6400 eV + \\ E ( Mn , 3 d 4 s )\end{matrix}\end{matrix} ) \\ = - ( \begin{matrix}119.203 eV + 95.6 eV + \\ 72.4 eV + 51.2 eV + \\ \begin{matrix}33.668 eV + 15.6400 eV + \\ 14.22133 eV\end{matrix}\end{matrix} ) \\ = - 401.93233 eV\end{matrix} \qquad ( 23.108 )$$

where E(Mn, 3d 4s) is the sum of the energy of Mn, −7.43402 eV, and the hybridization energy.

The manganese HO donates an electron to each MO. Using Eq. (23.30), the radius r_{3d4s} of the Mn3d4s shell calculated from the Coulombic energy is

$$\begin{matrix}{r}_{Mn - L 3 d 4 s} = ( {\sum }_{n = 18}^{24} ( Z - n ) - 1 ) \frac{{e}^{2}}{8 {πɛ}_{0} ( e401 .93233 eV )} \\ = \frac{27 {e}^{2}}{8 {πɛ}_{0} ( e 401.93233 eV )} \\ = 0.91398 {a}_{0}\end{matrix} \qquad ( 23.109 )$$

Using Eqs. (15.19) and (23.109), the Coulombic energy E_{Coulomb}(Mn_{Mn-L},3d 4s) of the outer electron of the Mn3d 4s shell is

$$\begin{matrix}{E}_{Coulomb} ( {Mn}_{Mn - L} , 3 d 4 s ) = \frac{- {e}^{2}}{8 {πɛ}_{0} {r}_{Mn - L 3 d 4 s}} \\ = \frac{- {e}^{2}}{8 {πɛ}_{0} 0.91398 {a}_{0}} \\ = - 14.88638 eV\end{matrix} \qquad ( 23.110 )$$

The magnetic energy terms are those for unpairing of the 4s electrons (Eq. (23.105)) and paring one set of Mn3d4s electrons (Eq. (23.106)). Using Eqs. (23.32), (23.105), (23.106), and (23.110), the energy E(Mn_{Mn-L}, 3d4s) of the outer electron of the Mn3d4s shell is

$$\begin{matrix}E ( {Mn}_{Mn - L} , 3 d 4 s ) = \frac{- {e}^{2}}{8 {πɛ}_{0} {r}_{Mn - L 3 d 4 s}} + \frac{2 {πμ}_{0} {e}^{2} {ℏ}^{2}}{{{m}_{e}^{2} ( {r}_{25} )}^{3}} - \\ \frac{2 {πμ}_{0} {e}^{2} {ℏ}^{2}}{{{m}_{e}^{2} ( {r}_{3 d 4 s} )}^{3}} \\ = - 14.88638 eV + 0.01866 eV - \\ 0.12767 eV \\ = - 14.99539 eV\end{matrix} \qquad ( 23.111 )$$

Thus, E_{T}(Mn-L,3d4s), the energy change of each Mn3d4s shell with the formation of the Mn-L-bond MO is given by the difference between Eq. (23.111) and Eq. (23.107):

$$\begin{matrix}{E}_{T} ( Mn - L , 3 d 4 s ) = E ( {Mn}_{Mn - L} , 3 d 4 s ) - E ( Mn , 3 d 4 s ) \\ = - 14.99539 eV - ( - 14.22133 eV ) \\ = - 0.77406 eV\end{matrix} \qquad ( 23.112 )$$

The semimajor axis a solution given by Eq. (23.41) of the force balance equation, Eq. (23.39), for the σ-MO of the Mn-L-bond MO of MnLₙ, is given in Table 23.31 with the force-equation parameters Z=25, nₑ, and L corresponding to the orbital and spin angular momentum terms of the 3d4s HO shell. The semimajor axis a of carbonyl and organometallic compounds are solved using Eq. (15.51).

For the Mn-L functional groups, hybridization of the 4s and 3d AOs of Mn to form a single 3d4s shell forms an energy minimum, and the sharing of electrons between the Mn3d4s HO and L AO to form σ MO permits each participating orbital to decrease in radius and energy. The F AO has an energy of E(F)=−17.42282 eV, the Cl AO has an energy of E(Cl)=−12.96764 eV, the C2sp³ HO has an energy of E(C,2sp³)=−14.63489 eV (Eq. (15.25)), the Coulomb energy of Mn3d4s HO is E_{Coulomb}(Mn,3d4s)=−14.11232 eV (Eq. (23.103)), the Mn3d4s HO has an energy of E(Mn,3d4s)=−14.22133 eV (Eq. (23.107)), and 13.605804 eV is the magnitude of the Coulombic energy between the electron and proton of H (Eq. (1.243)). To meet the equipotential condition of the union of the Mn-L H₂-type-ellipsoidal-MO with these orbitals, the hybridization factor(s), at least one of c₂ and C₂ of Eq. (15.61) for the Mn-L-bond MO given by Eq. (15.77) is

$$\begin{matrix}\begin{matrix}{C}_{2} ( F AO to Mn 3 d 4 s HO ) = \frac{E ( Mn , 3 d 4 s )}{E ( F AO )} \\ = \frac{- 14.22133 eV}{- 17.42282 eV} \\ = 0.81625\end{matrix} & ( 23.113 ) \\ \begin{matrix}{C}_{2} ( Cl AO to Mn 3 d 4 s HO ) = \frac{E ( Cl AO )}{E ( Mn , 3 d 4 s )} \\ = \frac{- 12.96764 eV}{- 14.22133 eV} \\ = 0.91184\end{matrix} & ( 23.114 ) \\ \begin{matrix} {c}_{2} ( C 2 {sp}^{3} HO toMn 3 d 4 s HO ) = \frac{{E}_{Coulomb} ( Mn , 3 d 4 s )}{E ( C , 2 {sp}^{3} )} \\ {c}_{2} ( C 2 {sp}^{3} HO ) \\ = \frac{- 14.11232 eV}{- 14.63489 eV} ( 0.91771 ) \\ = 0.88495\end{matrix} & ( 23.115 ) \\ \begin{matrix}{C}_{2} ( Mn 3 d 4 s HO to Mn 3 d 4 s HO ) = \frac{E ( H )}{{E}_{Coulomb} ( Mn , 3 d 4 s )} \\ = \frac{- 13.605804 eV}{- 14.11232 eV} \\ = 0.96411\end{matrix} \\ & ( 23.116 )\end{matrix}$$

where Eqs. (15.76), (15.79), and (13.430) were used in Eq. (23.115) and Eq. (15.71) was used in Eq. (23.116). Since the energy of the MO is matched to that of the Mn3d4s HO in coordinate compounds, E(AO/HO) in Eq. (15.61) is E(Mn,3d4s) given by Eq. (23.107) and E(AO/HO) in Eq. (15.61) of carbonyl compounds is E_{Coulomb}(Mn,3d4s) given by Eq. (23.103). E_{T}(atom−atom,msp³.AO) of the Mn-L-bond MO is determined by considering that the bond involves an electron transfer from the manganese atom to the ligand atom to form partial ionic character in the bond as in the case of the zwitterions such as H₂B⁺—F⁻ given in the Halido Boranes section. For the coordinate compounds, E_{T}(atom−atom,msp³.AO) is −1.54812 eV, two times the energy of Eq. (23.112). For the Mn—CO bonds of carbonyl compounds, E_{T}(atom−atom,msp³.AO) is −1.44915 eV (Eq. (14.151)), and the C═O functional group of carbonyls is equivalent to that of vanadium carbonyls.

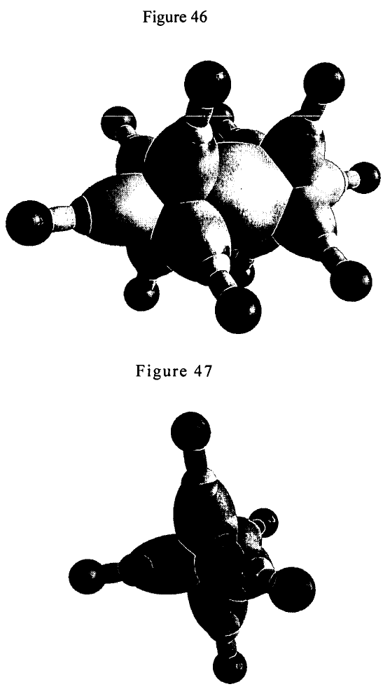

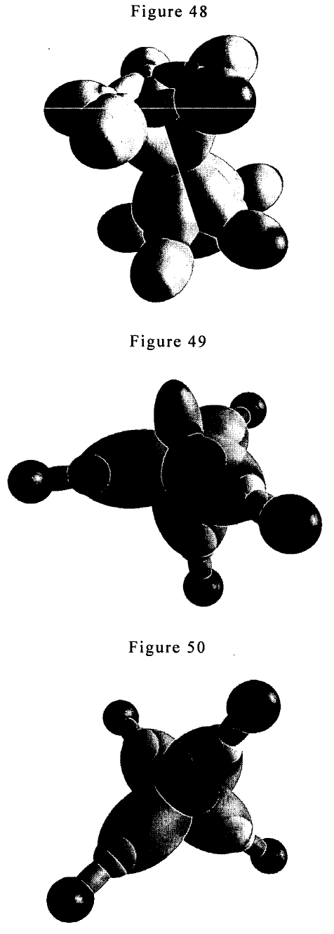

The symbols of the functional groups of manganese coordinate compounds are given in Table 23.30. The geometrical (Eqs. (15.1-15.5) and (23.41)), intercept (Eqs. (15.31-15.32) and (15.80-15.87)), and energy (Eqs. (15.61) and (23.28-23.33)) parameters of manganese coordinate compounds are given in Tables 23.31, 23.32 (as shown in the priority document), and 23.33, respectively. The total energy of each manganese coordinate compounds given in Table 23.34 (as shown in the priority document) was calculated as the sum over the integer multiple of each E_{D} (Group) of Table 23.33 corresponding to functional-group composition of the compound. The charge-densities of exemplary manganese carbonyl compound, dimanganese decacarbonyl (Mn₂ (CO)₁₀) comprising the concentric shells of atoms with the outer shell bridged by one or more H₂-type ellipsoidal MOs or joined with one or more hydrogen MOs is shown in FIG. 46.

TABLE 23.30
The symbols of the functional groups of manganese
coordinate compounds.

| Functional Group | Group Symbol |
|---|---|
| MnF group of MnF | Mn—F |
| MnCl group of MnCl | Mn—Cl |
| MnCO group of Mn₂(CO)₁₀ | Mn—CO |
| MnMn group of Mn₂(CO)₁₀ | Mn—Mn |
| C═0 | C═0 |

TABLE 23.31
The geometrical bond parameters of manganese
coordinate compounds and experimental values.

| | Mn—F | Mn—Cl | Mn—CO | Mn—Mn | C═O |
|---|---|---|---|---|---|
| Parameter | Group | Group | Group | Group | Group |
| nₑ | 2 | 3 | | 5 | |
| L | $2 + 4 \sqrt{\frac{3}{4}}$ | $4 + 6 \sqrt{\frac{3}{4}}$ | | $3 \sqrt{\frac{3}{4}}$ | |
| a (a₀) | 2.21856 | 2.86785 | 2.23676 | 3.60392 | 1.184842 |
| c′ (a₀) | 1.64864 | 2.04780 | 1.72695 | 2.73426 | 1.08850 |
| Bond Length | 1.74484 | 2.16729 | 1.82772 | 2.89382 | 1.15202 |
| 2c′ (Å) | | | | | |
| Exp. Bond | 1.729 [45] | 2.202 [15] | 1.830 [46] | 2.923 [46] | 1.151 [29, 46] |
| Length | (MnF₂) | (MnCl₂) | (Mn₂(CO)₁₀) | (Mn₂(CO)₁₀) | (Mn₂(CO)₁₀) |
| (Å) | | | | | |
| b, c (a₀) | 1.48459 | 2.00775 | 1.42153 | 2.34778 | 0.46798 |
| e | 0.74311 | 0.71405 | 0.77208 | 0.75869 | 0.91869 |

TABLE 23.33
The energy parameters (eV) of functional groups of
manganese coordinate compounds.

| | Mn—F | Mn—Cl | Mn—CO | Mn—Mn | C═O |
|---|---|---|---|---|---|
| Parameters | Group | Group | Group | Group | Group |
| f₁ | 1 | 1 | 1 | 1 | 1 |
| n₁ | 1 | 1 | 1 | 1 | 2 |
| n₂ | 0 | 0 | 0 | 0 | 0 |
| n₃ | 0 | 0 | 0 | 0 | 0 |
| C₁ | 0.5 | 0.375 | 0.375 | 0.25 | 0.5 |
| C₂ | 0.81625 | 0.91184 | 1 | 0.96411 | 1 |
| c₁ | 1 | 1 | 1 | 1 | 1 |
| c₂ | 1 | 1 | 0.88495 | 1 | 0.85395 |
| c₃ | 0 | 0 | 0 | 0 | 2 |
| c₄ | 1 | 1 | 2 | 2 | 4 |
| c₅ | 1 | 1 | 0 | 0 | 0 |
| C₁ₒ | 0.5 | 0.375 | 0.375 | 0.25 | 0.5 |
| C₂ₒ | 0.81625 | 0.91184 | 1 | 0.96411 | 1 |
| Vₑ (eV) | −31.60440 | −23.79675 | −28.59791 | −19.76726 | −134.96850 |
| Vₚ (eV) | 8.25276 | 6.64412 | 7.87853 | 4.97605 | 24.99908 |
| T (eV) | 7.12272 | 4.14889 | 6.39271 | 2.74246 | 56.95634 |
| Vₘ (eV) | −3.56136 | −2.07445 | −3.19636 | −1.37123 | −28.47817 |
| E(AO/HO) (eV) | −14.22133 | −14.22133 | −14.11232 | −14.11232 | 0 |
| ΔE_{H}_{₂}_{MO}(AO/HO) (eV) | 0 | 0 | 0 | 0 | −18.22046 |
| E_{T}(AO/HO) (eV) | −14.22133 | −14.22133 | −14.11232 | −14.11232 | 18.22046 |
| E_{T}(H₂MO) (eV) | −34.01162 | −29.29952 | −31.63535 | −27.53231 | −63.27080 |
| E_{T}(atom-atom,msp³.AO) (eV) | −1.54812 | −1.54812 | −1.44915 | −1.54005 | −3.58557 |
| E_{T}(MO) (eV) | −35.55974 | −30.84764 | −33.08452 | −29.07235 | −66.85630 |
| ω (10¹⁵ rad/s) | 7.99232 | 4.97768 | 7.56783 | 2.96657 | 22.6662 |
| E_{K} (eV) | 5.26068 | 3.27640 | 4.98128 | 1.95265 | 14.91930 |
| Ē_{D} (eV) | −0.16136 | −0.11046 | −0.14608 | −0.08037 | −0.25544 |
| Ē_{Kvib} (eV) | 0.07672 | 0.04772 | 0.04749 | 0.01537 | 0.24962 |
| | [47] | [47] | [29] | [48] | [29] |
| Ē_{osc} (eV) | −0.12299 | −0.08660 | −0.12234 | −0.07268 | −0.13063 |
| E_{mag} (eV) | 0.12767 | 0.12767 | 0.14803 | 0.12767 | 0.11441 |
| E_{T}(Group) (eV) | −35.68273 | −30.93425 | −33.20686 | −29.14504 | −67.11757 |
| Eᵢₙᵢₜᵢₐₗ(c₄ AO/HO) (eV) | −14.22133 | −14.22133 | −14.63489 | −14.11232 | −14.63489 |
| Eᵢₙᵢₜᵢₐₗ(c₅ AO/HO) (eV) | −17.42282 | −12.96764 | 0 | 0 | 0 |
| E_{D}(Group) (eV) | 4.03858 | 3.74528 | 3.93708 | 0.92039 | 8.34918 |

### Iron Functional Groups and Molecules

The electron configuration of iron is [Ar]4s²3 d⁶ having the corresponding term ⁵D₄. The total energy of the state is given by the sum over the eight electrons. The sum E_{T}(Fe,3d4s) of experimental energies [1] of Fe, Fe⁺, Fe²⁺, Fe³⁺, Fe⁴⁺, Fe⁵⁺, Fe⁶⁺, and Fe⁷⁺ is

$$\begin{matrix}{E}_{T} ( Fe , 3 d 4 s ) = - ( \begin{matrix}151.06 eV + 124.98 eV + 99.1 eV + \\ 75.0 eV + 54.8 eV + 30.652 eV + \\ 16.1877 eV + 7.9024 eV\end{matrix} ) \\ = - 559.68210 eV\end{matrix} \qquad ( 23.117 )$$

By considering that the central field decreases by an integer for each successive electron of the shell, the radius r_{3d4s} of the Fe3d4s shell may be calculated from the Coulombic energy using Eq. (15.13):

$$\begin{matrix}{r}_{3 d 4 s} = {\sum }_{n = 18}^{25} \frac{( Z - n ) {e}^{2}}{8 {πɛ}_{0} ( e559 .68210 eV )} \\ = \frac{36 {e}^{2}}{8 {πɛ}_{0} ( e559 .68210 eV )} \\ = 0.87516 {a}_{0}\end{matrix} \qquad ( 23.118 )$$

where Z=26 for iron. Using Eq. (15.14), the Coulombic energy E_{Coulomb}(Fe,3d4s) of the outer electron of the Fe3d4s shell is

$$\begin{matrix}{E}_{Coulomb} ( Fe , 3 d 4 s ) = \frac{- {e}^{2}}{8 {πɛ}_{0} {r}_{3 d 4 s}} \\ = \frac{- {e}^{2}}{8 {πɛ}_{0} 0.87516 {a}_{0}} \\ = - 15.546725 eV\end{matrix} \qquad ( 23.119 )$$

During hybridization, the spin-paired 4s electrons and the one set of paired 3d electrons are promoted to Fe3d4s shell as initially unpaired electrons. The energies for the promotions are given by Eq. (15.15) at the initial radii of the 4s and 3d electrons. From Eq. (10.102) with Z=26 and n=26, the radius r₂₆ of Fe4s shell is

r₂₆=1.72173a₀ (23.120)

and with Z=26 and n=24, the radius r₂₄ of Fe3d shell is

r₂₄=1.33164a₀ (23.121)

Using Eqs. (15.15), (23.120), and (23.121), the unpairing energies are

$$\begin{matrix}\begin{matrix}{E}_{4 s} ( magnetic ) = \frac{2 {πμ}_{0} {e}^{2} {ℏ}^{2}}{{{m}_{e}^{2} ( {r}_{26} )}^{3}} \\ = \frac{8 {πμ}_{0} {μ}_{B}^{2}}{{( 1.72173 {a}_{0} )}^{3}} \\ = 0.02242 eV\end{matrix} & ( 23.122 ) \\ \begin{matrix}{E}_{3 d} ( magnetic ) = \frac{2 {πμ}_{0} {e}^{2} {ℏ}^{2}}{{{m}_{e}^{2} ( {r}_{24} )}^{3}} \\ = \frac{8 {πμ}_{0} {μ}_{B}^{2}}{{( 1.33164 {a}_{0} )}^{3}} \\ = 0.04845 eV\end{matrix} & ( 23.123 )\end{matrix}$$

The electrons from the 4s and 3d shells successively fill unoccupied HOs until the HO shell is filled with unpaired electrons, then the electrons pair per HO. In the case of the Fe3d4s shell having eight electrons and six orbitals, two sets of electrons are paired. Using Eqs. (15.15) and (23.118), the paring energy is given by

$$\begin{matrix}{E}_{3 d 4 s} ( magnetic ) = - \frac{2 {πμ}_{0} {e}^{2} {ℏ}^{2}}{{{m}_{e}^{2} ( {r}_{3 d 4 s} )}^{3}} \\ = - \frac{8 {πμ}_{0} {μ}_{B}^{2}}{{( 0.87516 {a}_{0} )}^{3}} \\ = 0.17069 eV\end{matrix} \qquad ( 23.124 )$$

Thus, after Eq. (23.28), the energy E(Fe,3d4s) of the outer electron of the Fe3d4s shell is given by adding the magnetic energies of unpairing the 4s (Eq. (23.122)) and 3d electrons (Eq. (23.123)) and paring of two sets of Fe3d4s electrons (Eq. (23.124)) to E_{Coulomb}(Fe,3d4s) (Eq. (23.119)):

$$\begin{matrix}E ( Fe , 3 d 4 s ) = \frac{- {e}^{2}}{8 {πɛ}_{0} {r}_{3 d 4 s}} + \frac{2 {πμ}_{0} {e}^{2} {ℏ}^{2}}{{m}_{e}^{2} {r}_{4 s}^{3}} + \\ {\sum }_{3 d pairs} \frac{2 {πμ}_{0} {e}^{2} {ℏ}^{2}}{{m}_{e}^{2} {r}_{3 d}^{3}} - {\sum }_{HO pairs} \frac{2 {πμ}_{0} {e}^{2} {ℏ}^{2}}{{m}_{e}^{2} {r}_{3 d 4 s}^{3}} \\ = - 15.546725 eV + 0.02242 eV + \\ 0.04845 eV - 2 ( 0.17069 eV ) \\ = - 15.81724 eV\end{matrix} \qquad ( 23.125 )$$

Next, consider the formation of the Fe-L-bond MO of wherein each iron atom has an Fe3d4s electron with an energy given by Eq. (23.125). The total energy of the state of each iron atom is given by the sum over the eight electrons. The sum E_{T}(Fe_{Fe-L}3d4s) of energies of Fe3d4s (Eq. (23.125)), Fe⁺, Fe²⁺, Fe³⁺, Fe⁴⁺, Fe⁵⁺, Fe⁶⁺, and Fe⁷⁺ is

$$\begin{matrix}{E}_{T} ( {Fe}_{Fe—L} 3 d 4 s ) = - ( \begin{matrix}151.06 eV + 124.98 eV + \\ 99.1 eV + 75.0 eV + 54.8 eV + \\ 30.652 eV + 16.1877 eV + \\ E ( Fe , 3 d 4 s )\end{matrix} ) \\ = - ( \begin{matrix}151.06 eV + 124.98 eV + \\ 99.1 eV + 75.0 eV + 54.8 eV + \\ 30.652 eV + 16.1877 eV + \\ 15.81724 eV\end{matrix} ) \\ = - 567.59694 eV\end{matrix} \qquad ( 23.126 )$$

where E(Fe, 3d 4s) is the sum of the energy of Fe, −7.9024 eV, and the hybridization energy.

The iron HO donates an electron to each MO. Using Eq. (23.30), the radius r_{3d4s} of the Fe3d4s shell calculated from the Coulombic energy is

$$\begin{matrix}{r}_{Fe—L 3 d 4 s} = ( {\sum }_{n = 18}^{25} ( Z - n ) - 1 ) \frac{{e}^{2}}{8 {πɛ}_{0} ( e567 .59694 eV )} \\ = \frac{35 {e}^{2}}{8 {πɛ}_{0} ( e567 .59694 eV )} = 0.83898 {a}_{0}\end{matrix} \qquad ( 23.127 )$$

Using Eqs. (15.19) and (23.127), the Coulombic energy E_{Coulomb}(Fe_{Fe-L},3d4s) of the outer electron of the Fe3d4s shell is

$$\begin{matrix}{E}_{Coulomb} ( {Fe}_{Fe—L} , 3 d 4 s ) = \frac{- {e}^{2}}{8 {πɛ}_{0} {r}_{Fe—L 3 d 4 s}} \\ = \frac{- {e}^{2}}{8 {πɛ}_{0} 0.83898 {a}_{0}} \\ = - 16.21706 eV\end{matrix} \qquad ( 23.128 )$$

The magnetic energy terms are those for unpairing of the 4s and 3d electrons (Eqs. (23.122) and (23.123), respectively) and paring two sets of Fe3d4s electrons (Eq. (23.124)). Using Eqs. (23.32), (23.128) and (23.122-23.124), the energy E(Fe_{Fe-L},3d4s) of the outer electron of the Fe3d4s shell is

$$\begin{matrix}E ( {Fe}_{Fe—L} , 3 d 4 s ) = \frac{- {e}^{2}}{8 {πɛ}_{0} {r}_{Fe—L 3 d 4 s}} + \frac{2 {πμ}_{0} {e}^{2} {ℏ}^{2}}{{{m}_{e}^{2} ( {r}_{26} )}^{3}} + \\ \frac{2 {πμ}_{0} {e}^{2} {ℏ}^{2}}{{{m}_{e}^{2} ( {r}_{24} )}^{3}} + \frac{2 {πμ}_{0} {e}^{2} {ℏ}^{2}}{{{m}_{e}^{2} ( {r}_{3 d 4 s} )}^{3}} \\ = - 16.21706 eV + 0.02242 eV + \\ 0.04845 eV - 2 ( 0.17069 eV ) \\ = - 16.48757 eV\end{matrix} \qquad ( 23.129 )$$

Thus, E_{T}(Fe-L,3d4s), the energy change of each Fe3d4s shell with the formation of the Fe-L-bond MO is given by the difference between Eq. (23.129) and Eq. (23.125):

$$\begin{matrix}{E}_{T} ( Fe —L , 3 d 4 s ) = E ( {Fe}_{Fe—L} , 3 d 4 s ) - E ( Fe , 3 d 4 s ) \\ = - 16.48757 eV - ( - 15.81724 eV ) \\ = - 0.67033 eV\end{matrix} \qquad ( 23.130 )$$

The semimajor axis a solution given by Eq. (23.41) of the force balance equation, Eq. (23.39), for the σ-MO of the Fe-L-bond MO of FeLₙ is given in Table 23.36 (as shown in the priority document) with the force-equation parameters Z=26, nₑ, and L corresponding to the orbital and spin angular momentum terms of the 3d4s HO shell. The semimajor axis a of carbonyl and organometallic compounds are solved using Eq. (15.51).

For the Fe-L functional groups, hybridization of the 4s and 3d AOs of Fe to form a single 3d4s shell forms an energy minimum, and the sharing of electrons between the Fe3d4s HO and L AO to form σ MO permits each participating orbital to decrease in radius and energy. The F AO has an energy of E(F)=−17.42282 eV, the Cl AO has an energy of E(Cl)=−12.96764 eV, the C_{aryl}2sp³ HO has an energy of E(C_{aryl}2sp³)=−15.76868 eV (Eq. (14.246)), the C2sp³ HO has an energy of E(C,2sp³)=−14.63489 eV (Eq. (15.25)), the O AO has an energy of E(O)=−13.61805 eV, the Coulomb energy of Fe3d4s HO is E_{Coulomb}(Fe,3d4s)=−15.546725 eV (Eq. (23.119)), and the Fe3d4s HO has an energy of E(Fe,3d4s)=−15.81724 eV (Eq. (23.125)). To meet the equipotential condition of the union of the Fe-L H₂-type-ellipsoidal-MO with these orbitals, the hybridization factor(s), at least one of c₂ and C₂ of Eq. (15.61) for the Fe-L-bond MO given by Eq. (15.77) is

$$\begin{matrix}\begin{matrix} {c}_{2} ( F AO to Fe 3 d 4 sHO ) = {C}_{2} ( F AO to Fe 3 d 4 sHO ) \\ = \frac{E ( Fe , 3 d 4 s )}{E ( F AO )} \\ = \frac{- 15.81724 eV}{- 17.42282 eV} \\ = 0.90785\end{matrix} & ( 23.131 ) \\ \begin{matrix}{c}_{2} ( Cl AO to Fe 3 d 4 s HO ) = {C}_{2} ( Cl AO to Fe 3 d 4 s HO ) \\ = \frac{E ( Cl AO )}{E ( Fe , 3 d 4 s )} \\ = \frac{- 12.96764 eV}{- 15.81724 eV} \\ = 0.81984\end{matrix} & ( 23.132 ) \\ \begin{matrix}{c}_{2} ( C 2 {sp}^{3} HO to Fe 3 d 4 s HO ) = \frac{E ( C , 2 {sp}^{3} )}{{E}_{Coulomb} ( Fe , 3 d 4 s )} \\ {c}_{2} ( C 2 {sp}^{3} HO ) \\ = \frac{- 14.63489 eV}{- 15.54673 eV} ( 0.91771 ) \\ = 0.86389\end{matrix} & ( 23.133 ) \\ \begin{matrix}{c}_{2} ( {C}_{aryl} 2 {sp}^{3} HO to Fe 3 d 4 sHO ) = {C}_{2} ( \begin{matrix}{C}_{aryl} 2 {sp}^{3} HO to \\ Fe 3 d 4 s HO\end{matrix} ) \\ = \frac{E ( C , 2 {sp}^{3} )}{{E}_{Coulomb} ( Fe , 3 d 4 s )} \\ {c}_{2} ( {C}_{aryl} 2 {sp}^{3} HO ) \\ = \frac{- 14.63489 eV}{- 15.54673 eV} \\ ( 0.85252 ) \\ = 0.80252\end{matrix} & ( 23.134 ) \\ \begin{matrix} {c}_{2} ( O to Fe 3 d 4 s HO ) = {C}_{2} ( O to Fe 3 d 4 s HO ) \\ = \frac{E ( O )}{E ( Fe , 3 d 4 s )} \\ = \frac{- 13.61805 eV}{- 15.81724 eV} \\ = 0.86096\end{matrix} & ( 23.135 )\end{matrix}$$

where Eqs. (15.76), (15.79), and (13.430) were used in Eq. (23.133) and Eqs. (15.76), (15.79), and (14.417) were used in Eq. (23.134). Since the energy of the MO is matched to that of the Fe3d4s HO in coordinate compounds, E(AO/HO) in Eq. (15.61) is E(Fe,3d4s) given by Eq. (23.125) and E(AO/HO) in Eq. (15.61) of carbonyl and organometallic compounds is E_{Coulomb}(Fe,3d4s) given by Eq. (23.119). E_{T}(atom−atom,msp³.AO) of the Fe-L-bond MO is determined by considering that the bond involves an electron transfer from the iron atom to the ligand atom to form partial ionic character in the bond as in the case of the zwitterions such as H₂B⁺—F⁻ given in the Halido Boranes section. For the coordinate compounds, E_{T}(atom−atom,msp³.AO) is −1.34066 eV, two times the energy of Eq. (23.130). For the Fe—C bonds of carbonyl and organometallic compounds, E_{T}(atom−atom,msp³.AO) is −1.44915 eV (Eq. (14.151)), and the C═O functional group of carbonyls is equivalent to that of vanadium carbonyls. The aromatic cyclopentadienyl moieties of organometallic Fe(C₅H₅)₂ comprise

$$C {=}^{3 e} C$$

and CH functional groups that are equivalent to those given in the Aromatic and Heterocyclic Compounds section.

The symbols of the functional groups of iron coordinate compounds are given in Table 23.35. The geometrical (Eqs. (15.1-15.5) and (23.41)), intercept (Eqs. (15.31-15.32) and (15.80-15.87)), and energy (Eqs. (15.61) and (23.28-23.33)) parameters of iron coordinate compounds are given in Tables 23.36, 23.37, and 23.38, respectively (all as shown in the priority document). The total energy of each iron coordinate compounds given in Table 23.39 (as shown in the priority document) was calculated as the sum over the integer multiple of each E_{D} (Group) of Table 23.38 (as shown in the priority document) corresponding to functional-group composition of the compound. The charge-densities of exemplary iron carbonyl and organometallic compounds, iron pentacarbonyl (Fe (CO)₅) and bis-cylopentadienyl iron or ferrocene (Fe (C₅H₅)₂) comprising the concentric shells of atoms with the outer shell bridged by one or more H₂-type ellipsoidal MOs or joined with one or more hydrogen MOs are shown in FIG. 47 as 48, respectively.

TABLE 23.35
The symbols of the functional groups of iron coordinate compounds.

| Functional Group | Group Symbol |
|---|---|
| FeF group of FeF | Fe—F (a) |
| FeF₂ group of FeF₂ | Fe—F (b) |
| FeF₃ group of FeF₃ | Fe—F (c) |
| FeCl group of FeCl | Fe—Cl (a) |
| FeCl₂ group of FeCl₂ | Fe—Cl (b) |
| FeCl₃ group of FeCl₃ | Fe—Cl (c) |
| FeO group of FeO | Fe—O |
| FeCO group of Fe(CO)₅ | Fe—CO |
| C═O | C═O |
| FeC_{aryl} group of Fe(C₅H₅)₂ | Fe—C₅H₅ |
| CC (aromatic bond) | C^{3e}═C |
| CH (aromatic) | CH |

### Cobalt Functional Groups and Molecules

The electron configuration of cobalt is [Ar]4s²3d⁷ having the corresponding term ⁴F_{9/2}. The total energy of the state is given by the sum over the nine electrons. The sum E_{T}(Co,3d 4s) of experimental energies [1] of Co, Co⁺, Co²⁺, Co³⁺, Co⁴⁺, Co⁵⁺, Co⁶⁺, Co⁷⁺, and Co⁸⁺ is

$$\begin{matrix}{E}_{T} ( Co , 3 d 4 s ) = - ( \begin{matrix}186.13 eV + 157.8 eV + 128.9 eV + \\ 102.0 eV + 79.5 eV + 51.3 eV + \\ 33.50 eV + 17.084 eV + \\ 7.88101 eV\end{matrix} ) \\ = - 764.09501 eV\end{matrix} \qquad ( 23.136 )$$

By considering that the central field decreases by an integer for each successive electron of the shell, the radius r_{3d4s} of the Co3d4s shell may be calculated from the Coulombic energy using Eq. (15.13):

$$\begin{matrix}{r}_{3 d 4 s} = {\sum }_{n = 18}^{26} \frac{( Z - n ) {e}^{2}}{8 {πɛ}_{0} ( e 764.09501 eV )} \\ = \frac{45 {e}^{2}}{8 {πɛ}_{0} ( e 764.09501 eV )} \\ = 0.80129 {a}_{0}\end{matrix} \qquad ( 23.137 )$$

where Z=27 for cobalt. Using Eq. (15.14), the Coulombic energy E_{Coulomb}(Co,3d4s) of the outer electron of the Co3d4s shell is

$$\begin{matrix}{E}_{Coulomb} ( Co , 3 d 4 s ) = \frac{- {e}^{2}}{8 {πɛ}_{0} {r}_{3 d 4 s}} \\ = \frac{- {e}^{2}}{8 {πɛ}_{0} 0.80129 {a}_{0}} \\ = - 16.979889 eV\end{matrix} \qquad ( 23.138 )$$

During hybridization, the spin-paired 4s electrons and the two sets of paired 3d electrons are promoted to Co3d4s shell as initially unpaired electrons. The energies for the promotions are given by Eq. (15.15) at the initial radii of the 4s and 3d electrons. From Eq. (10.102) with Z=27 and n=27, the radius r₂₇ of Co4s shell is

r₂₇=1.72640a₀ (23.139)

and with Z=27 and n=25, the radius r₂₅ of Co3d shell is

r₂₅=1.21843a₀ (23.140)

Using Eqs. (15.15), (23.139), and (23.140), the unpairing energies are

$$\begin{matrix}\begin{matrix}{E}_{4 s} ( magnetic ) = \frac{2 {πμ}_{0} {e}^{2} {ℏ}^{2}}{{{m}_{e}^{2} ( {r}_{27} )}^{3}} \\ = \frac{8 {πμ}_{0} {μ}_{B}^{2}}{{( 1.72640 {a}_{0} )}^{3}} \\ = 0.02224 eV\end{matrix} & ( 23.141 ) \\ \begin{matrix}{E}_{3 d} ( magnetic ) = \frac{2 {πμ}_{0} {e}^{2} {ℏ}^{2}}{{{m}_{e}^{2} ( {r}_{25} )}^{3}} \\ = \frac{8 {πμ}_{0} {μ}_{B}^{2}}{{( 1.21843 {a}_{0} )}^{3}} \\ = 0.06325 eV\end{matrix} & ( 23.142 )\end{matrix}$$

The electrons from the 4s and 3d shells successively fill unoccupied HOs until the HO shell is filled with unpaired electrons, then the electrons pair per HO. In the case of the Co3d4s shell having nine electrons and six orbitals, three sets of electrons are paired. Using Eqs. (15.15) and (23.137), the paring energy is given by

$$\begin{matrix}{E}_{3 d 4 s} ( magnetic ) = - \frac{2 {πμ}_{0} {e}^{2} {ℏ}^{2}}{{{m}_{e}^{2} ( {r}_{3 d 4 s} )}^{3}} \\ = - \frac{8 {πμ}_{0} {μ}_{B}^{2}}{{( 0.80129 {a}_{0} )}^{3}} \\ = - 0.22238 eV\end{matrix} \qquad ( 23.143 )$$

Thus, after Eq. (23.28), the energy E(Co,3d4s) of the outer electron of the Co3d4s shell is given by adding the magnetic energies of unpairing the 4s (Eq. (23.141)) and 3d electrons (Eq. (23.142)) and paring of three sets of Co3d4s electrons (Eq. (23.143)) to E_{Coulomb}(Co,3d 4s) (Eq. (23.138)):

$$\begin{matrix}E ( Co , 3 d 4 s ) = \frac{- {e}^{2}}{8 {πɛ}_{0} {r}_{3 d 4 s}} + \frac{2 {πμ}_{0} {e}^{2} {ℏ}^{2}}{{m}_{e}^{2} {r}_{4 s}^{3}} + \\ {\sum }_{3 d pairs} \frac{2 {πμ}_{0} {e}^{2} {ℏ}^{2}}{{m}_{e}^{2} {r}_{3 d}^{3}} - {\sum }_{HO pairs} \frac{2 {πμ}_{0} {e}^{2} {ℏ}^{2}}{{m}_{e}^{2} {r}_{3 d 4 s}^{3}} \\ = - 16.979889 eV + 0.02224 eV + \\ 2 ( 0.06325 eV ) - 3 ( 0.22238 eV ) \\ = - 17.49830 eV\end{matrix} \qquad ( 23.144 )$$

Next, consider the formation of the Co-L-bond MO of wherein each cobalt atom has an Co3d4s electron with an energy given by Eq. (23.144). The total energy of the state of each cobalt atom is given by the sum over the nine electrons. The sum E_{T}(CO_{Co-L}3d 4s) of energies of Co3d4s (Eq. (23.144)), Co⁺, Co²⁺, Co³⁺, Co⁴⁺, Co⁵⁺, Co⁶⁺, Co⁷⁺, and Co⁸⁺ is

$$\begin{matrix}{E}_{T} ( {Co}_{Co - L} 3 d 4 s ) = - ( \begin{matrix}186.13 eV + 157.8 eV + 128.9 eV + \\ 102.0 eV + 79.5 eV + 51.3 eV + \\ 33.50 eV + 17.084 eV + E ( Co , 3 d 4 s )\end{matrix} ) \\ = - ( \begin{matrix}186.13 eV + 157.8 eV + 128.9 eV + \\ 102.0 eV + 79.5 eV + 51.3 eV + \\ 33.50 eV + 17.084 eV + 17.49830 eV\end{matrix} ) \\ = - 773.71230 eV\end{matrix} \qquad ( 23.145 )$$

where E(Co,3d4s) is the sum of the energy of Co, −7.88101 eV, and the hybridization energy.

The cobalt HO donates an electron to each MO. Using Eq. (23.30), the radius r_{3d4s} of the Co3d4s shell calculated from the Coulombic energy is

$$\begin{matrix}{r}_{Co - L 3 d 4 s} = ( {\sum }_{n = 18}^{26} ( Z - n ) - 1 ) \\ \frac{{e}^{2}}{8 {πɛ}_{0} ( e 773.71230 eV )} \\ = \frac{44 {e}^{2}}{8 {πɛ}_{0} ( e 773.71230 eV )} \\ = 0.77374 {a}_{0}\end{matrix} \qquad ( 23.146 )$$

Using Eqs. (15.19) and (23.146), the Coulombic energy E_{Coulomb}(CO_{Co-L},3d 4s) of the outer electron of the Co3d4s shell is

$$\begin{matrix}{E}_{Coulomb} ( {Co}_{Co - L} , 3 d 4 s ) = \frac{- {e}^{2}}{8 {πɛ}_{0} {r}_{Co - L 3 d 4 s}} \\ = \frac{- {e}^{2}}{8 {πɛ}_{0} 0.77374 {a}_{0}} \\ = - 17.58437 eV\end{matrix} \qquad ( 23.147 )$$

The magnetic energy terms are those for unpairing of the 4s and 3d electrons (Eqs. (23.141) and (23.142), respectively) and paring three sets of Co3d4s electrons (Eq. (23.143)). Using Eqs. (23.32), (23.147) and (23.141-23.143), the energy E(CO_{Co-L},3d4s) of the outer electron of the Co3d4s shell is

$$\begin{matrix}E ( {Co}_{Co - L} , 3 d 4 s ) = \frac{- {e}^{2}}{8 {πɛ}_{0} {r}_{Fe - L 3 d 4 s}} + \frac{2 {πμ}_{0} {e}^{2} {ℏ}^{2}}{{{m}_{e}^{2} ( {r}_{27} )}^{3}} + \\ \frac{2 {πμ}_{0} {e}^{2} {ℏ}^{2}}{{{m}_{e}^{2} ( {r}_{25} )}^{3}} - 3 \frac{2 {πμ}_{0} {e}^{2} {ℏ}^{2}}{{{m}_{e}^{2} ( {r}_{3 d 4 s} )}^{3}} \\ = - 17.58437 eV + 0.02224 eV + \\ 2 ( 0.06325 eV ) - 3 ( 0.22238 eV ) \\ = - 18.10278 eV\end{matrix} \qquad ( 23.148 )$$

Thus, E_{T}(Co-L, 3d 4s), the energy change of each Co3d4s shell with the formation of the Co-L-bond MO is given by the difference between Eq. (23.148) and Eq. (23.144):

$$\begin{matrix}{E}_{T} ( Co - L , 3 d 4 s ) = E ( {Co}_{Co - L} , 3 d 4 s ) - E ( Co , 3 d 4 s ) \\ = - 18.10278 eV - ( - 17.49830 eV ) \\ = - 0.60448 eV\end{matrix} \qquad ( 23.149 )$$

The semimajor axis a solution given by Eq. (23.41) of the force balance equation, Eq. (23.39), for the σ-MO of the Co-L-bond MO of CoLₙ is given in Table 23.41 (as shown in the priority document) with the force-equation parameters Z=27, nₑ and L corresponding to the orbital and spin angular momentum terms of the 3d4s HO shell. The semimajor axis a of carbonyl and organometallic compounds are solved using Eq. (15.51).

For the Co-L functional groups, hybridization of the 4s and 3d AOs of Co to form a single 3d4s shell forms an energy minimum, and the sharing of electrons between the Co3d4s HO and L AO to form σ MO permits each participating orbital to decrease in radius and energy. The F AO has an energy of E(F)=−17.42282 eV, the Cl AO has an energy of E(Cl)=−12.96764 eV, the C2sp³ HO has an energy of E(C,2sp³)=−14.63489 eV (Eq. (15.25)), the Coulomb energy of Co3d4s HO is E_{Coulomb}(CO₃3d 4s)=−16.979889 eV (Eq. (23.138)), 13.605804 eV is the magnitude of the Coulombic energy between the electron and proton of H (Eq. (1.243)), and the Co3d4s HO has an energy of E(Co,3d4s)=−17.49830 eV (Eq. (23.144)). To meet the equipotential condition of the union of the Co-L H₂-type-ellipsoidal-MO with these orbitals, the hybridization factor(s), at least one of c₂ and C₂ of Eq. (15.61) for the Co-L-bond MO given by Eq. (15.77) is

$$\begin{matrix}\begin{matrix}{c}_{2} ( FAO to Co 3d 4 s HO ) = \frac{E ( FAO )}{E ( Co , 3 d 4 s )} \\ = \frac{- 17.42282 eV}{- 17.49830 eV} \\ = 0.99569\end{matrix} & ( 23.150 ) \\ \begin{matrix}{C}_{2} ( ClAO to Co 3 d 4 s HO ) = \frac{E ( ClAO )}{E ( Co , 3 d 4 s )} \\ = \frac{- 12.96764 eV}{- 17.49830 eV} \\ = 0.74108\end{matrix} & ( 23.151 ) \\ \begin{matrix}{c}_{2} ( C 2 {sp}^{3} HO to Co3 d 4 s HO ) = \frac{E ( C , 2 {sp}^{3} )}{{E}_{Coulomb} ( Co , 3 d 4 s )} \\ {c}_{2} ( C 2 {sp}^{3} HO ) \\ = \frac{- 14.63489 eV}{- 16.97989 eV} \\ ( 0.91771 ) \\ = 0.79097\end{matrix} & ( 23.152 ) \\ \begin{matrix}{c}_{2} ( HAO to Co 3 d 4 s HO ) = {C}_{2} ( HAO to Co 3 d 4 s HO ) \\ = \frac{E ( H )}{{E}_{Coulomb} ( Co , 3 d 4 s )} \\ = \frac{- 13.605804 eV}{- 16.97989 eV} \\ = 0.80129\end{matrix} & ( 23.153 )\end{matrix}$$

where Eqs. (15.76), (15.79), and (13.430) were used in Eq. (23.152) and Eq. (15.71) was used in Eq. (23.153). Since the energy of the MO is matched to that of the Co3d4s HO in coordinate compounds, E(AO/HO) in Eq. (15.61) is E(Co,3d4s) given by Eq. (23.144) and E(AO/HO) in Eq. (15.61) of carbonyl compounds is E_{Coulomb}(Co,3d 4s) given by Eq. (23.138). E_{T}(atom−atom,msp³.AO) of the Co-L-bond MO is determined by considering that the bond involves an electron transfer from the cobalt atom to the ligand atom to form partial ionic character in the bond as in the case of the zwitterions such as H₂B⁺—F⁻ given in the Halido Boranes section. For the coordinate compounds, E_{T}(atom−atom,msp³.AO) is −1.20896 eV, two times the energy of Eq. (23.149). For the Co—C bonds of carbonyl compounds, E_{T}(atom−atom,msp³.AO) is −1.13379 eV (Eq. (14.247)), and the C═O functional group of carbonyls is equivalent to that of vanadium carbonyls.

The symbols of the functional groups of cobalt coordinate compounds are given in Table 23.40. The geometrical (Eqs. (15.1-15.5) and (23.41)), intercept (Eqs. (15.31-15.32) and (15.80-15.87)), and energy (Eqs. (15.61) and (23.28-23.33)) parameters of cobalt coordinate compounds are given in Tables 23.41, 23.42, and 23.43, respectively (all as shown in the priority document). The total energy of each cobalt coordinate compounds given in Table 23.44 (as shown in the priority document) was calculated as the sum over the integer multiple of each E_{D} (Group) of Table 23.43 (as shown in the priority document) corresponding to functional-group composition of the compound. The charge-densities of exemplary cobalt carbonyl compound, cobalt tetracarbonyl hydride (CoH(CO)₄ comprising the concentric shells of atoms with the outer shell bridged by one or more H₂-type ellipsoidal MOs or joined with one or more hydrogen MOs is shown in FIG. 49.

TABLE 23.40
The symbols of the functional groups of cobalt coordinate compounds.

| Functional Group | Group Symbol |
|---|---|
| CoF₂ group of CoF₂ | Co—F |
| CoCl group of CoCl | Co—Cl (a) |
| CoCl₂ group of CoCl₂ | Co—Cl (b) |
| CoCl₃ group of CoCl₃ | Co—Cl (c) |
| CoH group of CoH(CO)₄ | Co—H |
| CoCO group of CoH(CO)₄ | Co—CO |
| C═O | C═O |

### Nickel Functional Groups and Molecules

The electron configuration of nickel is [Ar]4s²3d⁸ having the corresponding term ³F₄. The total energy of the state is given by the sum over the ten electrons. The sum E_{T}(Ni,3d4s) of experimental energies [1] of Ni, Ni⁺, Ni²⁺, Ni³⁺, Ni⁴⁺, Ni⁵⁺, Ni⁶⁺, Ni⁷⁺, Ni⁸⁺, and Ni⁹⁺ is

$$\begin{matrix}{E}_{T} ( Ni , 3 d 4 s ) = - ( \begin{matrix}224.6 eV + 193 eV + 162 eV + \\ 133 eV + 108 eV + 76.06 eV + \\ 54.9 eV + 35.19 eV + 18.16884 eV + \\ 7.6398 eV\end{matrix} ) \\ = - 1012.55864 eV\end{matrix} \qquad ( 23.154 )$$

By considering that the central field decreases by an integer for each successive electron of the shell, the radius r_{3d4s} of the Ni3d4s shell may be calculated from the Coulombic energy using Eq. (15.13):

$$\begin{matrix}{r}_{3 d 4 s} = {\sum }_{n = 18}^{27} \frac{( Z - n ) {e}^{2}}{8 {πɛ}_{0} ( e 1012.55864 eV )} \\ = \frac{55 {e}^{2}}{8 {πɛ}_{0} ( e 1012.55864 eV )} \\ = 0.73904 {a}_{0}\end{matrix} \qquad ( 23.155 )$$

where Z=28 for nickel. Using Eq. (15.14), the Coulombic energy E_{Coulomb} (Ni,3d4s) of the outer electron of the Ni3d4s shell is

$$\begin{matrix}{E}_{Coulomb} ( Ni , 3 d 4 s ) = \frac{- {e}^{2}}{8 {πɛ}_{0} {r}_{3 d 4 s}} \\ = \frac{- {e}^{2}}{8 {πɛ}_{0} 0.73904 {a}_{0}} \\ = - 18.410157 eV\end{matrix} \qquad ( 23.156 )$$

During hybridization, the spin-paired 4s electrons and the three sets of paired 3d electrons are promoted to Ni3d4s shell as initially unpaired electrons. The energies for the promotions are given by Eq. (15.15) at the initial radii of the 4s and 3d electrons. From Eq. (10.102) with Z=28 and n=28, the radius r₂₈ of Ni4s shell is

r₂₈=1.78091a₀ (23.157)

and with Z=28 and n=26, the radius r₂₆ of Ni3d shell is

r₂₆=1.15992a₀ (23.158)

Using Eqs. (15.15), (23.157), and (23.158), the unpairing energies are

$$\begin{matrix}\begin{matrix}{E}_{4 s} ( magnetic ) = \frac{2 {πμ}_{0} {e}^{2} {ℏ}^{2}}{{{m}_{e}^{2} ( {r}_{28} )}^{3}} \\ = \frac{8 {πμ}_{0} {μ}_{B}^{2}}{{( 1.78091 {a}_{0} )}^{3}} \\ = 0.02026 eV\end{matrix} & ( 23.159 ) \\ \begin{matrix}{E}_{3 d} ( magnetic ) = \frac{2 {πμ}_{0} {e}^{2} {ℏ}^{2}}{{{m}_{e}^{2} ( {r}_{26} )}^{3}} \\ = \frac{8 {πμ}_{0} {μ}_{B}^{2}}{{( 1.15992 {a}_{0} )}^{3}} \\ = 0.07331 eV\end{matrix} & ( 23.160 )\end{matrix}$$

The electrons from the 4s and 3d shells successively fill unoccupied HOs until the HO shell is filled with unpaired electrons, then the electrons pair per HO. In the case of the Ni3d4s shell having ten electrons and six orbitals, four sets of electrons are paired. Using Eqs. (15.15) and (23.155), the paring energy is given by

$$\begin{matrix}{E}_{3 d4s} ( magnetic ) = - \frac{2 {πμ}_{0} {e}^{2} {ℏ}^{2}}{{{m}_{e}^{2} ( {r}_{3 d 4 s} )}^{3}} \\ = - \frac{8 {πμ}_{0} {μ}_{B}^{2}}{{( 0.73904 {a}_{0} )}^{3}} \\ = - 0.28344 eV\end{matrix} \qquad ( 23.161 )$$

Thus, after Eq. (23.28), the energy E(Ni,3d4s) of the outer electron of the Ni3d4s shell is given by adding the magnetic energies of unpairing the 4s (Eq. (23.159)) and 3d electrons (Eq. (23.160)) and paring of four sets of Ni3d4s electrons (Eq. (23.161)) to E_{Coulomb}(Ni,3d 4s) (Eq. (23.156)):

$$\begin{matrix}E ( Ni , 3 d 4 s ) = \frac{- {e}^{2}}{8 {πɛ}_{0} {r}_{3 d 4 s}} + \frac{2 {πμ}_{0} {e}^{2} {ℏ}^{2}}{{m}_{e}^{2} {r}_{4 s}^{3}} + \\ {\sum }_{3 d pairs} \frac{2 {πμ}_{0} {e}^{2} {ℏ}^{2}}{{m}_{e}^{2} {r}_{3 d}^{3}} - {\sum }_{HO pairs} \frac{2 {πμ}_{0} {e}^{2} {ℏ}^{2}}{{m}_{e}^{2} {r}_{3 d 4 s}^{3}} \\ = - 18.410157 eV + 0.02026 eV + \\ 3 ( 0.07331 eV ) - 4 ( 0.28344 eV ) \\ = - 19.30374 eV\end{matrix} \qquad ( 23.162 )$$

Next, consider the formation of the Ni-L-bond MO of wherein each nickel atom has an Ni3d4s electron with an energy given by Eq. (23.162). The total energy of the state of each nickel atom is given by the sum over the ten electrons. The sum E_{T} (Ni_{Ni-L}3d4s) of energies of Ni3d4s (Eq. (23.162)), Ni⁺, Ni²⁺, Ni³⁺, Ni⁴⁺, Ni⁵⁺, Ni⁶⁺, Ni⁷⁺, Ni⁸⁺, and Ni⁹⁺ is

$$\begin{matrix}{E}_{T} ( {Ni}_{Ni - L} 3 d 4 s ) = - ( \begin{matrix}224.6 eV + 193 eV + 162 eV + 133 eV + \\ 108 eV + 76.06 eV + 54.9 eV + \\ 35.19 eV + 18.16884 eV + E ( Ni , 3 d 4 s )\end{matrix} ) \\ = - ( \begin{matrix}224.6 eV + 193 eV + 162 eV + 133 eV + \\ 108 eV + 76.06 eV + 54.9 eV + \\ 35.19 eV + 18.16884 eV + 19.30374 eV\end{matrix} ) \\ = - 1024.22258 eV\end{matrix} \qquad ( 23.163 )$$

where E(Ni,3d4s) is the sum of the energy of Ni, −7.6398 eV, and the hybridization energy.

The nickel HO donates an electron to each MO. Using Eq. (23.30), the radius r_{3d4s} of the Ni3d4s shell calculated from the Coulombic energy is

$$\begin{matrix}{r}_{Ni = L 3 d 4 s} = ( {\sum }_{n = 18}^{27} ( Z - n ) - 1 ) \frac{{e}^{2}}{8 {πɛ}_{0} ( e 1024.22258 eV )} \\ = \frac{54 {e}^{2}}{8 {πɛ}_{0} ( e 1024.22258 eV )} \\ = 0.71734 {a}_{0}\end{matrix} \qquad ( 23.164 )$$

Using Eqs. (15.19) and (23.164), the Coulombic energy E_{Coulomb}(Ni_{Ni-L},3d 4s) of the outer electron of the Ni3d4s shell is

$$\begin{matrix}{E}_{Coulomb} ( {Ni}_{Ni - L} , 3 d 4 s ) = \frac{- {e}^{2}}{8 {πɛ}_{0} {r}_{Ni - L 3 d 4 s}} \\ = \frac{- {e}^{2}}{8 {πɛ}_{0} 0.71734 {a}_{0}} \\ = - 18.96708 eV\end{matrix} \qquad ( 23.165 )$$

The magnetic energy terms are those for unpairing of the 4s and 3d electrons (Eqs. (23.159) and (23.160), respectively) and paring four sets of Ni3d4s electrons (Eq. (23.161)). Using Eqs. (23.32), (23.165) and (23.159-23.161), the energy E(Ni_{Ni-L},3d4s) of the outer electron of the Ni3d4s shell is

$$\begin{matrix}E ( {Ni}_{Ni - L} , 3 d 4 s ) = \frac{- {e}^{2}}{8 {πɛ}_{0} {r}_{Ni - L 3 d 4 s}} + \frac{2 {πμ}_{0} {e}^{2} {ℏ}^{2}}{{{m}_{e}^{2} ( {r}_{28} )}^{3}} + \\ 3 \frac{2 {πμ}_{0} {e}^{2} {ℏ}^{2}}{{{m}_{e}^{2} ( {r}_{26} )}^{3}} - 4 \frac{2 {πμ}_{0} {e}^{2} {ℏ}^{2}}{{{m}_{e}^{2} ( {r}_{3 d 4 s} )}^{3}} \\ = - 18.96708 eV + 0.02026 eV + \\ 3 ( 0.07331 eV ) - 4 ( 0.28344 eV ) \\ = - 19.86066 eV\end{matrix} \qquad ( 23.166 )$$

Thus, E_{T}(Ni-L,3d4s), the energy change of each Ni3d4s shell with the formation of the Ni-L-bond MO is given by the difference between Eq. (23.166) and Eq. (23.162):

$$\begin{matrix}{E}_{T} ( Ni - L , 3 d 4 s ) = E ( {Ni}_{Ni - L} , 3 d 4 s ) - E ( Ni , 3 d 4 s ) \\ = - 19.86066 eV - ( - 19.30374 eV ) \\ = - 0.55693 eV\end{matrix} \qquad ( 23.167 )$$

The semimajor axis a solution given by Eq. (23.41) of the force balance equation, Eq. (23.39), for the σ-MO of the Ni-L-bond MO of NiLₙ, is given in Table 23.46 (as shown in the priority document) with the force-equation parameters Z=28, nₑ, and L corresponding to the orbital and spin angular momentum terms of the 3d4s HO shell. The semimajor axis a of carbonyl and organometallic compounds are solved using Eq. (15.51).

For the Ni-L functional groups, hybridization of the 4s and 3d AOs of Ni to form a single 3d4s shell forms an energy minimum, and the sharing of electrons between the Ni3d4s HO and L AO to form σ MO permits each participating orbital to decrease in radius and energy. The Cl AO has an energy of E(Cl)=−12.96764 eV, the C_{aryl},2sp³ HO has an energy of E(C_{aryl},2sp³)=−15.76868 eV (Eq. (14.246)), the C2sp³ HO has an energy of E(C,2sp³)=−14.63489 eV (Eq. (15.25)), the Coulomb energy of Ni3d4s HO is E_{Coulomb}(Ni,3d4s)=−18.41016 eV (Eq. (23.156)), and the Ni3d4s HO has an energy of E(Ni,3d4s)=−19.30374 eV (Eq. (23.162)). To meet the equipotential condition of the union of the Ni-L H₂-type-ellipsoidal-MO with these orbitals, the hybridization factor(s), at least one of c₂ and C₂ of Eq. (15.61) for the Ni-L-bond MO given by Eq. (15.77) is

$$\begin{matrix}\begin{matrix}{C}_{2} ( ClAO to Ni 3 d 4 s HO ) = \frac{E ( ClAO )}{E ( Ni , 3 d 4 s )} \\ = \frac{- 12.96764 eV}{- 19.30374 eV} \\ = 0.67177\end{matrix} & ( 23.168 ) \\ \begin{matrix}{c}_{2} ( C 2 {sp}^{3} HO to Ni 3 d 4 s HO ) = \frac{E ( C , 2 {sp}^{3} )}{{E}_{Coulomb} ( Ni , 3 d 4 s )} \\ {c}_{2} ( C 2 {sp}^{3} HO ) \\ = \frac{- 14.63489 eV}{- 18.41016 eV} ( 0.91771 ) \\ = 0.72952\end{matrix} & ( 23.169 ) \\ \begin{matrix}{C}_{2} ( {C}_{aryl} 2 {sp}^{3} HO to Ni 3 d 4 s HO ) = \frac{E ( C , 2 {sp}^{3} )}{{E}_{Coulomb} ( Ni , 3 d 4 s )} \\ {c}_{2} ( {C}_{aryl} 2 {sp}^{3} HO ) \\ = \frac{- 14.63489 eV}{- 18.41016 eV} \\ ( 0.85252 ) \\ = 0.67770\end{matrix} & ( 23.170 )\end{matrix}$$

where Eqs. (15.76), (15.79), and (13.430) were used in Eq. (23.169) and Eqs. (15.76), (15.79), and (14.417) were used in Eq. (23.170). Since the energy of the MO is matched to that of the Ni3d4s HO in coordinate compounds, E(AO/HO) in Eq. (15.61) is E(Ni,3d4s) given by Eq. (23.162) and E(AO/HO) in Eq. (15.61) of carbonyl compounds and organometallics is E_{Coulomb}(Ni,3d4s) given by Eq. (23.156). E_{T}(atom−atom,msp³.AO) of the Ni-L-bond MO is determined by considering that the bond involves an electron transfer from the nickel atom to the ligand atom to form partial ionic character in the bond as in the case of the zwitterions such as H₂B⁺—F⁻ given in the Halido Boranes section. For the coordinate compounds, E_{T}(atom−atom,msp³.AO) is −1.11386 eV, two times the energy of Eq. (23.167). For the Ni—C bonds of carbonyl compound, Ni (CO)₄ and organometallic, nickelocene, E_{T}(atom−atom,msp³.AO) is −1.85837 eV (two times Eq. (14.513)) and −0.92918 eV (Eq. (14.513)), respectively. The C═O functional group of Ni(CO)₄ is equivalent to that of vanadium carbonyls. The aromatic cyclopentadienyl moieties of organometallic Ni (C₅H₅)₂ comprise C^{3e}═C and CH functional groups that are equivalent to those given in the Aromatic and Heterocyclic Compounds section.

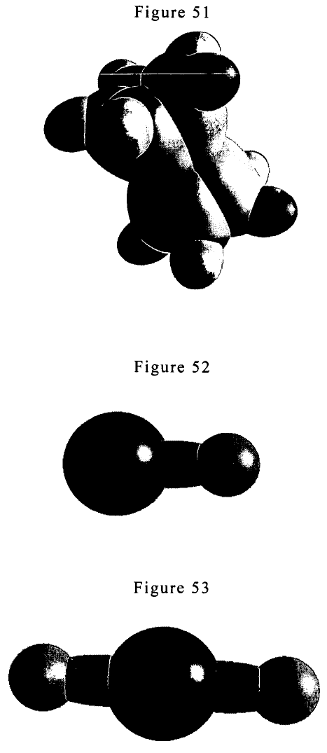

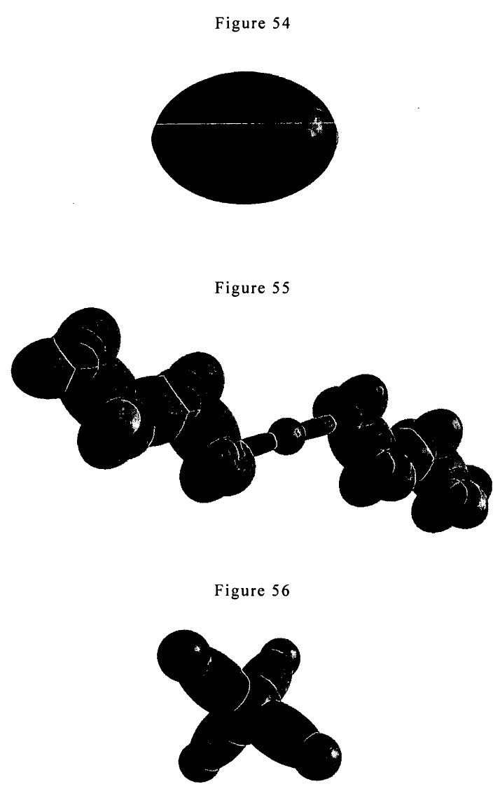

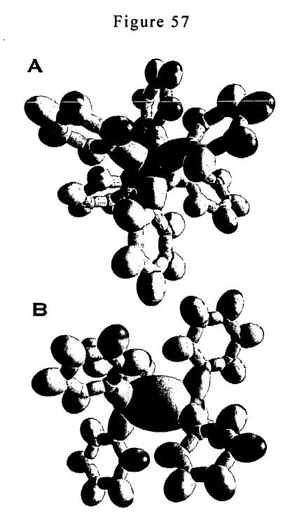

The symbols of the functional groups of nickel coordinate compounds are given in Table 23.45. The geometrical (Eqs. (15.1-15.5) and (23.41)), intercept (Eqs. (15.31-15.32) and (15.80-15.87)), and energy (Eqs. (15.61) and (23.28-23.33)) parameters of nickel coordinate compounds are given in Tables 23.46, 23.47, and 23.48, respectively (all as shown in the priority document). The total energy of each nickel coordinate compounds given in Table 23.49 was calculated as the sum over the integer multiple of each E_{D} (Group) of Table 23.48 (as shown in the priority document) corresponding to functional-group composition of the compound. The charge-densities of exemplary nickel carbonyl and organometallic compounds, nickel tetracarbonyl (Ni (CO)₄) and bis-cylopentadienyl nickel or nickelocene (Ni (C₅H₅)₂) comprising the concentric shells of atoms with the outer shell bridged by one or more H₂-type ellipsoidal MOs or joined with one or more hydrogen MOs are shown in FIGS. 50 and 51, respectively.

TABLE 23.45
The symbols of the functional groups of nickel coordinate compounds.

| Functional Group | Group Symbol |
|---|---|
| NiCl group of NiCl | Ni—Cl (a) |
| NiCl₂ group of NiCl₂ | Ni—Cl (b) |
| NiCO group of Ni(CO)₄ | Ni—CO |
| C═O | C═O |
| NiC_{aryl} group of Ni(C₅H₅)₂ | Ni—C₅H₅ |
| CC (aromatic bond) | C^{3e}═C |
| CH (aromatic) | CH |

### Copper Functional Groups and Molecules

The electron configuration of copper is [Ar]4s′3d¹⁰ having the corresponding term ²S_{1/2}. The single outer 4s [61] electron having an energy of −7.72638 eV [1] forms a single bond to give an electron configuration with filled 3d and 4s shells. Additional bonding of copper is possible involving a double bond or two single bonds by the hybridization of the 3d and 4s shells to form a Cu3d4s shell and the donation of an electron per bond. The total energy of the copper ²S_{1/2} state is given by the sum over the eleven electrons. The sum E_{T}(Cu, 3d4s) of experimental energies [1] of Cu, Cu⁺, Cu²⁺, Cu³⁺, Cu⁴⁺, Cu⁵⁺, Cu⁶⁺, Cu⁷⁺, Cu⁸⁺, Cu⁹⁺, and Cu¹⁰⁺ is

$$\begin{matrix}{E}_{T} ( Cu , 3 d 4 s ) = - ( \begin{matrix}265.3 eV + 232 eV + 199 eV + 166 eV + \\ 139 eV + 103 eV + 79.8 eV + 57.38 eV + \\ 36.841 eV + 20.2924 eV + 7.72638 eV\end{matrix} ) \\ = - 1306.33978 eV\end{matrix} \qquad ( 23.171 )$$

By considering that the central field decreases by an integer for each successive electron of the shell, the radius r_{3d4s} of the Cu3d4s shell may be calculated from the Coulombic energy using Eq. (15.13):

$$\begin{matrix}{r}_{3 d 4 s} = {\sum }_{n = 18}^{28} \frac{( Z - n ) {e}^{2}}{8 {πɛ}_{0} ( e 1306.33978 eV )} \\ = \frac{66 {e}^{2}}{8 {πɛ}_{0} ( e 1306.33978 eV )} \\ = 0.68740 {a}_{0}\end{matrix} \qquad ( 23.172 )$$

where Z=29 for copper. Using Eq. (15.14), the Coulombic energy E_{Coulomb}(Cu, 3d4s) of the outer electron of the Cu3d4s shell is

$$\begin{matrix}{E}_{Coulomb} ( Cu , 3 d 4 s ) = \frac{- {e}^{2}}{8 {πɛ}_{0} {r}_{3 d 4 s}} \\ = \frac{- {e}^{2}}{8 {πɛ}_{0} 0.68740 {a}_{0}} \\ = - 19.793027 eV\end{matrix} \qquad ( 23.173 )$$

During hybridization, the unpaired 4s electron and five sets of spin-paired 3d electrons are promoted to Cu3d4s shell as initially unpaired electrons. The energies for the promotions of the initially paired electrons are given by Eq. (15.15) at the initial radius of the 3d electrons. From Eq. (10.102) with Z=29 and n=28, the radius r₂₈ of Cu3d shell is

r₂₈=1.34098a₀ (23.174)

Using Eqs. (15.15), and (23.174), the unpairing energy is

$$\begin{matrix}{E}_{3 d} ( magnetic ) = \frac{2 {πμ}_{0} {e}^{2} {ℏ}^{2}}{{{m}_{e}^{2} ( {r}_{28} )}^{3}} \\ = \frac{8 {πμ}_{0} {μ}_{B}^{2}}{{( 1.34098 {a}_{0} )}^{3}} \\ = 0.04745 eV\end{matrix} \qquad ( 23.175 )$$

The electrons from the 4s and 3d shells successively fill unoccupied HOs until the HO shell is filled with unpaired electrons, then the electrons pair per HO. In the case of the Cu3d4s shell having eleven electrons and six orbitals, five sets of electrons are paired. Using Eqs. (15.15) and (23.172), the paring energy is given by

$$\begin{matrix}{E}_{3 d 4 s} ( magnetic ) = - \frac{2 {πμ}_{0} {e}^{2} {ℏ}^{2}}{{{m}_{e}^{2} ( {r}_{3 d 4 s} )}^{3}} \\ = - \frac{8 {πμ}_{0} {μ}_{B}^{2}}{{( 0.68740 {a}_{0} )}^{3}} \\ = - 0.35223 eV\end{matrix} \qquad ( 23.176 )$$

Thus, after Eq. (23.28), the energy E(Cu,3d4s) of the outer electron of the Cu3d4s shell is given by adding the magnetic energies of unpairing five sets of 3d electrons (Eq. (23.175)) and paring of five sets of Cu3d4s electrons (Eq. (23.176)) to E_{Coulomb}(Cu,3d4s) (Eq. (23.173)):

$$\begin{matrix}E ( Cu , 3 d 4 s ) = \frac{- {e}^{2}}{8 {πɛ}_{0} {r}_{3 d 4 s}} + \frac{2 {πμ}_{0} {e}^{2} {ℏ}^{2}}{{m}_{e}^{2} {r}_{4 s}^{3}} + \\ {\sum }_{3 d pairs} \frac{2 {πμ}_{0} {e}^{2} {ℏ}^{2}}{{m}_{e}^{2} {r}_{3 d}^{3}} - {\sum }_{HO pairs} \frac{2 {πμ}_{0} {e}^{2} {ℏ}^{2}}{{m}_{e}^{2} {r}_{3 d 4 s}^{3}} \\ = - 19.793027 eV + 0 eV + \\ 5 ( 0.04745 eV ) - 5 ( 0.35223 eV ) \\ = - 21.31697 eV\end{matrix} \qquad ( 23.177 )$$

Next, consider the formation of the Cu-L-bond MO of wherein each copper atom has an Cu3d4s electron with an energy given by Eq. (23.177). The total energy of the state of each copper atom is given by the sum over the eleven electrons. The sum E_{T}(C_{Cu-L} 3d4s) of energies of Cu3d4s (Eq. (23.177)), Cu⁺, Cu²⁺, Cu³⁺, Cu⁴⁺, Cu⁵⁺, Cu⁶⁺, Cu⁷⁺, Cu⁸⁺, Cu⁹⁺, and Cu¹⁰⁺ is

$$\begin{matrix}{E}_{T} ( {Cu}_{Cu - L} 3 d 4 s ) = - ( \begin{matrix}265.3 eV + 232 eV + 199 eV + 166 eV + \\ 139 eV + 103 eV + 79.8 eV + 57.38 eV + \\ 36.841 eV + 20.2924 eV + E ( Cu , 3 d 4 s )\end{matrix} ) \\ = - ( \begin{matrix}265.3 eV + 232 eV + 199 eV + 166 eV + \\ 139 eV + 103 eV + 79.8 eV + 57.38 eV + \\ 36.841 eV + 20.2924 eV + 21.31697 eV\end{matrix} ) \\ = - 1319.93037 eV\end{matrix} \qquad ( 23.178 )$$

where E(Cu,3d4s) is the sum of the energy of Cu, −7.72638 eV, and the hybridization energy.

The copper HO donates an electron to each MO. Using Eq. (23.30), the radius r_{3d4s} of the Cu3d4s shell calculated from the Coulombic energy is

$$\begin{matrix}{r}_{Cu - L 3 d 4 s} = ( {\sum }_{n = 18}^{28} ( Z - n ) - 1 ) \frac{{e}^{2}}{8 {πɛ}_{0} ( e 1319.93037 eV )} \\ = \frac{65 {e}^{2}}{8 {πɛ}_{0} ( e 1319.93037 eV )} \\ = 0.67002 {a}_{0}\end{matrix} \qquad ( 23.179 )$$

Using Eqs. (15.19) and (23.179), the Coulombic energy E_{Coulomb}(C_{Cu-L},3d 4s) of the outer electron of the Cu3d4s shell is

$$\begin{matrix}{E}_{Coulomb} ( {Cu}_{Cu - L} , 3 d 4 s ) = \frac{- {e}^{2}}{8 {πɛ}_{0} {r}_{Cu - L 3 d 4 s}} \\ = \frac{- {e}^{2}}{8 {πɛ}_{0} 0.67002 {a}_{0}} \\ = - 20.30662 eV\end{matrix} \qquad ( 23.180 )$$

The magnetic energy terms are those for unpairing of the five sets of 3d electrons (Eq. (23.175)) and paring of five sets of Cu3d4s electrons (Eq. (23.176)). Using Eqs. (23.32), (23.180), and (23.175-23.176), the energy E(Cu_{Cu-L},3d4s) of the outer electron of the Cu3d4s shell is

$$\begin{matrix}E ( {Cu}_{Cu - L} , 3 d 4 s ) = \frac{- {e}^{2}}{8 {πɛ}_{0} {r}_{Cu - L 3 d 4 s}} + 0 \frac{2 {πμ}_{0} {e}^{2} {ℏ}^{2}}{{{m}_{e}^{2} ( {r}_{29} )}^{3}} + \\ 5 \frac{2 {πμ}_{0} {e}^{2} {ℏ}^{2}}{{{m}_{e}^{2} ( {r}_{28} )}^{3}} - 5 \frac{2 {πμ}_{0} {e}^{2} {ℏ}^{2}}{{{m}_{e}^{2} ( {r}_{3 d 4 s} )}^{3}} \\ = - 20.30662 eV + 0 eV + \\ 5 ( 0.04745 eV ) - 5 ( 0.35223 eV ) \\ = - 21.83056 eV\end{matrix} \qquad ( 23.181 )$$

Thus, E_{T}(Cu-L,3d4s), the energy change of each Cu3d4s shell with the formation of the Cu-L-bond MO is given by the difference between Eq. (23.181) and Eq. (23.177):

$$\begin{matrix}{E}_{T} ( Cu - L , 3 d 4 s ) = E ( {Cu}_{Cu - L} , 3 d 4 s ) - E ( Cu , 3 d 4 s ) \\ = - 21.83056 eV - ( - 21.31697 eV ) \\ = - 0.51359 eV\end{matrix} \qquad ( 23.182 )$$

The semimajor axis a solution given by Eq. (23.41) of the force balance equation, Eq. (23.39), for the σ-MO of the Cu-L-bond MO of CuLₙ is given in Table 23.51 with the force-equation parameters Z=29, nₑ and L corresponding to the orbital and spin angular momentum terms of the 3d4s HO shell.

For the Cu-L functional groups, hybridization of the 4s and 3d AOs of Cu to form a single 3d4s shell forms an energy minimum, and the sharing of electrons between the Cu3d4s HO and L AO to form σ MO permits each participating orbital to decrease in radius and energy. The F AO has an energy of E(F)=−17.42282 eV, the Cl AO has an energy of E(Cl)=−12.96764 eV, the O AO has an energy of E(O)=−13.61805 eV, the Cu AO has an energy of E(Cu)=−7.72638 eV, and the Cu3d4s HO has an energy of E(Cu, 3d4s)=−21.31697 eV (Eq. (23.177)). To meet the equipotential condition of the union of the Cu-L H₂-type-ellipsoidal-MO with these orbitals, the hybridization factor(s), at least one of c₂ and C₂ of Eq. (15.61) for the Cu-L-bond MO given by Eq. (15.77) is

$$\begin{matrix}\begin{matrix}{C}_{2} ( F A O to CuAO ) = \frac{E ( CuAO )}{E ( F A O )} \\ = \frac{- 7.72638 eV}{- 17.42282 eV} \\ = 0.44346\end{matrix} & ( 23.183 ) \\ \begin{matrix}{c}_{2} ( ClAO to CuAO ) = {C}_{2} ( ClAO to CuAO ) \\ = \frac{E ( CuAO )}{E ( ClAO )} \\ = \frac{- 7.72638 eV}{- 12.96764 eV} \\ = 0.59582\end{matrix} & ( 23.184 ) \\ \begin{matrix}{C}_{2} ( F A O to Cu 3 d 4 sHO ) = \frac{E ( F A O )}{E ( Cu , 3 d 4 s )} \\ = \frac{- 17.42282 eV}{- 21.31697 eV} \\ = 0.81732\end{matrix} & ( 23.185 ) \\ \begin{matrix}{c}_{2} ( O to Cu 3 d 4 sHO ) = \frac{E ( O )}{E ( Cu , 3 d 4 s )} \\ = \frac{- 13.61805 eV}{- 21.31697 eV} \\ = 0.63884\end{matrix} & ( 23.186 )\end{matrix}$$

Since the energy of the MO is matched to that of the Cu3d 4s HO in coordinate compounds, E(AO/HO) in Eq. (15.61) is E(Cu, 3d 4s) given by Eq. (23.177) and twice this value for double bonds. E_{T}(atom−atom,msp³.AO) of the Cu-L-bond MO is determined by considering that the bond involves an electron transfer from the copper atom to the ligand atom to form partial ionic character in the bond as in the case of the zwitterions such as H₂B⁺—F⁻ given in the Halido Boranes section. For the two-bond coordinate compounds, E_{T}(atom−atom,msp³.AO) is −1.02719 eV, two times the energy of Eq. (23.182).

The symbols of the functional groups of copper coordinate compounds are given in Table 23.50. The geometrical (Eqs. (15.1-15.5) and (23.41)), intercept (Eqs. (15.31-15.32) and (15.80-15.87)), and energy (Eqs. (15.61) and (23.28-23.33)) parameters of copper coordinate compounds are given in Tables 23.51, 23.52, and 23.53 (all as shown in the priority document), respectively. The total energy of each copper coordinate compounds given in Table 23.54 was calculated as the sum over the integer multiple of each E_{D} (Group) of Table 23.53 (as shown in the priority document) corresponding to functional-group composition of the compound. The charge-densities of exemplary copper coordinate compounds, copper chloride (CuCl) and copper dichloride (CuCl₂) comprising the concentric shells of atoms with the outer shell bridged by one or more H₂-type ellipsoidal MOs or joined with one or more hydrogen MOs are shown in FIGS. 52 and 53, respectively.

TABLE 23.50
The symbols of the functional groups of copper coordinate
compounds.

| Functional Group | Group Symbol |
|---|---|
| CuF group of CuF | Cu—F (a) |
| CuF₂ group of CuF₂ | Cu—F (b) |
| CuCl group of CuCl | Cu—Cl |
| CuO group of CuO | Cu—O |

### Zinc Functional Groups and Molecules

The electron configuration of zinc is [Ar]4s²3d₁₀ having the corresponding term ¹S₀. The two outer 4s [61] electrons having energies of −9.394199 eV and −17.96439 eV [1] hybridize to form a single shell comprising two HOs. Each HO donates an electron to any single bond that participates in bonding with the HO such that two single bonds with ligands are possible to achieve a filled, spin-paired outer electron shell. Then, the total energy of the ¹S₀ state of the bonding zinc atom is given by the sum over the two electrons. The sum E_{T}(Zn,4sHO) of experimental energies [1] of Zn, and Zn⁺, is

E_{T}(Zn,4sHO)=−(17.96439 eV+9.394199 eV)=−27.35859 eV (23.187)

By considering that the central field decreases by an integer for each successive electron of the shell, the radius r_{4sHO} of the Zn4s HO shell may be calculated from the Coulombic energy using Eq. (15.13):

$$\begin{matrix}{r}_{4 sHO} = {\sum }_{n = 28}^{29} \frac{( Z - n ) {e}^{2}}{8 {πɛ}_{0} ( e27 .35859 eV )} \\ = \frac{3 {e}^{2}}{8 {πɛ}_{0} ( e27 .35859 eV )} \\ = 1.49194 {a}_{0}\end{matrix} \qquad ( 23.188 )$$

where Z=30 for zinc. Using Eq. (15.14), the Coulombic energy E_{Coulomb}(Zn,4sHO) of the outer electron of the Zn4s shell is

$$\begin{matrix}{E}_{Coulomb} ( Zn , 4 sHO ) = \frac{- {e}^{2}}{8 {πɛ}_{0} {r}_{4 sHO}} \\ = \frac{- {e}^{2}}{8 {πɛ}_{0} 1.49194 {a}_{0}} \\ = - 9.119530 eV\end{matrix} \qquad ( 23.189 )$$

During hybridization, the spin-paired 4s AO electrons are promoted to Zn4s HO shell as unpaired electrons. The energy for the promotion is given by Eq. (15.15) at the initial radius of the 4s electrons. From Eq. (10.102) with Z=30 and n=30, the radius r₃₀ of Zn4s AO shell is

r₃₀=1.44832a₀ (23.190)

Using Eqs. (15.15) and (23.190), the unpairing energy is

$$\begin{matrix}{E}_{4 s} ( magnetic ) = \frac{2 {πμ}_{0} {e}^{2} {ℏ}^{2}}{{{m}_{e}^{2} ( {r}_{30} )}^{3}} \\ = \frac{8 {πμ}_{o} {μ}_{B}^{2}}{{( 1.44832 {a}_{0} )}^{3}} \\ = 0.03766 eV\end{matrix} \qquad ( 23.191 )$$

Using Eqs. (23.189) and (23.191), the energy E(Zn, 4sHO) of the outer electron of the Zn4s HO shell is

$$\begin{matrix}E ( Zn , 4 sHO ) = \frac{- {e}^{2}}{8 {πɛ}_{0} {r}_{4 sHO}} + \frac{2 {πμ}_{0} {e}^{2} {ℏ}^{2}}{{{m}_{e}^{2} ( {r}_{30} )}^{3}} \\ = - 9.119530 eV + 0.03766 eV \\ = - 9.08187 eV\end{matrix} \qquad ( 23.192 )$$

Next, consider the formation of the Zn-L-bond MO wherein each zinc atom has a Zn4sHO electron with an energy given by Eq. (23.192). The total energy of the state of each zinc atom is given by the sum over the two electrons. The sum E_{T}(Zn_{Zn-L} 4sHO) of energies of Zn4sHO (Eq. (23.192)) and Zn⁺ is

$$\begin{matrix}{E}_{T} ( {Zn}_{Zn - L} 4 sHO ) = - ( 17.96439 eV + E ( Zn , 4 sHO ) ) \\ = - ( 17.96439 eV + 9.08187 eV ) \\ = - 27.04626 eV\end{matrix} \qquad ( 23.193 )$$

where E(Zn,4 s HO) is the sum of the energy of Zn, −9.394199 eV eV, and the hybridization energy.

The zinc HO donates an electron to each MO. Using Eq. (23.30), the radius r_{4sHO} of the Zn4sHO shell calculated from the Coulombic energy is

$$\begin{matrix}{r}_{Zn - L 4 sHO} = ( {\sum }_{n = 28}^{29} ( Z - n ) - 1 ) \frac{{e}^{2}}{8 {πɛ}_{0} ( e 27.04626 eV )} \\ = \frac{2 {e}^{2}}{8 {πɛ}_{0} ( e 27.04626 eV )} \\ = 1.00611 {a}_{0}\end{matrix} \qquad ( 23.194 )$$

Using Eqs. (15.19) and (23.194), the Coulombic energy E_{Coulomb}(Zn_{Zn-L},4sHO) of the outer electron of the Zn4sHO shell is

$$\begin{matrix}{E}_{Coulomb} ( {Zn}_{Zn - L} , 4 sHO ) = \frac{- {e}^{2}}{8 {πɛ}_{0} {r}_{Zn - L 4 sHO}} \\ = \frac{- {e}^{2}}{8 {πɛ}_{0} 1.00611 {a}_{0}} \\ = - 13.52313 eV\end{matrix} \qquad ( 23.195 )$$

During hybridization, the spin-paired 2s electrons are promoted to Zn4sHO shell as unpaired electrons. The energy for the promotion is the magnetic energy given by Eq. (23.191). Using Eqs. (23.195) and (23.191), the energy E(Zn_{Zn-L},4s HO) of the outer electron of the Zn4sHO shell is

$$\begin{matrix}E ( {Zn}_{Zn - L} 4 sHO ) = \frac{- {e}^{2}}{8 {πɛ}_{0} {r}_{Zn - L 4 sHO}} + \frac{2 {πμ}_{0} {e}^{2} {ℏ}^{2}}{{{m}_{e}^{2} ( {r}_{30} )}^{3}} \\ = - 13.52313 eV + 0.03766 eV \\ = - 13.48547 eV\end{matrix} \qquad ( 23.196 )$$

Thus, E_{T}(Zn-L, 4s HO), the energy change of each Zn4sHO shell with the formation of the Zn-L-bond MO is given by the difference between Eq. (23.196) and Eq. (23.192):

$$\begin{matrix}{E}_{T} ( Zn - L , 4 sHO ) = E ( {Zn}_{Zn - L} , 4 sHO ) - E ( Zn , 4 sHO ) \\ = - 13.48547 eV - ( - 9.08187 eV ) \\ = - 4.40360 eV\end{matrix} \qquad ( 23.197 )$$

The semimajor axis a solution given by Eq. (23.41) of the force balance equation, Eq. (23.39), for the σ-MO of the Zn-L-bond MO of ZnLₙ, is given in Table 23.56 (as shown in the priority document) with the force-equation parameters Z=30, nₑ and L corresponding to the orbital and spin angular momentum terms of the 4s HO shell. The semimajor axis a of organometallic compounds are solved using Eq. (15.51).

For the Zn-L functional groups, hybridization of the 4s AOs of Zn to form a single 4s HO shell forms an energy minimum, and the sharing of electrons between the Zn4s HO and L AO to form σ MO permits each participating orbital to decrease in radius and energy. The Cl AO has an energy of E(Cl)=−12.96764 eV, the C2sp³ HO has an energy of E(C,2sp³)=−14.63489 eV (Eq. (15.25)), the Coulomb energy of the Zn4s HO is E_{Coulomb}(Zn,4sHO)=−9.119530 eV (Eq. (23.189)), and the Zn4s HO has an energy of E(Zn, 4sHO)=−9.08187 eV (Eq. (23.192)). To meet the equipotential condition of the union of the Zn-L H₂-type-ellipsoidal-MO with these orbitals, the hybridization factor(s), at least one of c₂ and C₂ of Eq. (15.61) for the Zn-L-bond MO given by Eq. (15.77) is

$$\begin{matrix}\begin{matrix} {C}_{2} ( ClAO to Zn 4 sHO ) = \frac{E ( Zn , 34 sHO )}{E ( ClAO )} \\ = \frac{- 9.08187 eV}{- 12.96764 eV} \\ = 0.70035\end{matrix} & ( 23.198 ) \\ \begin{matrix}{c}_{2} ( C 2 {sp}^{3} HO to Zn 4 sHO ) = {C}_{2} ( C 2 {sp}^{3} HO to Zn 4 sHO ) \\ = \frac{{E}_{Coulomb} ( Zn , 4 sHO )}{E ( C , 2 {sp}^{3} )} {c}_{2} ( C 2 {sp}^{3} HO ) \\ = \frac{- 9.11953 eV}{- 14.63489 eV} ( 0.91771 ) \\ = 0.57186\end{matrix} & ( 23.199 )\end{matrix}$$

where Eqs. (15.76), (15.79), and (13.430) were used in Eq. (23.199). Since the energy of the MO is matched to that of the Zn4sHO in coordinate compounds, E(AO/HO) in Eq. (15.61) is E(Zn,4sHO) given by Eq. (23.192) and E(Zn,4s HO) for organometallics is E_{Coulomb}(Zn, 4sHO) given by Eq. (23.189). E_{T} (atom−atom,msp³.AO) of the Zn-L-bond MO is determined by considering that the bond involves an electron transfer from the zinc atom to the ligand atom to form partial ionic character in the bond as in the case of the zwitterions such as H₂B⁺—F⁻ given in the Halido Boranes section. For the coordinate compounds, E_{T}(atom−atom,msp³.AO) is −8.80720 eV, two times the energy of Eq. (23.197).

The symbols of the functional groups of zinc coordinate compounds are given in Table 23.55. The geometrical (Eqs. (15.1-15.5) and (23.41)), intercept (Eqs. (15.31-15.32) and (15.80-15.87)), and energy (Eqs. (15.61) and (23.28-23.33)) parameters of zinc coordinate compounds are given in Tables 23.56, 23.57, and 23.58 (all as shown in the priority document), respectively (all as shown in the priority document). The total energy of each zinc coordinate compounds given in Table 23.59 (as shown in the priority document) was calculated as the sum over the integer multiple of each E_{D}(Group) of Table 23.58 (as shown in the priority document) corresponding to functional-group composition of the compound. The charge-densities of exemplary zinc coordinate and organometallic compounds, zinc chloride (ZnCl) and di-n-butylzinc (Zn(C₄H₉)₂) comprising the concentric shells of atoms with the outer shell bridged by one or more H₂-type ellipsoidal MOs or joined with one or more hydrogen MOs are shown in FIG. 54 as 55, respectively.

TABLE 23.55
The symbols of the functional groups of zinc coordinate compounds.

| Functional Group | Group Symbol |
|---|---|
| ZnCl group of ZnCl | Zn—Cl (a) |
| ZnCl₂ group of ZnCl₂ | Zn—Cl (b) |
| ZnC_{alkyl} group of RZnR′ | Zn—C |
| CH₃ group | C—H (CH₃) |
| CH₂ group | C—H (CH₂) |
| CC bond (n-C) | C—C |

### Tin Functional Groups and Molecules

As in the cases of carbon and tin, the bonding in the tin atom involves four sp³ hybridized orbitals formed from the 5p and 5s electrons of the outer shells. Sn—X X=halide,oxide, Sn—H, and Sn—Sn bonds form between Sn5sp³ HOs and between a halide or oxide AO, a H1s AO, and a Sn5sp³ HO, respectively to yield tin halides and oxides, stannanes, and distannes, respectively. The geometrical parameters of each Sn—X X=halide,oxide, Sn—H, and Sn—Sn functional group is solved from the force balance equation of the electrons of the corresponding σ-MO and the relationships between the prolate spheroidal axes. Then, the sum of the energies of the H₂-type ellipsoidal MOs is matched to that of the Sn5sp³ shell as in the case of the corresponding carbon and tin molecules. As in the case of the transition metals, the energy of each functional group is determined for the effect of the electron density donation from the each participating Sn5sp³ HO and AO to the corresponding MO that maximizes the bond energy.

The branched-chain alkyl stannanes and distannes, SnₘCₙH₂₍ₘ₊ₙ₎₊₂, comprise at least a terminal methyl group (CH₃) and at least one Sn bound by a carbon-tin single bond comprising a C—Sn group, and may comprise methylene (CH₂), methylyne (CH), C—C, SnH_{n=1,2,3}, and Sn—Sn functional groups. The methyl and methylene functional groups are equivalent to those of straight-chain alkanes. Six types of C—C bonds can be identified. The n-alkane C—C bond is the same as that of straight-chain alkanes. In addition, the C—C bonds within isopropyl ((CH₃)₂ CH) and t-butyl ((CH₃)₃C) groups and the isopropyl to isopropyl, isopropyl to t-butyl, and t-butyl to t-butyl C—C bonds comprise functional groups.

The Sn electron configuration is [Kr]5s²4d¹⁰5p², and the orbital arrangement is

$$5 p state \\ \begin{matrix}\frac{↑}{1} & \frac{↑}{0} & \frac{ }{- 1}\end{matrix} \qquad ( 23.200 )$$

corresponding to the ground state ³P₀. The energy of the carbon 5p shell is the negative of the ionization energy of the tin atom [1] given by

E(Sn,5p shell)=−E(ionization;Sn)=−7.34392 eV (23.201)

The energy of tin is less than the Coulombic energy between the electron and proton of H given by Eq. (1.243), but the atomic orbital may hybridize in order to achieve a bond at an energy minimum. After Eq. (13.422), the Sn5s atomic orbital (AO) combines with the Sn5p AOs to form a single Sn5sp³ hybridized orbital (HO) with the orbital arrangement

$$5 {sp}^{3} state \\ \begin{matrix}\frac{↑}{0 , 0} & \frac{↑}{1 , - 1} & \frac{↑}{1 , 0} & \frac{↑}{1 , 1}\end{matrix} \qquad ( 23.202 )$$

where the quantum numbers (l, mₗ) are below each electron. The total energy of the state is given by the sum over the four electrons. The sum E_{T}(Sn, 4sp³) of experimental energies [1] of Sn, Sn⁺, Sn²⁺, and Sn³⁺ is

$$\begin{matrix}{E}_{T} ( Sn , 5 {sp}^{3} ) = 40.73502 eV + 30.50260 eV + \\ 14.6322 eV + 7.34392 eV \\ = 93.21374 eV\end{matrix} \qquad ( 23.203 )$$

By considering that the central field decreases by an integer for each successive electron of the shell, the radius r₅ₛₚ_{³} of the Sn5sp³ shell may be calculated from the Coulombic energy using Eq. (15.13):

$$\begin{matrix}{r}_{5 {sp}^{3}} = {\sum }_{n = 46}^{49} \frac{( Z - n ) {e}^{2}}{8 π {ɛ}_{0} ( e 93.21374 eV )} \\ = \frac{10 {e}^{2}}{8 π {ɛ}_{0} ( e 93.21374 eV )} \\ = 1.45964 {a}_{0}\end{matrix} \qquad ( 23.204 )$$

where Z=50 for tin. Using Eq. (15.14), the Coulombic energy E_{Coulomb}(Sn, 5sp³) of the outer electron of the Sn5sp³ shell is

$$\begin{matrix}{E}_{Coulomb} ( Sn , 5 {sp}^{3} ) = \frac{- {e}^{2}}{8 {πɛ}_{0} {r}_{5 {sp}^{3}}} \\ = \frac{- {e}^{2}}{8 {πɛ}_{0} 1.45964 {a}_{0}} \\ = - 9.321374 eV\end{matrix} \qquad ( 23.205 )$$

During hybridization, the spin-paired 5s electrons are promoted to Sn5sp³ shell as unpaired electrons. The energy for the promotion is the magnetic energy given by Eq. (15.15) at the initial radius of the 5s electrons. From Eq. (10.255) with Z=50, the radius r₄₈ of Sn5s shell is

r₄₈=1.33816a₀ (23.206)

Using Eqs. (15.15) and (23.206), the unpairing energy is

$$\begin{matrix}E ( magnetic ) = \frac{2 {πμ}_{0} {e}^{2} {ℏ}^{2}}{{{m}_{e}^{2} ( {r}_{48} )}^{3}} \\ = \frac{8 {πμ}_{o} {μ}_{B}^{2}}{{( 1.33816 {a}_{0} )}^{3}} \\ = 0.04775 eV\end{matrix} \qquad ( 23.207 )$$

Using Eqs. (23.203) and (23.207), the energy E(Sn,5sp³) of the outer electron of the Sn5sp3 shell is

$$\begin{matrix}E ( Sn , 5 {sp}^{3} ) = \frac{- {e}^{2}}{8 {πɛ}_{0} {r}_{5 {sp}^{3}}} + \frac{2 {πμ}_{0} {e}^{2} {ℏ}^{2}}{{{m}_{e}^{2} ( {r}_{48} )}^{3}} \\ = - 9.321374 eV + 0.04775 eV \\ = - 9.27363 eV\end{matrix} \qquad ( 23.208 )$$

Next, consider the formation of the Sn-L-bond MO of tin compounds wherein L is a ligand including tin and each tin atom has a Sn5sp³ electron with an energy given by Eq. (23.208). The total energy of the state of each tin atom is given by the sum over the four electrons. The sum E_{T}(Sn_{Sn-L},5sp³) of energies of Sn5sp³ (Eq. (23.208)), Sn⁺, Sn²⁺, and Sn³⁺ is

$$\begin{matrix}{E}_{T} ( {Sn}_{Sn - L} , 5 {sp}^{3} ) = - ( \begin{matrix}40.73502 eV + 30.50260 eV + \\ 14.6322 eV + E ( Sn , 5 {sp}^{3} )\end{matrix} ) \\ = - ( \begin{matrix}40.73502 eV + 30.50560 eV + \\ 14.6322 eV + 9.27363 eV\end{matrix} ) \\ = - 95.14345 eV\end{matrix} \qquad ( 23.209 )$$

where E(Sn,5sp³) is the sum of the energy of Sn, −7.34392 eV, and the hybridization energy.

A minimum energy is achieved while matching the potential, kinetic, and orbital energy relationships given in the Hydroxyl Radical (OH) section with the donation of electron density from the participating Sn5sp³ HO to each Sn-L-bond MO. As in the case of acetylene given in the Acetylene Molecule section, the energy of each Sn-L functional group is determined for the effect of the charge donation. For example, as in the case of the Si—Si-bond MO given in the Alkyl Silanes and Disilanes section, the sharing of electrons between two Sn5sp³ HOs to form a Sn—Sn-bond MO permits each participating orbital to decrease in size and energy. In order to further satisfy the potential, kinetic, and orbital energy relationships, each Sn5sp³ HO donates an excess of 25% of its electron density to the Sn—Sn-bond MO to form an energy minimum. By considering this electron redistribution in the distannane molecule as well as the fact that the central field decreases by an integer for each successive electron of the shell, in general terms, the radius r_{Sn-L5s}_{³}, of the Sn5sp³ shell may be calculated from the Coulombic energy using Eq. (15.18):

$$\begin{matrix}{r}_{Sn - L 5 {sp}^{3}} = ( {\sum }_{n = 46}^{49} ( Z - n ) - 0.25 ) \frac{{e}^{2}}{8 π {ɛ}_{0} ( e 95.14345 eV )} \\ = \frac{9.75 {e}^{2}}{8 {πɛ}_{0} ( e 95.14345 eV )} \\ = 1.39428 {a}_{0}\end{matrix} \qquad ( 23.210 )$$

Using Eqs. (15.19) and (23.210), the Coulombic energy E_{Coulomb}(Sn_{Sn-L},5sp³) of the outer electron of the Sn5sp³ shell is

$$\begin{matrix}{E}_{Coulomb} ( {Sn}_{Sn - L} , 5 {sp}^{3} ) = \frac{- {e}^{2}}{8 {πɛ}_{0} {r}_{Sn - L 5 {sp}^{3}}} \\ = \frac{- {e}^{2}}{8 π {ɛ}_{0} 1.39428 {a}_{0}} \\ = - 9.75830 eV\end{matrix} \qquad ( 23.211 )$$

During hybridization, the spin-paired 5s electrons are promoted to Sn5sp³ shell as unpaired electrons. The energy for the promotion is the magnetic energy given by Eq. (23.207). Using Eqs. (23.207) and (23.211), the energy E(Sn_{Sn-L},5sp³) of the outer electron of the Si3sp³ shell is

$$\begin{matrix}E ( {Sn}_{Sn - L} , 5 {sp}^{3} ) = \frac{- {e}^{2}}{8 π {ɛ}_{0} {r}_{Sn - L 5 {sp}^{3}}} + \frac{2 {πμ}_{0} {e}^{2} {ℏ}^{2}}{{{m}_{e}^{2} ( {r}_{48} )}^{3}} \\ = - 9.75830 eV + 0.04775 eV \\ = - 9.71056 eV\end{matrix} \qquad ( 23.212 )$$

Thus, E_{T}(Sn-L,5sp³), the energy change of each Sn5sp³ shell with the formation of the Sn-L-bond MO is given by the difference between Eq. (23.212) and Eq. (23.208):

E_{T}(Sn-L,5sp³)=E(Sn_{Sn-L},5sp³)−E(Sn,5sp³)=−0.43693 eV (23.213)

Next, consider the formation of the Si-L-bond MO of additional functional groups wherein each tin atom contributes a Sn5sp³ electron having the sum E_{T}(Sn_{Sn-L},5sp³) of energies of Sn5sp³ (Eq. (23.208)), Sn⁺, Sn²⁺, and Sn³⁺ given by Eq. (23.209). Each Sn-L-bond MO of each functional group Si-L forms with the sharing of electrons between a Sn5sp³ HO and a AO or HO of L, and the donation of electron density from the Sn5sp³ HO to the Sn-L-bond MO permits the participating orbitals to decrease in size and energy. In order to further satisfy the potential, kinetic, and orbital energy relationships while forming an energy minimum, the permitted values of the excess fractional charge of its electron density that the Sn5sp³ HO donates to the Si-L-bond MO given by Eq. (15.18) is (0.25); s=1,2,3,4 and linear combinations thereof. By considering this electron redistribution in the tin molecule as well as the fact that the central field decreases by an integer for each successive electron of the shell, the radius r_{Sn-L5sp}_{³} of the Sn5sp³ shell may be calculated from the Coulombic energy using Eq. (15.18):

$$\begin{matrix}{r}_{Sn - L 5 {sp}^{3}} = ( {\sum }_{n = 46}^{49} ( Z - n ) - s ( 0.25 ) ) \frac{{e}^{2}}{8 π {ɛ}_{0} ( e 95.14345 eV )} \\ = \frac{( 10 - s ( 0.25 ) ) {e}^{2}}{8 π {ɛ}_{0} ( e 95.14345 eV )}\end{matrix} \qquad ( 23.214 )$$

Using Eqs. (15.19) and (23.214), the Coulombic energy E_{Coulomb}(Sn_{Sn-L},5sp³) of the outer electron of the Sn5sp³ shell is

$$\begin{matrix}{E}_{Coulomb} ( {Sn}_{Sn - L} , 5 {sp}^{3} ) = \frac{- {e}^{2}}{8 {πɛ}_{0} {r}_{Sn - L 5 {sp}^{3}}} \\ = \frac{- {e}^{2}}{8 {πɛ}_{0} \frac{( 10 - s ( 0.25 ) ) {e}^{2}}{8 {πɛ}_{0} ( e 95.14345 eV )}} \\ = \frac{95.14345 eV}{( 10 - s ( 0.25 ) )}\end{matrix} \qquad ( 23.215 )$$

During hybridization, the spin-paired 5s electrons are promoted to Sn5sp³ shell as unpaired electrons. The energy for the promotion is the magnetic energy given by Eq. (23.207). Using Eqs. (23.207) and (23.215), the energy E(Sn_{Sn-L}, 5 sp³) of the outer electron of the Si3sp³ shell is

$$\begin{matrix}E ( {Sn}_{Sn - L} , 5 {sp}^{3} ) = \frac{- {e}^{2}}{8 {πɛ}_{0} {r}_{Sn - L 5 {sp}^{3}}} + \frac{2 {πμ}_{0} {e}^{2} {ℏ}^{2}}{{{m}_{e}^{2} ( {r}_{48} )}^{3}} \\ = \frac{95.14345 eV}{( 10 - s ( 0.25 ) )} + 0.04775 eV\end{matrix} \qquad ( 23.216 )$$

Thus, E_{T}(Sn-L,5sp³), the energy change of each Sn5sp³ shell with the formation of the Sn-L-bond MO is given by the difference between Eq. (23.216) and Eq. (23.208):

$$\begin{matrix}{E}_{T} ( Sn - L , 5 {sp}^{3} ) = E ( {Sn}_{Sn - L} , 5 {sp}^{3} ) - E ( Sn , 5 {sp}^{3} ) \\ = - \frac{95.14345}{( 10 - s ( 0.25 ) )} eV + 0.04775 eV - \\ ( - 9.27363 eV )\end{matrix} \qquad ( 23.217 )$$

Using Eq. (15.28) for the case that the energy matching and energy minimum conditions of the MOs in the tin molecule are met by a linear combination of values of s (s₁ and s₂) in Eqs. (23.214-23.217), the energy E(Sn_{Sn-L},5sp³) of the outer electron of the Si3sp³ shell is

$$E ( {Sn}_{Sn - L} , 5 {sp}^{3} ) = \frac{\begin{matrix}\frac{95.14345 eV}{( 10 - {s}_{1} ( 0.25 ) )} + \frac{95.14345 eV}{( 10 - {s}_{2} ( 0.25 ) )} + \\ 2 ( 0.04775 eV )\end{matrix}}{2} \qquad ( 23.218 )$$

Using Eqs. (15.13) and (23.218), the radius corresponding to Eq. (23.218) is:

$$\begin{matrix}{r}_{5 {sp}^{3}} = \frac{{e}^{2}}{8 π {ɛ}_{0} E ( {Sn}_{Sn - L} , 5 {sp}^{3} )} \\ = \frac{{e}^{2}}{8 π {ɛ}_{0} ( e ( \frac{\begin{matrix}\frac{95.14345 eV}{( 10 - {s}_{1} ( 0.25 ) )} + \frac{95.14345 eV}{( 10 - {s}_{2} ( 0.25 ) )} \\ 2 ( 0.04775 eV )\end{matrix} +}{2} ) )}\end{matrix} \qquad ( 23.219 )$$

E_{T}(Sn-L, 5sp³), the energy change of each Sn5sp³ shell with the formation of the Sn-L-bond MO is given by the difference between Eq. (23.219) and Eq. (23.208):

$$\begin{matrix}{E}_{T} ( Sn - L , 5 {sp}^{3} ) = E ( {Sn}_{Sn - L} , 5 {sp}^{3} ) - E ( Sn , 5 {sp}^{3} ) \\ = \frac{\begin{matrix}\frac{95.14345 eV}{( 10 - {s}_{1} ( 0.25 ) )} + \frac{95.14345 eV}{( 10 - {s}_{2} ( 0.25 ) )} + \\ 2 ( 0.04775 eV )\end{matrix}}{2} - \\ ( - 9.27363 eV )\end{matrix}$$

E_{T}(Sn-L,5sp³) is also given by Eq. (15.29). Bonding parameters for Sn-L-bond MO of tin functional groups due to charge donation from the HO to the MO are given in Table 23.60.

TABLE 23.60
The values of r_{Sn5sp}_{³}, E_{Coulomb} (Sn_{Sn-L},5sp³), and E(Sn_{Sn-L},5sp³) and the
resulting E_{T} (Sn-L,5sp³) of the MO due to charge donation from
the HO to the MO.

| MO | | | | E_{Coulomb}(Sn_{Sn-L},5sp³) | E(Sn_{Sn-L},5sp³) | |
|---|---|---|---|---|---|---|
| Bond | | | r_{Sn5sp}_{³} (a₀) | (eV) | (eV) | E_{T}(Sn-L,5sp³) |
| Type | s1 | s2 | Final | Final | Final | (eV) |
| 0 | 0 | 0 | 1.45964 | −9.321374 | −9.27363 | 0 |
| I | 1 | 0 | 1.39428 | −9.75830 | −9.71056 | −0.43693 |
| II | 2 | 0 | 1.35853 | −10.01510 | −9.96735 | −0.69373 |
| III | 3 | 0 | 1.32278 | −10.28578 | −10.23803 | −0.96440 |
| IV | 4 | 0 | 1.28703 | −10.57149 | −10.52375 | −1.25012 |
| I + II | 1 | 2 | 1.37617 | −9.88670 | −9.83895 | −0.56533 |
| II + III | 2 | 3 | 1.34042 | −10.15044 | −10.10269 | −0.82906 |

The semimajor axis a solution given by Eq. (23.41) of the force balance equation, Eq. (23.39), for the σ-MO of the Sn-L-bond MO of SnLₙ is given in Table 23.62 (as shown in the priority document) with the force-equation parameters Z=50, nₑ, and L corresponding to the orbital and spin angular momentum terms of the 4s HO shell. The semimajor axis a of organometallic compounds, stannanes and distannes, are solved using Eq. (15.51).

For the Sn-L functional groups, hybridization of the 5p and 5s AOs of Sn to form a single Sn5sp³ HO shell forms an energy minimum, and the sharing of electrons between the Sn5sp³ HO and L AO to form σ MO permits each participating orbital to decrease in radius and energy. The Cl AO has an energy of E(Cl)=−12.96764 eV, the Br AO has an energy of E(Br)=−11.8138 eV, the I AO has an energy of E(I)=−10.45126 eV, the O AO has an energy of E(O)=−13.61805 eV, the C2sp³ HO has an energy of E(C,2sp³)=−14.63489 eV (Eq. (15.25)), 13.605804 eV is the magnitude of the Coulombic energy between the electron and proton of H (Eq. (1.243)), the Coulomb energy of the Sn5sp³ HO is E_{Coulomb}(Sn,5sp³ HO=−9.32137 eV (Eq. (23.205)), and the Sn5sp³ HO has an energy of E(Sn,5s, HO)=−9.27363 eV (Eq. (23.208)). To meet the equipotential condition of the union of the Sn-L H₂-type-ellipsoidal-MO with these orbitals, the hybridization factor(s), at least one of c₂ and C₂ of Eq. (15.61) for the Sn-L-bond MO given by Eq. (15.77) is

$$\begin{matrix}\begin{matrix}{c}_{2} ( Cl A O to Sn 5 {sp}^{3} HO ) = {C}_{2} ( Cl A O to Sn 5 {sp}^{3} HO ) \\ = \frac{E ( Sn , 5 {sp}^{3} )}{E ( Cl A O )} \\ = \frac{- 9.27363 eV}{- 12.96764 eV} \\ = 0.71514\end{matrix} & ( 23.221 ) \\ \begin{matrix}{C}_{2} ( Br A O to Sn 5 {sp}^{3} HO ) = \frac{E ( Sn , 5 {sp}^{3} )}{E ( Br A O )} \\ = \frac{- 9.27363 eV}{- 11.8138 eV} \\ = 0.78498\end{matrix} & ( 23.222 ) \\ \begin{matrix}{c}_{2} ( I A O to Sn 5 {sp}^{3} HO ) = \frac{E ( Sn , Sn 5 {sp}^{3} )}{E ( I A O )} \\ = \frac{- 9.27363 eV}{- 10.45126 eV} \\ = 0.88732\end{matrix} & ( 23.223 ) \\ \begin{matrix}{c}_{2} ( O to Sn 5 {sp}^{3} HO ) = {C}_{2} ( O to Sn 5 {sp}^{3} HO ) \\ = \frac{E ( Sn , 5 {sp}^{3} )}{E ( O )} \\ = \frac{- 9.27363 eV}{- 13.61805 eV} \\ = 0.68098\end{matrix} & ( 23.224 ) \\ \begin{matrix}{c}_{2} ( H A O to Sn 5 {sp}^{3} HO ) = \frac{{E}_{Coulomb} ( Sn , 5 {sp}^{3} )}{E ( H )} \\ = \frac{- 9.32137 eV}{- 13.605804 eV} \\ = 0.68510\end{matrix} & ( 23.225 ) \\ \begin{matrix}{C}_{2} ( C 2 {sp}^{3} HO to Sn 5 {sp}^{3} HO ) = \frac{E ( Sn , 5 {sp}^{3} HO )}{E ( C , 2 {sp}^{3} )} \\ {c}_{2} ( C 2 {sp}^{3} HO ) \\ = \frac{- 9.27363 eV}{- 14.63489 eV} ( 0.91771 ) \\ = 0.58152\end{matrix} & ( 23.226 ) \\ \begin{matrix}{c}_{2} ( Sn 5 {sp}^{3} HO to Sn 5 {sp}^{3} HO ) = \frac{{E}_{Coulomb} ( Sn , 5 {sp}^{3} )}{E ( H )} \\ = \frac{- 9.32137 eV}{- 13.605804 eV} \\ = 0.68510\end{matrix} & ( 23.227 )\end{matrix}$$

where Eq. (15.71) was used in Eqs. (23.225) and (23.227) and Eqs. (15.76), (15.79), and (13.430) were used in Eq. (23.226). Since the energy of the MO is matched to that of the Sn5sp³ HO, E(AO/HO) in Eq. (15.61) is E(Sn,5sp³ HO) given by Eq. (23.208) for single bonds and twice this value for double bonds. E_{T}(atom−atom,msp³.A 0) of the Sn-L-bond MO is determined by considering that the bond involves up to an electron transfer from the tin atom to the ligand atom to form partial ionic character in the bond as in the case of the zwitterions such as H₂B⁺—F⁻ given in the Halido Boranes section. For the tin compounds, E_{T}(atom−atom,msp³.AO) is that which forms an energy minimum for the hybridization and other bond parameter. The general values of Table 23.60 are given by Eqs. (23.217) and (23.220), and the specific values for the tin functional groups are given in Table 23. 64.

The symbols of the functional groups of tin compounds are given in Table 23.61. The geometrical (Eqs. (15.1-15.5) and (23.41)), intercept (Eqs. (15.31-15.32) and (15.80-15.87)), and energy (Eqs. (15.61) and (23.28-23.33)) parameters of tin compounds are given in Tables 23.62, 23.63, and 23.64, respectively (all as shown in the priority document). The total energy of each tin compounds given in Table 23.65 (as shown in the priority document) was calculated as the sum over the integer multiple of each E_{D} (Group) of Table 23.64 (as shown in the priority document) corresponding to functional-group composition of the compound. The bond angle parameters of tin compounds determined using Eqs. (15.88-15.117) are given in Table 23.66. The E_{T}(atom−atom,msp³.AO) term for SnCl₄ was calculated using Eqs. (23.214-23.217) with s=1 for the energies of E(Sn,5sp³). The charge-densities of exemplary tin coordinate and organometallic compounds, tin tetrachloride (5 nCl₄) and hexaphenyldistannane ((C₆H₅)₃ SnSn(C₆H₅)₃) comprising the concentric shells of atoms with the outer shell bridged by one or more H₂-type ellipsoidal MOs or joined with one or more hydrogen MOs are shown in FIG. 56 as 57, respectively.

TABLE 23.61
The symbols of functional groups of tin compounds.

| Functional Group | Group Symbol |
|---|---|
| SnCl group | Sn—Cl |
| SnBr group | Sn—Br |
| SnI group | Sn—I |
| SnO group | Sn—O |
| SnH group | Sn—H |
| SnC group | Sn—C |
| SnSn group | Sn—Sn |
| CH₃ group | C—H (CH₃) |
| CH₂ alkyl group | C—H (CH₂) (i) |
| CH alkyl | C—H (i) |
| CC bond (n-C) | C—C (a) |
| CC bond (iso-C) | C—C (b) |
| CC bond (tert-C) | C—C (c) |
| CC (iso to iso-C) | C—C (d) |
| CC (t to t-C) | C—C (e) |
| CC (t to iso-C) | C—C (f) |
| CC double bond | C═C |
| C vinyl single bond to —C(C)═C | C—C (i) |
| C vinyl single bond to —C(H)═C | C—C (ii) |
| C vinyl single bond to —C(C)═CH₂ | C—C (iii) |
| CH₂ alkenyl group | C—H (CH₂) (ii) |
| CC (aromatic bond) | $C {\overline{—}}_{ }^{3 e} C$ |
| CH (aromatic) | CH (ii) |
| Cₐ—C_{b} (CH₃ to aromatic bond) | C—C (iv) |
| C—C(O) | C—C(O) |
| C═O (aryl carboxylic acid) | C═O |
| (O)C—O | C—O |
| OH group | OH |

### REFERENCES

1. D. R. Lide, CRC Handbook of Chemistry and Physics, 86th Edition, CRC Press, Taylor & Francis, Boca Raton, (2005-6), pp. 10-202 to 10-204.
2. B. G. Willis, K. F. Jensen, “An evaluation of density functional theory and ab initio predictions for bridge-bonded aluminum compounds”, J. Phys. Chem. A, Vol. 102, (1998), pp. 2613-2623.
3. D. R. Lide, CRC Handbook of Chemistry and Physics, 86th Edition, CRC Press, Taylor & Francis, Boca Raton, (2005-6), pp. 9-19 to 9-45.
4. T. Shinzawa, F. Uesugi, I. Nishiyama, K. Sugai, S. Kishida, H. Okabayashi, “New molecular compound precursor for aluminum chemical vapor deposition”, Applied Organometallic Chem., Vol. 14, (2000), pp. 14-24.
5. D. R. Lide, CRC Handbook of Chemistry and Physics, 86th Edition, CRC Press, Taylor & Francis, Boca Raton, (2005-6), p. 9-82.
6. G. Herzberg, Molecular Spectra and Molecular Structure II. Infrared and Raman Spectra of Polyatomic Molecules, Van Nostrand Reinhold Company, New York, N.Y., (1945), p. 344.
7. R. J. Fessenden, J. S. Fessenden, Organic Chemistry, Willard Grant Press. Boston, Mass., (1979), p. 320.
8. cyclohexane at http://webbook.nist.gov/.
9. D. R. Lide, CRC Handbook of Chemistry and Physics, 86th Edition, CRC Press, Taylor & Francis, Boca Raton, (2005-6), p. 9-54.
10. J. D. Cox, G. Pilcher, Thermochemistry of Organic and Organometallic Compounds, Academic Press, New York, (1970).
11. M. B. J. Smith, J. Organometal. Chem., Vol. 76, (1974), pp. 171-201.
12. NIST Atomic Spectra Database, www.physics.nist.gov/cgi-bin/AtData/display.ksh.
13. J. E. Huheey, Inorganic Chemistry Principles of Structure and Reactivity, 2^{nd} Edition, Harper & Row Publishers, New York, (1978), Chp. 9.
14. D. R. Lide, CRC Handbook of Chemistry and Physics, 86th Edition, CRC Press, Taylor & Francis, Boca Raton, (2005-6), p. 9-86.
15. J. Li, P. C. de Mello, K. Jug, “Extension of SINDO1 to transition metal compounds”, Journal of Computational Chemistry, Vol. 13, No. 1, (1992), pp. 85-92.
16. D. R. Lide, CRC Handbook of Chemistry and Physics, 86th Edition, CRC Press, Taylor & Francis, Boca Raton, (2005-6), p. 9-81.
17. G. Herzberg, Molecular Spectra and Molecular Structure II Infrared and Raman Spectra of Polyatomic Molecules, Van Nostrand Reinhold Company, New York, N.Y., (1945), p. 567.
18. D. R. Lide, CRC Handbook of Chemistry and Physics, 86th Edition, CRC Press, Taylor & Francis, Boca Raton, (2005-6), p. 9-27.
19. M. W. Chase, Jr., C. A. Davies, J. R. Downey, Jr., D. J. Frurip, R. A. McDonald, A. N. Syverud, JANAF Thermochemical Tables, Third Edition, Part I, Al—Co, J. Phys. Chem. Ref. Data, Vol. 14, Suppl. 1, (1985), pp. 467, 509, 522, 535.
20. M. W. Chase, Jr., C. A. Davies, J. R. Downey, Jr., D. J. Frurip, R. A. McDonald, A. N. Syverud, JANAF Thermochemical Tables, Third Edition, Part II, Cr—Zr, J. Phys. Chem. Ref. Data, Vol. 14, Suppl. 1, (1985), pp. 1411, 1438, 1447, 1460.
21. M. W. Chase, Jr., C. A. Davies, J. R. Downey, Jr., D. J. Frurip, R. A. McDonald, A. N. Syverud, JANAF Thermochemical Tables, Third Edition, Part II, Cr—Zr, J. Phys. Chem. Ref Data, Vol. 14, Suppl. 1, (1985), pp. 1096, 1153, 1174, 1192.
22. M. W. Chase, Jr., C. A. Davies, J. R. Downey, Jr., D. J. Frurip, R. A. McDonald, A. N. Syverud, JANAF Thermochemical Tables, Third Edition, Part I, Al—Co, J. Phys. Chem. Ref. Data, Vol. 14, Suppl. 1, (1985), pp. 808, 866, 887, 906.
23. M. W. Chase, Jr., C. A. Davies, J. R. Downey, Jr., D. J. Frurip, R. A. McDonald, A. N. Syverud, JANAF Thermochemical Tables, Third Edition, Part I, Al—Co & Part II, Cr—Zr, J. Phys. Chem. Ref Data, Vol. 14, Suppl. 1, (1985), pp. 796, 843, 1082, 1132, 1738, 1762.
24. M. W. Chase, Jr., C. A. Davies, J. R. Downey, Jr., D. J. Frurip, R. A. McDonald, A. N. Syverud, JANAF Thermochemical Tables, Third Edition, Part II, Cr—Zr, J. Phys. Chem. Ref. Data, Vol. 14, Suppl. 1, (1985), p. 1616.
25. G. Herzberg, Molecular Spectra and Molecular Structure. I. Spectra of Diatomic Molecules, Krieger Publishing Company, Malabar, Fla., (1950), p. 578.
26. E. L. Muetterties, J. R. Bleeke, E. J. Wucherer, “Structural, stereochemical, and electronic features of arene-metal complexes, Chem. Rev., Vol. 82, No. 5, (1982), pp. 499-525.
27. vanadium pentafluoride at http://webbook.nist.gov/.
28. vanadium oxytrichloride at http://webbook.nist.gov/.
29. M. W. Chase, Jr., C. A. Davies, J. R. Downey, Jr., D. J. Frurip, R. A. McDonald, A. N. Syverud, JANAF Thermochemical Tables, Third Edition, Part I, Al—Co & Part II, Cr—Zr, J. Phys. Chem. Ref Data, Vol. 14, Suppl. 1, (1985), p. 698.
30. G. Herzberg, Molecular Spectra and Molecular Structure II Infrared and Raman Spectra of Polyatomic Molecules, Van Nostrand Reinhold Company, New York, N.Y., (1945), pp. 362-369.
31. M. W. Chase, Jr., C. A. Davies, J. R. Downey, Jr., D. J. Frurip, R. A. McDonald, A. N. Syverud, JANAF Thermochemical Tables, Third Edition, Part II, Cr—Zr, J. Phys. Chem. Ref. Data, Vol. 14, Suppl. 1, (1985), p. 1763.
32. D. D. Wagman, W. H Evans, V. B. Parker, I. Halow, S. M. Bailey, R. L. Schumm, R. H. Nuttall, The NBS Tables of Chemical. Thermodynamic Properties, J. Phys. Chem. Ref. Data, Vol. 11, Suppl. 2 (1982) Wagman, D. D.; Evans, W. H.; Parker, V. B.; Halow, I.; Bailey, .S. M.; Schumm, R. L.; Nuttall, R. H. The NBS Tables of Chemical. Thermodynamic Properties, J. Phys. Chem. Ref Data, Vol. 11, Suppl. 2 (1982).
33. J. D. Cox, G. Pilcher, Thermochemistry of Organometallic Compounds, Academic Press, New York, (1970), p. 478.
34. W. I. F. David, R. M. Ibberson, G. A. Jeffrey, J. R. Ruble, “The structure analysis of deuterated benzene and deuterated nitromethane by pulsed-neutron powder diffraction: a comparison with single crystal neutron analysis”, Physica B (1992), 180 & 181, pp. 597-600.
35. G. A. Jeffrey, J. R. Ruble, R. K. McMullan, J. A. Pople, “The crystal structure of deuterated benzene,” Proceedings of the Royal Society of London. Series A, Mathematical and Physical Sciences, Vol. 414, No. 1846, (Nov. 9, 1987), pp. 47-57.
36. H. B. Burgi, S. C. Capelli, “Getting more out of crystal-structure analyses,” Helvetica Chimica Acta, Vol. 86, (2003), pp. 1625-1640.
37. M. W. Chase, Jr., C. A. Davies, J. R. Downey, Jr., D. J. Frurip, R. A. McDonald, A. N. Syverud, JANAF Thermochemical Tables, Third Edition, Part II, Cr—Zr, J. Phys. Chem. Ref Data, Vol. 14, Suppl. 1, (1985), pp. 968, 969, 970.
38. A. Jost, B. Rees, “Electronic structure of chromium hexacarbonyl at 78K. I. Neutron diffraction study, Acta. Cryst. Vol. B31 (1975), pp. 2649-2658.
39. J. A. Ibers, “The structure of dibenzene chromium”, J. Phys. Chem., Vol. 40, (1964), pp. 3129-3130.
40. B. B. Ebbinghaus, “Thermodynamics of gas phase chromium species: The chromium chlorides, oxychlorides, fluorides, oxyfluorides, hydroxides, oxyhydroxides, mixed oxyfluorochlorohydroxides, and volatility calculations in waste incineration processes”, Combustion and Flame, Vol. 101, (1995), pp. 311-338.
41. hexacarbonylnickel at http://webbook.nist.gov/.
42. CrCC at http://webbook.nist.gov/.
43. D. Lin-Vien. N. B. Colthup, W. G. Fateley, J. G. Grasselli, The Handbook of Infrared and Raman Frequencies of Organic Molecules, Academic Press, Inc., Harcourt Brace Jovanovich, Boston, (1991), p. 481.
44. J. D. Cox, G. Pilcher, Thermochemistry of Organometallic Compounds, Academic Press, New York, (1970), p. 489.
45. N. Vogt, “Equilibrium bond lengths, force constants and vibrational frequencies of MnF₂, FeF₂, CoF₂, NiF₂, and ZnF₂ from least-squares analysis of gas-phase electron diffraction data”, J Molecular Structure, Vol. 570, (2001), pp. 189-195.
46. L. F. Dahl, “The structure of dimanganese decacarbonyl, Mn₂ (CO)₁₀”, Acta. Cryst., Vol. 16, (1963), pp. 419-426.
47. G. Herzberg, Molecular Spectra and Molecular Structure. I. Spectra of Diatomic Molecules, Krieger Publishing Company, Malabar, Fla., (1950), p. 550.
48. Mn₃ at http://webbook.nist.gov/.
49. J. D. Cox, G. Pilcher, Thermochemistry of Organometallic Compounds, Academic Press, New York, (1970), p. 491.
50. M. W. Chase, Jr., C. A. Davies, J. R. Downey, Jr., D. J. Frurip, R. A. McDonald, A. N. Syverud, JANAF Thermochemical Tables, Third Edition, Part I, Al—Co, J. Phys. Chem. Ref. Data, Vol. 14, Suppl. 1, (1985), pp. 822, 879.
51. M. W. Chase, Jr., C. A. Davies, J. R. Downey, Jr., D. J. Frurip, R. A. McDonald, A. N. Syverud, JANAF Thermochemical Tables, Third Edition, Part II, Cr—Zr, J. Phys. Chem. Ref Data, Vol. 14, Suppl. 1, (1985), p. 1054.
52. M. W. Chase, Jr., C. A. Davies, J. R. Downey, Jr., D. J. Frurip, R. A. McDonald, A. N. Syverud, JANAF Thermochemical Tables, Third Edition, Part II, Cr—Zr, J. Phys. Chem. Ref Data, Vol. 14, Suppl. 1, (1985), p. 1239.
53. J. D. Cox, G. Pilcher, Thermochemistry of Organometallic Compounds, Academic Press, New York, (1970), p. 493.
54. M. W. Chase, Jr., C. A. Davies, J. R. Downey, Jr., D. J. Frurip, R. A. McDonald, A. N. Syverud, JANAF Thermochemical Tables, Third Edition, Part II, Cr—Zr, J. Phys. Chem. Ref Data, Vol. 14, Suppl. 1, (1985), p. 953.
55. M. W. Chase, Jr., C. A. Davies, J. R. Downey, Jr., D. J. Frurip, R. A. McDonald, A. N. Syverud, JANAF Thermochemical Tables, Third Edition, Part II, Cr—Zr, J. Phys. Chem. Ref Data, Vol. 14, Suppl. 1, (1985), p. 695.
56. G. Herzberg, Molecular Spectra and Molecular Structure. I. Spectra of Diatomic Molecules, Krieger Publishing Company, Malabar, Fla., (1950), p. 522.
57. D. R. Lide, CRC Handbook of Chemistry and Physics, 86th Edition, CRC Press, Taylor & Francis, Boca Raton, (2005-6), p. 9-85.
58. Co(CO) at http://webbook.nist.gov/.
59. M. W. Chase, Jr., C. A. Davies, J. R. Downey, Jr., D. J. Frurip, R. A. McDonald, A. N. Syverud, JANAF Thermochemical Tables, Third Edition, Part II, Cr—Zr, J. Phys. Chem. Ref. Data, Vol. 14, Suppl. 1, (1985), pp. 794, 840.
60. P. Seiler, J. D. Dunitz, “The structure of nickelocene at room temperature and at 101 K”, Acta. Cryst., Vol. B36, (1980), pp. 2255-2260.
61. NIST Atomic Spectra Database, www.physics.nist.gov/cgi-bin/AtData/display.ksh.
62. D. R. Lide, CRC Handbook of Chemistry and Physics, 86th Edition, CRC Press, Taylor & Francis, Boca Raton, (2005-6), pp. 9-83 to 9-84.
63. M. W. Chase, Jr., C. A. Davies, J. R. Downey, Jr., D. J. Frurip, R. A. McDonald, A. N. Syverud, JANAF Thermochemical Tables, Third Edition, Part II, Cr—Zr, J. Phys. Chem. Ref Data, Vol. 14, Suppl. 1, (1985), pp. 1013, 1017, 1020.
64. dimethylzinc at http://webbook.nist.gov/.
65. J. D. Cox, G. Pilcher, Thermochemistry of Organometallic Compounds, Academic Press, New York, (1970), pp. 446-447.
66. H. Preut, “Structure of triphenyltin bromide”, Acta. Cryst., Vol. B35, (1979), pp. 744-746.
67. S. W. Ng, “Triphenyltin iodide”, Acta. Cryst., Vol. C51, (1995), pp. 629-631.
68. Von H. Preut, H.-J. Haupt, F. Huber, “Die Kristall-und molekularstruktur des hexaphenyl-distannans”, Zeitschrift fair anorganische und allgemeine Chemie, Vol. 396, Issue 1, January, (1973), pp. 81-89.
69. G. A. Sim, J. M. Robertson, T. H. Goodwin, “The crystal and molecular structure of benzoic acid”, Acta Cryst., Vol. 8, (1955), pp. 157-164.
70. D. Lin-Vien. N. B. Colthup, W. G. Fateley, J. G. Grasselli, The Handbook of Infrared and Raman Frequencies of Organic Molecules, Academic Press, Inc., Harcourt Brace Jovanovich, Boston, (1991), pp 5,14.
71. J. F. Sanz, A. Marquez, “Molecular structure and vibrational analysis of distannane from ab initio second-order perturbation calculations. A theoretical approach to the tin-X bond (X═C1, Si, Ge, Sn)”, J. Phys. Chem., Vol. 93, (1989), pp. 7328-7333.
72. G. Herzberg, Molecular Spectra and Molecular Structure II Infrared and Raman Spectra of Polyatomic Molecules, Van Nostrand Reinhold Company, New York, N.Y., (1945), p. 326.
73. b1 2-methyl-1-propene at http://webbook.nist.gov/.
74. a1 2-methyl-1-propene at http://webbook.nist.gov/.
75. acetic acid at http://webbook.nist.gov/.
76. G. Herzberg, Molecular Spectra and Molecular Structure II Infrared and Raman Spectra of Polyatomic Molecules, Krieger Publishing Company, Malabar, Fla., (1991), p. 195.
77. D. Lin-Vien. N. B. Colthup, W. G. Fateley, J. G. Grasselli, The Handbook of Infrared and Raman Frequencies of Organic Molecules, Academic Press, Inc., Harcourt Brace Jovanovich, Boston, (1991), p. 138.
78. K. P. Huber, G. Herzberg, Molecular Spectra and Molecular Structure, IV. Constants of Diatomic Molecules, Van Nostrand Reinhold Company, New York, (1979).
79. J. Crovisier, Molecular Database—Constants for molecules of astrophysical interest in the gas phase: photodissociation, microwave and infrared spectra, Ver. 4.2, Observatoire de Paris, Section de Meudon, Meudon, France, May 2002, pp. 34-37, available at http://wwwusr.obspm.fr/˜.crovisie/.
80. D. R. Lide, CRC Handbook of Chemistry and Physics, 86th Edition, CRC Press, Taylor & Francis, Boca Raton, (2005-6), pp. 5-8, 5-10, 5-14, 5-16, 5-28.
81. J. D. Cox, G. Pilcher, Thermochemistry of Organometallic Compounds, Academic Press, New York, (1970), pp. 472-477.
82. P. G. Harrison, Chemistry of Tin, Blackie, Glasgow, (1989), pp. 10-12.
83. O. Knacke, O. Kubaschewski, K. Hesselmann, Thermochemical Properties of Inorganic Substances, 2^{nd} Edition, Vol. II, Springer, N.Y. (1991), pp. 1888-1889.

1-305. (canceled)

306. A system for computing and rendering a nature of a chemical bond comprising physical, Maxwellian solutions of charge, mass, and current density functions of molecules, compounds, and materials, wherein at least one atom is other than hydrogen, the system comprising:
processing means for calculating solutions to Maxwellian equations representing charge, mass, and current density functions of molecules, compounds, and materials; and
an output device in communication with the processing means, the output device being configured to display solutions to the Maxwellian equations including solutions of charge, mass, and current density functions and the corresponding energy components of molecules, compounds, and materials comprising at least one entity chosen from pharmaceutical molecules, allotropes of carbon, metals, silicon molecules, semiconductors, boron molecules, aluminum molecules, coordinate compounds, organometallic molecules, and tin molecules.

307. The system of claim 306, further comprising:
an input means comprising at least one of a serial port, universal serial bus (USB) port, microphone, camera, keyboard, and mouse; and
a computer readable medium encoded with a computer program product or products loadable into a memory of at least one computer and including software code portions for calculating the solutions to the Maxwellian equations,
wherein the at least one computer includes the processing means and comprises at least one of a central processing unit (CPU), one or more specialized processors, the memory, and a mass storage device such as a magnetic disk, an optical disk, or a solid state flash drive,
wherein the computer readable medium comprises any available media which can be accessed by the at least one computer and comprises at least one of RAM, ROM, EPROM, CD-ROM, DVD, or other optical disk storage, magnetic disk storage or other magnetic storage devices, or any other medium which can embody the computer program product and which can be accessed by the at least one computer,
wherein the computer program product comprises executable instructions and data which cause the at least one computer to calculate the solutions to the Maxwellian equations, and
wherein the output device comprises a monitor, video projector, printer, or three-dimensional rendering device that displays at least one of visual or graphical media comprising at least one of the group of static or dynamic images, vibration and rotation, and reactivity and physical properties.

308. The system of claim 306, wherein the at least one entity comprises at least one function group chosen from alkanes, branched alkanes, alkenes, branched alkenes, alkynes, alkyl fluorides, alkyl chlorides, alkyl bromides, alkyl iodides, alkene halides, primary alcohols, secondary alcohols, tertiary alcohols, ethers, primary amines, secondary amines, tertiary amines, aldehydes, ketones, carboxylic acids, carboxylic esters, amides, N-alkyl amides, N,N-dialkyl amides, ureas, acid halides, acid anhydrides, nitriles, thiols, sulfides, disulfides, sulfoxides, sulfones, sulfites, sulfates, nitro alkanes, nitrites, nitrates, conjugated polyenes, aromatics, and heterocyclic aromatics, wherein substituted aromatics are superimposed by the processing means to calculate said solutions.

309. The system of claim 308, wherein the at least one entity is chosen from diamond, fullerene (C₆₀), graphite, lithium metal, sodium metal, potassium metal, rubidium metal, cesium metal, silicon molecular functional groups and molecules, silanes, alkyl silanes and disilanes, silicon oxides, silicic acids, silanols, siloxanes, disiloxanes, boron molecules, boranes, bridging bonds of boranes, alkyl boranes, alkoxy boranes, alkyl borinic acids, tertiary and quarternary aminoboranes and borane amines, halido boranes, organometallic molecular functional groups and molecules, alkyl aluminum hydrides, bridging bonds of organoaluminum hydrides, transition metal organometallic and coordinate compounds, scandium functional groups and molecules, titanium functional groups and molecules, vanadium functional groups and molecules, chromium functional groups and molecules, manganese functional groups and molecules, iron functional groups and molecules, cobalt functional groups and molecules, nickel functional groups and molecules, copper functional groups and molecules, zinc functional groups and molecules, and tin functional groups and molecules.

310. The system of claim 309, wherein the at least one entity comprises complex macromolecules that are solved from the groups at each vertex atom of a periodic structure of the group comprising the vertex atom.

311. The system of claim 306, wherein the nature of the metal bond comprises a lattice of metal ions and corresponding electrons of the lattice comprise balancing negative charges to the positive ions, wherein the surface charge density of each electron gives rise to an electric field equivalent to that of image point charge for each corresponding positive ion of the lattice.

312. The system of claim 306, wherein that nature of the semiconductor comprises lattice ions formed from the atoms of the semiconductor with excitation energy of at least that of the band gap, and the conduction electrons excited from molecular bonds are equivalent to those of the electrons of metals with the appropriate lattice parameters and boundary conditions of the semiconductor, wherein the surface charge density of each electron gives rise to an electric field equivalent to that of image point charge for each corresponding positive ion of the lattice.

313. The system of claim 309, wherein the at least one entity comprises at least one functional group chosen from:
SiH₃, SiH₂, SiH, Si—Si, C—Si, Si—O, B—B, B—C, B—H, B—O, B—N, B—X, wherein X is a halogen atom,
M—C, M—H, M—X, M—OH, and M—OR, wherein M is a metal, X is a halogen atom, and R is an organic group,
B—H, B—B, B—H—B, B—B—B, B—O, tertiary and quaternary B—N, and B—X, wherein X is a halogen atom,
M—C, M—H, M—X, M—OH, and M—OR, wherein M is a transition metal, X is a halogen atom, and R is an organic group,
Sn—X wherein X is a halide or an oxide, Sn—H, Sn—Sn, and C—Sn, and the alkyl functional groups of organic molecules.

314. The system of claim 313, wherein the rendering of the non-organic functional groups are obtained using generalized forms of the force balance equation wherein the centrifugal force is equated to the Coulombic and magnetic forces and the length of the semimajor axis is solved.

315. The system of claim 314, wherein the Coulombic force on the pairing electron of the molecular orbital (MO) is
$${F}_{Coulomb} = \frac{{e}^{2}}{8 π {ɛ}_{0} {ab}^{2}} {Di}_{ξ} \qquad ( 20.22 )$$
the spin pairing force is
$${F}_{spin - pairing} = \frac{{h}^{2}}{2 {m}_{e} {a}^{2} {b}^{2}} {Di}_{ξ} \qquad ( 20.23 )$$
the diamagnetic force is:
$${F}_{diamagneticMO 1} = \frac{{n}_{e} {h}^{2}}{4 {m}_{e} {a}^{2} {b}^{2}} {Di}_{ξ} \qquad ( 20.24 )$$
where nₑ is the total number of electrons that interact with the binding σ-MO electron, mₑ is the electron mass, D is the distance from the origin to the MO electron, a is the semimajor axis, and b is the semiminor axis;
the diamagnetic force F_{diamagneticMO2} on the pairing electron of the σ MO is given by the sum of the contributions over the components of angular momentum:
$${F}_{diamagneticMO 2} = - {\sum }_{i , j} \frac{\vert {L}_{i} \vert h}{{Z}_{j} 2 {m}_{e} {a}^{2} {b}^{2}} D {i}_{ξ} \qquad ( 20.25 )$$
where |L| is the magnitude of the angular momentum of each atom at a focus that is the source of the diamagnetism at the σ-MO and Z is the nuclear charge, and
the centrifugal force is
$${F}_{centrifugalMO} = - \frac{{h}^{2}}{{m}_{e} {a}^{2} {b}^{2}} {Di}_{ξ} \qquad ( 20.26 )$$

316. The system of claim 315, wherein the geometrical equations for functional groups comprised of carbon, and the energy equations for the rendering of the functional groups are given by
$$- \frac{{n}_{1} {e}^{2}}{8 π {ɛ}_{0} \sqrt{\frac{{aa}_{0}}{2 {C}_{1} {C}_{2}}}} [ {c}_{1} {c}_{2} ( 2 - \frac{{a}_{0}}{a} ) ln \frac{a + \sqrt{\frac{{aa}_{0}}{2 {C}_{1} {C}_{2}}}}{a - \sqrt{\frac{{aa}_{0}}{2 {C}_{1} {C}_{2}}}} - 1 ] + {E}_{T} ( A O / H O ) = E ( basis energies ) \\ 2 {c}^{′} = 2 \sqrt{\frac{{aa}_{0}}{2 {C}_{1} {C}_{2}}} \qquad ( 15.3 )$$
the length of the semiminor axis of the prolate spheroidal MO b=c is given by
b=\sqrt{a²−c′²} (15.4)
and, the eccentricity, e, is
$$e = \frac{{c}^{′}}{a} \qquad ( 15.5 )$$
wherein c′ is the ellipsoidal parameter; and
$$\begin{matrix} ( 15.61 ) \\ {E}_{T + osc} ( Group ) = {E}_{T} ( M O ) + {\overline{E}}_{osc} \\ = ( \begin{matrix}( \begin{matrix}- \frac{{n}_{1} {e}^{2}}{8 π {ɛ}_{0} \sqrt{\frac{{aa}_{0}}{2 {C}_{1} {C}_{2}}}} [ {c}_{1} {c}_{2} ( 2 - \frac{{a}_{0}}{a} ) ln \frac{a + \sqrt{\frac{{aa}_{0}}{2 {C}_{1} {C}_{2}}}}{a - \sqrt{\frac{{aa}_{0}}{2 {C}_{1} {C}_{2}}}} - 1 ] + \\ {E}_{T} ( A O / H O ) + {E}_{T} ( atom - atom , {msp}^{3} \cdot A O )\end{matrix} ) \\ [ 1 + \sqrt{\frac{2 ℏ \sqrt{\frac{{C}_{1 o} {C}_{2 o} {e}^{2}}{\frac{4 π {ɛ}_{o} {R}^{3}}{{m}_{e}}}}}{{m}_{e} {c}^{2}}} ] + {n}_{1} \frac{1}{2} ℏ \sqrt{\frac{k}{μ}}\end{matrix} ) \\ = ( E ( basis energies ) + {E}_{T} ( atom - atom , {msp}^{3} \cdot A O ) ) \\ [ 1 + \sqrt{\frac{2 ℏ \sqrt{\frac{{C}_{1 o} {C}_{2 o} {e}^{2}}{\frac{4 π {ɛ}_{o} {R}^{3}}{{m}_{e}}}}}{{m}_{e} {c}^{2}}} ] + {n}_{1} \frac{1}{2} ℏ \sqrt{\frac{k}{μ}}\end{matrix}$$
wherein:
n is an integer;
k is the spring constant of the equivalent harmonic oscillator;
μ is the reduced mass;
c₁ is the fraction of the H₂-type ellipsoidal MO basis function of a chemical bond of the group;
c₂ is the factor that results in an equipotential energy match of the participating at least two atomic orbitals of each chemical bond;
C₁ is the fraction of the H₂-type ellipsoidal MO basis function of a chemical bond of the molecule or molecular ion;
C₂ is the factor that results in an equipotential energy match of the participating at least two molecular or atomic orbitals of the chemical bond;
C₁ₒ is the fraction of the H₂-type ellipsoidal MO basis function of the oscillatory transition state of a chemical bond of the group;
C₂ₒ is the factor that results in an equipotential energy match of the participating at least two atomic orbitals of the transition state of the chemical bond;
E_{T} (AO/HO) is the total energy of the atomic and hybrid orbitals;
E_{T+osc} (Group) is the total energy of the group;
E_{T} (MO) is the total energy of the MO of the functional group; and
R is the semimajor axis (a) or the semiminor axis (b) depending on the eccentricity of the bond that is most representative of the oscillation in the transition state.

317. The system of claim 316, wherein the hybridization is of the 3d and 4s electrons to form the corresponding number of 3d4s hybrid orbitals (HOs) except for Cu and Zn which each have a filled inner 3d shell and one and two outer 4s electrons, respectively, such that Cu may form a single bond involving the 4s electron or the 3d and shells may hybridize to form multiple bonds with one or more ligands, and
the 4s shell of Zn hybridizes to form two 4s HOs that provide for two possible bonds, typically two metal-alkyl bonds.

318. The system of claim 317, wherein the electrons of the 3d4s HOs pair such that the binding energy of the HO is increased,
the hybridization factor accordingly changes which effects the bond distances and energies;
the diamagnetic terms of the force balance equations of the electrons of the molecular orbitals (MOs) formed between the 3d4s hybrid orbitals (HOs) and the atomic orbitals (AOs) of the ligands also changes depending on whether the nonbonding HOs are occupied by paired or unpaired electrons, and
the orbital and spin angular momentum of the HOs and MOs is determined by the state that achieves a minimum energy including that corresponding to the donation of electron charge from the HOs and AOs to the MOs.

319. The system of claim 318, wherein for transition metal atoms with electron configuration 3dⁿ4s², the spin-paired 4s electrons are promoted to 3d4s shell during hybridization as unpaired electrons, and for n>5 the electrons of the 3d shell are spin-paired and these electrons are promoted to 3d4s shell during hybridization as unpaired electrons;
the energy for each promotion is the magnetic energy given by Eq. (15.15):
$$E ( magnetic ) = \frac{2 {π}_{0} {e}^{2} {ℏ}^{2}}{{m}_{e}^{2} {r}^{3}} = \frac{8 {πμ}_{0} {μ}_{B}^{2}}{{r}^{3}} \qquad ( 15.15 )$$
at the initial radius of the 4s electrons and the paired 3d electrons determined using Eq. (10.102):
$$E ( electric ) = - \frac{( Z - ( n - 1 ) ) {e}^{2}}{8 {πɛ}_{0} {r}_{n}} \qquad ( 10.102 )$$
with the corresponding nuclear charge Z of the metal atom and the number electrons n of the corresponding ion with the filled outer shell from which the pairing energy is determined;
the electrons from the 4s and 3d shells successively fill unoccupied HOs until the HO shell is filled with unpaired electrons, then the electrons pair per HO;
the magnetic energy of paring given by Eq. (15.13)
$${r}_{{msp}^{3}} = {\sum }_{q = Z - n}^{Z - 1} \frac{- ( Z - q ) {e}^{2}}{8 π {ɛ}_{0} {E}_{T} ( atom , {msp}^{3} )} \qquad ( 15.13 )$$
and Eq. (15.15) is added to E_{Coulomb}(atom,3d4s) for each pair;
after Eq. (15.16),
$$E ( atom , {msp}^{3} ) = \frac{- {e}^{2}}{8 {πɛ}_{0} {r}_{{msp}^{3}}} + \frac{2 {πμ}_{0} {e}^{2} {ℏ}^{2}}{{m}_{e}^{2} {r}^{3}} \qquad ( 15.16 )$$
the energy E(atom,3d4s) of the outer electron of the atom 3d4s shell is given by the sum of E_{Coulomb}(atom,3d4s) and E(magnetic):
$$E ( atom , 3 d 4 s ) = \frac{- {e}^{2}}{8 π {ɛ}_{0} {r}_{3 d 4 s}} + \frac{2 {πμ}_{0} {e}^{2} {h}^{2}}{{m}_{e}^{2} {r}_{4 s}^{3}} + {\sum }_{3 d pairs} \frac{2 {πμ}_{0} {e}^{2} {h}^{2}}{{m}_{e}^{2} {r}_{3 d}^{3}} - {\sum }_{HO pairs} \frac{2 {πμ}_{0} {e}^{2} {h}^{2}}{{m}_{e}^{2} {r}_{3 d 4 s}^{3}} ; \qquad ( 23.28 )$$
the total energy E_{T}(mol.atom,3d4s) of the HO electrons is given by the sum of energies of successive ions of the atom over the n electrons comprising total electrons of the initial AO shell and the hybridization energy:
$${E}_{T} ( mol \cdot atom , 3 d 4 s ) = E ( atom , 3 d 4 s ) - {\sum }_{m = 2}^{n} {IP}_{m} \qquad ( 23.29 )$$
where IPₘ is the mth ionization energy (positive) of the atom and the sum of −IP₁ plus the hybridization energy is E(atom,3d4s);
the radius r_{3d4s} of the hybridized shell due to its donation of a total charge −Qe to the corresponding MO is given by is given by:
$$\begin{matrix}{r}_{3 d 4 s} = ( {\sum }_{q = Z - n}^{Z - 1} ( Z - q ) - Q ) \frac{- {e}^{2}}{8 {πɛ}_{0} {E}_{T} ( mol \cdot atom , 3 d 4 s )} \\ = ( {\sum }_{q = Z - n}^{Z - 1} ( Z - q ) - s ( 0.25 ) ) \frac{- {e}^{2}}{8 π {ɛ}_{0} {E}_{T} ( mol \cdot atom , 3 d 4 s )}\end{matrix} \qquad ( 23.30 )$$
where −e is the fundamental electron charge, s=1,2,3 for a single, double, and triple bond, respectively, and s=4 for typical coordinate and organometallic compounds wherein L is not carbon in metal-ligand bond M-L;
the Coulombic energy E_{Coulomb}(mol.atom,3d4s) of the outer electron of the atom 3d4s shell is given by
$${E}_{Coulomb} ( mol \cdot atom , 3 d 4 s ) = \frac{- {e}^{2}}{8 {πɛ}_{0} {r}_{3 d 4 s}} \qquad ( 23.31 )$$
wherein in the case that during hybridization the metal spin-paired 4s AO electrons are unpaired to contribute electrons to the 3d4s HO, the energy change for the promotion to the unpaired state is the magnetic energy E(magnetic) at the initial radius r of the AO electron given by Eq. (15.15) and in the case that the 3d4s HO electrons are paired, the corresponding magnetic energy is added such that the energy E(mol.atom,3d4s) of the outer electron of the atom 3d4s shell is given by the sum of E_{Coulomb}(mol.atom,3d4s) and E(magnetic):
$$E ( mol \cdot atom , 3 d 4 s ) = \frac{- {e}^{2}}{8 π {ɛ}_{0} {r}_{3 d 4 s}} + \frac{2 π {μ}_{0} {e}^{2} {h}^{2}}{{m}_{e}^{2} {r}_{4 s}^{3}} - {\sum }_{HO pairs} \frac{2 {πμ}_{0} {e}^{2} {h}^{2}}{{m}_{e}^{2} {r}_{3 d 4 s}^{3}} \qquad ( 23.32 )$$
and E_{T}(atom−atom,3d4s), the energy change of each atom msp³ shell with the formation of the atom-atom-bond MO is given by the difference between E(mol.atom,3d4s) and E(atom,3d4s):
E_{T}(atom−atom,3d4s)=E(mol.atom,3d4s)−E(atom,3d4s) (23.33)

320. The system of claim 319, wherein hybridization the factors c₂ and C₂ of Eq. (15.61) are
$$\begin{matrix}\begin{matrix}{C}_{2} ( silaneSi 3 {sp}^{3} HO ) = {c}_{2} ( silaneSi 3 {sp}^{3} HO ) \\ = \frac{10.31324 eV}{13.605804 eV} \\ = 0.75800\end{matrix} & ( 20.33 ) \\ \begin{matrix}{C}_{2} ( C 2 {sp}^{3} HO to Si 3 {sp}^{3} HO ) = \frac{E ( Si , 3 {sp}^{3} )}{E ( C , 2 {sp}^{3} )} \\ = \frac{- 10.25487 eV}{- 14.63489 eV} \\ = 0.70071\end{matrix} & ( 20.37 ) \\ \begin{matrix}{c}_{2} ( O to Si 3 {sp}^{3} HO ) = {C}_{2} ( O to Si 3 {sp}^{3} HO ) \\ = \frac{E ( Si , 3 {sp}^{3} )}{E ( O )} \\ = \frac{- 10.25487 eV}{- 13.61805 eV} \\ = 0.75304\end{matrix} & ( 20.49 ) \\ \begin{matrix}{c}_{2} = {C}_{2} ( borane 2 {sp}^{3} HO ) \\ = \frac{11.89724 eV}{13.605804 eV} \\ = 0.87442\end{matrix} & ( 22.29 ) \\ \begin{matrix}{c}_{2} ( C 2 {sp}^{3} HO to B 2 {sp}^{3} HO ) = {C}_{2} ( C 2 {sp}^{3} HO to B 2 {sp}^{3} HO ) \\ = \frac{E ( B , 2 {sp}^{3} )}{E ( C , 2 {sp}^{3} )} \\ = \frac{- 11.80624 eV}{- 14.63489 eV} \\ = 0.80672\end{matrix} & ( 22.40 ) \\ \begin{matrix}{C}_{2} ( O A O to B 2 {sp}^{3} HO ) = \frac{E ( O A O )}{E ( B , 2 {sp}^{3} )} \\ = \frac{- 13.61805 eV}{- 11.80624 eV} \\ = 1.15346\end{matrix} & ( 22.43 ) \\ \begin{matrix}{C}_{2} ( B 2 {sp}^{3} HO to O ) = \frac{E ( B , 2 {sp}^{3} )}{E ( O )} {c}_{2} ( C 2 {sp}^{3} HO ) \\ = \frac{- 11.80624 eV}{- 1361805 eV} ( 0.91771 ) \\ = 0.79562\end{matrix} & ( 22.44 ) \\ \begin{matrix}{C}_{2} ( N A O to B 2 {sp}^{3} HO ) = \frac{E ( B , 2 {sp}^{3} )}{E ( N A O )} \\ = \frac{- 11.80624 eV}{- 14.53414 eV} \\ = 0.81231\end{matrix} & ( 22.48 ) \\ \begin{matrix}{c}_{2} ( F A O to B 2 {sp}^{2} HO ) = \frac{E ( B , 2 {sp}^{3} )}{E ( FAO )} \\ = \frac{- 11.80624 eV}{- 17.42282 eV} \\ = 0.68285\end{matrix} & ( 22.58 ) \\ \begin{matrix}{C}_{2} = ( Cl A O to B 2 {sp}^{3} HO ) \\ = \frac{E ( B , 2 {sp}^{3} )}{E ( Cl A O )} \\ = \frac{- 11.80624 eV}{- 12.96764 eV} \\ = 0.91044\end{matrix} & ( 22.63 ) \\ \begin{matrix}{C}_{2} ( organoAlH 3 {sp}^{3} HO ) = \frac{8.87700 eV}{13.605804 eV} \\ = 0.65244\end{matrix} & ( 23.21 ) \\ \begin{matrix}{C}_{2} ( C 2 {sp}^{3} HO to Al 3 {sp}^{3} HO ) = {c}_{2} ( \begin{matrix}C 2 {sp}^{3} HO to \\ Al 3 {sp}^{3} HO\end{matrix} ) \\ = \frac{E ( Al , 3 {sp}^{3} )}{E ( C , 2 {sp}^{3} )} {c}_{2} ( C 2 {sp}^{3} HO ) \\ = \frac{- 8.83630 eV}{- 14.63489 eV} ( 0.91771 ) \\ = 0.55410\end{matrix} & ( 23.23 ) \\ \begin{matrix}{c}_{2} ( F A O to Sc 3 d 4 sHO ) = {C}_{2} ( F A O to Sc 3 d 4 sHO ) \\ = \frac{E ( Sc , 3 d 4 s )}{E ( F A O )} \\ = \frac{- 7.34015 eV}{- 17.42282 eV} \\ = 0.42130\end{matrix} & ( 23.53 ) \\ \begin{matrix}{c}_{2} ( Cl A O to Sc 3 d 4 sHO ) = {C}_{2} ( Cl A O to Sc 3 d 4 sHO ) \\ = \frac{E ( Sc , 3 d 4 s )}{E ( F A O )} \\ = \frac{- 7.34015 eV}{- 12.96764 eV} \\ = 0.56604\end{matrix} & ( 23.54 ) \\ \begin{matrix}{c}_{2} ( O to Sc 3 d 4 sHO ) = \frac{E ( Sc , 3 d 4 s )}{E ( O )} \\ = \frac{- 7.34015 eV}{- 13.61805 eV} \\ = 0.53900\end{matrix} & ( 23.55 ) \\ \begin{matrix}{C}_{2} ( F A O to Ti 3 d 4 sHO ) = \frac{E ( Ti , 3 d 4 s )}{E ( F A O )} \\ = \frac{- 9.10179 eV}{- 17.42282 eV} \\ = 0.52241\end{matrix} & ( 23.67 ) \\ \begin{matrix}{C}_{2} ( ClAO to Ti 3 d 4 sHO ) = \frac{E ( Ti , 3 d 4 s )}{E ( Cl A O )} \\ = \frac{- 9.10179 eV}{- 12.96764 eV} \\ = 0.70188\end{matrix} & ( 23.68 ) \\ \begin{matrix}{c}_{2} ( BrAO to Ti 3 d 4 sHO ) = {C}_{2} ( BrAO to Ti 3 d 4 sHO ) \\ = \frac{E ( Ti , 3 d 4 s )}{E ( BrAO )} \\ = \frac{- 9.10179 eV}{- 11.8138 eV} \\ = 0.77044\end{matrix} & ( 23.69 ) \\ \begin{matrix}{c}_{2} ( I A O to Ti 3 d 4 sHO ) = {C}_{2} ( I A O to Ti 3 d 4 sHO ) \\ = \frac{E ( Ti , 3 d 4 s )}{E ( I A O )} \\ = \frac{- 9.10179 eV}{- 10.45126 eV} \\ = 0.87088\end{matrix} & ( 23.70 ) \\ \begin{matrix}{c}_{2} ( O to Ti 3 d 4 sHO ) = \frac{E ( Ti , 3 d 4 s )}{E ( O )} \\ = \frac{- 9.10179 eV}{- 13.61805 eV} \\ = 0.66836\end{matrix} & ( 23.71 ) \\ \begin{matrix}{C}_{2} ( F A O to V 3 d 4 sHO ) = \frac{E ( V , 3 d 4 s )}{E ( F A O )} \\ = \frac{- 10.83045 eV}{- 17.42282 eV} \\ = 0.62162\end{matrix} & ( 23.82 ) \\ \begin{matrix}{C}_{2} ( Cl A O to V 3 d 4 sHO ) = \frac{E ( V , 3 d 4 s )}{E ( Cl A O )} \\ = \frac{- 10.83045 eV}{- 12.96764 eV} \\ = 0.83519\end{matrix} & ( 23.83 ) \\ \begin{matrix}{C}_{2} ( C 2 {sp}^{3} HO to V 3 d 4 sHO ) = \frac{{E}_{Coulomb} ( V , 3 d 4 s )}{E ( C , 2 {sp}^{3} )} \\ {c}_{2} ( C 2 {sp}^{3} HO ) \\ = \frac{- 10.84439 eV}{- 14.63489 eV} \\ ( 0.91771 ) \\ = 0.68002\end{matrix} & ( 23.84 ) \\ \begin{matrix}{c}_{2} ( {C}_{aryl} 2 {sp}^{3} HO to V 3 d 4 sHO ) = {C}_{2} ( \begin{matrix}{C}_{aryl} 2 {sp}^{3} HO to \\ V 3 d 4 sHO\end{matrix} ) \\ = \frac{{E}_{Coulomb} ( V , 3 d 4 s )}{E ( {C}_{aryl} , 2 {sp}^{3} )} \\ = \frac{- 10.84439 eV}{- 15.76868 eV} \\ = 0.68772\end{matrix} & ( 23.85 ) \\ \begin{matrix}{c}_{2} ( N A O to V 3 d 4 sHO ) = {C}_{2} ( N A O to V 3 d4sHO ) \\ = \frac{E ( V , 3 d4s )}{E ( N A O )} \\ = \frac{- 10.83045 eV}{- 14.53414 eV} \\ = 0.74517\end{matrix} & ( 23.86 ) \\ \begin{matrix}{c}_{2} ( O to V 3 d 4 sHO ) = \frac{E ( V , 3 d 4 s )}{E ( O )} \\ = \frac{- 10.83045 eV}{- 13.61805 eV} \\ = 0.79530\end{matrix} & ( 23.87 ) \\ \begin{matrix}{c}_{2} ( F A O to Cr 3 d 4 sHO ) = {C}_{2} ( F A O to Cr 3 d 4 sHO ) \\ = \frac{{E}_{Coulomb} ( Cr , 3 d 4 s )}{E ( F A O )} \\ = \frac{- 12.54605 eV}{- 17.42282 eV} \\ = 0.72009\end{matrix} & ( 23.96 ) \\ \begin{matrix}{c}_{2} ( Cl A O to Cr 3 d 4 sHO ) = {C}_{2} ( Cl A O to Cr 3 d 4 sHO ) \\ = \frac{{E}_{Coulomb} ( Cr , 3 d 4 s )}{E ( Cl A O )} \\ = \frac{- 12.54605 eV}{- 12.96764 eV} \\ = 0.96749\end{matrix} & ( 23.97 ) \\ \begin{matrix}{c}_{2} ( C 2 {sp}^{3} HO to Cr 3 d 4 sHO ) = {C}_{2} ( \begin{matrix}C 2 {sp}^{3} HO to \\ Cr 3 d 4 sHO\end{matrix} ) \\ = \frac{{E}_{Coulomb} ( Cr , 3 d 4 s )}{E ( C , 2 {sp}^{3} )} \\ = \frac{- 12.54605 eV}{- 14.63489 eV} \\ = 0.85727\end{matrix} & ( 23.98 ) \\ \begin{matrix}{C}_{2} ( {C}_{aryl} 2 {sp}^{3} HO to Cr 3 d 4 sHO ) = \frac{{E}_{Coulomb} ( Cr , 3 d 4 s )}{E ( {C}_{aryl} , 2 {sp}^{3} )} \\ = \frac{- 12.54605 eV}{- 15.76868 eV} \\ = 0.79563\end{matrix} & ( 23.99 ) \\ \begin{matrix}{c}_{2} ( O to Cr 3 d 4 sHO ) = {C}_{2} ( O to Cr 3 d 4 sHO ) \\ = \frac{{E}_{Coulomb} ( Cr , 3 d 4 s )}{E ( O )} \\ = \frac{- 12.54605 eV}{- 13.61805 eV} \\ = 0.92128\end{matrix} & ( 23.100 ) \\ \begin{matrix}{C}_{2} ( F A O to Mn 3 d 4 sHO ) = \frac{E ( Mn , 3 d 4 s )}{E ( F A O )} \\ = \frac{- 14.22133 eV}{- 17.42282 eV} \\ = 0.81625\end{matrix} & ( 23.113 ) \\ \begin{matrix}{C}_{2} ( Cl A O to Mn 3 d 4 sHO ) = \frac{E ( Cl A O )}{E ( Mn , 3 d 4 s )} \\ = \frac{- 12.96764 eV}{- 14.22133 eV} \\ = 0.91184\end{matrix} & ( 23.114 ) \\ \begin{matrix}{c}_{2} ( C 2 {sp}^{3} HO to Mn 3 d 4 sHO ) = \frac{{E}_{Coulomb} ( Mn , 3 d 4 s )}{E ( C , 2 {sp}^{3} )} \\ {c}_{2} ( C 2 {sp}^{3} HO ) \\ = \frac{- 14.11232 eV}{- 14.63489 eV} ( 0.91771 ) \\ = 0.88495\end{matrix} & ( 23.115 ) \\ \begin{matrix}{C}_{2} ( Mn 3 d 4 sHO to Mn 3 d 4 sHO ) = \frac{E ( H )}{{E}_{Coulomb} ( Mn , 3 d 4 s )} \\ = \frac{- 13.605804 eV}{- 14.11232 eV} \\ = 0.96411\end{matrix} & ( 23.116 ) \\ \begin{matrix}{c}_{2} ( F A O to Fe 3 d 4 sHO ) = {C}_{2} ( F A O to Fe 3 d 4 sHO ) \\ = \frac{E ( Fe , 3 d 4 s )}{E ( F A O )} \\ = \frac{- 15.81724 eV}{- 17.42282 eV} \\ = 0.90785\end{matrix} & ( 23.131 ) \\ \begin{matrix}{c}_{2} ( Cl A O to Fe 3 d 4 sHO ) = {C}_{2} ( Cl A O to Fe 3 d 4 sHO ) \\ = \frac{E ( Cl A O )}{E ( Fe , 3 d 4 s )} \\ = \frac{- 12.96764 eV}{- 15.81724 eV} \\ = 0.81984\end{matrix} & ( 23.132 ) \\ \begin{matrix}{c}_{2} ( C 2 {sp}^{3} HO to Fe 3 d 4 sHO ) = \frac{E ( C , 2 {sp}^{3} )}{{E}_{Coulomb} ( Fe , 3 d 4 s )} \\ {c}_{2} ( C 2 {sp}^{3} HO ) \\ = \frac{- 14.63489 eV}{- 15.54673 eV} ( 0.91771 ) \\ = 0.86389\end{matrix} & ( 23.133 ) \\ \begin{matrix}{c}_{2} ( {C}_{aryl } 3 {sp}^{2} HO to Fe 3 d 4 sHO ) = {C}_{2} ( \begin{matrix}{C}_{aryl} 2 {sp}^{3} HO to \\ Fe 3 d 4 sHO\end{matrix} ) \\ = \frac{E ( C , 2 {sp}^{3} )}{{E}_{Coulomb} ( Fe , 3 d 4 s )} \\ {c}_{2} ( {C}_{aryl} 2 {sp}^{3} HO ) \\ = \frac{- 14.63489 eV}{- 15.54673 eV} \\ ( 0.85252 ) \\ = 0.80252\end{matrix} & ( 23.134 ) \\ \begin{matrix}{c}_{2} ( O to Fe 3 d 4 sHO ) = {C}_{2} ( O to Fe 3 d 4 sHO ) \\ = \frac{E ( O )}{E ( Fe , 3 d 4 s )} \\ = \frac{- 13.61805 eV}{- 15.81724 eV} \\ = 0.86096\end{matrix} & ( 23.135 ) \\ \begin{matrix}{c}_{2} ( F A O to Co 3 d 4 s HO ) = \frac{E ( F A O )}{E ( Co , 3 d 4 s )} \\ = \frac{- 17.42282 eV}{- 17.49830 eV} \\ = 0.99569\end{matrix} & ( 23.150 ) \\ \begin{matrix}{C}_{2} ( Cl A O to Co 3 d 4 sHO ) = \frac{E ( Cl A O )}{E ( Co , 3 d 4 s )} \\ = \frac{- 12.96764 eV}{- 17.49830 eV} \\ = 0.74108\end{matrix} & ( 23.151 ) \\ \begin{matrix}{c}_{2} ( C 2 {sp}^{3} HO to Co 3 d 4 sHO ) = \frac{E ( C , 2 {sp}^{3} )}{{E}_{Coulomb} ( Co , 3 d 4 s )} \\ {c}_{2} ( C 2 {sp}^{3} HO ) \\ = \frac{- 14.63489 eV}{- 16.97989 eV} \\ ( 0.91771 ) \\ = 0.79097\end{matrix} & ( 23.152 ) \\ \begin{matrix}{c}_{2} ( H A O to Co 3 d 4 sHO ) = {C}_{2} ( H A O to Co 3 d 4 sH O ) \\ = \frac{E ( H )}{{E}_{Coulomb} ( Co , 3 d 4 s )} \\ = \frac{- 13.605804 eV}{- 16.97989 eV} \\ = 0.80129\end{matrix} & ( 23.153 ) \\ \begin{matrix}{C}_{2} ( Cl A O to Ni 3 d 4 sHO ) = \frac{E ( Cl A O )}{E ( Ni , 3 d 4 s )} \\ = \frac{- 12.96764 eV}{- 19.30374 eV} \\ = 0.67177\end{matrix} & ( 23.168 ) \\ \begin{matrix}{c}_{2} ( C 2 {sp}^{3} HO to Ni 3 d 4 sHO ) = \frac{E ( C , 2 {sp}^{3} )}{{E}_{Coulomb} ( Ni , 3 d 4 s )} \\ {c}_{2} ( C 2 {sp}^{3} HO ) \\ = \frac{- 14.63489 eV}{- 18.41016 eV} ( 0.91771 ) \\ = 0.72952\end{matrix} & ( 23.169 ) \\ \begin{matrix}{C}_{2} ( {C}_{aryl} 2 {sp}^{3} HO to Ni 3 d 4 sHO ) = \frac{E ( C , 2 {sp}^{3} )}{{E}_{Coulomb} ( Ni , 3 d 4 s )} \\ {c}_{2} ( {C}_{aryl} 2 {sp}^{3} HO ) \\ = \frac{- 14.63489 eV}{- 18.41016 eV} \\ ( 0.85252 ) \\ = 0.67770\end{matrix} & ( 23.170 ) \\ \begin{matrix}{C}_{2} ( F A O to CuAo ) = \frac{E ( CuAO )}{E ( F A O )} \\ = \frac{- 7.72638 eV}{- 17.42282 eV} \\ = 0.44346\end{matrix} & ( 23.183 ) \\ \begin{matrix}{c}_{2} ( Cl A O to Cu A O ) = {C}_{2} ( Cl A O to Cu A O ) \\ = \frac{E ( Cu A O )}{E ( Cl A O )} \\ = \frac{- 7.72638 eV}{- 12.96764 eV} \\ = 0.59582\end{matrix} & ( 23.184 ) \\ \begin{matrix}{C}_{2} ( F A O to Cu 3 d 4 sHO ) = \frac{E ( F A O )}{E ( Cu , 3 d 4 s )} \\ = \frac{- 17.42282 eV}{- 21.31697 eV} \\ = 0.81732\end{matrix} & ( 23.185 ) \\ \begin{matrix}{c}_{2} ( O to Cu 3 d 4 sHO ) = \frac{E ( O )}{E ( Cu , 3 d 4 s )} \\ = \frac{- 17.42282 eV}{- 21.31697 eV} \\ = 0.81732\end{matrix} & ( 23.185 ) \\ \begin{matrix}{c}_{2} ( O to Cu 3 d 4 sHO ) = \frac{E ( O )}{E ( Cu , 3 d 4 s )} \\ = \frac{- 13.61805 eV}{- 21.31697 eV} \\ = 0.63884\end{matrix} & ( 23.186 ) \\ \begin{matrix}{C}_{2} ( Cl A O to Zn 4 sHO ) = \frac{E ( Zn , 34 sHO )}{E ( Cl A O )} \\ = \frac{- 9.08187 eV}{- 12.96764 eV} \\ = 0.70035\end{matrix} & ( 23.198 ) \\ \begin{matrix}{c}_{2} ( C 2 {sp}^{3} HO to Zn 4 sHO ) = {C}_{2} ( C 2 {sp}^{3} HO to Zn 4 sHO ) \\ = \frac{{E}_{Coulomb} ( Zn , 4 sHO )}{E ( C , 2 {sp}^{3} )} \\ {c}_{2} ( C 2 {sp}^{3} HO ) \\ = \frac{- 9.11953 eV}{- 14.63489 eV} ( 0.91771 ) \\ = 0.57186\end{matrix} & ( 23.199 ) \\ \begin{matrix}{c}_{2} ( Cl A O to Sn 5 {sp}^{3} HO ) = {C}_{2} ( Cl A O to Sn 5 {sp}^{3} HO ) \\ = \frac{E ( Sn , 5 {sp}^{3} )}{E ( Cl A O )} \\ = \frac{- 9.27363 eV}{- 12.96764 eV} \\ = 0.71514\end{matrix} & ( 23.221 ) \\ \begin{matrix}{C}_{2} ( Br A O to Sn 5 {sp}^{3} HO ) = \frac{E ( Sn , 5 {sp}^{3} )}{E ( Br A O )} \\ = \frac{- 9.27363 eV}{- 11.8138 eV} \\ = 0.78498\end{matrix} & ( 23.222 ) \\ \begin{matrix}{c}_{2} ( I A O to Sn 5 {sp}^{3} HO ) = \frac{E ( Sn , Sn 5 {sp}^{3} )}{E ( I A O )} \\ = \frac{- 9.27363 eV}{- 10.45126 eV} \\ = 0.88732\end{matrix} & ( 23.223 ) \\ \begin{matrix}{c}_{2} ( O to Sn 5 {sp}^{3} HO ) = {C}_{2} ( O to Sn 5 {sp}^{3} HO ) \\ = \frac{E ( Sn , 5 {sp}^{3} )}{E ( O )} \\ = \frac{- 9.27363 eV}{- 13.61805 eV} \\ = 0.68098\end{matrix} & ( 23.224 ) \\ \begin{matrix}{c}_{2} ( H A O to Sn 5 {sp}^{3} HO ) = \frac{{E}_{Coulomb} ( Sn , 5 {sp}^{3} )}{E ( H )} \\ = \frac{- 9.32137 eV}{- 13.605804 eV} \\ = 0.68510\end{matrix} & ( 23.225 ) \\ \begin{matrix}{C}_{2} ( C 2 {sp}^{3} HO to Sn 5 {sp}^{3} HO ) = \frac{E ( Sn , 5 {sp}^{3} HO )}{E ( C , 2 {sp}^{3} )} \\ {c}_{2} ( C 2 {sp}^{3} HO ) \\ = \frac{- 9.27363 eV}{- 14.63489 eV} ( 0.91771 ) \\ = 0.58152\end{matrix} & ( 23.226 ) \\ and & \\ \begin{matrix}{c}_{2} ( Sn 5 {sp}^{3} HO to Sn 5 {sp}^{3} HO ) = \frac{{E}_{Coulomb} ( Sn , 5 {sp}^{3} )}{E ( H )} \\ = \frac{- 9.32137 eV}{- 13.605804 eV} \\ = 0.68510 .\end{matrix} & ( 23.227 )\end{matrix}$$
